(19) United States
(12) Patent Application Publication
(10) Pub. No.: US 2026/0295336 A1
(43) Pub. Date: Oct. 1, 2026

(54) Object-Originated Spatial Awareness System for Physical Performance Adjudication

(71) Applicant: Alvaro Ernesto Siman, West Jordan, UT (US)

(72) Inventor: Alvaro Ernesto Siman, West Jordan, UT (US)

(21) Appl. No.: 19/572,061

(22) Filed: Mar. 19, 2026

Related U.S. Application Data
(63) Continuation-in-part of application No. 17/461,021, filed on Aug. 30, 2021.
(60) Provisional application No. 63/775,207, filed on Mar. 20, 2025.
(60) Provisional application No. 63/776,889, filed on Mar. 24, 2025.
(60) Provisional application No. 63/966,150, filed on Jan. 22, 2026.

(51) Int. Cl. A63B 24/00; G01B 21/32

(52) U.S. Cl. CPC A63B 24/0021; G01B 21/32; A63B 2024/0025; A63B 2024/0028

(57) ABSTRACT

A system is disclosed wherein performer and venue spatial assemblies actively generate and emit positional and topographical spatial data in an object-originated architecture rather than being passively observed by external line-of-sight systems. Each assembly comprises Equipment Decentralized Identifier (EDID)-bearing surface regions generating timestamped spatial emission data attributed at emission, producing sparse vector-based topographical wireframe representations differentiated by anatomical region, equipment component, and venue delimiter rather than as undifferentiated point clouds. An AI sensor fusion engine generates time-indexed state records through conflict resolution, describing region-specific position, orientation, deformation state, and surface contact topology. The resulting records preserve continuity of deformable volumetric identity through motion, contact, compression, deformation, and occlusion without post hoc reconstruction from external observation. The system supports adjudication-grade spatial determinations, volumetric performance reconstruction, interactive simulation, and spatially enriched broadcast content.

### CROSS-REFERENCE TO RELATED APPLICATIONS

This application claims the benefit of priority under 35 U.S.C. § 119 (e) and § 120 to the following prior applications, each of which is incorporated by reference in its entirety for all purposes:

### PROVISIONAL APPLICATIONS

1. U.S. Provisional Application No. 63/966,150, entitled “Multi-Layered High-Precision Sports Tracking System-Third Iteration,” filed Jan. 22, 2026, Confirmation No. 3793;
2. U.S. Provisional Application No. 63/776,889, entitled “Multi-Layered High-Precision Sports Tracking System-Second Iteration,” filed Mar. 24, 2025, Confirmation No. 8378;
3. U.S. Provisional Application No. 63/775,207, entitled “Multi-Layered High-Precision Sports Tracking System,” filed Mar. 20, 2025, Confirmation No. 4556;
4. U.S. Provisional Application No. 63/204,174, entitled “Incorporation of Computing Hardware that Captures and Conveys the Shape and Relative Position of Sporting Equipment Without Affecting its Required Physical Performance,” filed Sep. 16, 2020, Confirmation No. 5943.

This provisional application is intended to become a non-provisional continuation-in-part of U.S. patent application Ser. No. 17/461,021, entitled “Incorporation of Computing Hardware that Captures and Conveys the Shape and Relative Position of Sporting Equipment Without Affecting its Required Physical Performance,” filed Aug. 30, 2021, which claims priority to U.S. Provisional Application No. 63/204,174, filed Sep. 16, 2020. The present application contains subject matter disclosed in the above-identified applications as well as new matter not previously disclosed. This provisional application is filed with the express intent to preserve, clarify, and further enable a foundational system architecture previously disclosed by the applicant in related applications, including U.S. patent application Ser. No. 17/461,021, wherein spatial knowledge, geometric state, and positional awareness originate within the tracked object and associated equipment rather than being inferred through external observation, line-of-sight scanning, or post-hoc reconstruction. The disclosure herein does not repudiate prior disclosures, or narrow the inventive paradigm previously described; instead, it builds upon and extends that same paradigm inversion through additional embodiments, refinements, and explanatory detail. The applicant expressly intends that priority, continuity, and claim support for this object-originated spatial awareness architecture be preserved across the parent application, this provisional filing, and any subsequent continuation, continuation-in-part, U.S. utility applications derived therefrom, regardless of differences in specific implementations, sensing modalities, or system components used to realize that architecture.

### FIELD OF INVENTION

This invention discloses a spatial tracking system for capturing the three-dimensional shape, position, and volumetric presence of multiple dynamic entities-Performers/Players (SEE: Inventor's Lexicography), referees, game balls, Equipment/Gear (SEE: Inventor's Lexicography), and field delimiters-within professional Performance/Game (SEE: Inventor's Lexicography) and athletic environments, including the field's or venue's topographical surface elevation profile. Unlike prior art systems offering two-dimensional tracking, this invention enables full sculptural object shape reconstruction across six degrees of freedom, while the sculptural shape of the object deforms in acrobatic contortions. (X, Y, Z, pitch, roll, and yaw).

In order to track and position the sculptural boundary shape of multiple dynamic entities and the space they occupy, the invention necessitates inverting traditional tracking and positioning paradigms. For example, conventional six-degree-of-freedom GPS or radar style positioning assumes rigid body movement wherein all surface points are counted on as maintaining the constant distances from the object's centroid that a fixed-form object offers. As such, centroid-based positioning inferences the outer boundary shape of a sculptural object, and reduces their 3D shapes to a single blinking dot on a 2D plane. These systems are inherently incapable of tracking the dynamic deformation or contorting surface characteristic of human athletic movement, and rely on a 2D dot (centroid) reductionist abstraction that represents the object/subject. Centroid-based tracking intentionally discards precisely the spatial information modern sports officiating and broadcasting require; for example, knowing the center-of-mass location of a football does not establish whether the nose of the ball crossed a boundary plane, the true determinant of a touchdown in American football. Knowing the center-of-mass location of a player does not establish whether the knee contacted the ground before the ball broke the plane. Boundary determinations require object shape boundary data, and 2D centroid tracking provides only the rough approximate location of where a dynamic entity's center mass falls on a 2D plane.

Sports officiating and broadcasting have tried to compensate for these deficiencies with what were the best available technologies in the 20th Century, namely Instant Replay. However, as experience has proven, Instant Replay is insufficient when it comes to tracking and positioning object boundaries when they traverse field lines and/or are in contact with surfaces. First, video cameras cannot see through humans or objects, and thus as specifically deficient in multi-player contact sports like American football, basketball, rugby and soccer where a mass of humanity occult the game ball as well as the rules-relevant position of player body parts. Second, video cameras flatten three-dimensional reality into two dimensions, and furthermore, segments the continual flow of reality it into a limited number of frames per second for replay. Sports broadcasters attempted to improve Instant Replay by adding more cameras for more view angles, but more cameras do not result in an ability to see through humans, regardless of the amount of camera angles. Determinations that require three-dimensional information become impossible, and Instant Replay, once seen as the future of modern sports, has become a frustrating impediment to the performance for both player and spectator alike. The problem to be solved is a physics problem, not a technology improvement task: no camera and no referee can see through solid bodies, and that is a law of physics, not a solvable technology limitation. Attempting to achieve the spatial awareness by incrementally improving Instant Replay is analogous to attempting to produce a Formula One racing vehicle by refining the horse-drawn buggy; the limitation is not insufficient engineering of the existing approach but the categorical inadequacy of the paradigm itself.

### The Pivotal Nature of the Necessary Paradigm/Conceptual Inversions:

Conventional motion-capture and tracking systems typically employ the 2D centroid tracking, as in GPS and radar, and what can be called an Internal Joint Abstraction Paradigm, where a simple stick figure represents the anatomical joint angles of a human or animal for posture and posing. 2D centroid abstracts three-dimensional reality into a single dot on a 2D plane, while skeletal-joint solutions attempt to model the three-dimensional human body via a collection of internal pivot points, resulting in a simplistic 3D stick figure that fails to capture volumetric and sculptural truth of the body it represents. Sculptural object surface boundaries are at best inferred, not measured, in these systems. These two approaches may be appropriate for animation, biomechanics modeling, robotics, and gait analysis, and the 2D centroid reduction of a 3D object may be useful for avionics or vehicular positioning, but both are inadequate where the positioning of a multiple, dynamic, 3D object shapes must be positioned within relation to other 3D sculptural boundary shapes, within a 3D space, and tracked in their continual and unpredictable motion. Neither are appropriate for adjudication of objects whose shape is continually morphing, namely the human body in acrobatic contortion.

Sports adjudication cares about a fundamentally different spatial question than what navigation and video gaming positioning require. Sports officials do not care where a knee's rotational axis is located. They care whether the outermost surface of the knee crossed the outermost surface of a line or boundary. This invention is a boundary-primary paradigm, where the sculptural surface truth of the object and spaces being tracked are the necessary metric to be measured.

This invention is also distinguished from traditional 3D object shape capture, otherwise known as 3D scanning, as those systems are inherently line-of-sight dependent like Instant Replay. LiDAR, for example, (Light Detection and Ranging) focuses a laser beam on the object to be scanned/tracked, but is equally prone to failure once that object is concealed behind other masses. Traditional high-fidelity or metrology-grade 3D object shape scanning systems teach away from the need to track continual motion of a contorting and deforming acrobatic figure, and are designed to work with stationary objects in order to accurately ascertain the fixed shape of a solid object by systematic and accumulating calculations of the laser's distance from the surface being scanned. This process of slowly and systematically accumulating point distances in the creation of a “point cloud” is geared towards generating a maximum density of points representing a static, non-amorphous form, where there is no hierarchy or differentiation between one point in the cloud and the next, only continuous triangulation between distances to convert a mass of points (fixed distances) into a continuous and undifferentiated high-polygon-count sculptural surface mesh connecting all those points.

For avoidance of doubt, this distinction equally applies to photogrammetry, which utilize multiple photographs to extrapolate 3D shapes by analysis of 2D depth representation. Those systems are approximations of actual depth and are equally reliant on a clear line-of-sight. Other systems, such as time-of-flight cameras or structured-light depth sensors are equally incapable of resolving the full geometric/sculptural envelope of an object that is occluded, in motion, or undergoing deformation, and therefore also fall within the same line-of-sight limitation already addressed above.

Line-of-sight dependent 3D scanning processes, even when AI assisted, teach away from motion and continual deformation capture, as well as away from a hierarchical and differentiation between the parts of the object scanned, for example, differentiating the ball from the hand that is holding it. They simply produce a continuous mesh of all the connected points into a fixed sculptural shape, regardless of real world differentiation; doors are rendered as the same mass as walls; jewelry is rendered as surface texture on skin; a baseball bat would be rendered as an extending mass from the player's arms. Semantic segmentation requires either (a) human-curated training data that encodes the segmentation decisions a priori, or (b) human correction at production quality thresholds, or both—and in either case, the semantic knowledge is being imposed externally onto inherently undifferentiated data. (PointNet, PointNet++, RandLA-Net, etc.) In the age of AI assisted 3D, even supervised machine learning models for point cloud segmentation require massive human-labeled training datasets (ScanNet, S3DIS, SemanticKITTI—are all hand-annotated). In those applications, human intervention is baked into the pipeline at the training stage, and in their production workflows (architectural scanning, forensic reconstruction, industrial metrology), human operators routinely review and correct segmentation boundaries after the fact, because automated results are unreliable at object interfaces—and are ill-equipped for real-time segmentation of objects that are acrobatically contorting while in motion, where one object comes into the line-of-sight of the other, as would be the case in a live American football game with 22 players running at full speed around each other and tackling each other. While post-acquisition computational techniques, including but not limited to semantic segmentation of point clouds, can impose categorical labels upon subsets of an already-captured point cloud—for example, labeling certain points as belonging to an arm and adjacent points as belonging to a baseball bat—such techniques do not and cannot overcome the fundamental line-of-sight limitation from which the source data was acquired. Semantic segmentation can only operate upon data that was successfully observed/captured from an unoccluded line-of-sight; it does not generate, recover, or reconstruct spatial data for surfaces that were never observed or observable due to line-of-sight occlusion.

This invention is also distinct from the traditional motion picture industry's motion-capture systems. Those motion-capture frameworks define identity through joint hierarchies and kinematic chains, where anatomical joint markers are adhered to the body of the performer whose performance is captured as flattened video data. A computer later extrapolates the position of those anatomical markers into the performer's acrobatic movements so they can later be utilized to create a virtual character whose outer volumetric shape is substantively different than that of the performing actor's bodily shape. 3D volumetric truth is not being captured. It is post hoc extrapolated and replaced in the motion-capture systems of movie making.

This invention inverts this line-of-sight, observer to observed paradigm, by having the object report its sculptural shape's placement in spatial coordinates, while in full motion and acrobatic contortion. It is the diametric opposite of traditional 3D object scanning and conventional 3D modeling. This invention is more akin to a dynamic topographical map in the form of 3D wireframes, where the topographical lines align with the object's or performer's anatomical design lines, (knee, elbow, hand) thus capturing and expressing the 3D shape of major anatomical shapes, where the subject/object generate and report their shape and position. It also prioritizes positioning and tracking according to the hierarchy of adjudicatory importance per the performance being captured. Poignantly, these 3D wireframe topographies of objects and spaces are exponentially more manageable for data transmission needs than the computation-heavy dense point clouds of conventional 3D objects. This is especially so when the intent is to capture unpredictable, real-time, chaotic movement of multiple tracked objects all simultaneously contorting in acrobatic play.

This invention also distinguishes itself from the planned positioning of choreographed performances, like drone swarms. Drone swarm systems are choreographed hub-to-spoke conceptions, where the hub tells the objects how and where to move in a planned and orderly fashion in order to choreograph a predictable outcome of a performance. This invention is the inverse, in that the information flows in the opposite direction, where the objects tell the hub when and where they are moving to, in order to report chaos in a performance that is intended for collisions and unpredictable outcomes. This change in the direction of information travel is a critical paradigm inversion. One is systematic and orderly, anticipated, planned and programmatically managed movement. The other assumes unplanned disorder, chaos, dynamic acrobatic contortion of the subjects and seeks to capture, transmit, and preserve that chaos.

Most importantly, in this model, the external perimeter of each object being tracked constitutes the authoritative spatial truth, as opposed to the 2D centroid reduction of the volumetric subject. Adjudication-relevant determinations are resolved by evaluating the spatial relationship between external volumetric boundaries rather than by calculating internal joint positions or centroid trajectories. The Boundary-Primary Conceptual Inversion:
Does not rely on rigid-body abstractions
Directly measures, does not infer, sculptural shape of the bodies being tracked
Does not model internal joint pivot centers as primary truth
Deems internal skeletal geometry as irrelevant to adjudication
Defines spatial truth by outer perimeter geometry
Resolves contact events by surface-to-surface intersection
Rejects centroid-based inference of outer shape as insufficient

The present invention defines identity as a continuously updated volumetric boundary envelope preserving actual sculptural truth. The 3D topographical wire mesh of the performer maintains a coherent external surface representation despite deformation, compression, or fabric displacement. Identity is preserved through directly measured boundary continuity, not through extrapolation. This is a pivotal conceptual inversion. The failures described above are not a matter of higher or lower resolution. This is a shift in what counts as relevant geometry, and a domain-driven conceptual inversion that is non-negotiable per the needs of the performances being captured, where it is always the outer boundaries of a ball that matters for officiating.

### Paradigm & Conceptual Inversions:

Conventional spatial tracking systems are defined herein as External Observation Paradigms wherein external sensors must observe passive objects to acquire spatial data. This invention operates within an Object-Originated Spatial Awareness Paradigm wherein tracked objects themselves generate and emit their spatial position data. This measurement causality inversion—from “observers measure objects” to “objects report their own position”—eliminates line-of-sight dependency. Spatial knowledge exists within the tracked objects/subjects participating in the system prior to any external visualization. This concept inversions is an architectural reassignment that affords capabilities unattainable under conventional frameworks. Each inversion described herein reallocates where spatial knowledge originates, how identity is defined, how motion is interpreted, and what constitutes adjudicative truth. The foregoing paradigm and conceptual inversions collectively define the architectural identity of the invention and thus must be clearly defined:
Spatial knowledge originates from the object being tracked rather than externally reconstructed.
Positioning is distributed and collective rather than a fixed hub-to-spoke configuration.
Independent movement, chaos, and collisions are assumed rather than avoided.
Human bodies are treated as dynamically deformable volumetric identities not than rigid abstractions.
Surface boundaries, not internal skeletal joint pivots, determine positioning truth. (see FIG. 13)
Reporting is hierarchically modulated according to adjudicative relevance of the performance.

### Each Inversion Reallocates Foundational Assumptions of Prior Art Systems:

(a) Infrastructure Conceptual Inversion: Under conventional positioning systems, tracking infrastructure is fixed and objects are positioned relative to that infrastructure; anchors are stationary; participants are mobile targets. In the present invention's Infrastructure Conceptual Inversion, tracked entities may themselves constitute the positioning infrastructure. Through reciprocal ranging and spatial emission, the subject/objects dynamically function as mobile reference anchors for one another. Infrastructure may therefore be distributed, mobile, and event-bound rather than permanently installed and externally imposed. Passive targets become active contributors to the spatial framework.
(b) Collision-Assumptive Conceptual Inversion: Swarm robotics and multi-agent systems are designed to avoid collision and choreograph planned performance outcomes Intersection of volumes (collisions) are treated as a fault condition to be prevented through trajectory planning and obstacle detection. Rigid-body separation is a governing constraint. The present invention implements a Collision-Assumptive Conceptual Inversion, where acrobatic athletic contortion, collision, compression, occlusion, and volumetric overlap are not failures; they are defining events. The architecture presumes dense multi-body contact and is engineered to maintain spatial resolution during pile formations, grappling, and impact events. Spatial reporting does not degrade during contact; contact itself is adjudication-relevant data. Systems designed to prevent collision cannot be trivially modified to operate under collision-native conditions because their foundational assumptions treat overlap as error rather than as signal.
(c) Deformable-Body & Boundary-Primary Conceptual Inversions: Conventional multi-agent localization and swarm systems assume rigid-body geometry. An agent's spatial state is fully described by six degrees of freedom—three translational and three rotational—because the agent's shape is constant. In avionics, for example, pitch, yaw, roll, surge, sway, and heave are the six degrees of freedom, where the body being described is assumed to be rigid and unchanging in shape. The present invention operates on a Deformable-Body Conceptual paradigm, where the subject/object to be tracked are assumed to be continuously deformable volumetric identities. Fabric stretches, padding compresses, limbs articulate, and surfaces morph under load. Spatial truth is therefore not reducible to centroid coordinates upon which a rigid body's orientation is described. This inversion is essential in collision-intensive athletic contexts where surface contact, compression, and morphological change determine rule outcomes.
(d) Dynamic Adjudicative Relevance Hierarchy Inversion: Conventional distributed networks treat nodes symmetrically. Reporting weight and communication frequency are typically uniform or governed by generic network efficiency criteria. The present invention operates upon a Dynamic Adjudicative Relevance Hierarchy Inversion. Reporting density, ranging priority, and verification redundancy are modulated according to performance/event rule relevance. Assemblies proximate to a game ball, boundary delimiter, or scoring marker are elevated in reporting priority. Distal participants may operate at reduced density without compromising global coherence. This inversion replaces symmetric peer equivalence with context-weighted hierarchy. Spatial certainty is concentrated where rule consequences are greatest.
(e) Measurement Causality Paradigm Inversion: Conventional spatial tracking systems operate under an External Observation Paradigm. In that paradigm, tracked entities are passive and spatial knowledge is reconstructed by external observers. Spatial awareness exists outside the tracked object and is dependent upon vantage geometry. In the present invention's Measurement Causality Paradigm Inversion, spatial knowledge originates within the tracked objects themselves. Tracked entities actively emit their spatial state rather than waiting to be externally observed.

### Applicable Fields Beyond Sports Officiating:

The architecture applies to any domain of Acrobatic Performance (SEE: Inventor's Lexicography)—any coordinated human body movement requiring spatial precision, temporal synchronization, and three-dimensional biomechanical fidelity, encompassing athletic, artistic, occupational, and recreational activities—requiring high-resolution spatial awareness where line-of-sight-technologies impose fundamental limitations:
(a) Motion Picture, Visual Effects Production, and the Performing Arts Preservation: This invention captures the continuous sculptural acrobatics of the performer's anatomy directly in three-dimensional space without having to flatten the performance in order to later extrapolate it into 3D spatial expressions, and thus affords a significantly greater fidelity in capturing the artistic performance.
(b) Combat Sports & Athletic Technique Coaching Analysis: Slow-motion video analysis projects three-dimensional athletic movement onto two-dimensional frames, requiring coaches to discern body poses, joint angles, and segment trajectories from flat imagery constrained by camera placement. In multi-performer contexts such as combat sports, video analysis fails entirely during clinch work and grappling where bodies mutually occlude limb positions. This invention captures true three-dimensional body poses directly—including during physical occlusion—providing quantified biomechanical data rather than subjective visual interpretation. The same capability extends to physical therapy and rehabilitation, where postural assessment determines injury risk and therapeutic benefit, and enables remote instruction without requiring the therapist's physical presence.
(c) Military and Law Enforcement Training: Tactical exercises including war games, force-on-force scenarios, and room clearing drills span terrain and structures where observation posts cannot maintain line-of-sight across all engagement areas. Breaching entry and arrest control techniques require acrobatic precision where incorrect body positioning determines operational failure or personnel injury. This invention enables technique assessment across distributed tactical environments and during close-quarters engagement where the spatial scope and physical occlusion exceed what instructor observation or fixed-camera video review can capture.

### Inventor'S Lexicography & Glossary

1) Acrobatic Performance: Any coordinated human body movement requiring spatial precision, temporal synchronization, and three-dimensional biomechanical fidelity for execution, analysis, preservation, or adjudication—encompassing athletic, artistic, occupational, and recreational activities wherein three-dimensional spatial relationships between body segments, equipment, and environmental reference points determine performance quality, safety, or correctness. The term is not limited to aerial or gymnastic movements but includes any physical performance requiring capture fidelity exceeding line-of-sight observation, two-dimensional video recording or line-of-sight dependent scanning.
2) Anatomical Contour Lines, Design Lines, Boundary-Primary Spatial Determination & Enveloping Substrate Methodology: Boundary-Primary Spatial Determination refers to the rule that spatial truth for adjudication purposes is determined by the external volumetric boundary of tracked assemblies rather than by internal joint pivots or centroid coordinates. This definition extends to the performance venue's topographical or spatial contours which need true renditions of their spatial boundaries, not inferred geometries. The Enveloping Substrate Methodology, which captures the major anatomical object/subject contour lines, where the tracked object and/or space is enveloped by a sensing substrate acquiring three-dimensional shape data akin to a plaster cast capturing a mold, rather than being externally scanned—is a physical implementation of the Object-Originated Paradigm. This principle applies with equal structural force to the design lines of the performance venue itself. The regulatory boundary markings of a performance field—sidelines, end lines, goal lines, hash marks, try lines, pitch boundary lines, and all other markings whose lateral edges at which field territory terminates define the spatial truth of in-bounds, out-of-bounds, scoring, and adjudication determinations—are the venue's design lines in the identical sense that anatomical contour lines are the performer's design lines. Spatial truth for adjudication purposes is determined by the lateral edge of the regulatory marking at which field territory terminates, not by a center-line approximation or a representative point within the marking's width. Accordingly, the Enveloping Substrate Methodology applies to venue regulatory markings as it applies to performer-worn equipment: the sensing substrate integrated within or beneath each regulatory marking is dimensionally co-extensive with the full width of that marking, with sensing elements positioned at or proximate to each lateral edge of the marking's painted boundary, such that the outer perimeter of the marking is the active sensing boundary. The interstitial space between the lateral perimeters of the regulatory marking is a continuous spatial region within which contact and proximity state is independently trackable—a shoe making contact within the inner boundary of the line, straddling the inner edge, straddling the outer edge, or entirely outside the marking each constitutes a distinct and independently determinable adjudicative spatial state. This full-width venue design-line instrumentation implements the Boundary-Primary Spatial Determination principle at the venue level: the playing field is not a collection of graphical markings observed by external cameras, but a Venue Spatial Assembly whose regulatory marking design lines are active EDID-bearing components participating in the cooperative spatial mesh.
3) Equipment/Gear: Non-wearable and wearable implements used in Performances, encompassing sports, theatrical, and military/police training contexts, including uniforms, bats, rackets, sticks, firearms, batons, shields, and gymnastic apparatus, distinct from field delimiters like flags, goal posts, and end-zone pylons—all report their individual sculptural object/volume shape via implementation of the Enveloping Substrate Methodology, which captures the major anatomical object/subject design lines, wherein the tracked object is enveloped by a sensing substrate acquiring three-dimensional shape data akin to a plaster cast capturing a mold, rather than being externally scanned.
4) Spatial Delimiters: Spatial Delimiters are the delimiters of the performance stage, venue, playing field, and/or terrain, such as endzone pylons, corner markers, boundary lines, hashmarks, flags, goals, nets, and goalposts. Spatial Delimiters also capture and transmit their critical boundary shapes by employing the Enveloping Substrate Methodology within the system's cooperative spatial mesh.
5) Timestamped Spatial Emission Data: The data type descriptor for spatial records generated and emitted by individual EDID-bearing components within this system. A Timestamped Spatial Emission Data record consists, at minimum, of: (1) a three-dimensional position coordinate; (2) a nanosecond-resolution timestamp bound to the data at the moment of emission within the originating EDID-bearing component; (3) an orientation quaternion; (4) a confidence metric; and (5) a cryptographic attestation generated by the originating EDID. The timestamp is not a post-hoc label appended during transmission or processing—it is constitutively inseparable from the spatial record, attributed at the moment of origination within the tracked object. Distinguished from position estimates produced by External Observation Paradigm systems, wherein the timestamp records when an external observer captured imagery or signal data, not when the tracked object was at the observed position. Pipeline position: Stage 1 (pre-fusion). All data generated by EDID-bearing components and received by the sensor fusion engine is Timestamped Spatial Emission Data. Distinguished from Spatiotemporal Data, which is the Stage 2 post-fusion conflict-resolved validated output. (SEE: Emission/Compilation/Transmission; EDID; Object-Originated Spatial Awareness Paradigm; Spatiotemporal Data; Sensor Fusion)
6) Spatiotemporal Data: Validated output records produced by the sensor fusion engine following Spatiotemporal Integrity Validation (SIV), wherein each record carries both full three-dimensional spatial state and nanosecond-resolution temporal attribution as structurally constitutive attributes. Distinguished from Timestamped Spatial Emission Data in that Spatiotemporal Data represents a conflict-resolved, SIV-validated determination integrating multiple emission sources, rather than a single component-level ground-truth emission record. Pipeline position: Stage 2 (post-fusion, post-SIV). The conflict-resolution process employs multi-modal reconciliation techniques—Kalman filtering, particle filtering, machine learning inference—applied to Stage 1 Timestamped Spatial Emission Data. These techniques resolve conflicts among multiple simultaneous component-level ground-truth readings, producing a minimum-variance conflict-resolved determination with residual uncertainty bounds. This is architecturally distinct from External Observation Paradigm sensor fusion, which applies the same mathematical techniques to external observation inferences rather than component-level ground-truth measurements. All Officiating Proof-of-Position attestations are generated from Spatiotemporal Data. (SEE: Timestamped Spatial Emission Data; Spatiotemporal Integrity Validation; Sensor Fusion; EDID; Officiating Proof-of-Position)
7) Emission/Compilation/Transmission: Emission, as used herein, emission refers to the act by which an EDID-bearing equipment component generates spatial identity data from within that component, with said data attributed to the component's per-element EDID at the moment of origination. Emission is the data origination event. The attribution of timestamped spatial emission data to a per-element EDID occurs at emission-before compilation, before transmission, and before reception by any external system. Spatial data that is attributed at emission carries its identity as an intrinsic structural property, not as an assignment made by a downstream reconstruction process. Compilation, as used herein, compilation refers to the internal act by which a performer spatial assembly's computing architecture gathers emission outputs from multiple EDID-bearing equipment components within the assembly, relates them hierarchically through the dynamic authority modulation architecture, and commits them to a structured spatiotemporal record prior to transmission. Compilation is an implementation-layer act of the preferred embodiment. The claims do not require a discrete compilation step; they require that timestamped spatial emission data arrive at the sensor fusion engine already attributed to per-element EDIDs at the moment of origination, however that attribution is architecturally achieved. Transmission, as used herein, transmission refers to the act by which compiled, EDID-attributed timestamped spatial emission data is conveyed from a performer spatial assembly through the radio frequency communication architecture to the AI-driven sensor fusion engine. Transmission is the conveyance event. Data that is transmitted by the differentiated surface regions of a performer spatial assembly has already been attributed at emission and compiled into a structured spatial record. Transmission conveys identity-attributed data; it does not create, assign, or modify that attribution. The three terms describe a single continuous sequence that occurs for every timestamped spatial emission data record this architecture produces: EMISSION→COMPILATION→TRANSMISSION. Emission: Timestamped spatial emission data originates from within the EDID-bearing equipment component. Identity and timestamp are bound to data at this moment. Compilation: The performer spatial assembly gathers, relates, and commits emission outputs from its component EDIDs into a structured spatial record. Transmission: The compiled, attributed spatial record is conveyed to the AI-driven sensor fusion engine. This is the communication act.
8) Point Cloud: An industry term utilized to describe dense sampling of surface points sufficient to reconstruct three-dimensional sculptural shapes employed by traditional 3D scanning/computing. In order to resemble observable reality, point clouds require upwards of 250,000 measured points woven into a mesh of connected dots for a human subject's anatomical contours to resemble anatomical reality, and are here distinguished from the vector-based, topographical, wireframe representations of the sculptural shape of key anatomical shapes of a human body and/or equipment this invention primarily relies upon. Point Cloud are also distinguished from the invention's sparse vector-based and topographical coordinate collections as point clouds are continuous, uninterrupted, and undifferentiated surface reconstruction through tessellation or mesh fitting with no hierarchy or distinction between major anatomical shapes, or from the performer and the performer's equipment or game ball.
9) Accuracy: As required for adjudication applications, adjudication-grade accuracy is defined as positional uncertainty equal to or better than one-sixteenth ( 1/16th) of an inch (approximately 1.6 millimeters) in all three spatial dimensions under operational conditions including high-velocity motion, transient occlusion, dense electromagnetic interference, and multi-body contact events both indoors and outdoors. Adjudication-grade accuracy is distinguished from navigation-grade, consumer-grade, and asset-tracking accuracy: (a) it must resolve spatial distinctions smaller than the minimum consequential threshold for officiating determinations-whether a ball crossed a goal line or a foot touched a boundary marker; (b) it must be maintained continuously without degradation during dynamic athletic events at the precise moments officiating determinations occur; (c) it must be empirical and defensible under competitive protest, broadcast review, and legal challenge; and (d) it must be achieved for all simultaneously tracked objects—game balls in flight, players in contact, and officials in motion.
10) Sensor Fusion: Integration of data from multiple heterogeneous sensors to generate position, orientation, and motion estimates surpassing the accuracy achievable by any single sensor in isolation. Sensor modalities include inertial measurement units (IMUs), optical sensors, radio frequency sensors (UWB, RFID), and environmental sensors. Sensor Fusion as employed in this invention is distinguished from sensor aggregation or sequential polling: (a) fusion applies multi-modal conflict-resolution techniques—Kalman filtering, particle filtering, machine learning inference—to produce conflict-resolved positional determinations with uncertainty bounds smaller than any individual sensor achieves, wherein said techniques resolve conflicts among multiple component-level ground-truth readings rather than inferring position from external observation; (b) fusion performs cross-validation comparing independent modalities for consistency, enabling detection and rejection of erroneous, spoofed, or degraded inputs; (c) fusion operates continuously in real-time with latency constraints dictated by adjudication requirements; and (d) fusion adapts dynamically to sensor availability, degradation, and environmental conditions without manual reconfiguration. Systems that merely collect multi-sensor data without statistical integration, or select whichever sensor appears most reliable without combining measurements, do not perform Sensor Fusion as defined herein. Systems achieving meter-level or centimeter-level fusion accuracy for navigation or consumer applications do not demonstrate capability for adjudication-grade Sensor Fusion requiring sub-millimeter accuracy under professional sports conditions. The distinction is statistical integration producing estimates superior to any individual input, not sensor count.
11) Object/Subject & Performer/Player: Object and Subject are used interchangeably to refer to the object that is a “performer” and “player” as described in this glossary. Performer/Player are used interchangeably to denote human participants in sporting events, theatrical and artistic performances, AI training simulations, and military or police exercises.
12) Physical Compliance: The preservation of Rotational Balance, Weight Distribution, Aerodynamics, Elasticity, friction, durability, and symmetry required for sporting equipment to perform as intended. Physical Compliance imposes industry-specific engineering constraints that prior art sports tracking systems do not address and in many cases teach away from. A tracking system that embeds electronics without preserving Rotational Balance for flying objects rotating at high speeds, like an American football, or that alters Weight Distribution detectably affecting trajectory, spin, or handling, does not achieve Physical Compliance regardless of tracking accuracy or component miniaturization. Systems designed for non-sports applications—medical monitoring, industrial asset tracking, consumer fitness, robot fleet localization—do not inherently satisfy Physical Compliance merely because sensors are small or circuits flexible, as these applications lack the aerodynamic, rotational, and competitive-integrity constraints governing professional sports equipment. Physical Compliance requires holistic system design wherein embedded electronics are distributed and configured to preserve athletic performance characteristics. Three fundamental requirements apply: (1) Weight Distribution appropriate for intended use, (2) Rotational Balance preventing wobble during throwing, kicking, or rolling, and (3) durability for professional competition. These requirements are self-evident to practitioners—equipment that wobbles in the trajectory of travel or is heaver than their respective traditional non-interactive counterpart—is rejected regardless of electronic capabilities. Physical Compliance is verified through governing body certification protocols: equipment either passes or fails published weight, dimensional, and performance specifications (coefficient of restitution, inflation pressure, sphericity).
13) Equipment Performance Specifications: The published technical standards governing physical attributes of sports equipment—game balls, protective gear, uniforms, footwear, apparatus—as promulgated by recognized governing bodies with jurisdiction over competitive play. Specifications define: permitted weight ranges (grams or ounces with tolerances); dimensional requirements (length, width, circumference, diameter); material composition requirements; surface texture and friction characteristics; elasticity and bounce behavior (coefficient of restitution); inflation pressure ranges; and other measurable physical properties affecting competitive fairness, player safety, or game integrity. Governing bodies include: NFL Official Playing Rules; NCAA sport-specific equipment regulations; FIFA Laws of the Game; MLB Official Baseball Rules; NBA Official Rules; NHL Official Rules. Specifications are inherently dynamic—revised in response to technological innovation, competitive evolution, and manufacturer capabilities—and competitive sports equipment exists in continuous technological advancement as players, teams, and manufacturers seek rules-compliant modifications providing competitive advantage. This competitive pressure toward equipment evolution is a defining characteristic of professional sports that any tracking system must accommodate.
14) Rotational Balance & Weight Distribution: Rotational balance governs an object's stability and uniformity of motion when rotating about an axis; Weight Distribution refers to the spatial arrangement of mass relative to geometric structure and intended axes of motion. Both properties influence trajectory predictability, and interaction with external forces (air resistance, gravity, surface friction, player manipulation). For purposes of this specification, “Rotational Balance” refers to the engineering concepts of optimal balance rather than perfect balance. Perfect balance occurs when center of mass coincides exactly with the axis of rotation, producing zero unbalanced forces. Optimal balance involves slight deviations that nonetheless achieve acceptable performance for the specific application. In professional sports equipment manufacturing, perfect balance is not feasible due to inconsistencies of natural materials like leather and rubber, whose thickness and weight fluctuate with weather and humidity. Practitioners understand the objective is balance within acceptable tolerances rather than nanometer-level perfection that is neither achievable nor necessary. (SEE: Thin film electronics) This distinction explains why this specification does not require micrometer-precision component specifications: Rotational Balance and Weight Distribution requirements are satisfied when embedded equipment meets the same tolerances governing non-embedded professional sports equipment as certified by relevant governing bodies.
15) Aerodynamic Profile & Surface Friction: Shape, material, and surface texture determine how objects interact with air and contact surfaces. Aerodynamic profile governs drag, lift, and spin-induced effects (Magnus effect), influencing flight stability, distance, and path curvature—as with golf ball dimples that reduce drag and enhance lift. Surface friction governs grip, spin, and sliding or rolling behavior on contact surfaces (ice, turf, racket strings), enabling player manipulation while ensuring intended movement. For purposes of this specification, the engineering constraint is that embedded electronics must not alter aerodynamic profile or surface friction beyond the tolerances enforced by governing body certification. Aerodynamic Profile & Surface Friction requirements are satisfied when the completed assembly passes the same flight-behavior and surface-interaction tests applied to non-embedded equipment.
16) Elasticity (Coefficient of Restitution): The measure of kinetic energy conserved during collision, expressed as coefficient of restitution (COR) ranging from 0 (inelastic) to 1 (perfectly elastic). COR determines bounce height and responsiveness, critical for rebounding and striking sports. Elasticity requirements are sport-specific: basketball COR (~0.8) ensures consistent dribbling bounce; hockey puck low COR minimizes bounce to maintain ice sliding. For purposes of this specification, the engineering constraint is that embedded electronics must not shift COR outside governed tolerances. COR is a bulk material property determined primarily by bladder composition, inflation pressure, and shell elasticity rather than by trace-level mass additions. Elasticity requirements are satisfied when the completed assembly meets the same COR testing protocols applied to non-embedded equipment by the relevant governing body.
17) Structural Integrity & Mass: Structural integrity is the ability to withstand mechanical stresses—impact, compression, torsion—without permanent deformation or breaking, ensuring shape and function retention under repeated use. Durability prevents mid-game failure; controlled rigidity or flexibility supports sport-specific performance requirements (stiff puck versus deformable basketball; baseball leather/cork construction enduring bat impacts). Mass refers to total weight (distinct from distribution), affecting momentum, force requirements, and gravitational interaction, and must suit sport-specific demands: light for agility (shuttlecock), heavy for impact transfer (bowling ball). For purposes of this specification, the engineering constraint is that embedded electronics must not compromise structural integrity or shift total mass outside governed weight tolerances. Thin-film electronics add approximately 0.15 to 2 grams to assemblies weighing hundreds of grams; equipment manufacturers compensate by adjusting surrounding materials—leather panel thickness, bladder wall gauge, foam density—through standard manufacturing processes such as calendaring in leatherworking, maintaining governed total mass. Structural Integrity & Mass requirements are satisfied when the completed assembly passes governing body weight, dimensional, and durability certification.
18) Performance/Game: Any activity captured and digitized for training, broadcasting, officiating, AI training, 3D simulation, or video game creation—encompassing theatrical, dance, athletic, military, and police contexts.
19) Game Ball: For the purposes of brevity, the term “game ball” is used interchangeably with items of play that have a similar role in an athletic performance such as a hockey puck or badminton birdie, as well as discs, curling stones, a Ringette ring, or a Quots hoop.
20) 3D Spatial Positioning: Determination of an object's location as coordinates within an external reference frame independent of the positioned object. 3D Spatial Positioning requires expressing position relative to both fixed environmental features, stadium infrastructure, or geodetic coordinates as well as to other objects/subjects that are in constant motion and acrobatic contortion whose spatial relationship to other object/subjects participating in the performance and/or game.
21) Officiating Proof-of-Position (OpoP): A cryptographically verifiable digital certificate attesting a tracked object's presence—including but not limited to game ball, player anatomical segment, or equipment element—at a specific three-dimensional position and timestamp, generated through collective agreement of multiple independent positioning modalities and/or mobile reference elements rather than any single sensing technology or fixed infrastructure. Distinguished from prior art general-purpose Proof-of-Location systems in that: (a) position attestation achieves adjudication-grade accuracy sufficient for boundary-crossing determinations, contact event verification, and rules enforcement rather than general proximity confirmation; (b) attesting elements—mobile anchors, referee-worn devices, player-worn tags, ball-embedded sensors. Position proof must withstand evidentiary scrutiny where officiating determinations have binding competitive consequences, imposing tamper-evidence and audit trail requirements exceeding consumer standards. Implementation may employ distributed threshold signature schemes wherein multiple positioning modalities contribute partial attestations aggregating into collective proof only when minimum independent confirmation thresholds are achieved, providing Byzantine fault tolerance against sensor failure, calibration drift, or adversarial manipulation.
22) Contact-Based Sensing: Measurement methodologies determining object state through direct physical interaction between sensor elements and measured object, including but not limited to pressure transduction, thermal conduction, capacitive touch detection, resistive strain measurement, and mechanical deformation sensing. Contact-Based Sensing is distinguished from 3D Spatial Positioning in that: (a) Contact-Based Sensing requires mechanical coupling between sensor and target, whereas 3D Spatial Positioning operates through wireless signal propagation across free space; (b) Contact-Based Sensing measures localized surface phenomena at the contact point, whereas 3D Spatial Positioning determines global coordinates within an external reference frame; (c) Contact-Based Sensing cannot determine position of objects in free flight or non-contact motion phases, whereas 3D Spatial Positioning maintains continuous tracking regardless of contact state; and (d) Contact-Based Sensing provides information about what is touching the sensor surface, whereas 3D Spatial Positioning provides information about where objects are located in three-dimensional space. The distinction is not one of degree but fundamental operational principle: Contact-Based Sensing answers “what is touching this surface and where?” while 3D Spatial Positioning answers “where is this object located in space?”
23) Thin film/Flexible/Wearable Electronics: “Thin film” is a generic industry term in commercial use, describing circuit fabrication involving deposition of conductive or functional materials in layers at micron scales. The industry and this invention use it as a simple adjective+noun phraseology as opposed to a term proprietary to the industry. Thin film circuits comprise conductive or semiconductive layers, typically nanometers to micrometers thick, deposited onto substrates through sputtering, chemical vapor deposition, or printing. Thin film electronic components-sensors, processors, power sources, communication modules—engineered to be affixed to, embedded within, or operatively associated with the human body, clothing, protective gear, or sporting equipment. Flexible circuits comprise conductive pathways (copper or silver traces) patterned onto pliable substrates such as polyimide, polyethylene terephthalate (PET), or elastomeric polymers (e.g., PDMS). These circuits bend, stretch, and conform to non-planar surfaces without compromising electrical integrity. Thin film electronics are employed by this invention as one of several means by which to embed electronics into sports and/or performance equipment without altering or affecting its Physical Compliance. This application is distinct from the performance metrics typical of the thin film electronics industry. In this application, Physical Compliance does not require nanometer-precision component specifications. Embedded thin-film electronics weigh approximately 0.15 to 2 grams; a professional football weighs 400 to 430 grams. At less than 0.5 percent of total mass, the engineering concern is even mass distribution, not component-level dimensional control. Governing bodies test completed assemblies against published tolerances, not individual component dimensions. Equipment manufacturers compensate for embedded electronics by adjusting surrounding materials-leather panel thickness, bladder wall gauge, foam density, mold cavity volume, fabric ply count-through standard processes (calendering, die cutting, material substitution). In these assemblies, thin film electronics constitute engineering “givens” whose dimensions are fixed by sensing function, while traditional materials are alterable to achieve governed outcomes. The specification question is not “how thick is the electronic layer?” but “does the completed assembly pass governing body certification?”
24) Equipment Decentralized Identifier (EDID): A cryptographically verifiable, globally unique identifier assigned to each tracked equipment piece, wearable garment component, or embedded sensor array, conforming to the World Wide Web Consortium (W3C) Decentralized Identifier specification while adapted for professional sports equipment identity and provenance tracking. Each EDID comprises a method-specific identifier string resolving to an EDID Document containing: (a) public cryptographic keys enabling equipment to generate verifiable signatures attesting to identity, calibration state, and operational integrity; (b) service endpoints specifying communication protocols for identity resolution and credential exchange; and (c) metadata including manufacturing origin, league certification status, calibration history, and custody chain records. EDID is distinguished from prior art radio-frequency identification (RFID) in sports tracking in that: (a) EDID provides cryptographic verification through public-key infrastructure rather than static identifiers vulnerable to cloning, spoofing, or replay attacks; (b) EDID enables equipment identity proof without real-time centralized database connectivity, supporting infrastructure-independent operation; (c) EDID supports selective disclosure wherein equipment may attest to league certification without revealing manufacturing details, or confirm calibration validity without exposing custody chain information; and (d) EDID persists across venue deployments, enabling career-spanning tracking of equipment provenance, performance history, and chain of custody for memorabilia authentication and intellectual property attribution. EDID is further distinguished from general-purpose consumer Decentralized Identifier systems—including national digital identity platforms such as China RealDID—in that: (a) identified subjects are physical equipment and embedded sensor arrays rather than human individuals, eliminating biometric verification while introducing Physical Compliance constraints; (b) identity verification derives trust from league certification authorities, manufacturer attestation, and calibration verification rather than government-issued credentials or citizenship documentation; (c) EDID must function within equipment constrained by Rotational Balance, Weight Distribution, and aerodynamic profile preservation, precluding identity hardware disrupting Physical Compliance; (d) the identifier must remain functional under high-velocity impact, environmental exposure, and commercial laundering cycles; and (e) the privacy model inverts the consumer paradigm-equipment identity is maximally transparent for adjudication while ownership and custody information may require selective disclosure for commercial confidentiality. EDID may integrate with Officiating Proof-of-Position, enabling equipment to generate cryptographically signed position attestations binding identity verification to spatial claims—answering not merely “where is the game ball?” but “where is this specific, authenticated, league-certified game ball whose identity has been cryptographically verified?” The integrated OPoP-SIV-EDID architecture—wherein Equipment Decentralized Identifiers establish cryptographically verifiable equipment identity, Spatiotemporal Integrity Validation screens position claims against physics-constrained plausibility tests, and Officiating Proof-of-Position generates threshold-signed position attestations—achieves a synergistic combination absent from prior art. Consumer Proof-of-Location systems lack equipment identity verification and physics-constrained validation. Financial blockchain fraud detection lacks spatiotemporal plausibility constraints for physical motion. Generic W3C DID implementations and national identity systems lack position attestation integration. RFID-based sports tracking lacks cryptographic identity verification, fraud detection, and decentralized position attestation. This non-obvious combination addresses attack vectors—equipment spoofing, position data injection, sensor manipulation, identity forgery—that no single protocol addresses in isolation, establishing defense-in-depth architecture for professional sports adjudication where officiating determinations may face competitive protest, broadcast review, or legal challenge.
25) Performer/Venue Spatial Assembly (PSA & VSA): A Performer Spatial Assembly (PSA) is the federated grouping of all digitally-enabled uniform components with an EDID, namely protective gear, wearable articles, and embedded sensor arrays assigned to a single performer for a defined performance session, wherein each component's boundary/sculptural shape is captured by its integrated sensors and transmitted as a vector-based wiremesh topographical 3D map of each component. Each component possesses a unique EDID and collectively operates as a unified volumetric identity within the spatial tracking system. A PSA, and its components, is continuously deformable and not treated as a rigid body. A PSA is not merely a collection of tagged EDID objects. A PSA is reconstructed computationally to operate as a single adjudicative volumetric entity. It is a logically bound spatial entity whose constituent components cooperatively define the three-dimensional boundary, contour, and positional state of the performer in real time. For avoidance of doubt: A PSA is session-bound and identity-coherent. A PSA may function simultaneously as a tracked subject and as a spatial reference contributor for other PSAs. A Venue Spatial Assembly (VSA), like the PSA, is the federated grouping of all digitally-enabled performance venue spatial delimiting and defining components, gear, equipment and embedded sensor arrays assigned to a single venue for a defined performance session, wherein each component possesses a unique serialized identifier and collectively operates as a unified spatial volume within the spatial tracking system. (SEE: Session Bound Federated Identity)
26) Topographical Registration (pre-performance): The pre-performance procedure in which the AI-driven sensor fusion engine establishes inter-layer transfer functions for the first time in a performance session by mapping the geometric relationships between each EDID-bearing anatomical proximity layer and the body-conformal shape tape substrate adhered to the performer's body surface. This procedure creates the transfer functions—it does not adjust pre-existing functions. Topographical registration is Phase 2 of the Pre-Performance Session-Bound EDID Federation and Topographical Registration Protocol (the Weigh In) (see FIG. 1B). The word “calibration” is architecturally inapplicable to this procedure and is prohibited in all claims and specification language describing it.
27) Continuous Live-Performance Drift-Correction Calibration (live-performance): The continuous, iterative procedure in which the AI-driven sensor fusion engine applies ongoing corrections to the inter-layer transfer functions established during topographical registration. Drift—gradual deviation of sensor output from the registered baseline due to thermal, mechanical, and environmental factors—accumulates during live performance. The sensor fusion engine applies continuous corrections to maintain the fidelity of the transfer functions relative to the anatomical ground truth datum provided by the body-conformal shape tape substrate. This procedure corrects pre-existing functions against a pre-established baseline—it does not create them. The word “calibration” in this lexicography refers exclusively to this procedure.
28) Session-Bound Federated Identity: Session-Bound Federated Identity refers to the pre-performance digital binding of all serialized EDID components belonging to a Performer Spatial Assembly into a single adjudicative identity for the duration of a defined event. This binding may be cryptographic, UUID-based, or otherwise uniquely serialized such that: EDID components cannot be ambiguously attributed across performers during the session. Spatial emissions from constituent EDID components are associated with the correct PSA. Evidentiary continuity is preserved from event commencement through conclusion. EDID identity association may be reset or re-established for subsequent sessions, or during the performance when equipment needs to be replaced and the replacement pieces bound to the PSA. A Performer Spatial Assembly (PSA) and a Venue Spatial Assembly (VSA) are assembly classes within the same cooperative spatial mesh architecture. Both classes share identical architectural principles: each constituent component bears a unique EDID, generates and emits Timestamped Spatial Emission Data, and serves simultaneously as a tracked subject and as a spatial reference contributor for all other EDID-bearing components within the mesh. The architectural equivalence of PSA and VSA classes is a structural consequence of the Object-Originated Spatial Awareness Paradigm: because spatial knowledge originates within each EDID-bearing component regardless of whether that component is performer-worn equipment or venue-installed infrastructure, the cooperative mesh does not distinguish between component classes at the data-architecture level. Any implementation that sources Timestamped Spatial Emission Data from performer-worn equipment components while routing venue spatial delimiter data through External Observation Paradigm infrastructure is a partial implementation that retains hub-and-spoke architecture for the venue dimension and does not constitute the cooperative spatial mesh architecture disclosed herein (see FIG. 14).
29) Collision & Deformation Assumptive Spatial Architecture: Collision & Deformation Assumptive Spatial Architecture refers to a system configuration designed for environments in which inter-object contact, volumetric overlap, compression, volumetric deformation and occlusion are frequent, intentional, and performance-defining phenomena. Within this architecture: Volumetric intersection is not treated as error or failure; Spatial reporting persists during multi-body compression and assumes body deformation and contortion; Contact proximity may be adjudication-relevant data. Localization accuracy of the PSAs and VSA is maintained despite dense body clustering. Systems predicated on collision avoidance, rigid-body separation, or formation symmetry do not satisfy this definition. (SEE: Continuously Deformable Volumetric Identity Model and EDID)
30) Continuously Deformable Volumetric Identity Model: Continuously Deformable Volumetric Identity Model refers to the representation of each Performer Spatial Assembly as a deformable three-dimensional boundary whose contour, surface topology, and volumetric envelope are updated in real time. Under this model: Spatial state is not reducible to six-degree-of-freedom rigid-body parameters as it is in conventional avionics and driver-less vehicles. Surface displacement, compression, and morphological change are tracked. Fabric stretch, padding deformation, and limb articulation alter the volumetric envelope. Adjudication is resolved using boundary geometry rather than centroid inference. Rigid-body swarm agents or skeletal abstractions as utilized in avionics and driver-less vehicle systems do not satisfy this definition. (SEE: Collision & Deformation Assumptive Spatial Architecture)
31) Volumetric Performance Reconstruction (VPR): Volumetric Performance Reconstruction is the computational process of assembling a three-dimensional, temporally continuous digital representation of a live performance event from object-originated spatial data, wherein the reconstruction preserves the full geometric envelope, six-degree-of-freedom articulation, surface deformation characteristics, and contact event topology of all instrumented participants and EDID articles of performance throughout the duration of the event. A Volumetric Performance Reconstruction is distinguished from motion capture reconstructions, camera-derived point clouds, or statistical tracking overlays in that its source data originates from the tracked objects themselves rather than from external observation, and therefore captures spatial information that persists through occlusion events, maintains accuracy independent of camera angle availability, and preserves evidentiary-grade position attestation throughout the reconstruction. The Volumetric Performance Reconstruction constitutes a novel digital work product whose creation is enabled exclusively by the Object-Originated Spatial Awareness Paradigm disclosed herein.
32) Geometric Performance Capture (GPC): Geometric Performance Capture is the process of recording the actual three-dimensional biomechanical execution of a live performance in digitized 3D—including the full spatial trajectory, surface geometry, contact event sequence, and deformation state of all instrumented participants and equipment—from object-originated spatial data, producing a digital record that preserves the performer's individual movement signature with geometric fidelity. Geometric Performance Capture is structurally distinguished from all prior art methods of recording athletic, theatrical, or acrobatic performance in that the captured record encodes what the performer's body and equipment actually did in three-dimensional space, not what statistical models infer the performer's body is likely to have done based on aggregate performance metrics, flattened video/film captures, centroid position estimates, or algorithmically generated animation. This distinction is not one of resolution, sampling rate, or computational sophistication; it is a categorical difference in what the captured data represents. A statistically parameterized performance model encodes probability distributions describing how a performer is likely to move based on historical data, scouting assessments, and attribute ratings; the resulting animation is a computational prediction that never occurred. Geometric Performance Capture digitally encodes the performer's actual spatial states as they occurred, attested by cryptographic provenance from the originating EDID-authenticated sensing elements. No existing sports video game (Madden NFL, FIFA/EA Sports FC, NBA 2K, and MLB The Show) captures or reproduces the actual spatial performance of an identified performer during a specific competition event; all existing sports video games generate algorithmically interpolated approximations parameterized by statistical abstractions of performer capability. Geometric Performance Capture, enabled exclusively by the Object-Originated Spatial Awareness Paradigm, produces a fundamentally different digital work product: a geometrically faithful record of what a specific identified performer actually did during a specific identified competition event, carrying EDID-authenticated cryptographic provenance linking the captured data to the specific performer's Performer Spatial Assembly at the specific event timestamp. For avoidance of doubt, camera-based performance recording—including multi-angle video, photogrammetric reconstruction, and marker-based motion capture—does not constitute Geometric Performance Capture as defined herein, because the spatial content is derived from external observation subject to line-of-sight dependency, occlusion loss, and reconstructive inference rather than originated by the tracked objects themselves.
33) Generalized Gaussian Distribution (GGD): A parametric probability distribution for statistical anomaly detection in Non-Line-of-Sight (NLoS) signal classification, with probability density function p(x; μ, α, β)=(β/2αΓ(1/β))×exp (−|x−μ/\hat{ }β/α\hat{ }β), where μ is location parameter, α is scale parameter, β is shape parameter controlling tail behavior, and Γ denotes the gamma function. When β=2, GGD reduces to standard Gaussian; β<2 accommodates heavier tails. GGD modeling applies to Line-of-Sight (LoS) signal parameters including ranging distance variance (σ²_d) and received first-path power (P_fp) to detect NLOS events as statistical anomalies. GGD is employed because professional sports environments exhibit signal variability with heavier tails than standard Gaussian accommodates, arising from heterogeneous NLOS sources—human tissue attenuation, equipment material interference, transient contact events—differing fundamentally from static-obstacle NLOS in industrial or consumer positioning. (SEE: reference image for formula rendition and Reciprocal Spatial Emission Architecture)
34) Collaborative Spatial Mapping & Reciprocal Spatial Emission Architecture (RSEA): A distributed methodology wherein multiple independently tracked objects within a venue contribute spatial data to a shared computational model, enhancing positional accuracy, resolving occlusion events, and enabling tracking fidelity beyond what any single element could achieve in isolation. Assemblies may dynamically serve as mobile ranging references. Spatial determination persists during occlusion and collision events. Player-worn tag arrays, game ball sensors, equipment-mounted tags, field delimiter mounted emitter/receivers and referee devices contribute to a unified three-dimensional point cloud, each functioning as an active contributor to system-wide spatial intelligence rather than a passive tracking target. RSEA and Collaborative Spatial Mapping are distinguished from conventional swarm or mesh networking systems in that: Spatial knowledge originates within participating assemblies rather than from external observers. Assemblies operate under chaotic, non-cooperative motion conditions. RSEA is not a choreographic swarm control framework and does not impose trajectory planning upon participants. The architecture is measurement-centric rather than motion-control-centric. RSEA and conventional motion-control swarm systems are diametric opposites, as the moving items report the unplanned movements through space and in relation to other items, as opposed to being choreographed to move in a specific pattern by a command unit. (SEE: Collision & Deformation Assumptive Spatial Architecture)
35) Cross-Venue Adaptation Protocol & Infrastructure-Independent Localization Mode: The methodology for maintaining adjudication-grade positioning accuracy across multiple professional sports venues without venue-specific model retraining from initialization. The protocol employs transfer learning wherein a pre-trained deep convolutional neural network (DCNN) for Angle of Arrival (AoA) estimation, optimized using aggregated Channel Impulse Response (CIR) data from characterized venues, is fine-tuned to unseen venues through minimal calibration dataset acquisition and weight adjustment. The protocol addresses sports-venue-specific domain shift including: (a) venue-specific multipath signatures from distinct architectural geometries; (b) variable electromagnetic interference from broadcast equipment and spectator devices; (c) crowd-density-dependent signal attenuation; and (d) temporary infrastructure configurations such as tournament-specific field dimensions. Distinguished from prior art domain generalization in that: adaptation must maintain tracking continuity for multiple simultaneously tracked elements; acceptable accuracy degradation is bounded by adjudication requirements rather than navigation convenience thresholds; and the protocol must preserve distinguishability between similar tracked elements during adaptation. Dynamic Adjudicative Relevance Hierarchy within a Collaborative Spatial Mapping paradigm release the system from dependency of tracking hardware built into the venue or arena. An Infrastructure-Independent Localization Mode operational configuration positional tracking functions without reliance on permanently installed fixed anchor infrastructure, instead utilizing dynamically designated mobile elements-referee-worn devices, officiating crew equipment, portable boundary markers, or the temporarily deployed units of Collaborative Spatial Mapping—to establish spatial reference. In this mode: Mobile assemblies may function as temporary reference anchors per the Dynamic Adjudicative Relevance Hierarchy model. Nodes can be stationary, like in the case of goal posts and end-zone pylon markers, or mobile repeaters/transmitters worn by the performers or embedded in the gear/equipment. This mode enables deployment in temporary venues, outdoor training environments, military and police exercise fields, and locations where permanent infrastructure is impractical or cost-prohibitive.
36) Adjudication-Grade Continuous Measurement: Adjudication-Grade Continuous Measurement refers to the real-time, sub-millisecond temporal capture of spatial state for multiple tracked objects, subjects and spatial delimiters. Measurement is independent of camera refresh rates, visual angle or visual rendering cadence. Adjudication-Grade Continuous Measurement is evidentiary-grade spatial attestation as it generates contemporaneous, tamper-evident digital records attesting to the three-dimensional position and boundary state of tracked assemblies at defined instants. Such attestation: May incorporate multi-modal sensor concurrence. May utilize distributed verification across assemblies. Is generated at the moment of measurement rather than during replay. Is suitable for competitive protest, regulatory review, or legal scrutiny. (SEE: Collaborative Spatial Mapping and Dynamic Adjudicative Relevance Hierarchy)
37) Dynamic Adjudicative Relevance Hierarchy: Dynamic Adjudicative Relevance Hierarchy is a critical aspect of Collaborative Spatial Mapping in high-velocity, multiple-player, object shape boundary adjudicative systems. It refers to the context-sensitive modulation of reporting frequency, ranging priority, and verification density based on proximity to rule-critical objects or spatial delimiters. Within this hierarchy: Assemblies proximate to a game ball may receive elevated reporting priority; Assemblies near boundary markers or scoring delimiters increase emission density; Reporting weight may decrease for distant participants without compromising system integrity; Priority recalculates dynamically as spatial relationships change. Unlike hub-and-spoke systems, these networks are self-healing, providing robust connectivity for assets as nodes (e.g., performers and spatial delimiters) act as relays for each other, transmitting location data even without direct central coverage. This definition distinguishes the invention from symmetric peer-based mesh systems, as it rejects the paradigm that data flows the same path in both directions. Relevance hierarchy dynamically alters the routing path and/or hub modulated upon adjudication circumstances of the performance being captured, for example, as the performer carrying the ball changes with the game's performance. (SEE: Reciprocal Spatial Emission Architecture) The modulation factors described above—proximity to rule-critical objects, spatial delimiters, and other context-significant elements—are collectively termed context-defined relevance criteria. Context-defined relevance criteria encompass all factors by which the Dynamic Adjudicative Relevance Hierarchy modulates reporting priority, ranging priority, and verification density, including but not limited to: spatial proximity to boundary surfaces; velocity vector relative to scoring delimiters; contact-state with other Performer Spatial Assembly components; and adjudicatively significant positional thresholds as defined by applicable Officiating Rules and Adjudication Standards. No single factor—including proximity—is the exclusive basis for authority weight allocation. (SEE: Hub-and-Spoke Spatial Architecture; Officiating Rules and Adjudication Standards)
38) Non-Audible Acoustic Spectrum: Acoustic frequencies outside typical human hearing range while remaining transducible by authorized system components in stadium, arena, and outdoor environments. The spectrum encompasses frequencies greater than approximately 18 kHz, including but not limited to: near-ultrasonic (approximately 18-24 kHz); ultrasonic (approximately 24-60 kHz); higher ultrasonic (approximately 60-200 kHz); and any sub-bands, adaptive selections, or frequency-hopping sequences within or across these ranges. The system may employ any portion individually, in combination, or with dynamic switching based on environmental conditions, transducer characteristics, venue acoustics, or adjudication requirements. The Non-Audible Acoustic Spectrum is not limited to any single carrier frequency; operating frequency selection may be adaptive, venue-specific, or dynamically adjusted by sensor fusion logic. Implementation includes airborne transmission, structure-borne vibration coupled into infrastructure, or combination thereof.
39) Spatiotemporal Integrity Validation (SIV): A multi-stage verification methodology screening position data for anomalous patterns prior to tamper-evident audit ledger incorporation or Officiating Proof-of-Position attestation generation. Distinguished from general-purpose blockchain fraud detection in that SIV applies physics-constrained plausibility testing to position claims, verifying consistency with: (a) kinematic capabilities of tracked entities, including maximum velocities, accelerations, and trajectory curvatures bounded by human biomechanical limits or equipment physical properties; (b) geometric consistency across independent sensing modalities, wherein Ultra-Wideband ranging, inertial measurement integration, acoustic near-field confirmation, and touch sensing estimates must converge within defined tolerance envelopes; (c) temporal continuity constraints rejecting position discontinuities exceeding physically realizable displacement rates; and (d) environmental boundary conformance ensuring reported positions remain within the tracking volume without penetrating physical obstacles or field infrastructure. SIV employs ensemble machine learning classifiers—including but not limited to gradient boosting, random forest aggregation, and deep neural network anomaly detectors—trained on labeled datasets comprising legitimate athletic motion patterns and synthetically generated or historically observed manipulation attempts, spoofing signatures, and sensor failure modes. The SIV module operates as a pre-attestation gateway, screening position data before blockchain commitment or OpoP certificate generation. SIV further incorporates cross-venue transfer learning, wherein models trained in one deployment environment adapt to novel venues through incremental retraining on venue-specific calibration data, preserving detection efficacy across heterogeneous stadium configurations.
40) Cognitive Spectrum Adaptation: Real-time sensing, analysis, and dynamic modification of radio-frequency transmission characteristics in response to detected interference within the Ultra-Wideband operating band. CSA encompasses three integrated functional stages: (a) spectrum sensing, wherein the system monitors the UWB band using energy detection, cyclostationary feature detection, and matched filtering to identify active interference sources, their carrier frequencies, bandwidths, and temporal activity patterns; (b) interference classification, wherein detected sources are categorized by origin—spectator mobile device emissions, broadcast equipment, venue WiFi infrastructure, LED display switching noise, and other venue-specific sources—using machine learning classifiers trained on labeled interference signatures from venue calibration; and (c) adaptive waveform synthesis, wherein UWB transmission pulse shape is dynamically modified to place spectral notches at frequencies where interference power exceeds positioning-accuracy-degradation thresholds while preserving sufficient bandwidth for sub-millimeter ranging resolution. Adaptive waveform synthesis employs neural network architectures—including but not limited to radial basis function networks and convolutional neural networks trained on venue-specific interference profiles—to generate interference-avoiding pulse shapes achieving spectral notch depths of fifty decibels or greater while maintaining temporal resolution for adjudication-grade time-of-flight measurement. CSA is distinguished from general-purpose cognitive radio approaches in that: (a) the sensing-adaptation cycle must complete within timing constraints preserving continuous tracking of all simultaneously monitored objects without positioning discontinuities; (b) spectral notching must preserve sufficient UWB bandwidth for sub-millimeter ranging accuracy rather than merely avoiding interference at the cost of positioning degradation; and (c) interference models incorporate sports-venue-specific patterns including game-state-correlated crowd device activity, broadcast schedule-driven RF loading, and venue infrastructure electromagnetic signatures differing fundamentally from static or slowly-varying interference environments assumed in consumer and industrial cognitive UWB applications. Consumer cognitive UWB literature teaches away from the present invention by prioritizing spectrum coexistence and regulatory compliance over continuous positioning accuracy, accepting positioning degradation during adaptation transients as acceptable trade-off for interference avoidance. The present invention inverts this priority hierarchy: adjudication-grade positioning accuracy is the inviolable constraint, and spectral adaptation must achieve interference mitigation without positioning discontinuities compromising evidentiary validity. This priority inversion—wherein positioning accuracy constrains adaptation rather than adaptation degrading positioning—represents a non-obvious departure from the consumer cognitive radio paradigm and would not be motivated by prior art teaching that accepts positioning accuracy loss as the cost of interference coexistence.
41) Spatially Enriched Broadcast Signal (SEBS): Spatially Enriched Broadcast Signal is a broadcast-ready data stream, whether transmitted via television, streaming, mobile, or in-venue display platforms, that contains embedded EDID-attributed object-originated spatial metadata generated by Articles of Performance and performer-worn equipment whose distributed sensing elements actively emit positional, orientational, and contact-event data, said embedded spatial metadata enabling receiving systems to render spatial reconstructions not dependent on physical camera infrastructure. A Spatially Enriched Broadcast Signal is structurally distinguished from conventional sports broadcast signals in that its spatial content derives from measurement causality inversion—the tracked objects originated the spatial data rather than being observed by external sensors—and therefore carries geometric envelope data, six-degree-of-freedom pose information, surface contact maps, and cryptographically attested position records that are structurally unachievable through any external observation methodology regardless of sophistication. For avoidance of doubt, a broadcast signal that merely overlays graphical enhancements generated by camera-based tracking, GPS position estimates, or other external observation technologies upon a conventional video feed does not constitute a Spatially Enriched Broadcast Signal as defined herein, because its spatial content is inferential rather than originated.
42) Interactive Performance Data Stream (IPDS): Interactive Performance Data Stream is a machine-readable data output derived from the system disclosed herein, formatted for consumption by interactive entertainment platforms, simulation engines, training analysis systems, or digital gaming environments, wherein the data stream transmits real-time or near-real-time object-originated spatial states—including but not limited to player position arrays, equipment pose sequences, contact event records, and boundary intersection determinations—with sufficient fidelity, temporal resolution, and cryptographic attestation to enable consuming applications to reconstruct, simulate, modify, or extend the tracked performance with geometric accuracy not achievable through external observation data sources. For avoidance of doubt, an Interactive Performance Data Stream differs from conventional sports statistics feeds, camera-derived tracking data packages, or GPS-based telemetry in both data origin (object-originated versus externally observed) and data completeness (full geometric envelope versus centroid approximation or single-point estimation). The IPDS is the enabling data transport for Geometric Performance Capture (GPC) (SEE: Inventor's Lexicography), carrying the geometrically faithful performance records that distinguish GPC-derived interactive entertainment and cinematic content from statistically parameterized simulation content.
43) Officiating Rules and Adjudication Standards: The published rule books, competition regulations, and officiating guidelines promulgated by recognized professional and amateur sports governing bodies, defining criteria for scoring, boundary determinations, possession rulings, penalty assessments, and other officiating decisions the present invention supports. Governing bodies include but are not limited to: the National Football League (NFL); National Collegiate Athletic Association (NCAA); Fédération Internationale de Football Association (FIFA); Union of European Football Associations (UEFA); Major League Baseball (MLB); National Basketball Association (NBA); National Hockey League (NHL); World Rugby; International Tennis Federation (ITF); and analogous governing bodies worldwide. For non-sports application domains, analogous certification authorities govern equipment requirements: Screen Actors Guild (SAG-AFTRA) and studio safety departments for motion capture equipment; aviation authorities including the Federal Aviation Administration (FAA), European Union Aviation Safety Agency (EASA), and military aviation commands for flight equipment; motorsports sanctioning bodies including Fédération Internationale de l′Automobile (FIA), NASCAR, and IndyCar for driver safety equipment; and professional dance companies and theatrical organizations for performance attire. Physical Compliance applies to certification requirements across all enumerated domains—the methodology is universal even as certifying authorities and numerical tolerances vary. Officiating Rules and Adjudication Standards means rules in effect at deployment time for the relevant competition. The invention does not incorporate by reference any specific edition or revision of any rule book, but provides technological capability to support officiating under whatever rules the governing body has established. This definition recognizes that: (a) each governing body maintains exclusive authority to define, interpret, and revise rules for competitions under its jurisdiction; (b) rules are revised periodically to address competitive evolution, safety considerations, and officiating experience; (c) different governing bodies may establish different rules for the same sport; and (d) the adjudication function is to provide spatial data of sufficient accuracy and integrity to support officiating determinations under applicable rules, not to define, interpret, or supplant those rules. A system supporting officiating must provide spatial information resolving the distinctions that matter under applicable rules—regardless of how governing bodies revise dimensional tolerances, timing windows, or boundary definitions. The relationship between Officiating Rules and Adjudication Standards and Equipment Performance Specifications is complementary: the former define spatial and temporal criteria for officiating determinations, while the latter define physical attributes equipment must exhibit for competition—and the present invention provides tracking capability supporting officiating under applicable rules using equipment satisfying applicable specifications. The entity promulgating such rules is referred to herein as a recognized governing authority with jurisdiction over the tracked activity. A recognized governing authority with jurisdiction is any professional, amateur, collegiate, or domain-specific certifying body that holds recognized authority to define, interpret, and enforce the rules applicable to the activity being tracked, including but not limited to the governing bodies enumerated in this definition. Adjudicative criteria promulgated by a recognized governing authority with jurisdiction are applied by the present invention at deployment time—meaning the rules in effect when the system is deployed for a given competition or activity—without incorporating any specific revision or edition of said criteria by reference.
44) Adjudication Participation State (APS): A dynamic, system-managed classification assigned to each Performer Spatial Assembly (PSA) indicating whether that PSA's spatial emissions are eligible for inclusion in officiated adjudication computations during a given temporal window. The Adjudication Participation State is not a binary active/inactive toggle but a multi-state classification comprising at minimum: (a) Active-On-Field, wherein the PSA's spatial emissions are fully eligible for all adjudication computations including boundary determinations, scoring resolutions, contact adjudication, and possession rulings; (b) Sideline-Present, wherein the PSA's spatial emissions continue to be recorded with full fidelity for data integrity and blockchain provenance purposes but are excluded from boundary-proximate adjudication computations to prevent spatial contamination of officiated determinations by non-participating performers whose instrumented equipment occupies spatial regions adjacent to or overlapping with adjudication-critical boundary zones; (c) Bench-Inactive, wherein the PSA's spatial emissions are recorded at reduced reporting priority; (d) Ejected-Excluded, wherein the PSA is permanently decoupled from adjudication computations for the remainder of the session; and (e) Transitional, a time-bounded intermediate state during which the system tracks the PSA's movement between field-of-play and sideline regions to determine appropriate state assignment. Adjudication Participation State is distinguished from the point cloud exclusion described elsewhere herein in that: APS does not suppress, silence, or discard spatial emissions—all EDID-authenticated emissions from all PSAs are preserved in the tamper-evident audit ledger regardless of participation state—but rather attaches participation state metadata to each emission record such that the AI-driven sensor fusion engine and adjudication logic can filter, weight, or exclude emissions based on participation context without destroying evidentiary completeness. Adjudication Participation State is further distinguished from any power management, sleep mode, or emission suppression mechanism in that PSA hardware operational state remains unchanged across all participation states; the classification operates entirely at the logical and computational layer. The Adjudication Participation State architecture addresses a spatial contamination vulnerability unique to the Object-Originated Spatial Awareness paradigm: because every instrumented equipment piece actively generates and emits spatial data regardless of whether its wearer is participating in live play, boundary-proximate adjudication computations—particularly toe-tap, foot-drag, and sideline catch determinations—are vulnerable to false spatial correlation between boundary-line sensing arrays and the instrumented footwear of non-participating performers standing on or near sideline boundaries. External observation systems do not face this vulnerability because camera operators and replay officials visually distinguish active participants from sideline personnel; the Object-Originated paradigm requires a systematic computational equivalent to this visual discrimination. (SEE: Session-Bound Federated Identity; Dynamic Adjudicative Relevance Hierarchy; Performer/Venue Spatial Assembly)
45) Game-State Transition Event (GSTE): A sport-specific occurrence that triggers reassignment of Adjudication Participation States across all registered Performer Spatial Assemblies within the session. Game-State Transition Events include but are not limited to: (a) snap initiation in American football, wherein the system captures the spatial position of all PSAs at the temporal instant of snap detection and assigns Active-On-Field status to PSAs whose spatial centroid falls within the field-of-play boundary at that instant, while PSAs whose spatial centroid falls outside the field-of-play boundary are assigned Sideline-Present status for the duration of that play; (b) formal substitution registration in association football, wherein the fourth official's substitution authorization triggers state transition for the entering and departing PSAs; (c) bench-gate crossing detection in ice hockey, wherein PSA movement through designated bench-access zones triggers Transitional state assignment and subsequent Active-On-Field or Bench-Inactive assignment based on movement trajectory resolution; (d) dead-ball intervals in basketball, wherein the system recalculates Active-On-Field assignments during stoppage to accommodate substitution; (e) set-piece restarts in association football, wherein the system verifies Active-On-Field count matches the legal participant maximum before permitting adjudication computation to resume; and (f) any sport-specific event defined by applicable Officiating Rules and Adjudication Standards as constituting a personnel change opportunity. The Game-State Transition Event architecture does not define or interpret sport-specific rules but provides the computational mechanism through which the system responds to sport-specific events with appropriate Adjudication Participation State reassignment. For avoidance of doubt: Game-State Transition Event detection operates through the same Object-Originated Spatial Awareness infrastructure disclosed herein—snap detection through game ball sensor arrays, substitution detection through boundary-crossing spatial analysis, bench-gate detection through venue infrastructure spatial arrays—rather than through external observation or manual input, although manual override by authorized officiating personnel remains available for edge cases not resolvable through automated detection. (SEE: Adjudication Participation State; Venue Spatial Assembly; Boundary-Line Cooperative Sensing Array)
46) Hub-and-Spoke Spatial Architecture: A spatial tracking or measurement architecture in which a fixed or centrally administered external infrastructure node (the “hub”) serves as the necessary authority intermediary for spatial knowledge generation, with tracked objects serving exclusively as observed, interrogated, or passively reflective subjects (the “spokes”) rather than as active emitters or spatial reference contributors. In a hub-and-spoke spatial architecture: (1) spatial data does not exist within the tracked object—it is constructed by the hub from observation of the spoke; (2) authority flows unidirectionally from hub to spoke; (3) the hierarchy of authority is predetermined and structurally fixed, not dynamically modulated; and (4) the tracked object cannot serve as a spatial reference contributor for other objects in the network.
47) External Line-of-Sight Dependent Observation: A spatial measurement architecture requiring an unobstructed optical or electromagnetic line-of-sight path from one or more external observers, sensors, or transceivers to the tracked object as a necessary precondition for spatial knowledge generation. In an External Line-of-Sight Dependent Observation architecture: (1) spatial knowledge does not originate within the tracked object—it is produced by external observers interpreting signal return or reflected energy from the tracked object; (2) any interruption of the required line-of-sight path—by occlusion, physical contact between tracked objects, environmental interference, or signal absorption—degrades or eliminates spatial knowledge for the duration of the interruption; (3) the tracked object is a passive subject of observation rather than an active originator of spatial knowledge; and (4) contact between tracked objects constitutes an error condition or measurement gap rather than a structurally significant signal event. External Line-of-Sight Dependent Observation is the observational-vector face of the External Observation Paradigm, distinct from but architecturally equivalent to Hub-and-Spoke Spatial Architecture (which describes the network topology) and Unidirectionally Hierarchical Tracking Infrastructure (which describes the authority structure). All three formulations describe the same foreclosed paradigm from different structural angles. (SEE: Hub-and-Spoke Spatial Architecture; Unidirectionally Hierarchical Tracking Infrastructure; Object-Originated Spatial Awareness Paradigm; Measurement Causality Paradigm Inversion)
48) Unidirectionally Hierarchical Tracking Infrastructure: A spatial tracking or measurement infrastructure in which authority over spatial knowledge generation flows exclusively from fixed external infrastructure components to tracked objects, with tracked objects serving exclusively as passive subjects of measurement rather than as active emitters or spatial reference contributors. The authority hierarchy is predetermined and structurally fixed: the infrastructure always occupies the authoritative position and the tracked object always occupies the measured position, with no mechanism for dynamic reassignment of authority weights based on context. A Unidirectionally Hierarchical Tracking Infrastructure is the authority-structure face of the External Observation Paradigm, distinct from but architecturally equivalent to External Line-of-Sight Dependent Observation (which describes the observational vector) and Hub-and-Spoke Spatial Architecture (which describes the network topology). All three formulations describe the same foreclosed paradigm from different structural angles: (1) External Line-of-Sight Dependent Observation forecloses by observational mechanism; (2) Hub-and-Spoke Spatial Architecture forecloses by network topology; (3) Unidirectionally Hierarchical Tracking Infrastructure forecloses by authority structure. The present invention's Dynamic Authority Modulation Architecture is the structural inversion of Unidirectionally Hierarchical Tracking Infrastructure: authority weights are dynamically assigned, reassigned, and modulated among differentiated surface regions and tracking tiers based on context-defined relevance criteria, never permanently fixed in a hierarchy that flows exclusively from infrastructure to tracked object (see FIG. 3). (SEE: Hub-and-Spoke Spatial Architecture; External Observation Paradigm; Dynamic Adjudicative Relevance Hierarchy; Measurement Causality Paradigm Inversion)

### BACKGROUND OF INVENTION

Conventional sports tracking systems deployed across professional Acrobatic Performance contexts—including professional leagues rely predominantly on single-modality frameworks including Global Positioning System (GPS), Radio Frequency Identification (RFID), and optical or vision-based imaging systems such as photogrammetry and Instant Replay. Each technology. All exhibit deficiencies rendering them inadequate for the positional precision demanded in contemporary officiating in the 21^{st} Century. The inherent problems extends beyond just line-of-sight occlusion. GPS suffers from signal degradation and positioning drift in enclosed or partially obstructed environments such as domed stadiums or arenas with metallic infrastructure, where inaccuracy ranges in multiple yards/meters. RFID is vulnerable to electromagnetic interference and signal collision in dense, metal-rich venues. Both GPS and RFID have error ranges larger than the game balls whose position they seek to capture: GPS error ranges from 6 inches to 10 yards, while an American football is only 11 inches long, and positioning determinations necessary for officiating require accuracy better than 1/16th of an inch. Peer-reviewed comparative studies in professional soccer have quantified this inadequacy: Ultra-Wideband systems at 20 Hz update rates achieve positional error of approximately 7-10 centimeters, while 10 Hz GPS systems exhibit error exceeding 40 centimeters under identical conditions—a four-to-six-fold accuracy differential confirming GPS as categorically incapable of adjudication-grade—as defined in the Inventor's Lexicography, distinguished from navigation-grade, consumer-grade, and asset-tracking-grade accuracy which tolerate centimeter-to-meter uncertainty acceptable for logistics or consumer applications but insufficient for officiating determinations requiring sub-millimeter precision under dynamic multi-target conditions—boundary determinations. No improvement in GPS accuracy addresses this mismatch, because the flaw is not precision but representation: a more accurate 2D dot is still only a 2D dot on a 2D plane.

Sports adjudication requires volumetric truth-edges, surfaces, and volumes interacting with defined boundaries. The present invention's target accuracy of one-sixteenth inch (approximately 1.6 millimeters) represents approximately 50-fold improvement beyond peer-reviewed UWB accuracy, achieved through multi-modal sensor fusion, AI-driven refinement, and hierarchical tracking architecture. The present invention also addresses the real-world needs of professional sports equipment manufacturing, which has diverged fundamentally from consumer athletic equipment over the past five decades. Fifty years ago, no functional difference existed between equipment used by professional athletes and products sold to consumers-basketball shoes worn by NBA players in the 1970s were structurally identical to consumer high-tops, and NFL jerseys were functionally indistinguishable from fan replicas. This historical conflation is no longer valid.

This complicating factor becomes consequential when one realizes that contemporary professional equipment are highly engineered, purpose-built assemblies with performance-optimized materials for player position-specific designs. The football uniform exemplifies this evolution: defensive lineman jerseys employ tight-fitting spandex onesie cutting patterns, wide receiver jerseys employ different patterns optimized for range of motion. The professional football uniform is a complex gear set undergoing continuous development, with designs changing multiple times within seasons as conditions vary, and each season's designs differing structurally from prior seasons as engineering optimization continues. This perpetual evolution is why the present invention claims methods applicable to successive equipment iterations rather than specifications tied to single designs: a patent incorporating computing technology into professional equipment must articulate concepts flexible enough to accommodate the frantic pace of change defining professional sports equipment manufacturing. The Physical Compliance requirement is deliberately framed in certification-outcome terms rather than component-dimensional terms because the sports equipment industry does not freeze technology—specifications are revised periodically to address technological evolution, safety research, competitive experience, and manufacturing capabilities—and this dynamic nature does not render them indefinite for patent purposes. Meanwhile authentic fan replicas retain twentieth-century designs bearing no structural relationship to game-issued equipment. The industry has fractured into what it refers to as “Activewear”, “Athleisure” and “Sportswear” each of which have dedicated engineering, design, marketing and manufacturing as the requirements and constraints no longer overlap.

### Requirements of the Person Versed in the Art:

To overcome the documented limitations of obsolete paradigms and conventions, the present invention introduces a multi-modal, sensor-agnostic, spatial tracking architecture integrating redundant and complementary positioning subsystems—primarily including Ultra-Wideband (UWB), Inertial Measurement Units (IMUs), LiDAR, and Visible Light Positioning (VLP)—into a unified, AI-assisted sensor fusion framework. Optionally, the system may leverage quantum-based computing for AI-processing, as quantum computing becomes commercially available. Five years ago, some these technologies would have been considered futuristic; ten years ago, they would have been deemed science fiction. As of 2025-2026, the technologies detailed herein are matured and require only customization for the system being assembled.

The temporal development of constituent technologies warrants explicit documentation as it addresses the cross-domain and multi-industry convergence necessary for design and implementation. Prior to 2010, three-dimensional object mapping remained theoretical research confined to military and academic laboratories. The 2006 Nintendo Wii provided basic gesture recognition without spatial mapping. The 2010 Microsoft Kinect provided skeletal tracking but lacked millimeter-accurate three-dimensional object mapping for professional sports adjudication. The 2014 Google Project Tango demonstrated experimental three-dimensional mapping under laboratory conditions, confirming underlying technology remained inaccessible to ordinary practitioners outside specialized research environments. These milestones establish that three-dimensional object mapping transitioned from experimental science to accessible technology only at approximately a 2016 inflection point, and did not achieve the requisite sophistication until on or about 2020-2021.

The technologies now integrated by this invention existed in forms inaccessible in 2016 to persons of ordinary skill in sports equipment, broadcast engineering, or athletic officiating arts. Ultra-Wideband positioning chipsets capable of sub-decimeter accuracy were specialized components lacking power efficiency for wearable deployment; mass-market UWB chipsets (Apple's U1, NXP's Trimension series) achieved miniaturization and power efficiency enabling practical integration only in 2019-2020. LiDAR sensors capable of real-time point cloud generation were automotive-grade or military-grade systems until Apple's 2020 LiDAR integration made the technology accessible to non-specialist developers. Flexible electronics manufacturing—thin film deposition on elastomeric substrates, serpentine conductor geometries, printed electronics on conformal carriers—was confined to academic laboratories before 2016; commercial flexible electronics fabrication matured in 2017-2020. As such, 2016-2017 represents a critical milestone marking convergence of thin-film hardware and spatial intelligence, when conformable electronic substrate systems first became network-aware and positionally contextual with GIS compatibility; a technology central to the patent this invention is a continuation in part of. Machine learning frameworks for real-time sensor fusion were dependent on cloud computation with unacceptable latency before 2016; neural processing units and TensorFlow Lite (released 2017) enabled on-device inference necessary for real-time adjudication integrating technologies that existed in disparate and unconnected proprietary laboratories.

Public awareness of feasibility of directly measuring three-dimensional reality in real time, as this invention proposes, did not emerge until approximately 2020, and even in 2025, the public remains reasonably skeptical of machine ability to comprehend three-dimensional spatial realities within safety parameters and adjudication-grade reliability. Autonomous vehicles and bi-pedal robotics—leading applications of real-time three-dimensional machine perception—are still viewed as nascent technologies not yet mature for safety-critical deployment, directly affecting what can legally be characterized as “reasonable expectation of success” for a convergence of technologies designed for multiple-player, high-speed, chaotic, violent contact sports. Practitioners outside robotics laboratories at organizations such as Google and Tesla would regard integration of real-time three-dimensional spatial awareness into sports equipment as the domain of those with extraordinary rather than ordinary skill, and certainly would have held this view prior to the technological inflection points disclosed above.

### The Cultural Inflection Points:

Contemporaneously, a cultural inflection point occurred within professional sports. Prior to approximately 2019, the dominant industry assumption was that Instant Replay technology would keep maturing and would result to be adequate for officiating. The prevailing belief was that incremental improvements to camera placement, resolution, and frame rate would address deficiencies. This assumption was disrupted by high-profile officiating controversies demonstrating the categorical inadequacy of line-of-sight dependent systems. The January 2019 NFC Championship “no-call” incident, in which pass interference was not called despite clear video evidence because officials did not see the contact, generated unprecedented attention to officiating technology limitations and is credited as catalyst for rule changes. The 2018 Video Assistant Referee (VAR) introduction at the FIFA World Cup, followed by 2019-2020 adoption in major European leagues including the English Premier League, exposed camera-based limitations when extended review times disrupted match flow and controversial calls persisted. Collegiate athletics delayed adoption five to seven years after professional sports.

Review Duration as Symptom of Line-of-Sight Measurement Failure: Extended officiating review duration in contemporary professional sports constitutes a direct consequence of line-of-sight measurement inadequacy, and a significant factor in the cultural inflection point at which point fans and players alike lost faith in the viability of Instant Replay. When camera-based systems cannot definitively resolve spatial relationships-due to occlusion, perspective ambiguity, or insufficient angular coverage-review officials must examine multiple camera angles sequentially, often without reaching empirical certainty. This process routinely extends three to eight minutes per contested call, during which game play halts. The fundamental problem is not procedural inefficiency but measurement system inadequacy: camera-based systems cannot observe through opaque objects, and officials must substitute extended deliberation for unavailable empirical data.

Quantified public sentiment documents this trajectory: in 1998-1999, NFL polling showed 89.7 percent of fans favored replay restoration, and ESPN's 50,000-fan survey produced 87 percent approval. By February 2019, CBS News polling documented only 45 percent favored increased replay usage. By July 2025, Lottoland survey documented sentiment reversal: 60 percent demanded technology improvement, 35 percent expressed frustration with video technology decisions, 52 percent cited flow disruption as primary concern, and 10 percent supported complete elimination of video review. A person versed in the art of professional sports officiating and/or broadcasting in 2005, 2010, 2011, or 2015 would not have been motivated to develop non-line-of-sight tracking for sports officiating because industry consensus held that camera-based systems required only incremental improvement, and non-line-of-sight reconstructions of observable reality were not in the public zeitgeist. This confidence reflected decades of institutional investment: following NFL instant replay adoption in 1986 and restoration in 1999, other major leagues progressively adopted video review through the 2000s and 2010s, creating industry-wide infrastructure commitment. Practitioners observing specific replay failures attributed them to implementation limitations correctable through better cameras, faster frame rates, or additional viewing angles—not fundamental architectural constraints of external observation systems. The 2019 cultural inflection disrupted this assumption by accumulating sufficient high-profile incidents across multiple sports to shift consensus from “replay needs improvement” to “replay has inherent limitations that improvement cannot address.”

The present invention eliminates review latency by replacing visual interpretation with direct spatial measurement provided from inside the action outwards. The difference between “examining footage to estimate whether the ball crossed the plane” and “retrieving the stored coordinate indicating the ball's position relative to the plane” reduces review duration from minutes to milliseconds. The system architecture provides:
Sub-12 ms total system latency from sensor measurement to officiating determination
Automated rule evaluation producing confidence-scored determinations
Instantaneous data retrieval eliminating sequential camera angle examination
Unambiguous spatial coordinates replacing subjective visual estimation

### Multi-Layered Combination of Unrelated Industries:

The present invention represents convergence of multiple distinct technical arts historically developed in isolation and never systematically integrated for adjudication-grade sports tracking: (a) leather working, stitching methodology, and sports equipment manufacturing; (b) textile engineering and uniform tailoring governing garment construction and fabric behavior under athletic stress; (c) safety equipment engineering governing helmet design, padding systems, and impact absorption; (d) radio-frequency engineering and ultra-wideband system design governing wireless positioning and antenna integration; (e) flexible and embedded electronics engineering governing mechanically compliant circuit design and thin film manufacturing; (f) computer vision, LiDAR, and multi-modal sensor fusion; (g) artificial intelligence, machine learning, and computational optimization including quantum computing approaches; (h) sports broadcasting technology governing real-time data integration with broadcast production; (i) sports officiating methodology governing rules interpretation, adjudication workflows, and evidentiary standards; and (j) civic and stadium infrastructure engineering governing venue-scale installation and environmental hardening. Blockchain-based cryptographic protocols preserve immutability and evidentiary integrity, enabling trusted officiating and dispute resolution in adversarial or high-stakes environments.

This invention constitutes a comprehensive system-level architecture engineered to simultaneously integrate digitally-enabled subsystems embedded in disparate physical domains—turf, uniforms, goalposts, protective equipment, game ball, player footwear—each requiring materially distinct integration methods, materials compatibility, and power management. The materials science companies developing advanced thin film substrates, conductive inks, and flexible electronics fabrication—companies in the DOW Chemical, BASF, and DuPont industrial chemistry lineage—still operate in a technological world completely alien to sports equipment manufacturing companies—Wilson, Spalding, Nike, Adidas—constructing game balls, fabricating uniforms, and engineering protective gear. Thin film deposition, chemical vapor processes, or roll-to-roll electronics manufacturing would find leather stitching patterns, bladder inflation specifications, and Rotational Balance requirements entirely outside their domain expertise; conversely, a person versed in the art of leatherworking, athletic footwear construction, or uniform tailoring would find semiconductor fabrication literature completely alien to their professional practice. The claimed invention requires unorthodox GIS technology redeployment that practitioners in the GIS art would not have contemplated. GIS technology was designed for metropolitan and state-scale geographic mapping as after-the-fact diagnostic tool, not real-time three-dimensional object shape capture within centimeter-level playing field environments. Applying GIS coordinate reference frameworks to centimeter-level sports field mapping required unprecedented conceptual leap that GIS practitioners—geographic surveyors and cartographers—would not have considered because sports officiating falls entirely outside their domain expertise. These trade and specialty industry populations are worlds apart with no professional occasion to encounter each other's technical literature, attend each other's industry conferences, or develop competency in each other's manufacturing methodologies. The multi-art convergence spans categorically distinct industrial ecosystems with no natural overlap; or more specifically, no overlap that existed prior to the empirically chartable cultural and technological inflection points where a person of ordinary skill would have been capable of making the cross-domain leaps necessary for this multi-industry multi-technology integration. The claimed invention's integration requirement demonstrates that no single profession or trade could have arrived at through ordinary skill, because ordinary skill in any one domain affirmatively excludes familiarity with the others. Combination of them, by definition, would have required extraordinary skill and reach beyond the conventional.

### Component-Level Feasibility & Simultaneous Availability and Compatibility

Most poignantly, the disclosed invention is not a single-technology improvement. It is not an enhancement to UWB positioning, nor an advancement in triboelectric nanogenerator design, nor a novel cryptographic protocol, although it employs all of them. Rather, it is an architectural framework requiring the simultaneous integration of technologies drawn from domains so disparate that no recognized field of practice, academic discipline, or commercial industry spans them. For the disclosed system to achieve its stated purpose—adjudication-grade spatial determination with sub-millimeter accuracy, line-of-sight independence, contact verification, and cryptographic attestation—the following categories of technology must not merely exist but must be simultaneously integrated:
1) Positioning Technology: Ultra-wideband transceivers capable of both anchor-to-tag and tag-to-tag ranging, with form factors suitable for embedding in sports equipment without compromising physical compliance, operating at update rates sufficient for athletic motion capture (minimum 50 Hz), and capable of peer-to-peer cooperative localization without infrastructure dependency.
2) Contact and Tactile Sensing: Self-powered sensors capable of detecting contact events through fabric, leather, and composite materials, surviving repeated athletic impacts, industrial laundering, and environmental exposure, while maintaining calibration across thousands of use cycles.
3) Flexible Electronics Manufacturing: Commercial-scale fabrication capability for thin-film circuits, stretchable interconnects, and conformable substrates at manufacturing readiness levels permitting integration into mass-produced sporting goods, not merely laboratory demonstration.
4) Cryptographic Verification: Standardized decentralized identity protocols enabling equipment authentication across venues and jurisdictions, combined with threshold signature schemes permitting distributed attestation without single points of failure.
5) Edge Computing: Embedded processing capability sufficient for real-time multi-modal sensor fusion at latencies compatible with officiating decisions, within power and weight budgets imposed by equipment physical compliance requirements.
6) Traditional Equipment Construction: Integration pathways that preserve the Rotational Balance, aerodynamic properties, tactile characteristics, and regulatory compliance of professional sporting goods, requiring knowledge of leatherworking, vulcanization, panel construction, bladder systems, and sport-specific certification requirements.
7) Officiating Protocol Compatibility: System outputs formatted for integration with existing officiating workflows, rules interpretation frameworks, and evidentiary standards applicable to professional sports adjudication.
   Why Prior Approaches have Failed: The Cross-Domain Synthesis Problem

There is a documented, industry-wide failure to develop adjudication-grade positioning systems despite massive economic incentive. Disney and ESPN abandoned multiple patents disclosing interactive surface technologies with potential sports applications. Multiple billion-dollar organizations including the NBA, NFL, NCAA, and FIFA—each possessing both substantial financial resources—failed to develop non-line-of-sight positioning systems. This pattern of industry-wide failure despite economic incentive is not coincidental. It reflects a structural barrier that resources alone cannot overcome: the solution requires cross-domain synthesis across technical fields that do not interact.

### The Paradigm Inversion as Architectural Conception

The disclosed invention cannot be reduced to a combination of mature, available components. What, then, is the invention? The invention is the architectural conception that spatial awareness for sports adjudication should originate from the tracked objects themselves rather than from external observation and post-hoc reconstruction. This conception is not a philosophical preference. It is an operational requirement that imposes specific constraints on system design:
(a) Objects must contain spatial determination capability. They cannot be passive targets for external sensors.
(b) Spatial knowledge must be emitted, not inferred. The system cannot rely on reconstruction from multiple vantage points.
(c) Line-of-sight cannot be required. The system must operate when objects are occluded or obscured.
(d) Contact must be directly verified. The system cannot rely on proximity inference or algorithmic estimation.
(e) Position must be cryptographically attestable. The system must produce evidence suitable for disputed adjudications.
   These five operational requirements map directly to the paradigm and conceptual inversions defined herein: requirement (a) derives from the Measurement Causality Paradigm Inversion, wherein tracked objects generate and emit their own spatial state rather than awaiting external observation; requirement (b) derives from that same inversion's elimination of reconstructive inference; requirement (c) derives from the Infrastructure Conceptual Inversion, wherein tracked entities may themselves constitute the positioning infrastructure through reciprocal ranging and spatial emission, eliminating dependence on fixed line-of-sight observation; requirement (d) derives jointly from the Collision-Assumptive Conceptual Inversion, which presumes dense multi-body contact as a defining condition rather than a fault state, and from the Deformable-Body & Boundary-Primary Conceptual Inversions, which determine spatial truth from external volumetric boundaries rather than internal joint pivots or centroid coordinates; and requirement (e) derives from the cumulative architectural consequence of these inversions, as only objects that actively generate spatial data can participate in cryptographic attestation of that data. The Dynamic Adjudicative Relevance Hierarchy Inversion governs how these requirements are operationally allocated—concentrating spatial certainty and verification redundancy at surfaces and moments where rule consequences are greatest.

### Problems to be Solved

The disclosure acknowledges that the requisite component technologies exist at varying maturity levels, and several remain in research phases where fundamental performance characteristics and manufacturing processes are not yet established. This is not a defect of the disclosure. It is the defining characteristic of an architectural invention that envisions, anticipates and thus enables future implementation rather than merely documenting present capability. The specification claims the architectural framework—the paradigm inversions and technological re-purposing and reconstitution.

### Closing the Accuracy Gap:

The invention captures and positions the full three-dimensional geometric envelope of each tracked object through hierarchical distributed tag arrays that generate 3D topographical wiremesh representations of actual object shape. Cryptographic position attestation through the integrated OPoP-SIV-EDID architecture provides evidentiary-grade tamper evidence absent from commercial tracking deployments designed for analytics rather than officiating. Infrastructure-independent operation modes through tag-to-tag relative localization and mobile anchor designation enable positioning continuity in dense occlusion scenarios—player pile-ups, goal-mouth scrambles, contested possession situations. Non-audible acoustic microcell integration provides independent near-field boundary verification at adjudication-critical field delimiters, creating redundant confirmation through a physically distinct sensing modality.

Taken in totality, this invention addresses the longstanding inadequacies in professional sports officiating systems which are not merely attributable to legacy limitations, but to a fundamental misalignment between existing technologies and the complex, real-world demands of elite sports competition. The fundamental inadequacy underlying all existing sports tracking and officiating systems is not technological immaturity, insufficient investment, or engineering oversight, but paradigmatic constraint—specifically, the universal adherence to what this specification defines as the External Observation Paradigm, wherein passive objects are observed and spatial data is reconstructed externally. The present invention's Measurement Causality Paradigm Inversion (SEE: Inventor's Lexicography) addresses this constraint directly: spatial knowledge must originate within the tracked objects themselves rather than being inferred from external vantage points.

### The Temporal Precision & Contact Verification Problem

American football officiating determinations depend not merely on spatial position but on a temporal decision on determining the time of physical contact: whether the ball touched the goal line at or near the exact moment in time when the player's hand may have contacted the opponent before the ball, knees and/or elbows touched the ground, or whether the receiver maintained possession through ground contact. External observation systems can infer proximity but cannot verify contact. The distinction between Contact-Based Sensing and 3D Spatial Positioning (SEE: Inventor's Lexicography) is critical here: external observation systems can at best infer that objects appear proximate, but lack the mechanical coupling required for Contact-Based Sensing and lack the object-originated spatial or temporal data required. Two objects may appear to touch from a camera angle yet not actually contact at the precise moment the rules make the contact adjudicatorily relevant. Sports adjudication requires determining the sequence of events: Did the knee touch before the ball crossed? Camera-based systems, even at high frame rates, provide discrete temporal samples rather than the Adjudication-Grade Continuous Measurement (SEE: Inventor's Lexicography). The required temporal resolution for officiating exceeds the practical limits of camera-based observation.

### The Evidentiary Integrity Problem

When officiating determinations carry financial consequences measured in millions of dollars—game outcomes affecting playoff qualification, championship results, betting market settlements—the evidentiary integrity becomes critical far beyond the expectations imposed on them even 30 to 40 years ago. The expectations exacerbate according to 21^{st} Century technological expectations. Furthermore, external observation provides no intrinsic tamper evidence. The system addresses this evidentiary integrity requirement through its Spatiotemporal Integrity Validation (SIV) architecture (SEE: Inventor's Lexicography), which screens position data for anomalous patterns through physics-constrained plausibility testing prior to tamper-evident audit ledger incorporation. The present invention addresses this problem through cryptographic attestation: spatial measurements are digitally signed at the moment of capture by multiple independent devices, creating a distributed audit trail that cannot be retroactively falsified without detection. This capability requires the tracked objects themselves to participate in the attestation process—a requirement incompatible with passive objects observed by external sensors and achievable only through the Measurement Causality Paradigm Inversion wherein tracked objects originate and emit their spatial state as active spatial participants.

### The Commercial Accuracy Gap

Commercially available UWB positioning systems marketed for asset tracking and industrial applications, such as those offered by Pozyx, Sewio, and similar vendors, typically achieve positioning accuracy in the range of 10 to 30 centimeters under favorable conditions. Consumer and industrial positioning literature uniformly prioritizes cost minimization, infrastructure simplicity, and “good enough” accuracy for navigation or asset location purposes, explicitly accepting accuracy degradation as an acceptable trade-off for reduced system complexity. A warehouse inventory system that locates pallets within 30 centimeters serves its commercial purpose adequately; the literature does not contemplate, and affirmatively discourages, the engineering investment required to achieve sub-millimeter accuracy because such accuracy provides no commercial benefit in asset-tracking applications. Consumer indoor navigation systems also prioritize user convenience and battery life over positioning precision, accepting meter-level accuracy as sufficient. A person versed in the art of commercial indoor positioning, trained in the optimization trade-offs characteristic of that field, would be actively discouraged from pursuing the accuracy targets, infrastructure complexity, and per-unit costs that the present invention requires.

Commercial UWB, like GPS, LiDAR, radar and other technologies mentioned above, suffers from the same deficiency arising from the conformity of what is simply good enough for their intended purposes. The design priorities of commercial indoor positioning systems actively teach away from the adjudication-grade accuracy requirements addressed by the present invention. Several meters of error for a GPS tracking system designed for large vehicles was never engineered to track the position of an 11 inch long football within 1/16th of an inch accuracy. Consistent with the Measurement Causality Paradigm Inversion defined in the Inventor's Lexicography, the present invention inverts these design priorities: adjudication-grade accuracy of one-sixteenth of an inch (approximately 1.6 millimeters) through multi-modal sensor fusion, AI-assisted error correction, and ground truth calibration—accuracy that exceeds commercial UWB systems by more than an order of magnitude and specifically engineered for the evidentiary demands of professional sports officiating.

### Physical Compliance of the Articles of Performance:

The technical challenges extend beyond positional tracking alone. Hiding a GPS receiver in a football player's helmet is the technological equivalent of installing an aerodynamic body kit on a minivan and pretending it meets the standards of Formula One racing. In order to be viable for professional use, any embedded technology must be seamlessly integrated and purpose-configured—in compliance with the Equipment Performance Specifications (SEE: Inventor's Lexicography)—particularly game balls—without compromising their Rotational Balance or Weight Distribution, as even minimal deviations in balance render the equipment unsuitable for high-performance play.

For a game ball or equivalent article of play to function properly, it must achieve a sport-specific balance of physical properties. Any imbalance in Rotational Balance & Weight Distribution impairs a ball's spin axis, velocity stability, and trajectory, thereby undermining not only player performance but also the very motions the tracking system intends to capture and preserve. A basketball needs high Elasticity (Coefficient of Restitution), and moderate friction for dribbling, while a curling stone requires low friction and high mass for sliding. A shuttlecock sacrifices durability for aerodynamic drag—a tradeoff governed by its Aerodynamic Profile & Surface Friction (SEE: Inventor's Lexicography)—while a baseball prioritizes Structural Integrity & Mass (SEE: Inventor's Lexicography) for repeated impacts. Designers use materials such as rubber, feathers, and granite, along with manufacturing techniques including dimpling and stitching, to tune these attributes, ensuring the object meets the physical demands of play—whether soaring through air, bouncing on a court, or gliding on ice.

Rotational Balance ensures smooth spin without wobble, relying on geometric symmetry and uniform Weight Distribution across the object's volume. Weight Distribution dictates the center of mass position, influencing stability and motion characteristics, but operates in conjunction with aerodynamics and elasticity for complete functionality and safety considerations. Aerodynamic Profile & Surface Friction refines flight behavior, amplifying or counteracting spin effects derived from Rotational Balance through surface texture, seam placement, and panel geometry. Elasticity (Coefficient of Restitution) and Surface Friction—components of the Physical Compliance sub-properties defined herein—govern surface interactions upon impact or contact, extending the object's utility beyond its internal mass arrangement to include bounce characteristics, grip response, and energy transfer. Mass—a component of Structural Integrity & Mass as defined herein—durability, buoyancy, and thermal stability ensure practical performance across diverse environmental conditions and mechanical stresses encountered during competition.

Each sport's Equipment Performance Specifications dictate which properties receive emphasis, making these articles of play precision-engineered tools of competition rather than generic spheroids or implements. This requirement necessitates an understanding of structural engineering and materials science, particularly in the use of mechanically compliant conformable electronics and high-tolerance manufacturing methods that preserve these finely tuned characteristics. Concurrently, the professional sport uniform-unlike consumer “Athleisure”—is engineered for compatibility with high-speed, high-impact data capture environments and must accommodate the unique demands of digital broadcasting and real-time performance analysis.

### Impact of the Field Crown and Topographical Contours on Spatial Tracking Accuracy:

The crown of a football field—the intentional convex elevation of the field's centerline to promote water runoff—significantly complicates accurate officiating determinations and the deployment of spatial tracking technologies. The topographic variations, which may range from 6 to 10 inches of elevation from the sidelines to the centerline depending on stadium construction, climate, turf type, and drainage architecture, introduce critical inaccuracies into systems that assume flat-field geometry for measurement and analysis. Comprehending how inconsistent field crowns result in non-planar, inconsistent field contours across and within stadiums is critical when designing a system that tracks objects whose height is smaller than what a field's crown height would obscure at eye level. Furthermore, any system that aspires to sub-millimeter accuracy must fundamentally account for the real-world inconsistencies of surfaces made of natural or malleable substances across 100-yard spans, including both natural grass and artificial turf installations that settle, compress, and deform differently under varying weather and use conditions. Officiating determinations—particularly those involving boundary line crossing events—require precise spatial adjudication. Game officials and referees attest that relying on line-of-sight and mental projections of geometric lines over a non-flat playing surface frequently reduces critical calls to best-guess approximations due to the crown's visual obfuscation.

The tracking and positioning problems compound when systems are tasked with tracking military training and any other performance that takes place in a non-athletic and/or non-theatrical venue, where line-of-sight problems are exacerbated by hills, mountains, and trees. In military exercises, a system capable of dynamically tracking the 3D spatial and shape configuration of personnel, equipment, and terrain permits after-action review and training analysis with granularity that current GPS and visual systems cannot deliver. These inconsistencies necessitate the implementation of technologies capable of detecting and mapping three-dimensional field contours, integrated within a system that can accommodate topological variability across all stadiums, and which can deliver millimeter levels of accuracy referenced to the actual playing surface rather than an idealized flat plane that does not exist.

### Simultaneous Multi-Object Tracking Problem:

### The Variable Positioning Array: Objects as Cooperative Infrastructure

The present invention addresses this simultaneous tracking requirement through a capability that External Observation systems cannot replicate: the objects themselves form a tracking cooperative—implementing the Collaborative Spatial Mapping & Reciprocal Spatial Emission Architecture (RSEA) defined herein—that establishes and continuously refines the coordinate framework through inter-object ranging. Each tracked element-player-worn tags at adjudication-critical anatomical points, game ball sensors distributed across panel surfaces, referee equipment, field boundary markers—actively participate in a tag-to-tag ranging network (see FIG. 4). When the officiating question is “Did the ball cross the goal line before the knee touched the ground?”, the system does not independently compute the ball's position and the knee's position against fixed anchors and then compare them. Instead, the ball's surface sensors and the knee's contour array directly range to each other and to the goal line's embedded boundary markers, establishing the critical spatial relationships through direct measurement between the objects whose relationship is being queried. The cooperative spatial mesh provides inter-object accuracy that exceeds what any external observation system can achieve, because the measurement path is direct rather than mediated through external infrastructure. This cooperative architecture reaches its full expression in the Infrastructure-Independent Localization Mode component of the Cross-Venue Adaptation Protocol & Infrastructure-Independent Localization Mode defined herein, where the distributed ranging collective maintains adjudication-grade accuracy even when fixed anchors are unavailable.

### TECHNOLOGICAL SUMMARY OF INVENTION

No single tracking technology is flawless; therefore, a hybrid approach fusing multiple layers and modalities with Artificial Intelligence processing-optionally quantum-based AI processing-ensures sub-millimeter tracking accuracy. The redundant positioning architecture employs UWB for baseline three-dimensional position data, LiDAR for spatial modeling, VLP for high-speed optical verification, IMUs for short-term positioning when external signals are unavailable, pre-performance 3D scans for ground truth calibration, and non-audible acoustic signaling for near-field event verification, identity confirmation, timing synchronization, and cross-modal integrity assurance. AI and Quantum computing afford the ability to hierarchically adjudicate the determining factors, treating positioning of players or elements outside of the focus of the game/performance as secondary context, while prioritizing and enhancing tracking and positioning of the elements with a descending relevance as determined by the particulars of the performance/game.

### NLOS Hardware Architecture:

NLOS conditions, where direct signal paths are obstructed, can significantly degrade UWB positioning accuracy, introducing errors in distance measurements due to multipath propagation. Specific hardware and software systems for NLOS Error Correction in UWB Positioning are utilized for mitigating non-line-of-sight (NLOS) effects in Ultra-Wideband (UWB) positioning, specifically for generating three-dimensional point clouds from UWB Micro-Tags. UWB anchors and tags incorporate transceivers capturing Channel Impulse Response (CIR) data-detailed signal arrival times and amplitudes-essential for identifying NLOS conditions and revealing multipath effects. Advanced configurations incorporate multiple or directional antennas for angle-of-arrival (AoA) measurement, distinguishing direct from reflected signal paths. The system employs Multi-Frequency Adaptive UWB tags performing dual tag-and-anchor functions, creating an adaptive triangulation network providing closer proximity to tracked subjects than fixed anchors alone—enabling both players and game balls to serve as ranging references during pile-ups or closely contested situations.

In further embodiments addressing extreme NLOS conditions—player pile-ups, goal-mouth scrambles, dense formations where fixed perimeter anchors have severely degraded line-of-sight—the system employs tag-to-tag relative localization wherein player-worn tags range directly to other player-worn tags and ball-embedded tags without routing through fixed infrastructure. Each tag within congested regions contributes ranging measurements to neighboring tags, forming a localized mesh of inter-tag distances resolved into relative positions even when absolute positioning from fixed anchors is unavailable. The AI-assisted sensor fusion engine aggregates inter-tag ranging with degraded fixed-anchor data, inertial measurements, and acoustic near-field confirmation to maintain continuous tracking through occlusion events.

### Central Processing Unit (CPU) & Software Methodologies:

The AI enabled CPU executes software modules for NLOS identification and error correction, collecting data from all anchors via wired or wireless networks with sufficient computational power for real-time signal processing and machine learning inference. UWB signals comply with IEEE 802.15.4-2011 standards, with bandwidth exceeding 500 MHz for high temporal resolution. The software system for NLOS error correction processes CIR data to extract features, employs machine learning models to identify NLOS conditions and correct distance errors, and computes accurate 3D positions through modular architecture. The Data Collection Module receives raw CIR data from each anchor for every tag transmission, capturing multipath profiles with timestamps synchronized across anchors for accurate time-of-flight measurements. The NLOS Classification Module employs machine learning models—convolutional neural networks (CNN), recurrent neural networks (RNN), or hybrid architectures such as parallel CNN and Gate Recurrent Unit (GRU) configurations—to classify each measurement as LOS or NLOS based on extracted features. Models are trained offline using labeled data from environments with known ground truth positions. The Distance Correction Module corrects NLOS-classified measurements using machine learning models such as fully connected neural networks or support vector regression (SVR), predicting actual distance from measured distance and extracted features. Alternative implementations employ statistical methods including biased Kalman filtering.

Prior art algorithmic approaches for NLOS error reduction in indoor sports tracking have demonstrated accuracy improvements of up to 50% over basic trilateration through geometric filtering, statistical outlier rejection, or single-factor bias correction. The present invention's NLOS mitigation architecture surpasses these prior art techniques through a multi-factor integrated approach comprising: (a) Generalized Gaussian Distribution statistical modeling that accommodates heavier-tailed signal variability (shape parameter β<2) characteristic of professional sports environments with heterogeneous NLOS sources including human tissue attenuation, equipment material interference, and transient contact events; (b) integration of NLOS detection with multi-modal cross-validation wherein GGD anomaly flags trigger increased weighting of alternative sensing modalities—including inertial measurement, acoustic near-field confirmation, and touch sensing—rather than simple measurement rejection or bias adjustment; (c) physics-constrained plausibility testing through the Spatiotemporal Integrity Validation protocol that screens position claims against kinematic limits, geometric consistency across modalities, and temporal continuity constraints; (d) continuous tracking maintenance through NLOS events via tag-to-tag relative localization and mobile anchor designation rather than accepting positioning discontinuities as unavoidable consequence of occlusion; and (e) venue-specific NLOS signature modeling through the Cross-Venue Adaptation Protocol, enabling transfer learning from previously characterized environments to novel deployment venues. Prior art NLOS correction approaches address single-factor error sources in isolation; the present invention's integrated OPoP-SIV-EDID architecture combines NLOS detection, multi-modal cross-validation, physics-constrained screening, and cryptographic position attestation into a unified framework specifically engineered for the evidentiary requirements of professional sports adjudication.

The Position Calculation Module computes 3D tag positions from corrected distance measurements using trilateration or multilateration with dynamically weighted least squares, assigning higher weights to LOS measurements and lower weights to corrected NLOS measurements. Final positions are attributed to their originating EDID-bearing components and federated into a component-differentiated spatial record—not an undifferentiated point cloud surface reconstruction (SEE: Lexicography Item 8, Point Cloud)—preserving the per-component identity attribution that enables the system to distinguish uniform surface from anatomical surface and one instrumented object from another at component-level granularity.

### Hierarchical Tracking Modality Architecture:

The present invention employs a functionally differentiated hierarchical architecture for tracking element deployment, implementing the Dynamic Adjudicative Relevance Hierarchy Inversion (SEE: Inventor\'s Lexicography), that organizes tracking modalities according to their functional roles within the object-originated spatial emission framework rather than according to any fixed rank, fixed processing order, or fixed authority direction. The four functional tiers disclosed herein—boundary-defining, interior contour, mesh-fill, and contact-sensing—represent a minimum functional differentiation of tracking modalities required to achieve adjudication-grade spatial and contact-event resolution; the architecture is not limited to exactly four tiers, and additional functional tiers or sub-tiers may be defined in specific implementations without departing from the hierarchical architectural principle. The relative authority weight assigned to each functional tier is not permanently fixed by tier designation; authority weights are dynamically modulated by the AI-driven sensor fusion engine in response to event-conditioned relevance criteria, including but not limited to: spatial proximity of a tracked assembly to a rule-critical boundary; detection of a contact or deformation event triggering elevated contact-sensing tier authority; occurrence of a garment deformation or equipment displacement event requiring elevated interior contour tier authority for anatomical ground truth recovery; and any other context-defined relevance criterion established by the applicable Officiating Rules and Adjudication Standards or equivalent evaluative framework. In particular, the contact-sensing tier is not architecturally subordinate to the boundary-defining, interior contour, or mesh-fill tiers; during contact events, the contact-sensing tier may assume the highest authority weight in the fused spatial determination, with the spatial positioning tiers providing geometric context for contact-event attribution rather than the reverse. All four functional tiers contribute simultaneously and continuously to the AI-driven sensor fusion engine; the architecture does not implement sequential handoff from tier to tier. This hierarchical framework prevents conflation of the invention with prior art systems that employ only single-modality tracking or that fail to differentiate between boundary-defining elements, surface-gradient elements, mesh-fill elements, and contact-sensing elements—the latter implementing Contact-Based Sensing (SEE: Inventor\'s Lexicography) as functionally distinct from the three-dimensional spatial positioning modalities of the other tiers. Each tier operates with distinct hardware configurations, sampling rates, and data processing pathways optimized for its functional role, while all tiers contribute simultaneously to the integrated spatial model through the AI-driven sensor fusion engine under dynamic authority weighting.

Data Efficiency and Real-Time Transmissibility: The architectural decision to prioritize topographical vector wireframes over continuous point cloud meshes is driven by the operational constraints of real-time adjudication. A continuous point cloud mesh comprising hundreds of thousands of interconnected surface points generates data volumes that scale proportionally with surface density—every additional point adds transmission payload, triangulation overhead, and processing latency. In contrast, a vector-based wireframe representation captures the same adjudicatorily relevant geometric information through topographical contour vectors that define shape boundaries, surface curvature inflection points, and anatomical articulation envelopes using orders-of-magnitude fewer data primitives. This distinction is analogous to the computational difference between raster image formats, which encode discrete color values for every pixel in a fixed grid, and vector graphic formats, which define shapes mathematically through control points and path equations—the latter achieving resolution-independent geometric fidelity at a fraction of the data volume. Because the adjudication determination depends on boundary positions and surface orientations at specific anatomical regions rather than on uniform surface sampling density across the entire body, the vector wireframe approach discards no adjudicatorily relevant information while eliminating the data burden of adjudicatorily irrelevant interior surface points. This data efficiency directly enables the real-time transmission rates, sub-millisecond processing latencies, and bandwidth headroom required for live adjudication during dynamic athletic events where dozens of tracked objects undergo simultaneous high-velocity motion and deformation.
The Boundary-Defining Tier comprises boundary-defining tracking elements positioned along the structural vectors that define the anatomy of tracked objects. For human participants, Boundary-Defining Tier elements trace the primary anatomical contour lines of the major anatomical articulations—shoulders, elbows, wrists, hips, knees, ankles—and the axial boundaries of torso, limbs, and head. For game equipment, Boundary-Defining Tier elements follow seams, edges, panel boundaries, and structural vertices defining the general wireframe representation of the object\'s fundamental geometric shape/envelope. Boundary-Defining Tier elements operate at high sampling rates and receive context-weighted allocation of system bandwidth and processing resources commensurate with their adjudicative relevance at any given moment, because they establish the skeletal framework upon which spatial configuration is referenced; however, this default resource allocation is subject to dynamic modulation by the AI-driven sensor fusion engine in response to event-conditioned relevance criteria as described above. The topographical vector wireframe representation (SEE: 3D Topographical Wireframe Representation) generated from Boundary-Defining Tier elements alone suffices to reconstruct the gross spatial configuration of all tracked objects/subjects—determining whether a player is standing, crouching, diving, or prone—even absent higher-resolution interior surface mesh data of the corresponding geometric representation.
The Interior Contour Tier comprises interior topographical contour tracking elements capturing the sculptural shape\'s surface gradient information within the Boundary-Defining Tier\'s vector/wireframe bounded regions defined by boundary vectors. Interior Contour Tier elements may be deployed as concentric rings, spiral paths, or nested contour traces within uniform panels, equipment surfaces, and anatomical regions where surface curvature carries adjudication-relevant information, and where Boundary-Defining Tier wireframe representations are not sufficient resolution for rules adjudication. Spacing and density vary according to adjudication criticality: high-density deployment on knee surfaces, elbow caps, and fingertips where surface orientation determines contact sequence; lower-density deployment on torso panels and inner-thigh surfaces where gross shape capture suffices that are not the subject of rules adjudication. Interior Contour Tier data enables interpolation of continuous surface geometry between Boundary-Defining Tier boundary points, transforming the skeletal envelope into a fully resolved three-dimensional surface mesh.

Conductor Redundancy and Fault-Tolerant Integrity Monitoring: For continuous spiral conductor implementations within the Secondary Tier, minimum dual-filament redundancy is recommended for durability and redundancy, with triple or greater filament implementation being preferred for adjudication-critical surfaces where single-point conductor failure would compromise officiating determinations. Dual-filament configurations enable real-time conductor path integrity verification through continuous signal propagation monitoring: each filament carries a distinct pilot signal from origin to termination, with successful reception confirming unbroken electrical continuity throughout the conductor's length. Severed, degraded, or intermittently connected conductors produce detectable signal attenuation or propagation delay anomalies that the monitoring logic identifies as fault conditions, enabling real-time adjustment of spatial interpolation algorithms to compensate for degraded data.

Cross-Validation and Adjudication-Critical Surface Assurance: Triple-filament implementation for adjudication-critical surfaces—including knee contact zones, elbow caps, palms, fingertip pads, and shoe sole boundaries—enables cross-validation between filament pairs to detect partial degradation, signal drift, or localized interference that might escape dual-filament detection. When two filaments produce consistent data while the third diverges, the system identifies the divergent filament as potentially compromised and weights its contribution accordingly. The triple-filament configuration also enables tie-breaking logic when two filaments produce marginally divergent readings at measurement tolerance boundaries, resolving ambiguity without escalation to higher-level arbitration.

The continuous conductor filaments that generate the topographical vector shapes also offer a more controlled failure detection architecture. The continuous conductor topology enables detection of manufacturing defects, installation errors, and cumulative wear degradation undetectable in discrete-element tracking implementations. A discrete tag array can fail silently when individual tags become non-functional—the system simply receives fewer data points without recognizing that specific positions are unrepresented. In contrast, the continuous conductor filaments produce an explicit fault indication when any segment becomes non-functional, because pilot signal propagation is interrupted at the failure point. This fault-positive characteristic ensures the system operates with known-good tracking elements or explicitly reports degraded capability, rather than producing officiating determinations based on incomplete spatial data without awareness of, or harder to pinpoint, compromising of data quality.
The Mesh-Fill Tier comprises distributed surface coverage elements providing mesh-fill density in regions where neither boundary vectors nor interior contours achieve sufficient resolution for the intended application. Mesh-Fill Tier elements deploy as dense micro-tag arrays, conductive mesh grids, or surface-printed antenna patterns blanketing specific high-resolution zones—the palmar surface of catching gloves, the foot and heel surface of footwear, or the contact panels of game balls. Mesh-Fill Tier data contributes to surface reconstruction where AI interpolation algorithms require additional constraint points to achieve adjudication-grade accuracy.
The Contact-Sensing Tier comprises contact-sensing elements operating independently of spatial positioning functions, providing binary or graduated confirmation of physical contact between tracked surfaces. The Contact-Sensing Tier's functional requirement is the detection, localization, and temporal stamping of physical contact, pressure, and proximity events at adjudication-relevant surfaces without dependence on the spatial positioning modalities of the other three tiers—enabling determination of not only where objects were located but whether and when physical contact occurred, supporting officiating determinations depending on contact confirmation independent of spatial proximity. The preferred embodiment implements Contact-Sensing Tier contact sensing through TENG-based tactile sensors exploiting triboelectric charge generation for self-powered contact detection, graphene capacitive arrays exploiting capacitance variation under mechanical deformation, and piezoelectric films generating voltage proportional to applied mechanical stress. However, as with the spatial positioning tiers, the Quaternary Tier is defined by its functional role—contact event detection and confirmation—rather than by any specific transduction mechanism. Without limitation, qualifying contact-sensing modalities for the Quaternary Tier include: triboelectric nanogenerator (TENG) sensors in any material configuration exploiting triboelectric charge separation; graphene-based capacitive sensors including single-layer graphene, reduced graphene oxide, graphene nanoplatelets, and graphene composite films; piezoelectric sensors including ceramic piezoelectrics (PZT), polymer piezoelectrics (PVDF and its copolymers), piezoelectric composites, and piezoelectric nanogenerators; piezoresistive sensors including conductive polymer composites, carbon nanotube networks, metallic nanowire films, and MXene-based composites whose electrical resistance varies under mechanical deformation; magnetoelastic sensors whose magnetic properties change under mechanical strain; optical contact sensors including fiber Bragg grating (FBG) arrays detecting strain-induced wavelength shift, micro-bend fiber sensors, and evanescent-wave fiber sensors; resistive pressure sensors including force-sensitive resistors and quantum tunneling composites; iontronic sensors exploiting electric double-layer capacitance at electrode-electrolyte interfaces for ultra-high-sensitivity pressure detection; bio-inspired artificial skin sensor arrays combining multiple transduction modalities on a single flexible substrate; and any future contact-sensing modality or combination thereof exploiting any physical phenomenon—electrical, optical, magnetic, acoustic, thermal, chemical, or otherwise—to detect, localize, and temporally stamp physical contact events at equipment and anatomical surfaces within the system. As with the spatial positioning tiers, a system implementing Quaternary Tier contact sensing using modalities other than those specifically enumerated—including modalities developed after the filing date of this application—nonetheless practices the architectural invention if it provides contact event detection operating independently of and orthogonally to the spatial positioning tiers within an object-originated spatial emission framework. The functional independence of the Contact-Sensing Tier from the spatial positioning tiers is a defining architectural characteristic: contact sensing confirms physical interaction without relying on positional proximity inference, providing an orthogonal verification channel that no prior art system employing undifferentiated sensor arrays can achieve because prior art systems lack the tier-separated functional architecture distinguishing contact confirmation from spatial determination. This functional independence does not establish permanent subordination; the Contact-Sensing Tier may assume elevated authority weight in the AI-driven sensor fusion determination during contact events, with the spatial positioning tiers providing geometric attribution context rather than governing authority.

For avoidance of doubt: the four-tier hierarchical tracking architecture disclosed herein defines each tier by its functional role within the spatial capture system—boundary definition, interior contour resolution, mesh-fill density, and contact confirmation respectively—rather than by any specific sensing modality or transduction technology, and further defines the relative authority weight of each tier as event-conditioned and dynamically modulated rather than permanently fixed by tier designation. The preferred embodiment implements the Boundary-Defining Tier, Interior Contour Tier, and Mesh-Fill Tier (the three spatial positioning tiers) through Ultra-Wideband radio-frequency time-of-flight ranging as the baseline three-dimensional positioning modality, supplemented by LiDAR, Visible Light Positioning, inertial measurement units, non-audible acoustic ranging, and 5G angle-of-arrival estimation as disclosed elsewhere herein. However, the architectural principle governing each tier—the functional requirement that a given tier must satisfy—is expressly independent of the specific physical phenomenon exploited to achieve spatial measurement. Any positioning modality capable of satisfying the functional requirements of a given tier may serve that tier's role within the hierarchical architecture, provided it achieves the adjudication-grade accuracy threshold disclosed herein (one-sixteenth of an inch) either independently or through AI-driven sensor fusion with complementary modalities. Without limitation, qualifying positioning modalities for the spatial positioning tiers include: radio-frequency time-of-flight ranging including but not limited to UWB, 5G millimeter-wave, Wi-Fi Fine Time Measurement (FTM), and future radio-frequency positioning standards operating in any frequency band; optical positioning including but not limited to LiDAR, Visible Light Positioning, structured-light scanning, time-of-flight camera arrays, and infrared positioning; acoustic positioning including but not limited to ultrasonic time-of-flight, acoustic microcell ranging, and non-audible acoustic spectrum techniques; magnetic field positioning including but not limited to magnetic beacon arrays, magnetoinductive ranging, and earth-field fingerprinting; inertial positioning including but not limited to MEMS accelerometers, gyroscopes, and magnetometers; radar-based positioning including but not limited to frequency-modulated continuous wave (FMCW) radar, impulse radar, and millimeter-wave radar; quantum sensing modalities including but not limited to atom interferometry, nitrogen-vacancy center magnetometry, and quantum radar; and any future positioning modality or combination thereof achieving spatial measurement through any physical phenomenon—electromagnetic, acoustic, optical, magnetic, gravitational, quantum, or otherwise—not yet commercially available or not yet conceived as of the filing date of this application. The invention's novelty resides in the hierarchical architectural organization of functionally differentiated tracking tiers operating within the Object-Originated Spatial Awareness paradigm under AI-driven sensor fusion, not in the selection of any particular transduction technology populating a given tier. A system implementing the four-tier hierarchy disclosed herein using positioning modalities other than those specifically enumerated—including modalities developed after the filing date of this application—nonetheless practices the architectural invention if it organizes functionally differentiated tracking elements into boundary-defining, interior-contour, mesh-fill, and contact-sensing tiers operating within an object-originated spatial emission framework fused by artificial intelligence into a unified three-dimensional geometric envelope under dynamic, event-conditioned authority weighting across all tiers.

The four-tier hierarchy ensures the system captures boundary geometry, surface gradient, mesh density, and contact confirmation through purpose-optimized hardware at each level, distinguishing the present invention from prior art systems that conflate these functionally distinct tracking requirements into undifferentiated sensor deployments.

### Adjudication-Weighted Density Gradient for Tracking Element Distribution:

Like the hierarchical tracking of objects/players within a performance, the distribution of tracking elements within an object's anatomical surfaces are also governed by an adjudication-weighted density gradient—a physical implementation of the Dynamic Adjudicative Relevance Hierarchy Inversion—that allocates higher element concentration to surfaces where precise spatial resolution directly determines rules outcomes, and lower concentration where general shape capture suffices. This density gradient methodology distinguishes the present invention from prior art tracking systems employing uniform element distribution without regard to differential adjudication criticality of distinct surface regions. Both the Performer Spatial Assemblies (PSA) and Venue Spatial Assemblies (VSA) use a rules-based prioritization of high to low criticality regions, which may add unnecessary weight, power consumption, and signal congestion—or under-instrument high-criticality regions, failing to achieve spatial resolution necessary for officiating determinations. The adjudication-weighted density gradient optimizes tracking resource allocation to maximize officiating utility while minimizing Physical Compliance burden.

The hierarchical density gradient tiers are calibrated according to sport-specific adjudication requirements identifying which anatomical surfaces and equipment regions most frequently determine rules outcomes. In American football, for example, adjudication-critical surfaces include knee and elbow outer surfaces whose ground contact terminates live play and determines forward progress; fingertip and palm surfaces whose ball relationship determines possession, catch completion, and fumble status; toe and heel perimeter whose boundary-line position determines in-bounds/out-of-bounds status; and ball nose and longitudinal extremities whose goal-line and first-down-marker position determines scoring and down-and-distance outcomes. Footwear purpose-engineered for American football, for example, necessitates sensors to adjudicate the highly consequential “toe tap” plays, which are traditionally pose the greatest level of difficulty in officiating. Said shoes would have an expanded amount of sensors around the toe and heel of the shoe, whereas similar footwear for soccer and rugby would not justify their inclusion. These rules-sensitive surfaces receive tracking element density sufficient to resolve spatial position to the system's claimed accuracy threshold of one-sixteenth of an inch. Lower-criticality surfaces—mid-torso, popliteal fossa, cubital fossa, and inner-thigh panels, for example—receive reduced density sufficient for gross shape reconstruction without boundary-condition resolution. The adjudication-weighted density gradient methodology extends to all performance capture domains disclosed in the Field of Invention section, where motion picture systems would differ from ballet or combat sports.

### Dynamic Deformation Tracking and Flexible Surface State Estimation:

The present invention addresses—within the Collision & Deformation Assumptive Spatial Architecture (SEE: Inventor's Lexicography)—the technical challenge of tracking anatomical position through flexible fabric substrates undergoing continuous deformation during athletic motion, a challenge arising directly from the Deformable-Body & Boundary-Primary Conceptual Inversions (SEE: Inventor's Lexicography) wherein tracked subjects are treated as continuously deformable volumetric identities rather than rigid-body abstractions. Unlike rigid-body tracking where geometric relationships between tracking elements remain constant, wearable tracking systems must account for fabric stretch, compression, bunching, and fold states that dynamically alter spatial relationships between tracking element positions and underlying anatomical surfaces, as well as being critical rules-bound determinants in the various sports. A tracking element on a knee panel does not maintain fixed offset distance from the underlying patella-fabric stretches during flexion, compresses during extension, and may bunch during lateral movement, producing tracking element displacements not corresponding to actual anatomical motion. Failure to account for these deformation states produces systematic positioning errors accumulating across the body surface and compromising reconstructed geometric envelope accuracy, as well as an inability to provide data for adjudication of officiating “holding” calls in soccer or American football where a jersey is pulled to obstruct the opposing player.

Consistent with the Continuously Deformable Volumetric Identity Model (SEE: Inventor's Lexicography), the system addresses dynamic deformation through a deformation state estimation methodology inferring fabric configuration from relative positions of adjacent tracking elements within the same anatomical region. This can be accomplished through sensor topography layering. This can be accomplished through a multi-garment hierarchical confidence architecture employing active, self-reporting sensor substrates at multiple anatomical proximity layers. Digitally enabled inner garments—including instrumented inner shirts, long underwear, and MOCAP turf tape (SEE: Shape Tape chapter)—function as body-conformal reference layers whose close anatomical proximity produces inherently higher-confidence positional data. For avoidance of doubt: the term “MOCAP” as used herein refers to an active, self-reporting tracking substrate operating within the Object-Originated Spatial Awareness paradigm disclosed in this application and is expressly distinguished from conventional motion capture systems employing passive retroreflective markers observed by external camera arrays. Whereas conventional motion capture markers require line-of-sight observation by external cameras and are rendered inoperative during occlusion events, the MOCAP turf tape disclosed herein actively generates and emits its own spatial position data consistent with the Measurement Causality Paradigm Inversion, maintaining continuous positional reporting regardless of external observability.

Dynamic Hierarchical AI Assisted Weighting: The system assigns hierarchical confidence weighting to positional data based on garment-to-anatomy proximity, wherein inner garment layers—conforming directly to the body surface with minimal intervening air gap—receive elevated confidence weighting as anatomical ground truth references, while outer uniform layers—subject to stretch, bunching, fold, and wind-induced displacement exceeding anatomical conformity—receive correspondingly reduced confidence weighting. The AI-driven sensor fusion engine continuously computes differential displacement between inner reference layers and outer deformable layers, interpreting divergence between these layers as fabric deformation state indicators rather than anatomical movement. This inside-to-out hierarchical confidence weighting operates as a complementary instantiation of the same architectural principle governing the Dynamic Adjudicative Relevance Hierarchy (SEE: Inventor's Lexicography) disclosed for player-level prioritization—wherein performers proximate to adjudication-critical events receive elevated reporting priority while distant performers receive reduced priority—and the Performer Spatial Assembly/Venue Spatial Assembly structural hierarchy wherein federated component assemblies operate at different levels of spatial authority. In the garment hierarchy, proximity to anatomy determines confidence authority; in the performer hierarchy, proximity to adjudication-critical spatial events determines reporting authority; in the PSA/VSA hierarchy, the structural relationship between performer assemblies and venue assemblies determines spatial reference authority. The unifying principle across all three hierarchies is that the system dynamically modulates data weighting based on contextual relevance rather than treating all spatial data sources as equivalent contributors—a fundamental departure from prior art systems that either lack multi-layer garment sensing entirely or treat all sensor inputs with uniform weighting regardless of anatomical proximity or adjudicative relevance.

In the stretchable outer uniform, when multiple tracking elements are distributed across a fabric panel according to the density gradient architecture disclosed herein, instantaneous distances between adjacent elements encode local fabric state information. Fabric under tension produces increased inter-element spacing relative to relaxed-state baseline; fabric under compression produces decreased spacing; fabric in folded configuration produces characteristic clustering patterns where elements on opposing fold surfaces approach while elements spanning the fold axis separate. The AI-driven sensor fusion engine maintains a deformation model for each instrumented fabric region, interpreting inter-element spacing patterns as fabric state indicators and applying corresponding corrections to anatomical position estimates.

The Pre-Game “Weigh In” Ritual: The deformation state estimation methodology is registered during the pre-performance body scanning (“weigh in”) procedure disclosed herein through a layered topographical registration sequence consistent with the multi-garment hierarchical confidence architecture described above. The layered topographical registration proceeds from innermost garment layer outward in sequential phases, establishing cumulative inter-layer correspondence at each stage. The inter-layer transfer functions produced by this registration sequence operate bidirectionally during live performance—the inward-to-outward procedural sequence establishes the functions but does not constrain their operational direction; authority transfer between layers is event-conditioned and bidirectional, governed by the AI-driven sensor fusion engine in real time. In the first registration phase, the athlete dons only the body-conformal inner reference layer—instrumented inner shirt, long underwear, and/or MOCAP turf tape as applicable to the sport—and performs a standardized range-of-motion sequence while the system records the three-dimensional spatial emissions of all active tracking elements in the inner garment relative to anatomical landmarks captured simultaneously by optical ground truth measurement systems (photogrammetry arrays or structured-light scanners as disclosed in the Pre-Performance Ground Truth Optical Measurement section herein). This first phase establishes the body-conformal baseline: a verified correspondence between inner-layer tracking element positions and underlying anatomical surfaces at each joint articulation state, producing athlete-specific anatomical transfer functions that map inner-layer spatial emissions to anatomical ground truth position with the highest confidence weighting available in the system. In the second registration phase, the athlete dons the outer uniform over the already-registered inner reference layer and repeats the standardized range-of-motion sequence. During this phase, the system simultaneously records spatial emissions from both inner reference layer and outer uniform layer, establishing the inter-layer deformation transfer function: the mathematical relationship between inner-layer anatomical ground truth positions and outer-layer tracking element positions at each joint articulation state. Because the inner layer has already been calibrated to anatomical ground truth in the first phase, any divergence between inner-layer and outer-layer tracking element positions during the second phase is attributable to outer garment deformation—stretch, compression, bunching, fold—rather than anatomical movement, enabling the system to isolate fabric deformation effects with precision unachievable by single-layer calibration approaches. In embodiments involving additional intermediate garment layers—such as sports requiring protective padding between inner reference layer and outer uniform—additional registration phases are interposed, each adding one garment layer and establishing correspondence between the newly added layer and the previously registered cumulative assembly, producing a nested hierarchy of inter-layer transfer functions from skin outward to outermost garment surface. Where sport-specific rules permit, the calibration sequence further incorporates hard-shell protective equipment (helmets, shoulder pads, shin guards) as a final outer layer, establishing correspondence between rigid equipment tracking elements and the deformable garment layers beneath. The complete layered topographical registration produces a multi-layer deformation model comprising: athlete-specific anatomical baseline from the inner reference layer; layer-to-layer deformation transfer functions for each successive garment interface; sport-specific and equipment-specific correction factors accounting for padding compression, hard-shell displacement, and protective equipment articulation; and composite confidence weightings assigning highest positional authority to inner-layer data and progressively reduced authority to each successive outer layer. This multi-layer deformation model is stored as part of the athlete's tracking profile and applied in real time during performance capture, enabling the AI-driven sensor fusion engine to reconstruct anatomical position by first resolving inner-layer ground truth, then applying successive inter-layer corrections outward, and finally computing the differential between reconstructed anatomical position and observed outer-garment tracking element positions to determine fabric deformation state. This inside-to-out registration and reconstruction sequence ensures that the system can simultaneously report both anatomical ground truth position of the performer and the deformation state of each garment layer independently—a dual-output capability enabling not only positional adjudication (was the knee down before the ball crossed the goal line) but also garment-interaction adjudication (was the jersey pulled in a manner constituting a holding foul) from a single integrated measurement architecture. For avoidance of doubt: the layered calibration procedure described herein is distinguished from conventional motion capture calibration—which captures correspondence between passive reflective markers and external camera systems in a single uniform-agnostic session—in that the present calibration establishes active, self-reporting inter-layer correspondences at each garment boundary within the Object-Originated Spatial Awareness paradigm, producing garment-layer-specific deformation models that conventional single-session calibration cannot generate because conventional systems lack multi-layer active sensing capability entirely.

For high-deformation regions where fabric stretch exceeds elastic tracking range of rigid circuit elements, the system employs stretchable conductor implementations utilizing serpentine trace geometries, coiled microstructures, or intrinsically stretchable conductive materials such as liquid metal alloys or conductive elastomer composites. These implementations maintain electrical continuity and signal integrity across fabric stretch ranges of up to 50% elongation, enabling tracking element deployment in regions such as posterior knee, anterior elbow, and lateral torso where fabric strain during athletic motion would fracture conventional rigid-flex circuit constructions. Stretchable conductor regions integrate with the continuous spiral topology disclosed herein such that conductor path integrity verification remains functional even when conductor path portions extend to maximum strain capacity.

By utilizing quantum-based weighted AI-driven error correction with ground truth models for reference, the system intelligently switches between tracking methods depending on real-time conditions, achieving sub-millimeter positioning in all spatial directions.

The specific layering configurations described in the foregoing section—inner shirt, outer jersey, shoulder pads, helmet, shin guards, and analogous sport-specific equipment layers—are non-limiting embodiments illustrating the hierarchical confidence architecture as applied to contemporary professional sports equipment configurations. The invention is not limited to any specific number of garment or equipment layers, any specific sequence of layer types, or any specific equipment configuration. The operative architectural requirement is that one or more EDID-bearing equipment layers are organized such that inter-layer transfer functions can be established during the pre-performance topographical registration procedure and applied bidirectionally during live performance by the AI-driven sensor fusion engine, satisfying the functional requirements of the hierarchical confidence architecture regardless of the specific number or type of layers present. This technology-agnostic, configuration-agnostic architectural principle is consistent with the continual evolution of sports equipment design, protective equipment technology, and instrumentation integration techniques in high-stakes competitive sports contexts, and the claims herein are intended to encompass any configuration of instrumented equipment layers whose inter-layer transfer functions satisfy these functional requirements, whether in equipment configurations existing as of the filing date or developed thereafter.

### Participation State Architecture and Game-State-Aware Emission Filtering:

The Object-Originated Spatial Awareness paradigm introduces a spatial contamination vulnerability absent from external observation systems: because every instrumented equipment piece—whether worn by an active participant, a sideline substitute, a bench-seated reserve, or an ejected player—continuously generates and emits spatial data through the same EDID-authenticated channels, the system's adjudication computations are exposed to spatial emissions from non-participating performers occupying regions spatially adjacent to or overlapping with adjudication-critical zones. This vulnerability is most acute at field boundaries in American football, where sideline personnel—including up to 24 non-participating dressed players per team, coaching staff wearing instrumented credentials, and chain gang operators—stand within inches of the painted sideline boundary that the Boundary-Line Cooperative Sensing Array monitors for toe-tap, foot-drag, and sideline catch adjudication. An instrumented shoe emitting spatial data from the sideline is, from the sensor fusion engine's perspective, indistinguishable from an instrumented shoe emitting spatial data from an active receiver's foot making a contested sideline catch—unless the system maintains awareness of which PSAs are authorized participants in live play at any given temporal instant.

External observation systems do not face this vulnerability because human camera operators, referees, and replay officials visually identify which individuals are active participants and which are sideline personnel—a cognitive filtering operation performed unconsciously and instantaneously by human observers. The Object-Originated paradigm, having eliminated dependence on external observation, must provide a systematic computational replacement for this visual discrimination capability. The Adjudication Participation State (APS) architecture disclosed herein provides this replacement.

The APS architecture operates through three integrated mechanisms: state assignment, state transition detection, and state-aware adjudication filtering.

State Assignment occurs during the Pre-Game “Weigh In” Ritual disclosed above, wherein each PSA constituted through Session-Bound Federated Identity binding receives an initial Adjudication Participation State. For sports with fixed starting lineups (American football, association football, basketball), the starting participants are assigned Active-On-Field status while all remaining PSAs are assigned Sideline-Present or Bench-Inactive status according to their designated pre-game location. The initial state assignment is recorded in the tamper-evident audit ledger as part of the session initialization record, establishing the evidentiary baseline from which all subsequent state transitions are tracked.

State Transition Detection operates through Game-State Transition Events (GSTEs) detected by the same Object-Originated Spatial Awareness infrastructure that performs all other spatial measurement functions. In American football, snap detection—accomplished through the game ball's embedded sensor array detecting the characteristic acceleration, rotation, and spatial displacement signature of a center-to-quarterback transfer—triggers an instantaneous spatial census: the system captures the three-dimensional position of every registered PSA's spatial centroid at the temporal instant of snap detection, correlates each centroid against the field-of-play boundary geometry maintained by the Venue Spatial Assembly, and assigns Active-On-Field status to each PSA whose centroid falls within the field-of-play boundary while assigning Sideline-Present status to each PSA whose centroid falls outside the field-of-play boundary. This snap-triggered census operates at the same sub-millisecond temporal resolution as all other adjudication measurements, ensuring that the participation state assignment reflects the actual spatial distribution of performers at the precise moment play commences. For association football, where substitution follows a formal administrative protocol, the system integrates with the fourth official's substitution authorization—whether communicated through electronic substitution board integration, manual officiating input, or designated substitution zone boundary crossing detection—to trigger state transitions for entering and departing PSAs. For ice hockey, where substitution occurs during continuous play through designated bench-gate zones, the system monitors PSA trajectories through bench-access spatial regions maintained as defined zones within the Venue Spatial Assembly, assigning Transitional status to PSAs entering or exiting these zones and resolving final Active-On-Field or Bench-Inactive assignment based on completed trajectory through the transition zone.

State-Aware Adjudication Filtering operates at the sensor fusion layer, applying participation state metadata to all adjudication computations without altering the underlying spatial data. When the AI-driven sensor fusion engine performs a boundary determination—toe-tap resolution, foot-drag trajectory analysis, sideline catch adjudication, or any computation correlating performer-originated spatial data with boundary-line sensing array data—the engine queries the Adjudication Participation State of each PSA whose spatial emissions fall within the computation's spatial and temporal window. Emissions from PSAs in Active-On-Field state are included in the adjudication computation with full weighting. Emissions from PSAs in Sideline-Present state are excluded from the adjudication computation but remain recorded in the underlying spatial data stream for evidentiary completeness and post-event audit capability. This filtering operates identically to the Dynamic Adjudicative Relevance Hierarchy disclosed in the Inventor's Lexicography herein, extending that hierarchy's proximity-based priority modulation with participation-state-based eligibility gating. The critical architectural distinction is that no spatial data is discarded, suppressed, or altered—the tamper-evident audit ledger preserves all emissions from all PSAs regardless of participation state, and the participation state metadata itself is recorded as an auditable adjudication parameter, enabling post-event review to verify that state assignments were correct and that filtering operated as intended.

Illegal Participation Detection operates as a derivative function of the APS architecture. Because the system maintains real-time awareness of how many PSAs hold Active-On-Field status at any temporal instant, the system can automatically detect and flag potential too-many-players violations—a determination that external observation systems struggle to make in real time because counting moving players across a large field from camera angles is unreliable, particularly during chaotic substitution sequences. In American football, where each team is permitted exactly eleven active participants, the snap-triggered spatial census described above inherently produces an Active-On-Field count for each team; a count exceeding eleven triggers an automatic officiating alert. In association football, where each team is permitted a maximum of eleven players including the goalkeeper, the system's continuous PSA state tracking detects any moment at which more than eleven PSAs from a single team hold Active-On-Field status—including during substitution windows where a departing player has not yet exited the field while the entering player has already crossed the touchline. The illegal participation detection function does not make officiating determinations—it provides automated alerting to officiating personnel who retain exclusive authority to assess penalties under applicable rules.

Sideline Spatial Contamination Mitigation addresses the specific scenario motivating the APS architecture: a contested sideline catch in American football where an active receiver's instrumented footwear contacts ground within inches of the painted sideline while substitute players' instrumented footwear occupies the immediately adjacent sideline area. Without APS filtering, the Boundary-Line Cooperative Sensing Array would detect proximity and contact events from both the active receiver's sole lip perimeter array and the substitute players' sole lip perimeter arrays, producing multiple simultaneous boundary-interaction spatial records that the adjudication engine must disambiguate. With APS filtering, the engine excludes substitute players' emissions from the boundary adjudication computation at the threshold level, evaluating only the active receiver's sole lip data against the boundary-line array data, producing an uncontaminated determination. The excluded emissions remain available in the audit ledger for post-event verification that the exclusion was appropriate—for example, to confirm that the substitute player flagged as Sideline-Present was not in fact an active participant who had been incorrectly classified. This architecture ensures that the spatial precision advantage of the Boundary-Line Cooperative Sensing Array is not undermined by the very comprehensiveness of the Object-Originated instrumentation approach—a failure mode that would be ironic in its causation but severe in its adjudicative consequence.

For avoidance of doubt: the Adjudication Participation State architecture is distinguished from conventional sports tracking systems employing roster management databases or lineup card digitization in that: (a) APS operates at the spatial emission level rather than at the administrative records level, filtering actual sensor data streams in real time rather than merely recording which players are designated as active in a database; (b) APS state transitions are detected through the same Object-Originated spatial infrastructure that performs all adjudication measurements, rather than through manual input, barcode scanning, or external observation; (c) APS filtering integrates directly into the AI-driven sensor fusion computation pipeline, operating at sub-millisecond temporal resolution contemporaneous with the adjudication measurements it filters, rather than operating asynchronously from measurement systems; and (d) the spatial contamination vulnerability APS addresses is unique to the Object-Originated Spatial Awareness paradigm—external observation systems that passively observe tracked subjects do not face the problem of non-participants' instrumented equipment generating indistinguishable spatial emissions in adjudication-critical zones, because external observation inherently excludes non-participants from the observation frame through camera pointing, zoom selection, and human visual discrimination.

### Method of Producing Spatially Enriched Broadcast and Interactive Content

The present invention discloses, in addition to the apparatus and infrastructure described herein, a method of producing broadcast content, interactive entertainment content, and digital performance reconstructions whose spatial data originates from the Measurement Causality Paradigm Inversion and that are therefore structurally distinguishable from content. This method comprises the following operational sequence, wherein each step depends upon capabilities exclusive to the Object-Originated Spatial Awareness Paradigm:
(a) Receiving, at a content production processing system, a plurality of Timestamped Spatial Emission Data records originating from EDID-bearing tracking elements embedded within or affixed to a plurality of instrumented object components bearing per-element EDIDs within one or more performer spatial assemblies and one or more venue spatial assemblies, wherein each Timestamped Spatial Emission Data record includes at minimum a three-dimensional position coordinate, an orientation quaternion, a confidence metric, and a cryptographic attestation generated by the originating Equipment Decentralized Identifier (EDID), and wherein the spatial data records are generated by the tracked objects themselves rather than being derived from external observation of those objects;
(b) Generating, from said received timestamped spatial emission data, a temporally ordered sequence of time-indexed state records over a defined event interval, wherein each state record includes, for each EDID-bearing instrumented object component within each performer spatial assembly and venue spatial assembly, the three-dimensional surface geometry expressed as a vector-based topographical wireframe representation of the component's sculptural surface contours—comprising sparse topographical coordinate collections defining anatomical articulation boundaries rather than undifferentiated point cloud surface reconstruction—together with region-specific deformation state, articulated configuration, and region-specific three-dimensional spatial state including position and orientation attributed at emission to the intrinsic per-element EDID of said component, and surface contact topology, wherein said EDID attribution differentiates discrete anatomical and equipment-associated surface regions within each said performer spatial assembly such that the geometric envelope of each instrumented object component is independently trackable and distinguishable from the geometric envelopes of all other instrumented object components within the cooperative spatial mesh, wherein said generated sequence is derived directly from timestamped spatial emission data emitted by said EDID-associated surface regions without post hoc geometric reconstruction from external line-of-sight dependent observation, and wherein continuity of deformable volumetric identity is preserved by maintaining persistent EDID attribution for said differentiated surface regions across successive time indices independent of spatial proximity, contact, compression, deformation, or occlusion, such that surface-specific contact-state durations are determinable from said ordered sequence;
(c) Producing, from said temporally ordered sequence of time-indexed state records, at least one of the following non-limiting output types, or any functionally equivalent output structure derived from said temporally ordered sequence that preserves EDID attribution and contact-state topology of the tracked activity: (i) a Spatially Enriched Broadcast Signal (SEBS) (SEE: Inventor's Lexicography) formatted for real-time broadcast or streaming distribution, wherein said signal carries embedded spatial metadata enabling receiving systems to render virtual camera viewpoints, augmented reality overlays, or three-dimensional scene reconstructions from perspectives not corresponding to any physical camera position; (ii) a Volumetric Performance Reconstruction preserving evidentiary-grade spatial accuracy throughout a defined event interval of a recorded activity, suitable for post-event production, archival, or redistribution; (iii) an Interactive Performance Data Stream (IPDS) (SEE: Inventor's Lexicography) formatted for consumption by interactive entertainment platforms, simulation engines, or digital gaming environments, wherein said data stream preserves sufficient geometric fidelity to enable consuming applications to reconstruct articulated body motion, equipment deformation, and surface contact topology with accuracy not achievable through any external line-of-sight dependent observation system, hub-and-spoke spatial architecture, or unidirectionally hierarchical tracking infrastructure wherein tracked objects serve as passive subjects rather than as active emitters; (iv) an identity-trajectory data structure in which each EDID-associated surface region defines an identity-continuous spatial trajectory preserved through successive time indices independently of occlusion, contact, compression, deformation, or proximity events occurring among tracked subjects, wherein said identity continuity is an architectural property of the object-originated spatial emission architecture and is structurally absent from records derived from external line-of-sight dependent observation systems wherein occlusion interrupts the observational chain upon which identity attribution depends; (v) a spatiotemporal field representation in which the tracked environment is expressed as a continuously evolving spatial field populated by EDID-attributed identity regions whose spatial states evolve across successive temporal indices, wherein contact topology is expressed as interaction edges within said field, and wherein said field representation preserves structural continuity through contact and occlusion events that would produce field discontinuities in any external line-of-sight dependent observation system; (vi) a contact-state event topology record in which the onset, duration, and termination of surface contact events among EDID-attributed surface regions are preserved as temporally ordered state transitions constitutively attributed to specific EDID-differentiated surface regions, wherein said contact-state durations and surface-region identities are first-class constitutive attributes of the record rather than inferences derived from externally observed positional frames; or (vii) a performance-topology representation structured as simultaneous multi-channel temporal data in which EDID-associated surface regions constitute identity channels distributed along a temporal axis and contact-state intervals, deformation states, and spatial transitions are expressed as temporally resolved events attributed to said channels, wherein said multi-channel temporal structure preserves the rhythmic and sequential contact-state topology of the tracked activity as an ordered, differentiated temporal record;
(d) Embedding, within said produced content, cryptographic provenance chains linking each spatial data record to the originating EDID of the specific instrumented object component that generated the underlying spatial measurement, through Proof-of-Position attestations each cryptographically linked to said originating EDID, such that per-component attribution is maintained as an architecturally intrinsic property of said produced content rather than as a separable administrative record, and wherein said cryptographic provenance chain maintains an unbroken audit trail from the point of spatial data origination through final distributed content suitable for evidentiary purposes; and
(e) Outputting or distributing said produced content through at least one output or distribution channel, wherein a cryptographic access control layer enforces tiered access rights governing access resolution, temporal availability, and attribution preservation across access tiers, said tiered access rights including but not limited to full-resolution access for primary broadcast licensees, reduced-resolution access for secondary media partners, and time-delayed access for archival or interactive entertainment consumers.

The method described above is distinguished from all prior art methods of producing broadcast, interactive, or performance-recording content, including but not limited to sports broadcast content, in that: (1) the spatial content embedded within the output is originated by the tracked objects themselves rather than inferred from external observation, and therefore persists through occlusion events, maintains accuracy independent of camera placement, and carries cryptographic provenance from the moment of spatial measurement through final distribution; (2) the output enables virtual camera synthesis from arbitrary viewpoints with geometric accuracy determined by tracking point density rather than physical camera availability, because the underlying data represents direct object-originated spatial knowledge rather than view-dependent optical capture; (3) the interactive data streams carry six-degree-of-freedom pose data for full geometric envelopes rather than centroid-only position estimates, enabling consuming applications to reconstruct articulated body motion, equipment deformation, and surface contact topology that is structurally beyond the capability of any external observation system; and (4) the evidentiary chain of cryptographic attestation from EDID-authenticated measurement through final content distribution provides verifiable provenance that is architecturally impossible in systems where spatial data originates from external observers rather than from the tracked objects themselves.

For avoidance of doubt, a broadcast production method that combines conventional camera feeds with graphical overlays generated from external tracking systems—including but not limited to camera-based tracking, radar-based tracking, GPS-based tracking, or any other system wherein spatial data is derived from observation of the tracked objects by sensors external to those objects—does not practice the method disclosed herein, regardless of the sophistication of the graphical enhancement or the number of overlaid data sources, because the fundamental data origin (external observation versus object-originated emission) determines the structural characteristics of the output content in ways that no post-processing can replicate.

The Spatially Enriched Broadcast Signal (SEBS) format constitutes a structurally novel class of signal defined by the six-element architectural signature of its embedded spatial metadata: (1) object-originated spatial data attributed at emission to EDID-bearing components; (2) component-level EDID attribution constitutively embedded in each spatial data record at the moment of generation; (3) geometric envelope data preserving three-dimensional surface state independently of external observation infrastructure; (4) cryptographic provenance chain from originating EDID through final distributed signal; (5) contact-state topology records preserving durational contact states as temporally resolved region-differentiated state sequences rather than binary event flags; and (6) adjudication-grade positional accuracy attested by the cryptographic provenance chain. This six-element structural signature defines the SEBS format as a signal class in the same architectural sense that a noise-reduction signal format is defined by its encoding signature—the format is enforceable as a class of signal regardless of the physical hardware that generated it, the transmission medium that carries it, or the jurisdiction in which the receiving system operates. For avoidance of doubt, the method-of-use of the SEBS format is practiced at the point of signal production, transmission, storage, or consumption—not only at the point of hardware manufacture—and therefore the claims directed to this signal format and to methods of producing, transmitting, or consuming signals of this class are infringed by any entity that produces, transmits, stores, or consumes a signal meeting the structural definition above, in any jurisdiction where the present invention is patented, regardless of where the Object-Originated Spatial Awareness hardware was manufactured.

### Application to Interactive Entertainment and Digital Gaming:

The Interactive Performance Data Stream (IPDS) (SEE: Inventor's Lexicography) produced by the method described above enables a category of interactive entertainment products that is structurally dependent upon object-originated spatial data. Specifically, digital gaming platforms that consume the IPDS can render player avatars whose movements correspond to actual articulated body motion captured through the geometric envelope—including finger position, limb orientation, equipment grip, and surface contact events—rather than relying upon centroid-based position estimates supplemented by algorithmic animation interpolation. This distinction is not merely one of fidelity or resolution; it represents a qualitative difference in the category of interactive content that can be produced. A gaming platform consuming externally observed tracking data can place an avatar at an estimated position and animate it algorithmically; a gaming platform consuming object-originated IPDS data can reproduce the actual biomechanical performance with geometric accuracy, including the precise moment and location of ball contact, the exact hand position during a catch, and the true surface deformation of equipment during impact events. These capabilities are necessary consequences of the Object-Originated Spatial Awareness Paradigm and are structurally unachievable within the External Observation Paradigm.

The distinction between Geometric Performance Capture (GPC) (SEE: Inventor's Lexicography) and statistically parameterized simulation warrants explicit elaboration because it defines a boundary that no amount of statistical refinement, computational investment, or animation sophistication can cross. Every sports video game produced as of the date of this filing operates within the same fundamental paradigm: performer capabilities are encoded as statistical attribute ratings derived from scouting data, historical metrics, and subjective evaluation; in-game movement is generated by animation engines selecting from pre-recorded motion capture libraries weighted by those attribute ratings; and the resulting on-screen performance is a computational prediction—an algorithmically plausible approximation of what a performer with those statistical attributes might do, not a record of what any specific performer actually did during any specific event. This paradigm has remained structurally unchanged since its introduction in early sports video games of the 1980s and 1990s, despite decades of improvement in graphical fidelity, animation quality, and statistical modeling complexity. The improvement trajectory is asymptotic: more detailed statistics produce more plausible simulations, but no quantity of statistical data transforms a probabilistic prediction into a geometric record of actual performance.

Geometric Performance Capture produces interactive entertainment content occupying a categorically different product space. A digital gaming platform consuming GPC-derived Interactive Performance Data Stream data can reproduce a specific identified performer's actual biomechanical execution during a specific identified competition event—the precise arm angle of a particular quarterback's throw on a particular play, the exact footwork sequence of a particular receiver's route on a particular down, the true hand position and ball deformation during a particular catch—with geometric fidelity attested by EDID-authenticated cryptographic provenance. This is not a higher-resolution version of what statistical simulation produces; it is a fundamentally different product that statistical simulation cannot produce regardless of statistical sophistication, because the required spatial information was never captured by any system operating within the External Observation Paradigm.

The method of producing GPC-derived interactive entertainment content comprises: (a) capturing live performance through the Object-Originated Spatial Awareness system disclosed herein, generating EDID-authenticated spatial data records preserving geometric envelope state at each time step; (b) formatting the captured spatial data as an Interactive Performance Data Stream with sufficient fidelity for consuming game engines to reconstruct articulated body motion, equipment state, and contact event topology; (c) applying the cryptographic access control layer disclosed herein, enforcing tiered distribution rights governing which interactive entertainment licensees may consume which spatial data at which temporal resolution; and (d) delivering the formatted IPDS to consuming interactive entertainment platforms through standardized interfaces. For avoidance of doubt, this method is practiced when a game studio, interactive entertainment platform, or digital content producer consumes GPC-derived IPDS data to produce interactive entertainment products in any jurisdiction where the present invention is patented, regardless of where the Object-Originated Spatial Awareness hardware was manufactured, because the method-of-use is practiced at the point of content production consumption rather than at the point of hardware manufacture.

### Temporal Fidelity as Functional Capability Benchmark:

The qualitative threshold for determining whether a spatial capture system achieves Geometric Performance Capture as defined herein is expressible through a functional litmus test grounded in temporally differentiated contact-state topology. A system satisfying the requirements of this disclosure must be capable of capturing, with full spatiotemporal fidelity, the rhythmic and sequential contact-state topology of a ballet performance or a tap dancing routine—wherein surface contact between a performer's foot and a support surface is not recorded as a binary state (contact or no contact) but as a temporally resolved, region-differentiated state sequence in which the duration, timing, and anatomical attribution of each contact event are preserved. Under this benchmark, a foot drag is captured as a structurally different contact-state expression than a tap; the temporal sequence of a prancing or leaping passage—left foot, right foot, left foot, right foot, double step—is inherently comprehended and preserved as an ordered, EDID-differentiated temporal topology in which the specific foot, the specific contact duration, and the specific airborne interval between contacts are recorded with fidelity sufficient to reconstruct the rhythmic structure of the performance. This benchmark is not a deviation from the sports and performance-tracking applications that constitute prominent embodiments of the present invention. It is an expression of the system's foundational capability operating at its qualitative floor—analogous to the principle in audio engineering wherein the ability to faithfully record the timbre of a pin dropping onto a hard surface establishes the qualitative bar for recording a violin, an electric guitar, or a full orchestra. A spatial capture system that can preserve the complete rhythmic temporal topology of a tap dance routine—every drag, every tap, every airborne interval, every contact-state transition attributed to a specific EDID-differentiated anatomical region—can, a fortiori, determine whether a player's knee contacted the playing surface before a game ball crossed a boundary plane, which is a temporally simpler determination involving fewer simultaneous contact-state transitions. The temporal fidelity benchmark disclosed herein is directly applicable to the interactive entertainment and digital gaming applications described above: existing sports video games, constrained by the statistically parameterized simulation paradigm described in the Geometric Performance Capture definition (SEE: Inventor's Lexicography), cannot reproduce the rhythmic temporal topology of an actual athletic performance because the required temporally differentiated, anatomically attributed contact-state sequence was never captured by any system operating within the External Observation Paradigm. In the Name, Image, and Likeness (NIL) era, the athlete's actual acrobatic performance—not a statistical abstraction of the athlete's capabilities—constitutes the commercially valuable asset. Capturing that performance with full spatiotemporal fidelity, including the temporal structure of contact-state sequences, is necessary both for faithful rebroadcast and archival preservation and for enabling interactive entertainment consumers to experience the actual spatial reality of the performance immersively rather than consuming an algorithmically generated approximation. The functional litmus test described in this paragraph therefore serves simultaneously as a capability benchmark, as a prior art differentiator, and as a commercial necessity metric for the interactive entertainment applications enabled by the Object-Originated Spatial Awareness Paradigm.

### Spatial Identity Record Representation Modalities:

The temporally ordered spatial identity record generated by the systems and methods disclosed herein constitutes a primary spatiotemporal signal derived from object-originated spatial emissions attributed to EDID-differentiated surface regions of tracked subjects and associated objects. This primary signal is not limited to a single representational format. Because the record encodes time-indexed spatial state information including surface geometry, deformation state, articulated configuration, region-specific spatial coordinates and orientation, contact topology, and surface contact maps, all attributed at emission to persistent per-element EDID identifiers, the same underlying primary signal may be expressed through multiple equivalent representational projections without altering the informational content of the stored record. The representational modalities described below are not independent data structures; each is a mathematically defined projection of the same underlying spatiotemporal signal whose canonical structural form is the temporally ordered sequence of EDID-attributed state records defined by the systems and methods herein.
Temporally Ordered Volumetric Frame Sequence: In a first representational modality, the spatial identity record may be expressed as a temporally ordered volumetric frame sequence in which each time index corresponds to a complete spatial state of the tracked environment. In this modality, each frame contains the three-dimensional spatial configuration and deformation state of EDID-associated surface regions for all tracked subjects and instrumented objects within the venue environment. Successive frames collectively form a spatiotemporal volumetric record analogous to a three-dimensional motion picture negative in which the evolving geometric configuration and contact topology of the environment are preserved with temporal continuity and per-surface-region identity attribution.
Identity-Trajectory Representation: In a second representational modality, the spatial identity record may be expressed as an identity-trajectory representation in which EDID-associated surface regions define identity-continuous spatial trajectories through time. In this modality, each EDID-associated region traces a continuous path through the shared coordinate space across successive time indices, thereby defining a persistent identity trajectory independent of occlusion, contact, compression, deformation, or proximity events occurring among tracked subjects. The persistence of identity attribution through occlusion and contact events is an architectural property of the object-originated spatial emission architecture and is structurally absent from records derived from external line-of-sight dependent observation systems, wherein occlusion interrupts the observational chain upon which identity attribution depends.
Contact-State Event & Topology Representation: In a third representational modality, the spatial identity record may be expressed as a contact-state event topology representation in which transitions between contact states among EDID-associated surface regions are recorded as temporally resolved topological events. In this modality, the onset, duration, and termination of surface contact events are preserved as temporally ordered state transitions attributed to specific EDID-differentiated surface regions, thereby enabling reconstruction of the rhythmic and sequential contact-state topology of a performance or tracked activity. This modality is the direct representational instantiation of the Temporal Fidelity Benchmark described above: a system whose spatial identity record supports this modality can, from that record alone, reconstruct the ordered left-right-left-right contact-state topology of a tap dance sequence, the specific contact duration at each anatomical surface region, and the airborne interval between contacts, because those quantities are constitutive attributes of the stored EDID-attributed state records rather than inferences from externally observed positional frames.
Spatiotemporal Field Representation: In a fourth representational modality, the spatial identity record may be expressed as a spatiotemporal field representation in which the tracked environment is represented as a continuously evolving spatial field populated by EDID-attributed identity regions whose spatial states evolve across successive temporal indices. In such representations, the spatial state of the environment at any time index may be interpreted as a field configuration defined by the set of EDID-associated spatial states present within the coordinate domain, with contact topology expressed as interaction edges within the field.
Performance Topology Representation: In a fifth representational modality, the spatial identity record may be expressed in a performance-topology representation whose structure has analogical correspondence to temporal score notation. In this modality, EDID-associated surface regions function as identity channels distributed along a temporal axis, and contact-state intervals, deformation states, and spatial transitions are expressed as temporally resolved events associated with those channels. The structural parallel to musical score notation is that the performance is recorded as simultaneous multi-channel temporal structure rather than as a single-stream sequence of geometric states. This modality is particularly applicable to athletic footwork analysis, contact-sport officiating reconstruction, and motion capture applications requiring rhythmically differentiated temporal topology.

These representational modalities constitute alternative projections of the same underlying spatial identity record and do not alter the structural content of the stored primary record defined herein. None of these representational projections is achievable from records derived from an external line-of-sight dependent observation system, a hub-and-spoke spatial architecture, or a unidirectionally hierarchical tracking infrastructure, because the continuity of deformable volumetric identity through contact and occlusion events, the per-surface-region EDID attribution constitutively embedded in each state record at emission, and the collision-assumptive architecture that treats contact-state topology as primary signal rather than as error data are architectural properties that these systems are structurally incapable of generating. The representational richness of the spatial identity record is therefore not a post-hoc analytical enhancement but a direct consequence of the object-originated spatial awareness architecture from which the record is produced.

The systems disclosed herein may generate one or more of these representational projections concurrently for visualization, analysis, officiating adjudication, broadcast rendering, simulation, archival preservation, or machine-learning applications. The Officiating Proof-of-Position attestation records described herein are generated from the primary spatiotemporal signal and may be associated with any representational projection through which the underlying state records are accessed. The tamper-evident forensic replay ledger stores the primary spatial identity record with cryptographic attestation linking successive temporal indices, and any representational projection derived therefrom inherits the cryptographic provenance chain of the underlying record.

### N.I.L.—Name, Image, and Likeness Implications:

The Name, Image, and Likeness implications of Geometric Performance Capture are architecturally distinct from those arising under existing sports video game licensing. Under existing practice, sports video game publishers license performer Name, Image, and Likeness rights to populate statistical attribute databases and associate performer identities with algorithmically generated avatars; the licensed content is the performer's identity and statistical profile, not any specific performance. Geometric Performance Capture creates a new category of licensable content: the performer's actual three-dimensional biomechanical performance during specific identified events, carrying EDID-authenticated cryptographic provenance linking the geometric record to the specific performer's Performer Spatial Assembly. This geometric performance record constitutes an original work product whose creation required the performer's physical participation and whose commercial value derives from the specific performer's unique movement characteristics—individual throwing mechanics, distinctive running style, characteristic catching technique—that Geometric Performance Capture preserves and that statistical parameterization discards. The EDID-authenticated provenance chain disclosed herein enables per-performer, per-event, per-use attribution tracking throughout the content distribution pipeline, supporting granular compensation structures that existing statistical licensing frameworks cannot implement because existing frameworks lack the technological infrastructure to attribute specific content elements to specific performance events by specific identified performers.

### Application to Motion Picture and Performing Arts Production:

The Volumetric Performance Reconstruction produced by the disclosed method enables motion picture, television, and performing arts producers to capture performances with spatial fidelity that exceeds the capabilities of conventional motion capture systems. Because the tracked objects originate their own spatial data rather than requiring external marker observation, the VPR maintains accuracy through costume occlusion, multi-performer proximity events, rapid movement phases, and environmental conditions (including outdoor or variable-lighting environments) where optical motion capture systems experience degraded performance or complete failure. The VPR therefore constitutes a production tool whose capabilities are exclusive to the Object-Originated Spatial Awareness Paradigm.

The method of producing cinematic and performing arts content through Volumetric Performance Reconstruction comprises: (a) capturing performer spatial states through the Object-Originated Spatial Awareness system disclosed herein during live performance—which may occur on sound stages, outdoor locations, theatrical venues, or any environment where performers execute coordinated movement—without requiring controlled lighting, marker visibility, camera line-of-sight coverage, or any of the environmental constraints that conventional motion capture systems impose; (b) assembling Volumetric Performance Reconstructions preserving the full geometric envelope, articulated pose, surface deformation, and inter-performer spatial relationships at each time step throughout the captured performance; (c) delivering the VPR to post-production systems including visual effects compositing engines, virtual production environments, digital double creation workflows, and performance archival systems through standardized interfaces; and (d) applying the cryptographic access control layer disclosed herein to enforce production-specific distribution rights governing which production entities may consume which performer spatial data at which fidelity level. For avoidance of doubt, this method is practiced when a motion picture studio, television production company, performing arts organization, or visual effects house consumes VPR data produced by the system disclosed herein to create cinematic, televisual, or theatrical content in any jurisdiction where the present invention is patented, regardless of where the Object-Originated Spatial Awareness hardware was manufactured.

The VPR's independence from controlled studio environments constitutes a commercially significant capability that conventional motion capture cannot replicate. Optical motion capture systems require controlled lighting to ensure marker visibility, controlled backgrounds to prevent tracking confusion, and controlled spatial volumes calibrated to fixed camera arrays. These requirements confine motion capture to purpose-built studio environments whose construction, calibration, and operational costs are substantial and whose spatial dimensions limit the scale of capturable performances. The Object-Originated Spatial Awareness system disclosed herein operates without these constraints: performers generate their own spatial data regardless of ambient lighting, background complexity, or environmental conditions, enabling Geometric Performance Capture during outdoor location shoots, live theatrical performances, stadium-scale action sequences, and any other production context where conventional motion capture is impractical or impossible. Stunt sequences performed in rain, snow, dust, or darkness; crowd scenes involving dozens of simultaneously tracked performers; chase sequences spanning outdoor terrain; and live theatrical performances captured without disruption to audience experience—all represent production contexts where VPR-derived content creation is commercially viable and optical motion capture is not.

Geometric Performance Capture in cinematic contexts produces performer attribution records with the same EDID-authenticated cryptographic provenance disclosed for sports applications. Each performer's spatial contribution to a captured scene is individually attributable through the Performer Spatial Assembly identity architecture, enabling per-performer usage tracking, residual computation, and intellectual property management throughout the production and distribution pipeline. Screen Actors Guild (SAG-AFTRA) and equivalent international performers' unions increasingly negotiate digital performance rights—including provisions governing digital doubles, de-aging, posthumous performance, and AI-generated likenesses—and the cryptographic attribution architecture disclosed herein provides the technological infrastructure to enforce such contractual provisions with verifiable precision that existing production tracking methods cannot achieve.

### DETAILED DESCRIPTION OF COMPONENTS

The following detailed description of components implements the paradigm inversions and architectural principles disclosed in the Field of Invention and Technological Summary sections. Each component and subsystem operates within the Measurement Causality Paradigm Inversion—wherein tracked objects generate and emit their own spatial state rather than being externally observed—and the Infrastructure Conceptual Inversion—wherein tracked entities may themselves function as mobile reference anchors constituting a distributed, participant-based positioning infrastructure. The Collision-Assumptive Conceptual Inversion governs the system's operational assumption that dense multi-body contact, compression, and occlusion are defining performance events rather than fault conditions. The Deformable-Body & Boundary-Primary Conceptual Inversions govern the treatment of tracked subjects as continuously deformable volumetric identities whose spatial truth is determined by external surface boundaries rather than internal joint pivots. The Dynamic Adjudicative Relevance Hierarchy Inversion governs the allocation of tracking density, ranging priority, and verification redundancy according to adjudication criticality rather than network symmetry.

The preferred embodiment deploys UWB anchors and tags across the playing field, goal posts, netting, field delimiters, and venue superstructure—the ensemble of venue-deployed elements constituting the Venue Spatial Assembly (VSA) (SEE: Inventor's Lexicography)—to provide primary positioning data based on Time Difference of Arrival (TDoA) and Two-Way Ranging (TWR). Fixed-position UWB tags deploy around the performance field perimeter and at varying heights to create multiple triangulation points. UWB devices on moving objects serve dual functions: generating the tag arrays that capture three-dimensional object shape while simultaneously acting as adaptive, multi-frequency anchors providing triangulation and trilateration at closer proximity than fixed anchors can achieve. This mobile-anchor strategy enhances accuracy and adaptability beyond what fixed anchor or fixed scanning systems can physically provide. For military or police exercises in open terrain, UWB anchors and tags deploy across trees, buildings, towers, poles, or geological formations providing necessary vantage points. UWB tags and anchors are sensor-fused with IMU-based sensors when capturing three-dimensional shape and position. Each tag continuously ranges to all anchors, enabling 3D trilateration. UWB antennas may be inkjet-printed on protective gear and uniform components; compact tri-notched flexible UWB antennas printed using inkjet technology operate effectively within the targeted UWB frequency band.

IMU-based motion sensors embed in uniforms, footwear, game balls, pucks, and sports equipment including rackets, sticks, bats, and paddles to track velocity, acceleration, and angular displacement. IMU placement targets the equipment regions where kinetic activity measurement is most valuable—the blade of a hockey stick, for example, where travel through three-dimensional space and impact with ice and puck is of primary interest to players, coaches, referees, and broadcast personnel. IMU integration preserves equipment shape and weight while enabling kinetic energy and motion metric capture. IMU sensor arrays integrate with UWB micro-tag arrays on the same circuit, enabling the sensor fusion that enhances positioning information with reference data for AI processing algorithms.

LiDAR scanning units mount around the performance field perimeter at varying heights to mitigate line-of-sight disruptions and create real-time 3D point clouds of all tracked subjects and objects, as well as the three-dimensional shape of the performance space—including natural terrain for military exercises or football and soccer fields with crown and slope for water drainage. LiDAR positioning provides ground truth reference data enabling AI algorithms to calculate with greater accuracy than single-modality systems. LiDAR scanning operates continuously throughout performance, supplemented by static scans pinpointing critical field landmarks analogous to surveyor's monuments and benchmarks that provide fixed reference points for topographical calculation. Static scans establish ground truth reference layers alongside pre-performance 3D full-body scans of performers in full gear. These static scans train the AI with ground truth shapes of actual objects and spaces being continuously reconstructed in real-time positioning calculations. Full-body scans capture anatomical reference points facilitated by tags and visual anchors in the engineered uniforms and safety gear—anatomical equivalents of surveyor's monuments providing fixed correspondence between tracking elements and underlying anatomical structures.

### UWB-Based Positioning System:

In the preferred embodiment, Ultra-Wideband positioning forms the primary tracking infrastructure, employing a plurality of UWB anchors at fixed locations around the stadium perimeter and at varying heights to optimize three-dimensional triangulation. UWB positioning achieves accuracy of ±1-2 cm when operating unassisted, operating by emitting short electromagnetic pulses across a broad frequency spectrum (typically 3.1 GHz to 10.6 GHz) with inherent resilience to multipath interference. Unlike GPS, UWB performs exceptionally in enclosed environments, ensuring sub-inch accuracy without requiring line-of-sight visibility. Multiple UWB receivers provide Time Difference of Arrival (TDoA) and Two-Way Ranging (TWR) data, offering error-tolerant tracking when coupled with AI-driven anomaly detection.

Each tracked object—players, referees, balls, field delimiters including corner markers and goal posts—is fitted with a plurality of UWB tags forming an array that captures three-dimensional shape by generating point cloud data transmitted via pulsed signals to anchors and central processors. UWB tags may additionally function as adaptive mobile anchors, mitigating line-of-sight limitations where fixed perimeter anchors require supplementation from mobile anchors moving within the action.

All UWB tags forming a single array—such as a game ball or player's shoe—are serialized with unique identifiers differentiating them from tags belonging to other objects. Each uniform component—jersey, knee pads, shoes, headgear, elbow pads, gloves—comprises a serialized tag group with identifiers differentiating left from right components and differentiating one performer's uniform set from another.

Fixed infrastructure elements may incorporate non-audible acoustic emitters and receivers operating in ultrasonic or near-ultrasonic frequency bands within the Non-Audible Acoustic Spectrum, defining localized acoustic microcells associated with known field geometry. These microcells emit coded, time-structured acoustic signals detectable by receivers in balls, player wearables, referee wearables, or other authorized components within defined short-range proximity. The acoustic microcell layer functions as an independent verification modality distinct from radio-frequency, optical, inertial, and visual tracking layers, using time-of-flight, phase, or correlation techniques to determine boundary-plane adjacency. The system may thereby independently confirm whether tracked objects are located on one side of a boundary plane, within a goal volume, or within tolerance regions adjacent to pylons, goal lines, or corner markers.

Acoustic carrier frequencies are selected greater than approximately 18 kHz or greater than approximately 20 kHz, remaining non-audible while detectable by piezoelectric, MEMS, or ultrasonic transducers. The system may operate within carrier frequency ranges including: a near-ultrasonic band between approximately 18 kHz and approximately 24 kHz; an ultrasonic band between approximately 24 kHz and approximately 60 kHz; and a higher ultrasonic band between approximately 60 kHz and approximately 200 kHz. Narrower sub-bands may be selected based on transducer efficiency, receiver sensitivity, environmental attenuation, and interference conditions, including bands centered around approximately 25-35 kHz, approximately 35-55 kHz, and approximately 75-125 kHz. For avoidance of doubt, true low-frequency airborne infrasonic signaling below approximately 20 Hz is not required for the described embodiments and may be omitted in implementations relying on compact emitters; where low-frequency vibration is used, it may be treated as mechanically coupled vibration sensing rather than airborne audio signaling.

In the preferred embodiment, UWB tag arrays and processing cores comprise flexible, stretchable, thin, impermeable circuits adopting the shape of tracked objects. For American footballs, flexible circuitry takes the shape of the four elliptical sections from which balls are sewn, with processing cores at center and UWB tag nodes radiating to perimeter, fixed at surface when sections are sewn together. For avoidance of doubt, the leather panels of American footballs, as manufactured under NFL and NCAA Equipment Performance Specifications, are joined by stitched seams using waxed thread—not by adhesive bonding or thermal welding—and this stitched construction is a universal industry standard that has remained unchanged since the leather football's development in the late nineteenth century; no professional or collegiate American football has ever employed glued panel seams in competition play, and any assertion to the contrary reflects fundamental misunderstanding of sports equipment manufacturing. The rubber layer incorporates sealed pockets where thin flexible circuits float in lubricating substance permitting conformance as the football changes shape during kicking, bouncing, squeezing, or atmospheric variation. For soccer balls, flexible circuits adopt polygonal section shapes, with each section's tag/processing array providing node-to-point-cloud relationships while optionally serving mobile anchor functions.

The system implements adaptive multi-frequency UWB architectures with real-time band switching based on environmental conditions, dynamically selecting optimal frequency bands to minimize interference in congested RF environments. Lower UWB frequencies (~3.5 GHZ) exhibit superior penetration through obstructions; higher frequencies (~8 GHz) provide finer time resolution for sub-millimeter accuracy. The system leverages a linearly constrained minimum variance (LCMV) interference mitigation algorithm reducing broadband interference impact even when interference spans more than 60% of available signal bandwidth. An AI-driven frequency selection engine continuously evaluates signal quality per-tag and adjusts transmission bands accordingly.

The Adaptive Spectrum Forming Filter dynamically shapes UWB transmission spectrum to avoid venue-specific interference sources while preserving positioning accuracy, engineered for professional sports venues wherein multiple high-power interference sources operate simultaneously: (a) aggregate RF emissions from spectator mobile devices numbering from tens of thousands to over one hundred thousand simultaneous cellular, WiFi, and Bluetooth transmitters; (b) broadcast equipment including wireless camera links, commentator microphones, and production trucks; (c) stadium public address systems; (d) LED advertising displays generating broadband electromagnetic interference; and (e) venue WiFi infrastructure. The filter employs LCMV optimization modified to incorporate sports-venue interference models predicting variation based on game state, crowd activity, and broadcast schedule, maintaining adjudication-grade positioning accuracy (≤ 1/16th inch) continuously rather than tolerating degradation during adaptation transients.

Neural network-based waveform synthesis generates interference-avoiding UWB pulses through learned mappings from detected interference spectra to optimal pulse shapes. A radial basis function neural network receives discretized interference spectrum representations and outputs transmission pulse waveform coefficients in basis function expansions such as Hermite-Gaussian or prolate spheroidal wave function expansions that inherently satisfy spectral mask constraints. Predictive interference anticipation forecasts near-future conditions based on game state and scheduled events-anticipating increased spectator device activity during commercial breaks, timeout periods, or halftime intervals-pre-computing adapted pulse shapes before interference transitions occur.

### UWB Technical Specifications and Performance:

The UWB micro-tags operate within the unlicensed ultra-wideband spectrum as defined by international regulatory frameworks, including the 3.1-10.6 GHz range authorized under FCC regulations in the United States. Within this spectrum, the system employs discrete channels—each several hundred megahertz wide—to achieve high temporal resolution. A core tradeoff exists between range and resolution: lower-frequency channels (3-4 GHz) provide superior propagation characteristics and improved penetration through human bodies or stadium infrastructure with slightly larger antenna requirements, while higher-frequency channels (6-8 GHz) enable finer time-domain precision due to reduced pulse duration. Most implementations leverage center frequencies in the 3-7 GHz band to balance these variables.

The UWB system's high-precision ranging capability—supporting the Adjudication-Grade Continuous Measurement defined in the Inventor's Lexicography—is enabled by substantial bandwidth—typically 500 MHz or greater—supporting nanosecond-scale pulse durations and time-of-flight measurements with timing accuracy in the tens of picoseconds. Tags may dynamically hop between channels to mitigate localized interference. Unlike Wi-Fi or Bluetooth Low Energy, UWB's expansive bandwidth inherently resists multipath interference; even when certain spectral components experience fading, others maintain transmission integrity. The direct signal path is reliably distinguished from secondary reflections based on differential timing structure of received pulse trains, preserving positional fidelity in complex stadium environments.

The UWB micro-tags conform to the IEEE 802.15.4-2011 (UWB) physical layer specification, supporting pulse repetition frequencies of 16 MHz and 64 MHz with selectable data rates ranging from 110 kilobits per second (kb/s) to 6.8 megabits per second (Mb/s). Tag performance is materially influenced by antenna design in body-mounted configurations. As disclosed in a patent assigned to Isolynx LLC, custom UWB antennas folded to direct radiation away from the player's body minimize signal absorption and improve omnidirectional coverage through near-dipole radiation patterns oriented outward. To address orientation sensitivity, tags may incorporate multiple antenna elements; the Adidas Connected Ball employs a suspended internal UWB module maintaining optimal antenna orientation during flight and impact.

Update rates of 10-20 Hz are common, with higher rates feasible for fewer tags. With TDoA, tags emit short blink packets while anchors report timestamps via backbone infrastructure, enabling high update rates even with multiplicity of shape-capturing tag arrays. UWB radio frames require 100-200 microseconds, with best systems achieving <100 ms latency for live feedback. Anchors positioned at varying heights enhance Z-axis resolution and vertical triangulation accuracy.

The highest positioning accuracies in prior art sports-related UWB tests range from 2-10 cm error under unassisted conditions. The principal error source is fixed positional bias of approximately 4.3 cm, correctable through calibration. Academic studies documented approximately 20 centimeters accuracy in eight-anchor deployments, with chest-mounted tags experiencing up to 50% packet loss due to human tissue signal attenuation. These prior art accuracy levels—suitable for navigation—are categorically insufficient for adjudication-grade boundary determinations requiring positioning resolution of one-sixteenth inch (approximately 1.6 millimeters).

The present invention surpasses prior art UWB accuracy thresholds by more than two orders of magnitude through combined application of: (a) multi-modal sensor fusion wherein UWB ranging data is cross-validated against inertial measurement, acoustic near-field, and touch sensing modalities; (b) Generalized Gaussian Distribution statistical modeling for NLOS detection that accommodates the heavier-tailed signal variability characteristic of professional sports environments; (c) AI-driven position refinement through ensemble machine learning classifiers trained on ground truth datasets; (d) hierarchical tracking architecture distributing positioning elements according to adjudication-weighted density gradients that concentrate resolution at anatomical surfaces where boundary determinations occur; and (e) antenna design optimization including body-optimized radiation patterns that mitigate the human tissue attenuation documented in prior art studies. The prior art's acceptance of centimeter-level accuracy reflects navigation convenience requirements rather than adjudication-grade precision.

The data fusion architecture incorporates particle filter and Kalman filter comparison—Kalman providing constant velocity motion model at tag blink rate, particle filter incorporating non-Gaussian noise and irregular update intervals. Extended Kalman filters (EKF) sensor-fuse UWB with accelerometer data modeling athlete motion dynamics. AI/ML regression models process raw UWB positions against ground truth data to estimate error functions, correcting systematic biases when applied to new data.

The present system extends prior approaches in several material respects: (a) the training architecture incorporates physics-constrained motion models specific to each sport's biomechanical boundaries rather than generic regression; (b) the multi-modal sensor fusion pipeline provides cross-validation inputs unavailable in single-modality UWB systems; (c) the Generalized Gaussian Distribution (GGD) error modeling accommodates heavier-tailed signal variability observed in professional stadium environments with metallic structures and dynamic crowd loading; and (d) the continuous learning capability enables real-time model refinement as venue-specific propagation characteristics are observed during actual gameplay rather than requiring pre-match calibration sessions.

Achieving sub-millimeter accuracy requires robust data fusion architecture; the system leverages quantum-based AI processing of fused raw range data in models handling outliers while incorporating motion knowledge with ground truth references.

### Hybrid Localization System & Multi-Modal Sensor Fusion Architecture:

The present invention employs a multi-modal sensor fusion framework integrating Ultra-Wideband (UWB) with complementary positioning technologies—inertial measurement units (IMUs), radio frequency (RF) mapping, and non-audible acoustic signaling within the Non-Audible Acoustic Spectrum—to mitigate limitations inherent in any single modality. Heterogeneous data sources are processed through algorithmic frameworks including Kalman filtering, extended Kalman filters (EKF), particle filters, and machine learning-based correction models, compensating for environmental variability and modality-specific deficiencies to deliver millimeter-level localization fidelity.

The system's adaptive, self-optimizing architecture constitutes a core differentiator: artificial intelligence algorithms continuously evaluate historical positioning errors and refine model parameters over time, enhancing precision in GPS-denied or signal-obstructed environments common to professional sports venues. The fusion engine dynamically assesses reliability of available data sources and selects optimal positioning input in real time, enabling consistent accuracy in environments characterized by motion complexity, signal distortion, or partial sensor coverage.

In further embodiments, the system implements a dynamic role allocation architecture wherein UWB-equipped devices transition between active and passive operational states based on real-time geometric and signal-quality assessments. Active-state devices perform Time-of-Flight (TOF) ranging to establish primary spatial reference geometry; passive-state devices perform Time-Difference-of-Arrival (TDoA) calculations relative to active-state device pairs, reducing channel congestion and power consumption while maintaining positional awareness.

Active versus passive state assignment is governed by each device's position relative to a convex envelope defined by currently active devices. A device at position P is inside the convex envelope of active devices {A₁, A₂, . . . , Aₙ} if and only if P can be expressed as a convex combination P=Σᵢ λᵢAᵢ where λᵢ≥0 for all i and Σᵢ λᵢ=1; devices satisfying this condition operate in passive mode, while devices outside or on the envelope boundary may be promoted to active mode to maintain geometric coverage. Role transitions are further constrained by a composite eligibility score S=w₁(f/f_min)+w₂(ε_max/ε)+w₃(B/B_max)+w₄(Q) exceeding threshold T_active, where f_min represents localization frequency requirements, ε_max represents accuracy thresholds, B represents battery state, Q represents signal quality history, and w₁, w₂, w₃, w₄ are weighting coefficients tuned to the deployment environment.

The convex envelope membership test and composite eligibility score represent preferred embodiments; however, the methodology is not limited to these specific formulations. Equivalent geometric containment tests fall within scope, including: (a) linear programming feasibility formulations; (b) halfspace intersection representations (H-representation); (c) support function methods comparing candidate position projection against maximum active device projections; (d) Delaunay triangulation or convex hull vertex enumeration; (e) approximate containment tests employing bounding boxes, bounding spheres, or simplified polytopes; or (f) machine learning classifiers trained on relative position features. Alternative eligibility combination methods—including multiplicative scoring, threshold-based decision trees, fuzzy logic membership functions, weighted voting schemes, or neural network decision functions—fall within scope. The inventive concept resides in adaptive assignment of active versus passive states based on geometric distribution and device-specific eligibility within professional sports adjudication context, rather than in any specific algorithm or formula.

This dynamic role allocation architecture is explicitly distinguished from robot swarm self-localization systems in that: (a) role transitions must accommodate non-programmatic, reactive movement patterns of human athletes rather than coordinated robotic motion planning; (b) the system must maintain adjudication-grade positional accuracy during and immediately following role transitions, whereas robot fleet systems typically tolerate transient accuracy degradation; (c) participant entry, exit, and substitution must trigger automatic role rebalancing without manual reconfiguration; and (d) the heterogeneous device mix—player-worn tags, refereecarried units, game ball-embedded sensors, equipment-mounted arrays—requires role allocation logic accounting for device-specific capabilities, Physical Compliance constraints, and officiating priority rather than assuming homogeneous node functionality.

In further embodiments, the system operates in Infrastructure-Independent Localization Mode wherein positional tracking proceeds without permanently installed fixed anchor infrastructure. The system dynamically designates mobile elements as spatial reference sources based on positional stability, signal quality, and geometric distribution. Officiating crew members, whose movement patterns exhibit lower velocity and higher positional stability than competing athletes, may be algorithmically assigned anchor functions, providing mobile triangulation geometry that moves with play flow and maintains proximity to adjudication-critical events. Portable boundary markers, temporarily deployed anchor units, or vehicle-mounted reference stations may establish spatial frameworks for temporary venue deployments where permanent infrastructure is impractical. Transition between infrastructure-dependent and infrastructure-independent modes occurs seamlessly under AI control, with the sensor fusion engine continuously evaluating whether fixed anchors, mobile anchors, or hybrid combination provides optimal positioning confidence.

### UWB & 5G for Positioning:

The system may optionally incorporate 5G-based infrastructure. 5G positioning employs massive multiple-input multiple-output (MIMO) antenna arrays for precise angle-of-arrival (AoA) estimation, while UWB excels in time-of-flight (ToF) ranging for ultra-precise short-range applications. UWB's pulse-based transmission achieves millimeter-level accuracy; 5G networks enhance localization through advanced beamforming and multi-access edge computing (MEC). Integrated within one system, these technologies provide real-time tracking with ultra-low latency suitable for adjudication-grade spatial capture.

### Nanomechanical FM Transmitters and 3D Woven Antennas:

Nanomechanical FM transmitters utilize nanoscale oscillators to generate FM signals, offering ultra-low power wireless communication at microscopic scales. 3D woven antennas integrate conductive fibers into textile structures, enabling seamless wireless communication integration into wearables and electronically-enabled textiles. These technologies supplement the primary tracking architecture: UWB tags establish major reference points at anatomical landmarks—head, shoulders, elbows, knees, hands—while nanomechanical and 3D woven FM antenna transmitters fill the mesh of the point cloud to capture surface contours of players, game balls, and performance surfaces including artificial turf.

The ultra-lightweight, energy-efficient characteristics of these technologies address a fundamental Physical Compliance constraint: player uniforms, game balls, and sports equipment cannot operate while connected to external power sources and must remain powered throughout prolonged performances without recharging or signal loss at critical junctures. 3D woven antennas further enable high-performance connectivity in extreme environments, including large arenas with significant signal interference or weather conditions involving water and mud exposure.

Integration of UWB with 5G,

### Nanomechanical Transmission, and Redundant Optical Systems:

As an additional redundancy layer, the system may incorporate LiDAR-based spatial mapping using laser pulses deployed from fixed perimeter mounts or aerial drones to generate millimeter-accurate point clouds. When integrated with UWB and inertial measurement unit (IMU) data, artificial intelligence filters resolve occlusions, discard false positives, and refine motion models in real time.

Visible Light Positioning (VLP) may optionally provide an RF-independent optical positioning layer. VLP systems utilize modulated LED beacons embedded in field infrastructure, paired with high-speed optical sensors, to triangulate position via light intensity variations. VLP is inherently immune to electromagnetic interference, making it suitable for environments saturated with wireless transmissions or metallic infrastructure where RF-based systems may be impaired.

### Adaptive UWB Power Management:

Energy efficiency is critical for wearable UWB tags in professional sports where players wear tags for extended periods. Standard UWB tags consume 100-300 mW per blink cycle; at 50 Hz operating frequency, battery life becomes constrained. Ultra-low-power UWB architectures reduce power consumption by up to 80% through duty cycling—reducing transmission frequency when movement is minimal—and AI-assisted power scaling wherein tags transmit at full power only when high accuracy is required.

Power may be supplied via kinetic energy capture and storage devices, already miniaturized sufficiently for wristwatch-scale applications. Each wearable tag may run edge AI algorithms directly, interpreting motion patterns locally rather than transmitting raw data for server-side processing, reducing transmission power requirements while enhancing accuracy.

In further embodiments, the system implements Cognitive Spectrum Adaptation (SEE: Inventor's Lexicography)—real-time sensing, analysis, and dynamic modification of radio-frequency transmission characteristics in response to detected interference within the Ultra-Wideband operating band. Cognitive Spectrum Adaptation is distinguished from general-purpose cognitive radio approaches in that adjudication-grade positioning accuracy is the inviolable constraint: spectral adaptation must achieve interference mitigation without positioning discontinuities compromising evidentiary validity, inverting the consumer cognitive radio priority hierarchy wherein positioning accuracy is sacrificed for interference avoidance. The adaptive power architecture leverages the dynamic role allocation wherein officiating crew members serve as mobile anchors. Because officiating crew equipment is not subject to the same Physical Compliance constraints as player equipment—officials need not perform acrobatics and can tolerate slightly heavier, bulkier gear—officiating crew UWB nodes may incorporate signal boosters and local point-cloud processing capability, collecting, processing, and transmitting positioning data with enhanced reliability before reaching central processing hardware. This distributed processing architecture reduces power demands on player-worn arrays: the more robust and distributed the positioning data from multiple nodes, the less any single player-worn array must transmit, conserving energy reserves.

UWB antenna miniaturization proceeds through metamaterials and frequency-selective surfaces (FSS), achieving stable gain across bandwidths of 3.4 to 9.8 GHz in reduced form factors. Continued semiconductor technology scaling enables integration of additional functionalities into smaller IC footprints, supporting efficient operation of wearable UWB devices without compromising performance.

### Touch and Proximity Sensing Technologies for Durability and Exposure:

TENG sensors' thin, lightweight form factor enables conformal integration onto curved surfaces while remaining mechanically unobtrusive, preserving the performance characteristics—including trajectory, Rotational Balance, and aerodynamic profile—of professional-grade sporting equipment. Touch and proximity sensing for sports Equipment/Gear and Spatial Delimiters (SEE: Inventor's Lexicography)—game balls, goal posts, netting, field delimiters, turf, footwear, and gloves—must sense through intervening materials such as leather, cloth, and polymers while withstanding extreme weather and physical abuse. The sensing technologies described in this section implement Contact-Based Sensing (SEE: Inventor's Lexicography)—measurement methodologies determining object state through direct physical interaction—which complements but is fundamentally distinct from the 3D Spatial Positioning system disclosed herein. The system employs multiple sensing technologies selected per application: touch sensing requirements for a high-velocity American football differ materially from those for tennis court boundary markers.

TENG-based tactile sensors—an implementation within the Thin film/Flexible/Wearable Electronics category defined in the Inventor's Lexicography—provide the primary solution for applications requiring thin, flexible, stretchable sensing that functions through layers of leather, plastic, or synthetic skin. TENG sensors generate electric charge upon contact and separation of dissimilar materials, enabling high-resolution force and proximity detection through non-conductive coverings without requiring air or light exposure. Self-healing polymer substrates enable TENG arrays to withstand prolonged mechanical stress, environmental exposure, and deformation while maintaining signal integrity. Self-powering capability eliminates dependency on external power sources—critical for rotationally balanced game balls and wearables where battery mass would compromise Physical Compliance.

Graphene-based capacitive sensors complement TENG technology, employing printed, stretchable graphene circuits on elastomeric substrates to create ultra-thin sensing layers detecting pressure, force, and proximity through non-conductive materials. Unlike conventional capacitive sensors susceptible to moisture and electromagnetic interference, graphene sensors exhibit strong oxidation resistance and environmental durability for outdoor, high-stress deployment.

Beyond direct contact detection, TENG sensors detect proximity and pressure gradients, enabling determination of partial touches, brush contacts, and close-range interactions without full compression—capabilities essential for adjudication where millimeter distinctions determine rule enforcement. Together, TENG and graphene-based sensing technologies enable real-time detection of three interaction categories: player-to-object, object-to-surface, and object-to-object contacts. Each surface contact event is captured, classified, and transmitted for adjudication, analytics, or immersive replication, forming the foundational contact-sensing layer for autonomous game-state determination in high-speed, high-contact, and visually obstructed performance settings.

Beyond pressure and contact detection, TENG sensors can be configured to detect temperature, vibration, and other mechanical stimuli, enabling multi-modal sensing from a single sensor element while maintaining self-powered operation and environmental resilience.

### Graphene-Based Capacitive Tactile Sensor:

Graphene's single-atom-thick structure—often just a few nanometers in total thickness when layered—enables seamless integration into stretchable skins and surface coatings. Graphene-based capacitive sensors provide real-time deformation sensing with minimal interference from external environmental factors, making them suitable for large volumetric spaces such as football fields and tennis courts. In one embodiment, court boundary lines incorporate graphene-based capacitive tactile sensing paint for continuous contact detection across the demarcation surface.

### Acoustic Near-Field Confirmation Layer

In further embodiments, the system employs non-audible acoustic signaling—operating within the Non-Audible Acoustic Spectrum defined in the Inventor's Lexicography—as a near-field confirmation layer for possession, contact, and interaction events. This acoustic layer operates at short spatial ranges within the Non-Audible Acoustic Spectrum and corroborates events where multiple players are in close proximity to the ball—situations where visual occlusion, RF interference, or rapid multi-contact sequences reduce confidence in any single sensing modality.

Ball and player-associated wearables may include acoustic transceivers configured to detect authenticated ultrasonic or near-ultrasonic signals emitted by nearby authorized components. When a touch, pressure, or proximity sensor registers an interaction event, contemporaneous detection of a corresponding acoustic signal confirms that interacting components were within defined spatial tolerance at the event timestamp. The system thereby distinguishes true possession or contact events from incidental interactions such as near-misses, deflections without control, or overlapping reach by multiple players. Acoustic confirmation data fuses with inertial measurements, radio-frequency ranging, and touch-sensor output to determine which specific serialized wearable or body region was responsible for the interaction, including left-versus-right differentiation.

The acoustic near-field layer assists in resolving contested or rapid—sequence events-fumbles, catches, handoffs, blocks, goal-mouth scrambles—by providing an independent temporal and spatial correlation channel resilient to visual obstruction and insensitive to lighting conditions. Acoustic confirmation may be selectively activated or sampled at higher resolution in response to detected interaction events or elevated adjudication uncertainty.

Data derived from the acoustic near-field layer further supports fraud-detection and integrity logic to identify anomalous interaction patterns, sensor desynchronization, or attempted spoofing, particularly where acoustic proximity data conflicts with radio-frequency or optical observations. For avoidance of doubt, the acoustic layer operates cooperatively among authorized system components and does not perform general audio capture or monitoring of human speech.

Venue Spatial Assembly Physical Compliance. The physical compliance requirements governing venue spatial assembly components are distinct from those governing performer spatial assemblies and are independently binding (see FIG. 5). Venue infrastructure elements must satisfy structural, dimensional, optical, and environmental durability specifications imposed by governing body regulations, facility management standards, and the operational conditions of professional sports venues, including outdoor exposure, heavy foot traffic, maintenance equipment contact, and multi-season operational lifetimes.

Field Boundary Marking Substrates. Field marking lines regulated under FIFA/IFAB and equivalent governing body specifications are two-dimensional areas of governed regulatory width—not one-dimensional geometric lines—with a maximum width of 12 centimeters under FIFA/IFAB Law 1. The adjudicative boundary is the lateral edge where field territory terminates, described without orientation-dependent qualification. EDID-bearing sensing substrates are integrated into field marking areas through graphene-based capacitive sensing paint applied as a constituent layer of the marking surface, preserving the optical properties—whiteness, contrast ratio, and retroreflective coefficient—required by governing body specifications for broadcast and officiating visibility. The sensing substrate layer is applied beneath the optical surface layer so that the field marking's visible appearance is unaffected by the integration. Electrical routing from sensing substrate to edge processing nodes follows the marking line boundary geometry, embedded in the turf backing at a depth that survives mowing, aeration, and irrigation cycles without signal degradation. At a ball-to-line contact geometry relevant to adjudication—FIFA Size 5 ball diameter approximately 22 centimeters against a maximum 12-centimeter marking width, a ratio of approximately 1.8 to 1—the distributed sensing substrate spanning the full regulatory width of the marking area captures the onset, lateral position, dwell duration, and pressure distribution of ball contact events with spatial resolution exceeding the ball-to-line ratio, producing a contact characterization sufficient for goal-line and out-of-bounds adjudication at sub-centimeter precision.

Goal Post and Crossbar Integration. Modern goal post structures are fabricated from hollow tubular steel or aluminum profiles with internal bore diameters that accommodate routed thin-film circuits without dimensional modification to the external profile. EDID-bearing UWB tag arrays are integrated along the internal bore of goal post uprights and crossbars, with antenna elements oriented radially outward through the post wall at spacing intervals determined by the required spatial resolution of the cooperative mesh geometry at goal-line proximity. TENG contact sensing substrates are applied to the post exterior surface beneath a protective clear-coat layer that satisfies governing body surface finish and impact safety requirements. The instrumented goal post assembly satisfies all structural load, deflection, and impact absorption specifications of the applicable governing body—including FIFA Goal Post Safety standards and equivalent national federation specifications—with no reduction in structural performance attributable to the integration of sensing elements. Goal post and crossbar EDID-bearing components are registered as venue spatial assembly elements during pre-performance topographical registration, with their precise three-dimensional coordinate positions recorded in the Forensic Replay Ledger genesis block.

Goal Netting Integration. Goal netting constitutes a three-dimensional venue spatial assembly element whose contact-sensing coverage spans the full interior volume of the goal structure. EDID-bearing contact sensing substrates are integrated into the net cord material at distributed nodes across the net's front face, side panels, and top panel. The front face constitutes the adjudication-relevant contact surface for goal determination; rear and side panel contact sensing provides ball trajectory reconstruction within the goal volume following confirmed entry. Durational characterization of ball-net contact—onset, dwell time, deformation extent, and release—provides entry confirmation that is architecturally independent of goal-line camera systems and operative under all lighting, weather, and obstruction conditions. Net cord sensing substrates are encapsulated in materials compatible with the environmental exposure profile of outdoor goal netting, including UV resistance, hydrolysis resistance, and mechanical compliance with high-velocity ball impact dynamics at professional match speeds.

Pre-Performance Topographical Registration of Venue Spatial Assembly Elements. The topographical registration procedure for venue spatial assembly elements establishes the precise three-dimensional coordinate frame of all instrumented venue infrastructure prior to each performance session. For each venue spatial assembly element, registration records its EDID identifier, its three-dimensional position and orientation within the venue coordinate frame, and its physical compliance certification status for the current deployment. The registration output for venue infrastructure is stored as session-bound topographical registration data in the Forensic Replay Ledger genesis block, parallel to the performer-side registration data recorded for each performer spatial assembly. This venue-side registration data constitutes the geometric ground truth against which all in-performance venue spatial assembly emissions are validated during SIV processing.

### Embedding of the Arrays on Equipment Examples

### Contour-Line Tracking Architecture: Design-Integrated Body Modeling

The contour-line tracking architecture implemented via the Enveloping Substrate Methodology and the Continuously Deformable Volumetric Identity Model disclosed herein achieves volumetric body modeling through strategic placement of tracking elements along critical body lines (see FIG. 10). These critical body lines correspond to the natural design features already present on athletic uniforms: collar edges defining neck circumference, sleeve boundaries defining arm cross-section, side stripes tracing torso lateral contours, and number/letter outlines spanning chest and back surfaces. Contemporary athletic uniforms incorporate design elements including: collar edge piping and trim; sleeve cuff boundaries; decorative side stripes extending from underarm to waist or ankle; team logo outlines and internal detail lines; player number outlines formed by contrast stitching, screen printing, or heat-fused polymer; player name lettering; and manufacturer logo placements. Each element follows a defined geometric path that, when tracked, provides the contour-line data necessary for volumetric body reconstruction. Thus, the design-line integrated embodiment, tracking hardware—including UWB micro-tag arrays, antenna conductors, TENG sensing layers, and interconnection routing—is manufactured to follow the geometric paths of existing uniform design elements such that tracking infrastructure and decorative design.

Visual Concealment Architecture: Invisible Positioning Infrastructure: The cooperative spatial mesh disclosed herein, by contrast, can achieve complete invisibility: the positioning infrastructure is indistinguishable from conventional uniforms, equipment, and officiating gear through visual inspection. This invisibility transforms the positioning system from observable infrastructure into an ambient capability that neither participants nor opponents can detect, avoid, or target. Concealment can occur via color-matched material selection. Concealment can be accomplished via pattern integration: Tracking elements are shaped, sized, and distributed to align with existing visual patterns. Seam-aligned elements follow visible stitching paths, rendering conductors indistinguishable from decorative or structural seams. Panel-interior elements in concentric or spiral configurations align with fabric weave patterns or texture gradients. Logo-integrated elements conform to team logo, manufacturer mark, or league insignia geometries, with conductor routing following graphic boundaries rather than introducing detectable novel features. Concealment can also be achieved via perceptual exploitation: Tracking elements positioned where technically visible but practically unnoticed. High-curvature regions—underarm panels, posterior knee surfaces, collar interiors—tolerate reduced concealment rigor due to infrequent direct inspection. Visual complexity zones—multi-color graphics, textured fabric, fold and shadow areas—provide masking rendering subtle tracking features imperceptible. Concealment extends to connector interfaces, charging contacts, and maintenance access points. Connectors are positioned in concealed locations—interior waistband, interior collar, equipment cavity interiors—accessible for maintenance but not visible during use. Charging contacts employ flush-mount or recessed designs color-matched to adjacent materials. Maintenance access points utilize concealed closure mechanisms—magnetic clasps beneath fabric overlays, snap fittings disguised as decorative buttons—permitting authorized access while presenting no visible indication of functional purpose.

Each manufacturing embodiment produces tracking-enabled elements visually indistinguishable from non-instrumented counterparts, ensuring compliance with league appearance standards without visual cues indicating which positions are instrumented. The design-line integrated architecture contemplates four manufacturing methods corresponding to distinct decoration techniques in professional athletic uniform production:
Heat-transfer application: The tracking hardware can be applied through heat-fusion or vulcanization processes similar to conventional heat-transfer number and letter application. The mechanically compliant heat-transfer circuit substrate would be manufactured with protective polymer overcoat—thermoplastic polyurethane, silicone elastomer, or cross-linked polyethylene—serving dual functions as abrasion protection and visible decorative surface bearing team colors, numbers, or graphics. This manufacturing approach enables installation using existing uniform production equipment, eliminates visible distinction between instrumented and non-instrumented uniforms, and provides environmental protection against moisture, abrasion, and repeated laundering. Tracking circuitry—implementing the Thin film/Flexible/Wearable Electronics defined in the Inventor's Lexicography—pre-fabricated as thin-film laminate comprising base carrier film, conductive circuit layer with UWB antenna traces and routing, and protective polymer overcoat bearing decorative graphics. Processing at temperatures between 150° C. and 200° C., pressures between 40 PSI and 80 PSI, for durations between 10 seconds and 30 seconds achieves permanent adhesion while remaining below thermal degradation threshold of conductive materials.

Sublimation printing with conductive inks: Decorative graphics and conductive circuit traces deposited simultaneously through modified sublimation wherein conventional dyes are supplemented with sublimation-compatible conductive ink formulations containing silver nanoparticle suspensions, carbon nanotube dispersions, or conductive polymer solutions. The process transfers both graphics and circuit pattern into fabric substrate at molecular level, producing unified structure with circuit traces visually indistinguishable from decorative elements. Particularly suited for polyester-based athletic fabrics.

Screen printing with conductive inks: Decorative graphics applied through conventional screen printing while select portions—outline elements, striping, logo boundaries corresponding to circuit routing paths—are printed with conductive ink formulations. Sequential passes deposit conductive base layers followed by decorative overcoats concealing traces while permitting electrical continuity through designated via points.

Tackle-twill appliqué with embedded conductors: Tracking circuitry integrated within layered fabric structure of tackle-twill numbers, letters, and logos. Thin-film flexible circuits positioned between tackle-twill layers prior to assembly, with antenna elements and tracking components distributed within appliqué outline. Multi-layer structure provides environmental protection while dimensional thickness accommodates components impractical for single-layer constructions. Particularly suited for player number and name applications where tackle-twill dimensional characteristics are expected.

### Broadcast and Media Integration Architecture:

The present invention incorporates a broadcast and media integration architecture—producing the Spatially Enriched Broadcast Signal (SEBS) and Interactive Performance Data Stream (IPDS) defined in the Inventor's Lexicography—enabling Volumetric Performance Reconstruction (VPR) (SEE: Inventor's Lexicography), through which captured three-dimensional geometric envelope data is exported to broadcast production systems and interactive media platforms. 21^{st} Century audience expectations increasingly demand immersive experiences that merge live sports viewing with interactive gaming functionality—real-time virtual camera control, player-perspective viewpoints, and integration with sports simulation platforms requiring true three-dimensional spatial data rather than statistical abstractions. Prior generations of sports-gaming integration relied upon feeding game engines with player statistics, performance metrics, and two-dimensional positional data—an approach representing 1980s-era technological capability now rendered obsolete by audience demand for geometric fidelity that statistics cannot provide. This transition from statistically parameterized simulation to Geometric Performance Capture (GPC) (SEE: Inventor's Lexicography) constitutes a categorical shift in the nature of the content produced, not merely an improvement in content quality. Audiences expect to view the preserved and actual acrobatic plays/performances from arbitrary perspectives, rotate viewpoints in real time, and experience sports content through gaming interfaces that require actual three-dimensional body geometry rather than statistical proxies for athletic performance.

External Observation systems—including multi-camera photogrammetry—cannot satisfy these requirements regardless of camera proliferation. The information loss inherent in projecting three-dimensional reality onto two-dimensional imaging planes cannot be recovered through computational reconstruction, regardless of algorithm sophistication, at the most critical points of the performance. Object-Originated Spatial Awareness produces three-dimensional geometric envelope data that exists prior to and independent of any visualization; exporting geometric envelope data at native sampling rates between 100 Hz and 1000 Hz through standardized interfaces compatible with broadcast graphics platforms and game engine integration, supporting real-time augmented reality overlays, virtual camera control, and sports-gaming convergence applications that External Observation photogrammetry cannot enable.

The resulting Spatially Enriched Broadcast Signal and Interactive Performance Data Stream are not limited to entertainment or athletic broadcasting applications. In military and law enforcement contexts, the same signal architecture exports geometric envelope reconstructions of force-on-force engagements, room-clearing exercises, and tactical movement sequences to after-action review platforms, enabling the reconstruction of engagement scenarios from arbitrary spatial perspectives, in real-time—including viewpoints within structures, behind barriers, and inside vehicle interiors where no observation post or body-worn camera maintained line-of-sight during the exercise. The evidentiary and analytical value of the signal is identical in function across performance domains; what changes between a football broadcast and a tactical after-action review is the consumption interface, not the spatial data architecture that produces it.

### Reference Deployment Scenario: American Football Game

The following illustrative, non-limiting operational sequence demonstrates the temporal orchestration of the disclosed system architecture during a single American football game deployment. This scenario references components, protocols, and architectures disclosed throughout this specification and does not introduce additional limitations. The invention is not limited to this deployment sequence, sport, or venue configuration.
Phase 1—Venue Spatial Assembly Initialization (Pre-Game, T-4 Hours): Fixed UWB anchors distributed across the venue superstructure, field perimeter, goal posts, and sideline infrastructure establish mutual ranging and synchronize to a common time base. LiDAR units perform static reference scans establishing the three-dimensional topographical profile of the playing surface, including crown geometry and sideline boundary elevations. The Cross-Venue Adaptation Protocol ingests venue-specific NLOS signature data—structural steel, crowd density projections, broadcast equipment positions—calibrating the Generalized Gaussian Distribution models for that venue's signal propagation characteristics. The Forensic Replay Ledger initializes a genesis block anchoring all subsequent spatial records to the calibrated venue coordinate frame.
Phase 2—Performer Spatial Assembly Registration (Pre-Game, T-90 Minutes): Each participant proceeds through the Equipment Ensemble Identification and Registration Protocol. The system sequentially interrogates every instrumented article—helmet, shoulder pads, jersey, pants, gloves, cleats, and knee pads—binding each Equipment Decentralized Identifier into a unified Performer Spatial Assembly. Pre-performance 3D body scans in full gear establish the ground truth topographical registration baseline, mapping the correspondence between tracking element positions and the anatomical surface geometry they instrument. Referee wearable configurations register as spatially privileged mobile anchors within the Cooperative Spatial Mesh.
Phase 3-Live Tracking Activation (Kickoff, T+0): Upon game clock initiation, all Performer Spatial Assemblies and the game ball transition from registration mode to continuous spatial emission. The Hierarchical Tracking Modality Architecture activates across all four tiers simultaneously: Tier 1 Boundary-Defining Elements establish the wireframe envelope of each tracked entity; Tier 2 Surface-Gradient Elements resolve curvature between boundary vertices; Tier 3 Mesh-Fill Elements provide interior density where adjudicative relevance warrants; and Tier 4 Contact-Based Sensing Elements monitor surface interaction events independently of the three-dimensional positioning modalities. The Dynamic Adjudicative Relevance Hierarchy Inversion continuously reallocates ranging priority and verification redundancy toward the spatial region of active play.
Phase 4—Occlusion and Contact Event Handling (During Play): When a ball carrier enters a tackle, the fixed-anchor line-of-sight to multiple Performer Spatial Assemblies degrades simultaneously. The system responds through the operational sequence the specification has disclosed: tag-to-tag relative localization activates within the congested region; the AI-driven sensor fusion engine increases weighting of inertial, acoustic, and contact-sensing modalities; the Spatiotemporal Integrity Validation protocol screens position claims against kinematic plausibility; and the Officiating Proof-of-Position Protocol generates cryptographically attested spatial records for every tracked entity throughout the occlusion event. At no point does the system require, request, or await restoration of external line-of-sight to maintain continuous tracking.
Phase 5—Adjudication Event Resolution (Scoring Play, Boundary Determination): When tracking data indicates a potential scoring event—the nose of the football approaching the goal line plane while a player's knee approaches the ground surface—the system produces a temporally synchronized geometric reconstruction of all relevant surface boundaries at sub-millisecond resolution. The adjudication output is not a camera image requiring human visual interpretation; it is a mathematically defined spatial relationship between instrumented surfaces, attested by cryptographic proof-of-position records, validated against physics-constrained plausibility, and archived in the Forensic Replay Ledger as an evidentiary record.
Phase 6—Broadcast Integration (Continuous): Throughout all phases, the Method of Producing Spatially Enriched Broadcast and Interactive Content operates in parallel, receiving time-stamped spatial data records from every active Performer Spatial Assembly and game ball, assembling geometric envelope reconstructions, and generating the Spatially Enriched Broadcast Signal. Receiving systems render virtual camera perspectives, augmented reality overlays, and volumetric reconstructions from viewpoints no physical camera occupies—including perspectives from within the occlusion events that defeated optical observation entirely.

The foregoing deployment scenario is illustrative of one sport-specific instantiation. The architectural principles—object-originated spatial emission, cooperative spatial meshing, hierarchical tracking allocation, multi-modal sensor fusion through occlusion, cryptographic spatial attestation, and spatially enriched content production—apply with equal force to any domain of Acrobatic Performance as defined in the Inventor's Lexicography, adapted to the spatial geometry, equipment substrate, and adjudication rule set of the specific performance domain.

What the foregoing deployment scenario further demonstrates is the organizational topology through which these principles are realized: an interlocking set of nested containment relationships in which every participating object simultaneously occupies a position within multiple hierarchies and derives its spatial meaning from those positional relationships rather than from its individual measurement capability alone. A single UWB micro-tag affixed to the anterior surface of a player's knee exists simultaneously within an intra-garment hierarchy (where it is one node among a density-gradient array distributed across the knee panel), within a garment-layer hierarchy (where its outer-uniform positional data is weighted against body-conformal inner reference data to isolate fabric deformation from anatomical movement), within an equipment-component hierarchy (where its panel-aggregated data feeds into the knee-region hub contributing to the full-body Performer Spatial Assembly), within a performer-to-venue hierarchy (where the Performer Spatial Assembly cooperates with the Venue Spatial Assembly's fixed anchors and embedded boundary sensors through the cooperative spatial mesh), and within an adjudicative relevance hierarchy (where its reporting priority is elevated or reduced depending on whether the knee is approaching a boundary line, a ground-contact event, or is distant from the current focus of play) (see FIG. 19). No individual hierarchy in this topology is sufficient to produce an adjudication-grade spatial determination; the determination emerges from the convergence of all hierarchies simultaneously resolving the same physical event from different organizational vantage points. This organizational topology is the structural expression of the Measurement Causality Paradigm Inversion: because the tracked objects generate their own spatial data, the system's intelligence resides in how that data is organized across nested containment relationships rather than in how accurately any external sensor observes the scene.

The topology further explains why node classes within the system carry differentiated hardware configurations rather than uniform equipment. Performer-worn arrays concentrate sensing density at the anatomical surface while minimizing transmission burden because the performer's Physical Compliance envelope constrains weight, bulk, and power consumption; officiating crew arrays invert this allocation, concentrating transmission, signal repetition, and local processing capacity because the officiating role tolerates heavier hardware while benefiting from sustained proximity to adjudication-critical events; venue-fixed infrastructure carries the static geometric reference framework and the highest-bandwidth data aggregation capacity because it bears no Physical Compliance constraints whatsoever. Game objects—balls, pucks, bats—carry sensor configurations optimized for their specific substrate mechanics and adjudicative function within the cooperative mesh, contributing spatial data that neither performer-worn arrays nor venue infrastructure could independently generate because the game object's spatial relationship to performers and boundaries is the adjudicative question itself. Each node class is purpose-engineered for its role within the topology, and the topology's value derives from the complementary differentiation among node classes rather than from the replication of equivalent capability across all nodes. This complementary differentiation is what distinguishes the disclosed architecture from prior art systems that either instrument a single object class in isolation (tracking only the ball, or only the player, or only the venue) or that deploy uniform tracking hardware across all participants without regard to the distinct Physical Compliance envelopes, adjudicative roles, and hierarchical positions that different node classes occupy within the system's organizational topology.

### Game Balls, Pucs, etc.:

### General Game Ball Rotation Estimation

In further embodiments, the distributed UWB tag array enables determination of spin axis orientation and rotation rate through Received Signal Strength (RSS) pattern analysis. As the ball rotates, each tag antenna's orientation relative to fixed anchors changes continuously, producing RSS variations correlating with rotational dynamics. Gaussian process regression or equivalent machine learning models applied to time-series RSS data from multiple tags estimate instantaneous spin axis vector, angular velocity, and rotational acceleration without sole reliance on IMU-derived data. RSS-based orientation estimation provides cross-validation when IMU drift accumulates during flight or impact events saturate inertial sensors.

Optimization-based rotation estimation relates measured world-frame tag positions to known body-frame geometry. For tags {T₀, T₁, . . . , Tₙ} with pre-calibrated body-frame positions P\hat{ }B_i and estimated world-frame positions P\hat{ }W_i,k at time step k, the rotation matrix R\hat{ }W_k is estimated by minimizing residual r_R,k=R\hat{ }W_k×P\hat{ }B_i+P\hat{ }W_0,k−P\hat{ }W_i,k subject to R\hat{ }W_k remaining a valid rotation matrix. However, Physical Compliance requirements—as governed by applicable Equipment Performance Specifications—Rotational Balance, Weight Distribution, aerodynamic profile, structural integrity—constrain maximum tag separation to ball diameter (typically less than 30 centimeters), limiting geometric leverage. For tag separation d and position uncertainty σ_p, rotation uncertainty scales as σ_θ≈arctan (σ_p/d); sub-degree accuracy would require sub-millimeter position accuracy or tag separations exceeding one meter, neither achievable within Physical Compliance constraints. (SEE: Mathematical Formula Reference Image)

These formulations represent preferred embodiments; equivalent rotation estimation approaches fall within scope, including: (a) singular value decomposition (SVD) for rigid body alignment; (b) quaternion-based optimization avoiding gimbal lock; (c) iterative closest point (ICP) algorithms; (d) extended Kalman filter formulations; (e) Procrustes analysis; (f) Horn's method or closed-form solutions; (g) gradient descent, Levenberg-Marquardt, or nonlinear optimization; or (h) machine learning regression models. Alternative uncertainty formulations including Fisher information analysis, Cramér-Rao bounds, or empirically calibrated models fall within scope. The inventive concept resides in recognition that Physical Compliance constraints fundamentally limit optimization-based rotation estimation alone, necessitating multi-modal sensor fusion for adjudication-grade rotation determination.

The system employs multi-modal sensor fusion combining optimization-based estimates with IMU-derived angular velocity, RSS-based orientation, acoustic near-field correlation indicating contact-induced spin changes, and touch/proximity sensor patterns reflecting grip and spin impartation. The AI-driven fusion engine dynamically weights each modality based on instantaneous confidence, enabling adjudication-grade rotation determination—spin axis orientation, rotational velocity, rotation phase at event timestamps—under conditions where single modalities are insufficient, distinguishing this system from prior art optimization methods designed for rigid robotic platforms with unconstrained tag placement.

### American Football Integration:

The UWB Micro-Tag array embedded within American football rubber and leather layers must withstand stretching and compression during kicking, bouncing, and gripping while remaining weatherproofed and temperature-insulated. The Primary Tier of object shape capture of the ball's three-dimensional shape is generated by UWB Micro-Tag arrays sewn into the four perimeter seams, with a central processing hub at the center of each of the four leather sections embodied as a thin film circuit suspended in the rubber and/or between the rubber and the leather. Each section's processing hub may optionally function as a redundant clone of the three others, ensuring data reliability and hardware durability through quadruple redundancy.

Each UWB tag carries a unique identifier within a hierarchical addressing structure: individual tag identifier, tag grouping identifier, section identifier, and ball EDID assembly-enabling communication of individual point-cloud coordinates while differentiating one game ball from another. Tag groupings and central hubs are sandwiched between rubber sheets joined by heat or industrial adhesive at surfaces where components leave interstitial space, suspending the hardware in lubricant lasting the ball's full operational life. This construction allows thin computing circuits to stretch and flex with ball deformation without mechanical damage. Between the rubber layer and ball leather, Triboelectric Nanogenerator (TENG)-based touch and proximity sensing film provides contact detection capability.

### Rugby Integration:

In a further embodiment directed to rugby union and rugby league, the game ball integration methodology extends to a regulation rugby ball—an oblate spheroid assembled from four panels—which receives UWB micro-tag arrays and TENG-based sensing elements through the same panel-interior integration methodology disclosed for soccer, American football, and cricket game balls, with the four-panel geometry simplifying the panel-hub topology relative to multi-panel ball constructions. The instrumented rugby ball cooperates with instrumented try-line boundary infrastructure analogous to the Boundary-Line Cooperative Sensing Array, instrumented goalposts carrying UWB micro-tags within their tubular cross-sections consistent with the multi-channel extrusion methodology disclosed for rigid structural members herein, and player-worn Performer Spatial Assemblies to adjudicate try-scoring, knock-on, and forward-pass determinations through object-originated spatial data rather than through the incumbent Television Match Official camera review system. Rugby-specific protective equipment—including rugby headguards (scrum caps) comprising a foam-padded soft shell over a body-conformal inner liner without a rigid thermoplastic outer shell—constitutes a two-layer cranial hierarchy variant demonstrating the architectural scalability of the hierarchical confidence methodology to sport-specific equipment formats of varying protective complexity. The shin guard multi-layer hierarchy disclosed in the association football embodiment applies equivalently to rugby shin guards where worn, and the multi-garment hierarchical confidence architecture comprising instrumented base layer, shorts, jersey, and protective equipment layers applies to the rugby Performer Spatial Assembly without architectural modification.

### Soccer Ball Integration:

Soccer ball integration employs the same methodology as American football and is utilized here to expand upon that embodiment's technology by extrapolating how it would be adapted to either the polygonal panel geometry of traditional soccer ball, or the more modern free-form puzzle shapes of 21^{st} Century soccer balls. Traditional soccer balls are assembled from 12 to 32 panels in polygonal arrangements—typically truncated icosahedrons of hexagons and pentagons, though modern variations utilize thermally bonded panels in non-traditional shapes. The thin computing hardware assumes each panel's cutting pattern shape, with components affixed beneath the outer leather or synthetic polymer layer and suspended within the bladder-lining structure using elastomeric sheets and low-viscosity inert lubricant permitting unrestricted flexion during heading, kicking, and deflection impacts.

Each UWB tag carries a hierarchical identifier: tag-level ID, panel-level ID, and globally unique ball ID—enabling point-cloud reconstruction and unambiguous differentiation between multiple balls via EDID. Panel-specific groupings capture deformation and panel-specific motion for spin, impact angle, and force vector analysis. Thin stretchable circuits fabricated via inkjet deposition or etched conductive mesh conform to panel geometries while ensuring Rotational Balance, and/or a dual or triple filament topographical spiral. A TENG-based layer between outer panel and suspension assembly provides first-touch control detection and ball-in-play state confirmation.

### Cricket Implementation:

In a further embodiment directed to the sport of cricket, the game ball integration methodology disclosed herein extends to a regulation cricket ball comprising a cork and wound-string core enclosed within four leather quarter-panels joined by a raised seam. The raised seam—a prominent structural ridge of stitched leather running along a great-circle path around the ball's equator—constitutes a pre-existing linear feature whose geometric path is exploited for conductor routing in accordance with the Visual Concealment Architecture, with conductive filaments integrated within or beneath the seam stitching such that the instrumented seam is visually and tactilely indistinguishable from a conventional cricket ball seam. UWB micro-tag arrays distribute across the four quarter-panel interiors using the same bladder-lining suspension methodology disclosed for soccer ball panels, with each quarter-panel carrying a panel-level identifier subordinate to a globally unique ball identifier under the EDID architecture. TENG-based sensing layers positioned beneath the leather quarter-panels detect ball-bat contact (edge detection), ball-pad contact (leg-before-wicket adjudication), and ball-ground contact (catch validity determination) through the same first-touch detection methodology disclosed supra.

The instrumented cricket ball operates within a cooperative spatial mesh comprising at minimum three independently instrumented element categories: the ball itself; instrumented stumps and bails constituting the wicket assembly as venue-integrated spatial delimiters analogous to the Boundary-Line Cooperative Sensing Array disclosed herein; and the instrumented cricket bat disclosed infra. Instrumented stumps embed UWB micro-tags and TENG contact-sensing elements within each stump's cylindrical body and within each bail resting in the stump grooves, enabling the wicket assembly to report its own spatial state—including the precise moment and manner of bail dislodgement—through object-originated spatial emission rather than through external camera observation. This ball-wicket-bat cooperative mesh provides adjudication data for run-out, stumping, hit-wicket, and bowled dismissals through direct inter-object ranging and contact detection, replacing the incumbent External Observation systems including the Decision Review System camera arrays and the existing Zing Bails product. The present invention is distinguished from Zing Bails—which incorporate LED illumination triggered by bail dislodgement for visual broadcast enhancement—in that the instrumented wicket assembly disclosed herein generates spatial position data and contact event data within the cooperative mesh architecture rather than merely providing a visual indicator observable by cameras, and the instrumented wicket cooperates with the instrumented ball and bat as co-participants in a multi-object spatial mesh rather than operating as an isolated illumination device.

### Vulcanized Pucks & Basketballs:

For vulcanized or molded sports implements, the invention integrates UWB micro-tag arrays and TENG-based sensing directly into the manufacturing process-components cast or formed during vulcanization or composite molding rather than post-processing insertion that could compromise integrity or performance. Hockey pucks, manufactured from vulcanized rubber to meet hardness, weight, and friction standards, embed UWB micro-tags in symmetric configuration near the geometric center of mass with redundant tag points extended radially outward, ensuring full rotational symmetry and preserving uniform slide, spin, and ricochet behavior. Each tag is serialized under a EDID unique puck identifier enabling continuous tracking when multiple pucks are active.

Basketballs, formed from inner rubber bladder wrapped in fiber composite layers beneath leather or synthetic panels, co-mold electronics into the composite substrate. UWB micro-tag arrays distribute across panel seams or beneath the surface layer, with orientation and density calibrated to maintain Rotational Balance and air pressure containment. Each panel array includes a centralized micro-hub for tag synchronization, sensor fusion, and power distribution, maintaining elastic response, bounce uniformity, and flight stability during high-speed play. TENG-based sensing films integrated within the outer elastomeric layer provide continuous contact detection-determining when and where the ball contacts player, hoop, net, or playing surface.

In a further embodiment exploiting the Visual Concealment Architecture, conductor traces, antenna elements, and interconnection routing between panel-mounted UWB micro-tag arrays are integrated within the basketball's channel lines—the raised rubber ribs that define panel boundaries and provide grip texture. Channel lines possess dimensional thickness sufficient to house thin-film flexible conductors within or beneath the rubber ridge, and their black pigmentation is inherently compatible with carbon-nanotube, graphene, and carbon-black conductive ink formulations whose native coloration is visually indistinguishable from the channel line material itself. Because channel lines traverse the entire ball surface in a continuous geometric pattern connecting all panel boundaries, they provide a complete interconnection network linking every panel's sensor array without introducing any conductor path that does not coincide with an existing visual feature. The instrumented channel lines are manufactured during the same molding or bonding process that forms the conventional channel lines, and the resulting ball is visually and tactilely indistinguishable from a non-instrumented basketball under inspection, satisfying both the Visual Concealment requirements and the Rotational Balance constraints established herein.

Both basketballs and pucks undergo repeated high-velocity impacts against ice, hardwood, or glass. Embedded UWB and TENG components incorporate impact-resistant encapsulation within vulcanized assemblies, with thin stretchable computing substrates sealed in elastomer-compatible enclosures that deform elastically without fracture or delamination. These assemblies withstand extreme environmental stressors including sub-zero temperatures for pucks and high-humidity conditions for basketballs.

### Uniform Components:

### Sports Footwear:

The invention integrates UWB micro-tag arrays and TENG-based sensing layers into high-performance athletic footwear construction. UWB tag arrays embed within the midsole, outsole, and perimeter structure—heel, toe box, lateral edges, and vamp regions—positioned to preserve symmetry and Weight Distribution while ensuring full kinematic coverage. This arrangement captures precise spatial data during toe taps, heel strikes, lateral pivots, accelerations, and vertical leaps critical for officiating determinations. TENG-based sensing layers may be co-molded or laminated into outsole and perimeter surfaces capture high-resolution proximity and contact data at geometric points where inbounds/out-of-bounds determinations occur. Upward-curved tag placement in toe and heel regions ensures spatial and contact data remains trackable during elevated or acrobatic movements such as toe-tap catches and heel-down planting maneuvers. This enables detection of surface interaction events—foot grazing sideline, contacting performance surface, tapping within contested scoring boundary—with precision supporting automated boundary rulings and possession determinations. The footwear may optionally function as a mobile anchor providing triangulation data to surrounding sensors.

Each tag carries a unique identifier tied to footwear unit, player, and foot orientation (left vs. right), synchronized with the system's point cloud identification framework. This detail is critical for adjudicating boundary rulings in American football, basketball, and soccer where inches- or less-determine play outcomes. Embedded components are fabricated on stretchable, impact-resistant substrates conforming to footwear deformation characteristics. UWB arrays are miniaturized with abrasion-resistant encapsulants withstanding repetitive stress, moisture, and thermal cycling. Antenna geometries maintain signal fidelity under flexion and compression.

Vulcanization Integration: Sole lip sensing structures embed within rubber outsole compound during vulcanization, with conductive elements at precise geometric locations. Vulcanization bonds sensing elements permanently within the rubber matrix, providing mechanical protection and environmental sealing while maintaining durometer, traction, and wear characteristics required for athletic performance. Graphene-based conductive paint formulations may be applied to sole lip surfaces as alternative or complementary sensing layer, providing capacitive proximity detection supplementing embedded TENG-based contact sensing.

### Sole Lip Perimeter Sensing Architecture

The convergence zone where outsole horizontal ground-contact surface meets vertical sidewall constitutes the critical geometric boundary for toe-tap and foot-drag adjudication. This sole lip perimeter requires a minimum of three distinct sensing structures at each anatomically critical location:
Outermost diagonal apex: Sensing node at the outermost sole lip point where curved perimeter reaches maximum lateral extension, capturing extreme foot placement boundary during sideline catches and boundary-straddling plays.
Horizontal-to-vertical transition point: Sensing node where sole surface transitions from horizontal ground-contact plane to vertical sidewall, capturing the geometric inflection determining whether ground contact occurred.
Vertical sidewall datum: Sensing node on the vertical sole perimeter portion, providing foot orientation reference and detecting sidewall-first contact characteristic of foot-drag techniques.

This three-point minimum configuration at each anatomical zone—toe, lateral forefoot, lateral midfoot, lateral heel, medial heel, medial midfoot, medial forefoot—creates a complete perimeter sensing array of 21 or more nodes dedicated to sole lip geometry capture. The array resolves spatial relationships for toe-tap and foot-drag determinations where rulebook compliance depends on whether any shoe portion contacted playing surface within bounds before any portion contacted out-of-bounds territory.

### Toe-Tap Event Resolution

During toe-tap catches, the receiver's foot contacts ground with the anterior sole lip for durations as brief as 50-100 milliseconds before completing a step or leaving the surface. The sole lip perimeter array captures precise three-dimensional contact zone coordinates at sub-millisecond temporal resolution, correlating sole lip contact position with simultaneously captured field boundary coordinates to produce definitive inbounds/out-of-bounds determinations impossible with camera-based observation.

This correlation is performed exclusively upon spatial emissions originating from Performer Spatial Assemblies holding Active-On-Field Adjudication Participation State at the temporal instant of the toe-tap event, ensuring that instrumented footwear worn by non-participating performers standing on or adjacent to the sideline boundary—whose sole lip perimeter arrays emit spatial data indistinguishable in format and fidelity from active participants' emissions—does not contaminate the boundary adjudication computation. The Adjudication Participation State filtering is particularly critical for toe-tap determinations because the spatial region of adjudicative interest—the boundary line and its immediate environs—is precisely the spatial region where non-participating sideline personnel physically stand during play, creating a spatial overlap between adjudication-critical emissions and adjudication-irrelevant emissions that no amount of sensor precision can resolve without participation state awareness.

### Foot-Drag Event Resolution

Foot-drag techniques involve intentionally dragging toe or lateral sole edge across the playing surface while moving toward or across the boundary. The continuous contact generates a trajectory of sole lip positions requiring correlation with boundary position throughout drag duration. The perimeter sensing array captures this trajectory at 100+Hz, providing complete spatial history necessary to determine whether any drag path portion crossed the boundary before possession was established.

In a further embodiment directed to association football, the sports footwear integration disclosed herein extends to regulation football boots whose upper surface—fabricated from synthetic polymer, knit textile, or leather—constitutes a dual-function substrate serving simultaneously as the primary ball-contact surface for kicking, passing, and shooting, and as a tracking substrate carrying UWB micro-tag arrays and TENG-based contact sensing elements integrated within the upper's material layers. The boot upper's contact-sensing capability enables determination of which boot surface contacted the ball, at what spatial coordinates, and at what temporal instant, providing ball-striking data that cooperates with the instrumented ball's own contact detection to produce dual-origin confirmation of each kick event. This boot-ball cooperative extends to goal-line adjudication when combined with the Boundary-Line Cooperative Sensing Array disclosed herein: the cooperative spatial mesh comprising instrumented ball, instrumented boots of nearby players, and instrumented goal-line boundary determines whether the whole of the ball crossed the whole of the goal line through inter-object ranging data rather than through the incumbent Goal-Line Technology camera systems or Video Assistant Referee camera review, both of which constitute External Observation systems subject to the frame-rate, occlusion, and angular limitations disclosed throughout this specification (see FIG. 6).

The football boot further operates within a multi-garment hierarchical confidence architecture when combined with an instrumented shin guard worn over the boot's ankle collar and beneath the player's sock. The shin guard constitutes a multi-layer hierarchical assembly analogous to the cranial hierarchy disclosed for helmet integration, comprising in its fullest preferred embodiment four hierarchically ordered layers: (1) a rigid or semi-rigid thermoplastic outer shell providing impact protection and carrying shell-integrated conductor arrays; (2) a compressible foam padding layer beneath the shell carrying deformation-sensing elements through the serpentine channel routing methodology; (3) an interior liner surface carrying body-proximal tracking elements; and (4) a compression sock or sleeve worn beneath the shin guard serving as the body-conformal reference layer analogous to the MOCAP turf tape or cranial liner garment in the helmet hierarchy. The inter-layer differential measurements across this multi-layer shin guard hierarchy produce hierarchically diagnosed contact event data—determining not merely that a tackle or foul contact occurred but the force magnitude, contact surface, and anatomical location of the contact—through the same inter-layer diagnostic methodology disclosed for the cranial hierarchy, applied to the lower extremity protective equipment context where tackle-contact adjudication governs penalty, free-kick, and disciplinary card decisions in association football.

### Boundary-Line Cooperative Sensing Array

The sole lip perimeter sensing architecture operates in conjunction with a complementary linear sensing array integrated beneath or within the painted field boundary markings. In American football, regulation sideline and end line markings are four inches (10.16 cm) wide; in association football, boundary markings are five inches (12 cm) wide per FIFA Law 1. The boundary-line sensing array occupies the width of the regulation marking and extends the full length of the boundary, concealed beneath the playing surface material such that the visible boundary line appearance is unaltered. This full-width geometry is not an engineering preference but a structural consequence of the Boundary-Primary Spatial Determination principle applied at the venue level: the adjudicative question in a sideline determination is whether a tracked surface crossed the lateral edge of the boundary marking at which field territory terminates, not whether it crossed a center-line approximation. A sensing substrate narrower than the full marking width would introduce a geometric gap between the outer edge of the painted marking—the legal boundary—and the outer edge of the sensing surface, producing a spatial ambiguity structurally equivalent to the centroid-approximation error that the Object-Originated Paradigm eliminates at the performer level. The sensing substrate is therefore dimensionally co-extensive with the painted boundary marking's full width, with its lateral sensing boundaries co-planar with the outer painted edges of the regulatory marking, implementing the same outer-perimeter-as-spatial-truth rule that governs the Enveloping Substrate Methodology for performer-worn equipment.

The boundary-line array comprises at minimum two parallel conductive filaments—one positioned beneath each lateral edge of the painted marking—with a sensing webbing spanning the interstitial width between them. The spatial region between the two lateral filaments—the full internal width of the regulatory marking—is thereby a continuously monitored contact zone, not a binary presence detector. The sensing architecture independently characterizes whether a tracked surface element is in contact with the inner zone of the marking (between the lateral edges), is in contact at or proximate to the field-proximate lateral edge, is in contact at or proximate to the lateral edge at which field territory terminates, or has crossed the lateral edge at which field territory terminates entirely. These are four distinct and independently resolvable adjudicative contact states, each corresponding to a different officiating determination in boundary and goal-line adjudication. This interior-zone contact characterization is the venue-level analogue of the contact-sensing tier's capacity to resolve the specific EDID-differentiated surface region of a performer spatial assembly that is in contact—the granularity of contact state resolution is applied both to the performer's boundary and to the venue's regulatory marking boundary. This webbing operates as a distributed proximity and contact detection surface responsive to the approach and contact of instrumented sole lip elements. When a player's instrumented footwear enters the near-field detection zone of the boundary-line array, the system registers a cooperative spatial event: the shoe-worn sole lip perimeter nodes report their three-dimensional coordinates while the boundary-line array independently confirms proximity, contact, and crossing sequence from the field surface perspective. This dual-origin confirmation—spatial data generated independently by both the player-worn assembly and the venue-integrated boundary array—provides adjudication evidence that neither source alone can produce, and that no external observation system can replicate regardless of camera quantity or resolution.

The boundary-line array integrates within synthetic turf installations beneath the turf carpet and above the shock-absorption substrate, following the same installation pathway as boundary marking inlay strips already standard in professional synthetic turf systems. For natural grass installations, the array integrates within a narrow subsurface channel at the boundary marking position, protected by weatherproof encapsulation compatible with groundskeeping maintenance including mowing, aerating, and repainting. In both installations, the array connects to the venue's fixed UWB anchor infrastructure through subsurface wired connections at interval junction points along the boundary length, providing power, data communication, and time synchronization without wireless transmission from the boundary surface itself.

The cooperative event resolution operates as follows: the sole lip perimeter array continuously reports shoe boundary geometry at sub-millisecond temporal resolution; the boundary-line array continuously reports proximity and contact events along its linear extent; the AI-driven sensor fusion engine temporally correlates both data streams to produce a definitive spatial determination of whether shoe contact occurred within, upon, or beyond the boundary marking, and in what sequence. For toe-tap events, this cooperative architecture resolves the adjudication question—did the toe contact ground in-bounds before any portion of the foot contacted out-of-bounds territory—through two independent spatial data origins rather than through visual interpretation of camera imagery showing a foot near a painted line obscured by turf debris, shadow, or other players.

The cooperative event resolution further incorporates Adjudication Participation State filtering at the correlation stage: when the boundary-line array detects proximity or contact events, and the sensor fusion engine identifies multiple PSA sole lip emissions within the spatial and temporal window of the detected boundary interaction, the engine evaluates the Adjudication Participation State of each contributing PSA and includes only Active-On-Field emissions in the adjudication determination. This state-aware filtering is architecturally necessary because the boundary-line array, by design, extends the full length of the sideline boundary—the same boundary along which non-participating personnel stand during play—and therefore detects proximity events from both active participants and sideline personnel indiscriminately. Without participation state filtering, the dual-origin confirmation architecture would paradoxically degrade rather than improve adjudication accuracy by amplifying rather than resolving spatial ambiguity at the boundary.

### Finger and Hand Articulation Tracking:

Hand articulation represents one of the most adjudication-critical tracking requirements in professional sports. Determinations of possession, catch completion, ball security, and intentional contact depend upon resolving the precise spatial configuration of individual fingers, palm, and dorsal hand surface at ball contact or release. Generating a wireframe of the human hand's sculptural shape presents difficulty because of the amount of critical adjudicatory surfaces in a compact space, but also because the hand is the one part of the human body where performers resist wearing gear. The minimalist approach of capturing sculptural 3D shapes with minimal vector topography is well suited for this task where less is more. The hand articulation tracking system captures three-dimensional position and orientation of each phalangeal segment independently, enabling complete hand geometry reconstruction with resolution supporting officiating determinations hinging on finger position, grip configuration, and contact sequence utilizing the minimum filament topography and hierarchical anatomical prioritization.

The tracking architecture employs annular positioning elements encircling each phalangeal segment—proximal phalanx, intermediate phalanx, and distal phalanx—at anatomically consistent midpoint locations. Annular elements may be implemented as conductive rings woven into glove fabric, flexible circuit bands laminated within glove structure, or printed conductive traces on stretchable substrates conforming to finger geometry during flexion and extension. Each annular element contains UWB micro-tags or RF positioning nodes reporting three-dimensional, wireframe topographical representations, of phalangeal segment position. The hierarchical identification scheme assigns unique identifiers to each phalangeal segment, grouped by finger, grouped by hand, grouped by player—enabling distinction of the distal phalanx of the left index finger from all other tracked elements across all participants, and differentiating between front inside palm and outside knuckle surfaces.

The contour conforming filaments can be incorporated in longitudinal tracking paths extend along dorsal and palmar surfaces, connecting annular elements and providing continuous position data along finger length to capture and transmit the hand's basic geometry with the minimal amount of hardware generating a minimal amount of data. Longitudinal conductors follow natural flexion creases and tendon paths, minimizing grip interference while maximizing coverage. Dorsal elements trace from metacarpophalangeal joint across each phalanx to fingertip; palmar elements follow flexor tendon paths from palm through finger pulp. The intersection of annular and longitudinal elements creates a grid topology capturing both segmental positions and continuous curvature during dynamic manipulation. For adjudication-critical applications, longitudinal conductors employ dual-filament paths with minimum two parallel filaments for redundancy, and triple-filament paths in fingertip regions where single-point failures would most severely impact possession and contact determinations.

The thumb requires geometry-specific architecture accounting for opposable orientation, saddle joint mobility at the carpometacarpal joint, and critical grip security role. Unlike four medial fingers flexing primarily in single plane, the thumb exhibits multi-axis rotation enabling opposition, circumduction, and precision grip essential to ball control. The thumb tracking subsystem employs modified annular-longitudinal grid accommodating enhanced mobility, with annular elements at proximal and distal phalanges and specialized elements spanning thenar eminence and first web space. The web space between thumb and index finger—primary locus of ball security in catching and carrying—receives enhanced tracking density capturing aperture width, web tension, and relative thumb-index separation throughout grip formation. Web-space tracking enables determination of whether a receiver achieved closed-grip configuration indicative of established possession or remained in open-hand configuration characteristic of incomplete catch.

Integration with sport-specific gloves—American football receiver gloves, goalkeeper gloves, baseball batting gloves, hockey gloves—embeds tracking architecture within glove construction without altering grip performance, tactile sensitivity, or Physical Compliance with league equipment regulations. For receiver gloves with tacky grip surfaces, tracking elements position in substrate layers beneath grip coating with antenna geometries optimized for signal propagation through silicone or polymer materials. For padded gloves such as goalkeeper and hockey gloves, tracking elements distribute across flexible finger regions and rigid protective panels, capturing both fine finger articulation and gross hand position during blocking, catching, and striking. The glove-integrated system interfaces with wrist-mounted computing hub aggregating finger-level position data, managing synchronization, and transmitting unified hand point cloud to central processing. TENG-based or graphene-based sensing layers co-integrated with positioning elements provide simultaneous contact confirmation-determining not only hand position but whether and when contact occurred between specific finger segments and tracked object.

Protective equipment worn on athlete extremities—kneepads, elbowpads, and gloves—incorporates the UWB tracking and TENG contact sensing architectures described herein, with sensing layers positioned at anatomically critical surfaces including glove palm regions and joint-covering padding. These placements enable adjudication-critical determinations that external observation cannot reliably resolve. Glove tracking relative to game ball position determines possession and fumble status during hand-ball contact events where the ball is visually obscured by the grasping hand itself.

In a further embodiment, the goalkeeper glove integration exploits a cooperative deformation characteristic unique to ball-catching events: when a goalkeeper catches or parries a struck ball, both the glove's foam palm and the ball's outer surface undergo simultaneous compressive deformation at the contact interface. When both the goalkeeper glove and the game ball are instrumented within the cooperative spatial mesh disclosed herein, the TENG-based and deformation-sensing elements in the glove palm and the corresponding sensing elements in the ball's outer panel produce temporally correlated contact signatures from both sides of the contact interface simultaneously—a dual-origin contact confirmation achievable only when both contacting objects are independently instrumented participants in the same cooperative architecture. This simultaneous deformation data resolves catch-versus-deflection adjudication, determines whether the goalkeeper maintained sufficient contact duration to establish possession, and provides force-magnitude data relevant to foul-contact adjudication when the ball arrives via a shot deflected off an opponent.

In a further embodiment directed to combat sports, the hand articulation tracking architecture extends to a boxing hand wrap and boxing glove combination constituting a two-layer multi-garment hierarchical confidence assembly. The hand wrap—a body-conformal elastic textile wound directly around the fighter's hand, wrist, and knuckle surfaces—serves as the inner body-conformal reference layer carrying tracking elements in direct skin-proximal contact analogous to the MOCAP turf tape or cranial liner garment in other hierarchical embodiments. The boxing glove worn over the wrapped hand serves as the outer protective and contact-sensing layer, with TENG-based sensing elements integrated within the glove's striking surface detecting impact events against the opponent. The inter-layer differential between hand-wrap reference position and glove outer-surface contact position produces hierarchically diagnosed strike data. The boxing glove further operates within a cooperative spatial mesh with the opponent's own instrumented body—comprising the opponent's Performer Spatial Assembly—such that each scoring strike is confirmed through dual-origin data: the striker's glove contact detection and the recipient's body-surface contact detection at the corresponding anatomical target, enabling automated scoring output derived from cooperative inter-object spatial data rather than from ringside judge visual observation subject to angular limitation and attentional bias.

### Kneepads, Elbowpads:

Kneepad and elbowpad integration addresses joint-surface contact determination—among the most adjudication-critical measurements in professional sports—where the precise spatial position and temporal moment of joint-to-ground or joint-to-surface contact determines play outcome; with the complication that these are the anatomical regions where the contact event occurs routinely obscured from external observation by body-on-body occlusion, equipment overlap, and player pile-up configurations. In American football, knee or elbow contact with the ground while a player is in the grasp of an opponent terminates live play and establishes the forward progress spot—a determination upon which the outcome of possession, first-down conversion, and scoring frequently depends. The camera-based adjudication of “down by contact” requires a referee or replay official to visually identify the precise frame in which the knee or elbow contacted the playing surface, correlate that frame with ball position, and determine whether an opposing player maintained contact at that temporal instant—a multi-variable visual estimation performed under occlusion conditions where the relevant joint surface is obscured beneath the player's own torso, an opponent's body mass, or accumulated pile-up mass. The present invention eliminates this observational dependence by instrumenting the joint-covering protective equipment itself with active, self-reporting spatial positioning and contact sensing architectures operating within the Object-Originated Spatial Awareness paradigm, providing sub-millisecond-resolution contact event detection and sub-millimeter joint-surface position determination independent of external camera observation.

Kneepad contact sensing combined with three-dimensional knee position tracking determines both “down” status and precise field location in American football—resolving disputes arising from player pile-ups where camera angles cannot observe the actual ground contact moment or location. The instrumented kneepad incorporates UWB micro-tag arrays distributed across the anterior patellar surface, medial and lateral condylar prominences, and inferior patellar border—the anatomical surfaces whose ground contact constitutes a “down” event under applicable rules. TENG-based and/or graphene-based contact sensing layers integrated within the kneepad's exterior contact surface detect the moment of ground interaction through the pad's outer material layer, consistent with the through-material sensing capability disclosed in the Touch and Proximity Sensing Technologies section herein. The spatial positioning array reports the three-dimensional coordinates of the patellar surface at the instant of contact detection, enabling automated determination of both the temporal moment and the precise field location at which the knee contacted the playing surface. The system correlates this knee-ground contact event with simultaneous data from ball-mounted sensors to determine ball position at the instant of contact—resolving the adjudication question that external observation is least capable of answering: what was the precise ball location at the precise instant the knee touched the ground.

Elbowpad integration addresses the equivalent adjudication requirement for elbow-to-ground contact, which constitutes a “down” event under the same rule frameworks governing knee contact in American football and analogous termination-of-play rules in rugby, Australian rules football, and other contact sports. The olecranon process—the bony prominence of the posterior elbow—serves as the primary contact surface in elbow-ground interactions during athletic play, and its spatial position at the moment of ground contact carries identical adjudicative consequence to the patella in knee-ground contact events. The instrumented elbowpad distributes UWB micro-tag arrays across the olecranon prominence, the posterior forearm surface immediately distal to the elbow joint, and the posterior upper arm surface immediately proximal to the joint—capturing the complete posterior elbow geometry whose ground contact terminates play. TENG-based and/or graphene-based contact sensing layers covering the exterior elbowpad surface detect ground interaction through the pad material, while the spatial positioning array simultaneously reports three-dimensional elbow coordinates, enabling the same automated contact-event and field-location determination disclosed for kneepad integration. The elbowpad spatial array further supports contact severity measurement when integrated with accelerometer arrays as disclosed in the Impact Force Measurement for Officiating section herein—providing objective force data for officiating determinations involving elbow-to-opponent contact events such as flagrant foul determinations in basketball, illegal use of elbow penalties in soccer, and unnecessary roughness determinations in American football where elbow strikes constitute distinct infraction categories.

Beyond American football “down by contact” determinations, instrumented kneepads and elbowpads address sport-specific adjudication requirements across multiple competitive frameworks. In basketball, knee and elbow position relative to boundary lines determines whether a player was inbounds or out-of-bounds when contact with another player or the ball occurred—a determination that current officiating resolves through visual estimation of a joint position relative to a painted line, often while the joint is obscured by the player's own body or an opponent's limb. In volleyball, the knee and elbow frequently contact the playing surface during diving defensive plays where the adjudication question is whether ball contact preceded or followed the player's body contact with the surface and whether the ball contact occurred within the court boundary—questions requiring simultaneous temporal correlation of body-surface contact events and ball trajectory that external cameras resolve through frame-by-frame analysis inherently limited by camera frame rate and viewing angle. In soccer, knee-to-ground contact during sliding tackles constitutes a critical adjudication surface for determining whether the tackler's contact with the ball preceded contact with the opponent—a determination whose accuracy directly governs penalty kick and red card decisions with match-outcome consequences. In cricket, knee position of batsmen relative to the crease line determines run-out and stumping adjudication. In combat sports including mixed martial arts, knee and elbow contact with the mat surface determines grounding status under rules that distinguish permissible strikes based on whether an opponent is standing or grounded. In each sport-specific application, the instrumented kneepad or elbowpad operates within the same Object-Originated Spatial Awareness paradigm, reporting its own spatial position and contact state rather than depending upon external observation to infer joint position.

The multi-layer hierarchical pad methodology disclosed herein extends to the complete cricket protective ensemble worn by batsmen, which comprises multiple independently instrumented protective items each constituting a hierarchical embodiment: batting pads (leg guards) comprising a rigid outer shell over foam padding over an inner liner, analogous to the shin guard multi-layer hierarchy; thigh guards and arm guards comprising semi-rigid protective inserts within fabric sleeves; chest guards comprising foam panels within a vest garment; and wicket-keeping gloves comprising padded finger and palm protection over an inner glove liner, analogous to the two-layer boxing hand wrap and glove hierarchy disclosed herein. Each item in the cricket protective ensemble operates not in isolation but as a layer within the batsman's complete Performer Spatial Assembly, cooperating with the instrumented cricket ball and instrumented wicket assembly disclosed supra to provide the inter-object spatial data from which leg-before-wicket, caught-behind, and hit-wicket adjudications are derived through cooperative ranging and contact detection rather than through the incumbent third-umpire camera review system.

The kneepad and elbowpad integration architecture contemplates multiple substrate embodiments corresponding to the sport-specific protective equipment formats disclosed herein. For sports requiring dedicated protective pad equipment—American football, volleyball, basketball, lacrosse, cricket, combat sports—the tracking and sensing architecture integrates within the pad construction using the same substrate-specific engineering methodologies disclosed in the Hard-Shell Protective Equipment Integration section for rigid and semi-rigid protective equipment: compressible foam padding receives sensing elements through surface-mount embedding, serpentine channel routing, or co-molding integration; hard-shell knee or elbow guards receive sensing elements through in-mold embedding, channel-routed conductor placement, or inter-layer lamination between shell and padding layers; and sleeve-type kneepad and elbowpad constructions receive sensing elements through the textile integration methodologies disclosed in the Contour-Line Tracking and Design-Line Integrated Tracking Architecture sections herein, with tracking elements following the knit or woven structure of the compression sleeve fabric.

Multi-Layer Hierarchy for Rules Determinant Kneepads & Elbowpads: For sports or competitive contexts where dedicated kneepad or elbowpad equipment is not worn—or where athletes elect not to wear such equipment despite its optional availability—the present invention contemplates MOCAP turf tape as an alternative or supplementary body-conformal reference substrate applied directly to the skin surface overlying the patellar and olecranon anatomical regions. Consistent with the multi-garment hierarchical confidence architecture disclosed in the Dynamic Deformation Tracking section herein and the Shape Tape body-conforming tracking substrate disclosed in the Shape Tape chapter herein, MOCAP turf tape applied to the knee or elbow provides the highest-confidence positional data achievable for these anatomical surfaces because the adhesive substrate eliminates all intervening air gap, fabric deformation, and garment-layer displacement artifacts that reduce positional confidence in equipment-integrated or uniform-integrated tracking approaches. MOCAP turf tape applied to the knee functions identically to MOCAP turf tape applied to other body regions as disclosed herein—comprising the same multi-layered, die-cut, flexible composite structure with biocompatible elastomer base layer, pressure-sensitive adhesive, interior TENG and/or graphene-based contact sensing circuitry, woven computing and communications arrays, UWB antenna traces, and exterior friction-modulating polymer—but die-cut in sport-specific geometries conforming to patellar and periarticular knee topography or olecranon and periarticular elbow topography. For avoidance of doubt: MOCAP turf tape as used in this kneepad and elbowpad context refers to the same active, self-reporting tracking substrate operating within the Object-Originated Spatial Awareness paradigm defined throughout this application and expressly distinguished from conventional motion capture systems employing passive retroreflective markers observed by external camera arrays.

In embodiments where athletes wear both dedicated kneepad or elbowpad equipment and MOCAP turf tape on the underlying skin surface, the system implements the same multi-garment hierarchical confidence architecture disclosed for inner garment and outer uniform layering: the skin-adhered MOCAP turf tape serves as the body-conformal inner reference layer receiving the highest confidence weighting for anatomical position determination, while the equipment-integrated tracking elements in the overlying kneepad or elbowpad serve as the outer layer whose positional data is weighted according to equipment-to-anatomy displacement characteristics. The AI-driven sensor fusion engine computes differential displacement between the skin-conformal MOCAP turf tape layer and the equipment-integrated outer layer, interpreting divergence as equipment shift or compression rather than anatomical movement—enabling the system to report both the anatomical ground truth position of the joint and the position of the protective equipment surface independently. This dual-layer configuration is particularly valuable for “down by contact” adjudication because the adjudicative question concerns the position of the anatomical joint surface relative to the playing surface, not the position of the protective equipment covering it—a distinction that becomes materially significant when equipment shifts during ground impact, producing momentary displacement between the kneepad's exterior surface position and the underlying patella's true position. In embodiments where the athlete wears MOCAP turf tape without overlying kneepad or elbowpad equipment, the turf tape functions as the sole tracking substrate for that joint, with its contact sensing layer providing direct ground-interaction detection through the exterior friction-modulating polymer surface designed for turf contact as disclosed in the Shape Tape section herein.

The kneepad and elbowpad tracking subsystems interface with the Performer Spatial Assembly (PSA) through the same Equipment Digital Identity Document (EDID) framework disclosed in the Equipment Ensemble Identification and Registration Protocol section herein, with each kneepad, elbowpad, and MOCAP turf tape panel carrying a unique cryptographic identity bound to the parent performer assembly and differentiating left from right, knee from elbow, inner reference layer from outer equipment layer. During the pre-performance “weigh-in” topographical registration procedure disclosed herein, kneepad and elbowpad tracking elements undergo the same layered registration sequence as all other garment and equipment layers—establishing body-conformal baseline correspondence between tracking element positions and underlying anatomical landmarks at each joint articulation state across the full range of flexion, extension, lateral, and rotational motion characteristic of the applicable sport. The registration data captures the sport-specific range of pad displacement relative to anatomy during dynamic movement, producing pad-specific deformation transfer functions that the AI-driven sensor fusion engine applies in real time to differentiate equipment displacement from anatomical movement throughout competition.

### Jerseys & Pants—Contact Event Detection:

The touch-sensitive textile architecture—implementing Contact-Based Sensing as defined in the Inventor's Lexicography—described in the Contour-Line Tracking section enables contact event differentiation critical to officiating determinations. The distributed sensing network localizes contact events spatially—differentiating left from right, front from back—while pressure-sensitive graphene-infused ink regions detect force signatures characteristic of specific contact types. In American football, this capability enables detection of “holding” infractions wherein offensive players illegally restrain defenders through jersey pulling or bunching—contact events that occur within body-on-body occlusion zones where external camera observation cannot reliably resolve the nature, location, or initiator of the contact.

### Cooperative Spatial Mesh: Human-Integrated Mobile Reference Architecture:

The Cooperative Spatial Mesh implements the Reciprocal Spatial Emission Architecture (RSEA) component of the Collaborative Spatial Mapping & Reciprocal Spatial Emission Architecture (RSEA) defined in the Inventor's Lexicography, wherein participating assemblies function as mutual spatial references through reciprocal ranging under chaotic, non-cooperative, collision-assumptive motion conditions (see FIG. 17). The cooperative spatial mesh disclosed herein leverages the inherent spatial distribution of officiating personnel—referees, umpires, line judges, and other on-field officials—as mobile reference nodes within the positioning system. Unlike fixed anchors, officiating crew members move with the flow of play, maintaining proximity to adjudication-critical events where tracking accuracy matters most. This human-integrated approach provides mobile triangulation geometry that adapts continuously to game state, concentrating positioning infrastructure near the spatial regions where boundary determinations, possession events, and scoring adjudications occur.

### Referee Wearable Configuration

Furthermore, referee proximity to the ball and key players during adjudication-critical moments enhances signal transmission fidelity for the tracked objects most requiring high-confidence positioning. When a referee moves toward a potential boundary violation or contested possession, the mobile reference architecture automatically improves tracking geometry for the objects central to that adjudication, without requiring infrastructure reconfiguration or system intervention. Referee wearables serve multiple distinct functions: providing positional reference data supplementing fixed infrastructure anchors, enabling Infrastructure-Independent Localization Mode in venues lacking permanent installations, carrying officiating-support interfaces delivering real-time spatial data to human decision-makers, and contributing to Collaborative Spatial Mapping by providing known-role position data constraining interpretation of player and ball positions in contested regions.

Tracking hardware configuration for referee wearables differs from player configurations in density, anatomical coverage, and functional prioritization. Because referee body position is not itself subject to adjudication—referees are not evaluated for boundary crossings, contact sequences, or possession determinations—tracking density is substantially reduced. Representative referee configuration comprises Primary Tier boundary elements establishing gross body position and orientation—head, shoulders, hips, feet—without Secondary Tier interior contour elements, Tertiary Tier mesh-fill arrays, or Quaternary Tier contact sensing layers characterizing player configurations. This reduced-density configuration minimizes hardware cost, weight burden, and power consumption while providing sufficient positional data for referee-dependent system functions.

Because officiating crew equipment is not subject to the Physical Compliance constraints governing performer equipment—officials need not perform acrobatic athletic movements and can tolerate heavier, bulkier hardware configurations without compromising competitive performance—the referee wearable architecture implements a complementary inversion of the player hardware hierarchy: where player-worn arrays maximize sensing density while minimizing transmission and processing hardware to preserve Physical Compliance, referee-worn arrays minimize sensing density (Primary Tier boundary elements only) while maximizing transmission, repeater, mobile anchor, and local processing hardware that would be impractical within player Physical Compliance envelopes. This hardware budget reallocation transforms the referee wearable from a reduced-functionality variant of the player configuration into a functionally distinct node class serving infrastructure-grade roles—signal repeater, mobile UWB anchor, local point-cloud pre-processor, and Officiating Proof-of-Position witness—that exploit the referee's sustained close proximity to adjudication-critical events. The resulting architecture is hierarchical and collaborative rather than flat and uniform: player-worn arrays generate high-density spatial emission data at minimum transmission power; referee-worn arrays collect, amplify, process, and retransmit that data with enhanced reliability and error correction before it reaches central processing infrastructure; and venue-fixed anchors provide the static geometric framework against which both mobile node classes are referenced. This three-tier collaborative transmission hierarchy—emitter (player), collector-processor (referee), and fixed reference (venue)—distributes the system's total processing and transmission workload across node classes optimized for their respective Physical Compliance constraints, reducing power demands on any single player-worn array because the more robust and distributed the processing from referee-carried nodes, the less any individual player array must transmit to achieve adjudication-grade positional confidence.

Referee wearables incorporate officiating-support interface elements absent from player configurations, including haptic feedback actuators delivering tactile alerts when the system detects adjudication-relevant events—boundary crossings, scoring events, possession changes—warranting official attention. Haptic alerts encode event type, confidence level, and directional information through distinct vibration patterns, durations, and spatial distributions, enabling referees to receive system-generated advisories without diverting visual attention. Referee wearables may additionally incorporate near-field communication interfaces enabling acknowledgment, confirmation, or override of system-generated determinations through gesture-based or button-based inputs recorded in the blockchain-backed audit trail.

In Infrastructure-Independent Localization Mode, referee wearables transition from passive tracking targets to active reference anchors providing spatial framework for player and ball tracking. The system's dynamic role allocation logic evaluates positional stability, geometric distribution, and signal quality of available referee wearables, designating a subset as mobile reference anchors whose positions are treated as known reference points for trilateration calculations. Role allocation is performed dynamically: a referee stationary at sideline position may be designated stable reference anchor, while a referee moving actively within the field may be tracked as mobile element; if positions reverse, role designations may reverse without manual intervention. This dynamic role transition capability distinguishes the system from both fixed infrastructure (which cannot adapt to changing spatial requirements) and drone swarms (which cannot maintain adjudication-grade accuracy during rapid role transitions involving human movement patterns).

Integration encompasses line judges, sideline officials, and replay booth personnel. Line judges at boundary lines carry wearables establishing known reference positions aligned with adjudication-critical boundary planes, providing geometric constraints enhancing boundary-crossing determination accuracy. Replay booth personnel carry portable interface devices receiving real-time tracking data streams and three-dimensional visualization feeds, enabling remote review with spatial information unavailable from camera-based replay systems. The complete officiating crew constitutes a distributed human-sensor network that both contributes to and benefits from the system's spatial intelligence capabilities.

### Equipment & Gear:

### Hockey Stick Integration:

The present invention extends to the integration of UWB micro-tags, gyroscopes, and accelerometers within equipment that is manufactured as composites, namely regulation hockey sticks, embedding sensors during composite lamination of carbon fiber, fiberglass, or layered plywood construction. To achieve impact resilience while preserving the stick's flex profile, torsional stiffness, and Weight Distribution, the invention contemplates a floating suspension methodology wherein sensor circuits are suspended within internal cavities filled with low-viscosity inert lubricant or elastomeric suspension medium. This configuration allows sensors to float and flex within the stick's structure without exposure to direct impact forces, providing mechanical protection across sub-zero operating temperatures and repeated high-impact collisions with boards, ice, pucks, and opposing sticks.

In a further embodiment, the fiberglass reinforcement mesh employed during composite lamination incorporates conductive fibers interwoven directly into the mesh weave pattern alongside the structural glass filaments. During the composite lay-up and resin impregnation process, these conductive fibers become permanently embedded within the cured composite matrix, forming an intrinsic constituent of the structural laminate rather than a separately applied or post-manufacture addition. The conductive fiber paths within the reinforcement mesh are oriented and patterned during weaving to define antenna conductors, signal interconnection traces, and sensor distribution networks that conform precisely to the three-dimensional geometry of the finished stick upon molding and curing. Because the conductive fibers participate in the same resin-impregnation and thermal curing cycle as the surrounding structural glass or carbon filaments, the resulting composite member is a unitary structural-electrical substrate in which the circuit architecture and the load-bearing reinforcement occupy the same spatial volume and cannot be separated without destroying the structural integrity of the stick itself.

This conductive-mesh-integrated approach provides several distinctions from prior art surface-applied or cavity-embedded sensing configurations. First, the conductive paths assume and permanently retain the complex curvatures of the stick blade, hosel transition, and shaft taper through the molding process, eliminating post-manufacture conductor routing that would require adhesive bonding or mechanical fastening to non-planar composite surfaces. Second, the resin matrix encapsulating the conductive fibers provides continuous environmental sealing against moisture intrusion, chemical exposure to ice-treatment compounds, and galvanic corrosion without requiring separate conformal coating or potting operations. Third, the distributed nature of the conductive mesh permits antenna elements and sensor interconnections to span the full surface area of the composite structure, enabling wireframe position capture of the complete stick geometry rather than discrete point-location sensing at isolated sensor mounting positions.

The floating suspension methodology described above and the conductive-mesh-integrated reinforcement are complementary rather than mutually exclusive embodiments. In a combined configuration, the conductive reinforcement mesh provides distributed antenna coverage and sensor interconnection across the composite shell, while the floating suspension isolates discrete inertial measurement components—including gyroscopes and accelerometers—within elastomeric-filled internal cavities where direct impact forces are attenuated. This dual-modality integration achieves comprehensive spatial and inertial capture while preserving mechanical resilience across the full operating envelope of competitive hockey.

These sensor-embedded hockey sticks enable contact event detection supporting officiating determinations that camera-based systems cannot reliably resolve. Stick-on-puck contact verification, high-sticking detection, slashing infractions, and illegal stick contact occur at velocities and in spatial configurations where external observation is limited by occlusion, motion blur, and insufficient angular coverage. Object-originated contact sensing detects these events at the point of occurrence rather than inferring them from external video frames, providing sub-millisecond temporal resolution independent of camera placement.

### Baseball Bat Integration:

The present invention further encompasses sensor integration within regulation baseball bats through an axial bore methodology. A precision-drilled central channel along the bat's longitudinal axis, created through lathe-based manufacturing, receives a computing core assembly comprising UWB micro-tags and inertial measurement units sandwiched between semi-cylindrical structural sections custom-fitted to the bore geometry. Vibration-damping polymer encasement absorbs impact shock during high-velocity ball contact while preserving regulatory weight, balance, and dimensional compliance across wood, composite, and aluminum bat constructions.

In a further embodiment, the invention contemplates a multi-bore configuration wherein three longitudinal channels are precision-drilled at equidistant radial positions from the bat's central longitudinal axis rather than—or in addition to—a single central axial bore. Each of the three radially distributed bores receives an independent sensor assembly comprising UWB micro-tags and inertial measurement units with the same vibration-damping polymer encasement and semi-cylindrical structural section methodology disclosed for the central bore configuration. The tri-bore geometry establishes a sensor triad whose three spatially separated measurement points enable trilateration of contact location along and around the bat's striking surface—determining not merely that ball-bat contact occurred but precisely where on the bat barrel the contact was made, at what longitudinal distance from the bat's sweet spot, and at what circumferential position relative to the bat's rotational orientation at the moment of impact. Contact localization resolution is a function of the radial separation between the three bore axes and the temporal resolution of the vibration-arrival-time differential measured across the triad: because impact-generated mechanical vibrations propagate through the bat's material matrix at finite velocity, the three spatially separated sensor assemblies detect the vibration wavefront at slightly different times, and the differential arrival times across the triad encode the contact location relative to the known geometric positions of the three sensor axes. This vibration-arrival trilateration operates in conjunction with—and provides cross-validation of—contact timing derived from TENG-based sensing at the bat's exterior surface, establishing a dual-modality contact localization architecture wherein interior vibration trilateration and exterior touch sensing independently resolve the same contact event from complementary measurement perspectives.

The multi-bore configuration preserves Rotational Balance and Weight Distribution compliance through symmetric radial placement of the three bore channels at 120-degree angular intervals around the bat's cross-section, ensuring that the material removal and sensor mass addition are rotationally symmetric about the longitudinal axis. For wood bat constructions, the tri-bore geometry is achieved through multi-axis CNC machining or sequential lathe operations with indexed rotational positioning; for composite and aluminum constructions, the three channels may be formed during the initial manufacturing layup or extrusion process consistent with the multi-channel extrusion methodology disclosed for rigid tubular structural members herein. The compensating alloy or composite material density selection methodology disclosed herein applies to the tri-bore configuration to ensure that the net cross-sectional mechanical properties—yield strength, impact absorption, deflection resistance—meet or exceed regulatory equipment specifications despite the additional material removal. In embodiments combining both central and tri-bore configurations, the central bore carries the primary computing core and communications hub while the three radial bores carry spatially distributed sensor nodes communicating with the central hub through short-range intra-bat data links, producing a hierarchical intra-equipment architecture wherein local sensor nodes (radial bores) report to a local aggregator (central bore) which reports to the broader Performer Spatial Assembly—a structural hierarchy paralleling the panel-hub-PSA hierarchy disclosed for game ball sensor arrays.

The embedded system captures bat trajectory, rotational velocity, and impact timing, while coordination with ball-mounted sensors enables precise contact moment detection and contact characterization. When the tri-bore bat-originated contact localization data is temporally correlated with spatial data from a digitally active baseball operating within the same Object-Originated Spatial Awareness paradigm, the cooperative spatial mesh between bat and ball reconstructs the complete three-dimensional geometry of the pitch-to-contact event: the ball's inbound trajectory, spin axis, rotational velocity, and pitch classification (fastball, curveball, slider, changeup, and further sub-classifications thereof) derived from the ball's own spatial emission and rotation estimation architecture disclosed herein; the bat's swing plane, angular velocity, attack angle, and barrel orientation derived from the bat's embedded sensor array; and the precise spatial coordinates, timing, and bat-surface location of the contact event itself derived from the cooperative ranging between ball-mounted and bat-mounted sensors at the moment of impact. Post-contact, the ball's outbound trajectory—exit velocity, launch angle, spin axis, and spin rate—is captured by the ball's own continued spatial emission, completing a continuous spatial narrative from pitcher's hand through batter contact to fielded or landed ball without any segment requiring external camera observation. This pitch-to-contact-to-outcome reconstruction achieves measurement fidelity that external observation systems cannot approach: high-speed cameras capturing bat-ball contact at frame rates of 1,000 to 10,000 frames per second can estimate contact location to within approximately one-half inch from visual analysis of ball deformation patterns, whereas the tri-bore vibration-arrival trilateration combined with ball-originated contact sensing resolves contact location to the system's claimed sub-millimeter accuracy threshold—an improvement of more than an order of magnitude over the best available optical methods.

When the digitally active bat and digitally active baseball are further combined with a Performer Spatial Assembly comprising the batter's instrumented uniform, MOCAP turf tape or instrumented inner garments, instrumented batting gloves, and instrumented footwear as disclosed herein, the system captures the complete biomechanical chain of the batting sequence: the batter's stance and weight distribution (from instrumented footwear); the load, stride, and hip rotation (from PSA-instrumented uniform tracking the torso, hip, and lower body kinematics); the shoulder rotation, arm extension, and wrist snap (from upper-body PSA elements and instrumented glove tracking); the bat's resulting swing plane, barrel speed, and attack angle (from the bat's embedded sensor array); the pitch trajectory and classification (from the ball's spatial emission during flight); and the contact event geometry linking all preceding kinematic elements to a measurable outcome (from the cooperative bat-ball spatial mesh at impact). This end-to-end spatial reconstruction of the complete pitch-to-hit acrobatic sequence—from pitcher's release through batter's biomechanical chain through bat-ball contact through batted ball outcome—is captured entirely through object-originated spatial emission from the participating objects themselves, without dependence on any external camera, radar gun, or optical tracking system. No prior art system captures this complete sequence because no prior art system instruments all participating objects—pitcher's uniform, ball, batter's uniform, bat, and field—within a single cooperative spatial emission architecture. Prior art systems capture fragments: radar guns measure pitch speed but not spin axis with precision; high-speed cameras capture bat-ball contact but lose the ball during pitcher-to-plate flight when occluded by the pitcher's body; wearable IMU systems capture limb kinematics but not spatial position relative to the field coordinate frame; and optical ball-tracking systems (Statcast, Hawk-Eye) track the ball externally but cannot resolve bat-ball contact geometry because the contact event occurs within an occlusion zone where the bat obscures the ball from all feasible camera angles. The present invention's cooperative architecture overcomes each of these fragment limitations because the measurement originates from within each object rather than from external observation of each object, and the cooperative spatial mesh between objects resolves inter-object relationships through direct ranging rather than through triangulation from external viewpoints. As with hockey stick integration, bat-originated contact sensing provides event detection capability independent of external camera observation, resolving contact events that occur within timeframes and spatial configurations where line-of-sight observation is fundamentally insufficient.

In a further embodiment, the bat integration methodology extends to a regulation cricket bat, whose multi-substrate construction presents a junction fastener analog not present in single-material baseball bat constructions. A cricket bat comprises a willow blade (the flat striking surface), a cane handle (cylindrical grip section), and a rubber splice junction bonding the handle to the blade through a tapered insertion joint reinforced with twine binding and adhesive. The rubber splice junction constitutes a mechanically active interface between two dissimilar substrate materials—willow and cane—analogous to the junction fastener assemblies disclosed for facemask-to-shell attachment hardware, and is instrumented with TENG-based or piezoelectric-based sensing elements embedded within the rubber splice material during bat manufacture to capture junction deformation data encoding impact force transmission from blade to handle. Conductor routing bridges the splice junction through conductive filaments integrated within the twine binding wrapping, providing electrical continuity between blade-embedded and handle-embedded sensor arrays through the same junction-bridging methodology disclosed for facemask attachment hardware. UWB micro-tag arrays distribute along the blade face and edges using surface-applied or channel-routed conductor geometries consistent with the bat bore methodology disclosed supra, preserving regulatory weight and balance compliance.

The instrumented cricket bat operates within a three-object cooperative spatial mesh comprising the bat, the instrumented cricket ball disclosed supra, and the venue-integrated boundary infrastructure including instrumented crease markings embedded within the pitch surface. This bat-ball-boundary cooperative enables adjudication of leg-before-wicket determinations through simultaneous ball-pad and ball trajectory data, edge detection through bat-ball contact sensing at the blade surface resolving the adjudication question of whether the ball contacted the bat edge before or after contacting the batsman's pad or glove, and run-out determinations through cooperative ranging between the bat's distal tip and the instrumented crease line as the batsman grounds the bat. Each adjudication determination derives from cooperative inter-object data within the Object-Originated Spatial Awareness paradigm rather than from the incumbent third-umpire camera review system, which is subject to frame-rate limitations, occlusion by fielder positioning, and angular ambiguity inherent in two-dimensional projection of three-dimensional contact events.

### Protective Equipment Integration & Contact Rule Adjudication:

### Hard-Shell Protective Equipment Integration

The present invention addresses integration of tracking and contact sensing elements into rigid and semi-rigid protective equipment—thermoplastic helmet and shoulder pad shells, compressible foam padding, and plasticized steel facemasks—whose impact exposure profiles require substrate-specific engineering to preserve both tracking functionality and Physical Compliance under repeated high-G loading. These hard-shell integrations exemplify a capability distinction that no improvement to external observation can replicate: the equipment itself experiences and reports contact events, force magnitudes, and surface-specific impact data that external cameras can only infer—and frequently cannot infer at all when the contact occurs within body-on-body occlusion.

Hard-shell protective equipment occupies a specific position within, constituting the an instrumented layer within the layered calibration stack such as the multi-garment hierarchical confidence architecture disclosed herein. In the representative American football embodiment, the complete layer hierarchy from skin outward comprises: (1) MOCAP turf tape and/or instrumented inner shirt adhered or fitted directly to the athlete's body surface, serving as the highest-confidence body-conformal reference layer; (2) the instrumented long underwear or inner shirt adhered or fitted directly to the athlete's body surface, serving as the body-conformal reference layer receiving highest authority weighting for anatomical position determination by virtue of direct skin-surface adhesion that eliminates intervening air gap and garment-layer displacement; (2) the instrumented long underwear or inner shirt; (3) rigid thermoplastic safety equipment shells—helmet, shoulder pad shells—whose spatial relationship to the underlying anatomy is mediated by the cumulative displacement across all intervening layers; (4) compressible foam padding elements—knee pads, thigh pads, hip pads, rib pads—positioned between the outer uniform and the hard-shell equipment, constituting an intermediate layer subject to compression deformation under impact loading; And (5) the instrumented outer jersey and pants, constituting the deformable textile layer subject to stretch, compression, bunching, and fold deformation.

Each successive layer receives confidence weighting in the hierarchical confidence architecture because each additional layer introduces its own displacement characteristics: the jersey stretches, the foam compresses, the hard shell shifts on its mounting straps, and the cumulative effect is that a tracking element on the outer surface of a shoulder pad shell may be displaced from the underlying shoulder anatomy by a distance substantially exceeding the displacement of any individual layer alone. The AI-driven sensor fusion engine resolves this cumulative displacement through the nested inter-layer transfer functions produced during the sequential “weigh-in” topographical registration protocol: for example, registration phase one establishes the MOCAP turf tape or inner shirt as anatomical ground truth; phase two establishes the foam padding's compression characteristics relative to the jersey; and phase three establishes the hard-shell's displacement characteristics relative to the foam padding beneath it; phase four establishes the outer jersey's deformation characteristics relative to the inner layer. This multi-phase calibration produces a complete skin-to-shell deformation model enabling the sensor fusion engine to reconstruct anatomical ground truth position from any layer's tracking data by applying the successive inter-layer corrections inward toward the body-conformal reference. The multi-layer architecture is particularly significant for shoulder pad integration because shoulder pads exhibit compound displacement modes absent in simpler equipment: the shell pivots on the torso during arm raising, slides laterally during cross-body reaching, and compresses asymmetrically during impact loading—each producing tracking element displacements that do not correspond to underlying shoulder movement and that single-layer instrumentation cannot distinguish from anatomical motion. The hierarchical architecture differentiates the displacement by comparing hard-shell tracking data against the already-registered inner layers beneath it, isolating equipment displacement from body movement with the same inside-to-out differential methodology applied to the inner-garment/outer-jersey hierarchy disclosed in the Dynamic Deformation Tracking section herein. This multi-layer positioning capability is absent from all prior art protective equipment sensor systems, which embed sensors in a single equipment layer and assume that equipment position corresponds to anatomical position—an assumption that fails precisely during the high-impact contact events where adjudication-grade accuracy is most critically required, because impact loading produces the greatest equipment-to-anatomy displacement.

Rigid Shell, Semi-Rigid Shell, and Inner Headgear: For helmet integration, the layer hierarchy is analogous but anatomically specific, and in its fullest preferred embodiment achieves a four-layer depth disclosed for shoulder pad integration, though the cranial hierarchy operates as a multi-layer hierarchical confidence architecture with at least two hierarchically ordered layers, and the four-layer depth represents the preferred embodiment rather than an architectural requirement: (1) MOCAP turf tape applied directly to the skin surface of the cranium, temporal regions, and posterior cervical area, functioning as the skin-adhered body-conformal reference layer receiving the highest confidence weighting for anatomical position determination, identical in construction and operating principle to MOCAP turf tape applied to any other body region as disclosed herein; (2) a sensor-equipped cranial liner garment—comprising, without limitation, a skullcap, Nomex balaclava/hood, flash hood, helmet liner hood, or other head-conforming textile substrate covering some or all of the cranial vault, auricular regions, cervical posterior, and submental or mandibular contour—worn over the MOCAP turf tape and under the helmet interior, functioning as the instrumented inner garment layer analogous to the instrumented inner shirt disclosed for the torso hierarchy, and itself carrying tracking elements emitting timestamped spatial emission data attributed at emission to respective per-element EDIDs, TENG and/or graphene-based contact sensing circuitry, and flexible-substrate conductor integration arrays incorporated into the textile substrate through woven, knitted, printed, bonded, or other flexible-substrate conductor integration methods disclosed herein for jersey and inner shirt fabrication; (3) compressible comfort liner and energy-absorbing foam padding within the helmet interior; and (4) the rigid thermoplastic outer shell. In embodiments where the athlete elects to wear only one inner head-conforming layer without skin-adhered MOCAP turf tape, the cranial liner garment itself constitutes the innermost body-conformal reference layer in a three-layer helmet hierarchy, receiving the highest confidence weighting available absent the skin-adhered substrate; in embodiments where neither MOCAP turf tape nor a full cranial liner garment is worn, a partial-coverage substrate such as a headband, bandana, or adhesive forehead strip may serve as the innermost reference, with correspondingly reduced cranial coverage and reduced spatial confidence relative to the full preferred four-layer embodiment. The cranial liner garment embodiment is particularly significant because it extends the body-conformal inner reference layer to the cervical spine and jaw regions—anatomical zones that a skullcap or adhesive tape limited to the cranial vault cannot instrument—thereby enabling the system to track neck flexion, extension, rotation, and lateral bending independently of helmet shell displacement, a capability critical for cervical injury mechanism analysis and for adjudicating contact fouls where the rules question involves not only head position but head-to-neck angular relationship at the moment of impact.

The helmet layered calibration establishes correspondence between the skullcap-conformal inner reference, the padding compression characteristics under simulated impact loading, and the outer shell displacement relative to the skull across the full range of head rotation, flexion, extension, and lateral movement (see FIG. 11). This layered helmet model enables the system to report both the true three-dimensional position and orientation of the athlete's head (derived from the inner reference layer through inter-layer corrections) and the position and orientation of the helmet shell surface independently—a distinction critical for targeting foul adjudication where the rules question is which portion of the player's head initiated contact, not which portion of the helmet shell was closest to the opponent, and where helmet displacement during the collision itself can alter the spatial relationship between the shell surface and the underlying cranium. The inside-to-out layered calibration methodology disclosed herein is the architectural prerequisite for this distinction because no single-layer helmet sensor system can independently measure helmet-to-skull displacement—it can only assume positional correspondence and accept the resulting error (see FIG. 7).

### Compressible Foam Padding Integration and Real-Time Compression State Measurement:

Foam padding substrates—knee pads, thigh pads, hip pads, rib pads, helmet interior padding, and shoulder pad cavity padding—compress substantially under load, requiring compression-tolerant conductor geometries: serpentine routing perpendicular to the compression axis absorbs dimensional change through geometric reconfiguration; helical routing around foam perimeters compresses axially while maintaining circumferential continuity. These geometries maintain electrical continuity through repeated compression-decompression cycles that would fracture conventionally-routed conductors. Foam-conductor co-molding, wherein conductors are positioned within the mold cavity prior to closed-cell or open-cell foam expansion and curing, encapsulates the conductive elements within the foam matrix as intrinsic structural constituents, providing environmental sealing and mechanical protection without separate lamination or adhesive bonding.

Beyond maintaining conductor continuity through compression, the instrumented foam padding layer within the multi-garment hierarchical confidence architecture disclosed herein provides a measurement output that is unique among all layers in the hierarchy and that no other layer, and no external observation system, can produce: real-time quantification of foam compression magnitude, compression rate, compression spatial distribution, and compression recovery characteristics during and following impact loading events. In every other layer of the hierarchical architecture—the body-conformal inner reference layer, the deformable textile outer uniform, the rigid thermoplastic shell—layer deformation is treated as positional noise to be corrected through inter-layer transfer functions in order to reconstruct anatomical ground truth. Foam padding compression is also corrected for positional purposes through the same inter-layer methodology; however, the compression data itself constitutes an independently valuable measurement output because the magnitude, rate, and spatial distribution of foam compression during an impact event is a direct, quantified measurement of impact energy absorption by the protective equipment—data that determines whether the equipment is functioning within its certified energy absorption design envelope. This dual role—the foam layer simultaneously serving as a positional-noise source to be corrected through hierarchical inter-layer computation AND as an independent energy absorption measurement source whose compression data is a primary output rather than an artifact to be eliminated—is architecturally unique to the foam padding layer and exemplifies the dual-output capability of the multi-garment hierarchical confidence architecture at the individual-layer level rather than merely at the system level.

The real-time foam compression measurement is inherently a multi-layer measurement that no single-layer sensor system can replicate. Measuring true foam compression magnitude during an impact event requires simultaneously determining the position of tracking elements on the outer face of the foam substrate and the position of the body-conformal reference layer or adjacent inner garment layer beneath the foam's inner face, and computing the change in inter-layer distance during the transient loading event. A single accelerometer embedded within a foam pad—the approach employed in all prior art helmet and padding sensor systems—measures the acceleration experienced at the sensor's location within the foam but cannot independently measure how much the foam actually compressed in response to that acceleration, because a single measurement point within a compressing medium cannot distinguish between whole-pad translational displacement and internal compression without an independent reference. The multi-layer architecture disclosed herein provides that independent reference: the body-conformal inner layer beneath the foam reports its position continuously, the outer surface of the foam (or the rigid shell overlying it) reports its position continuously, and the AI-driven sensor fusion engine computes the compression state as the inter-layer distance differential relative to the registered uncompressed baseline established during the sequential “weigh-in” protocol. This compression measurement capability enables several operationally significant outputs unavailable to any prior art system: first, real-time determination of whether a specific impact event exceeded the foam padding's rated energy absorption capacity, indicating potential equipment failure requiring immediate inspection or replacement; second, cumulative tracking of foam compression-recovery cycles to detect progressive degradation in foam resilience—closed-cell foams exhibit measurable loss of recovery height after repeated compression loading, and the system detects this degradation as a progressive decrease in inter-layer distance recovery to calibrated baseline, triggering equipment retirement alerts before the padding's energy absorption capacity falls below certification thresholds; third, spatial mapping of compression distribution across the foam surface during impact, distinguishing focal-point loading (where a concentrated area of the foam receives maximum compression) from distributed loading (where compression is spread across a broader area), a distinction critical for concussion protocol determinations where focal-point cranial loading produces different injury risk profiles than distributed loading at equivalent total force; and fourth, in the cross-domain occupant body-state monitoring applications disclosed in the Impact Force Measurement, Occupant Body-State Monitoring, and Cross-Domain Diagnostic Applications section herein, detection of foam “bottoming out”—the condition where foam compression reaches the substrate's maximum deformation capacity and residual impact energy transmits directly to the occupant's anatomy without further attenuation—which is the primary mechanism of padding-failure traumatic injury in both athletic and military/motorsport helmets and which no external observation system or vehicle telemetry system can detect because the foam's internal compression state is entirely invisible from outside the helmet shell.

### Thermoplastic Shell & Compression-State Foam Padding Integration:

Helmet and shoulder pad shells manufactured from injection-molded polycarbonate or ABS accommodate conductor integration through in-mold embedding wherein conductive arrays are encapsulated within the thermoplastic matrix during forming, or through inter-layer lamination positioning conductors between structural shell and comfort liner. Thermoplastic shell integration, together with the compressible foam padding integration described below, enables detection of the “targeting” foul—illegal use of the helmet crown to initiate contact with an opponent's head or neck—and medical diagnostic information for the Concussion Protocol that is orders of magnitude superior to conventional technology. External camera observation can show that helmet-to-helmet contact occurred but cannot quantify the forces or locality of the impact with the granularity a multi-layer, hierarchically diagnosed, assembly can.

### Facemask Attachment Hardware Integration and Inter-Layer Junction Instrumentation:

The facemask cage of a protective helmet is connected to the thermoplastic shell at a plurality of discrete attachment points—typically three to five per helmet in American football embodiments, comprising lateral jaw-level positions on each side of the shell and one or more forehead-level positions—by means of dedicated attachment hardware components collectively referred to herein as junction fastener assemblies. Junction fastener assemblies in conventional (non-instrumented) helmets comprise, without limitation, C-clips, U-clips, loop straps, retainer clips, quick-release pin mechanisms, T-nuts, screws, snap fasteners, quarter-turn fasteners, channel-and-projection interlocking systems, or any combination thereof, depending on helmet manufacturer and model. These junction fastener assemblies are structurally and functionally distinct from every other component in the helmet assembly: they are not the rigid thermoplastic shell (which is a continuous enclosing structure); they are not the facemask bars (which are continuous rigid projecting structural members); they are not the compressible foam padding (which is a continuous interior energy-absorbing volume); and they are not the cranial liner garment or body-conformal reference substrates (which are inner textile or adhesive layers conforming to anatomical surfaces). The junction fastener assembly is the only component in the helmet assembly whose primary mechanical function is controlled elastic deformation at a discrete junction point between two independently rigid structural members—the facemask cage and the thermoplastic shell—absorbing and distributing impact forces transmitted between those members during collision events.

In conventional helmet design, the junction fastener assemblies are passive mechanical components performing a single function: structural attachment. In the instrumented embodiment disclosed herein, each junction fastener assembly is configured as a multi-functional active component performing up to four simultaneous functions: (a) structural attachment of the facemask cage to the thermoplastic shell; (b) inter-layer mechanical stress-state characterization measuring the magnitude, rate, direction, and spatial distribution of relative displacement between the facemask cage and the shell at each attachment point during impact and contact events, said relative displacement being the physical expression of compressive stress loading during impact events and tensile stress loading during grasping events at said inter-member mechanical interface; (c) kinetic energy harvesting, converting the mechanical energy of junction deformation into electrical energy available for powering sensing, computing, and communication electronics within the helmet assembly and across the broader Performer Spatial Assembly; and (d) electrical conductor bridging, routing power, data, and sensor signal conductors between the multi-channel facemask bar conductor assemblies disclosed herein and the conductor arrays embedded within or laminated to the thermoplastic shell, thereby establishing electrical continuity across the facemask-to-shell mechanical interface without requiring separate external wiring harnesses or breakout connectors that would be visible, vulnerable to damage, or non-compliant with equipment appearance regulations.

The inter-layer mechanical stress-state characterization function exploits the fact that every impact event involving the facemask cage produces measurable relative displacement between the facemask and the shell at the attachment points. During a frontal impact to the facemask bars, the bars deflect inward, the junction fastener assemblies deform under the transmitted load, and the shell locally deflects at the attachment apertures. During a facemask grasping event (the “facemask” penalty in American football), the junction fastener assemblies experience outward tensile loading as the opposing player pulls the cage away from the shell—a directionally opposite deformation signature from an inward-directed impact. This directional distinction, measurable only at the attachment hardware, provides a supplemental facemask penalty detection modality independent of the TENG contact pattern sensing on the facemask bars themselves: inward compressive deformation at the junction correlates with impact events, while outward tensile deformation at the junction correlates with grasping events, and the deformation direction is determinable from the polarity and phase relationship of the sensing elements within the junction fastener assembly. Lateral, torsional, and oblique deformation patterns at the junction fastener assemblies further enable determination of impact vector direction relative to the helmet's geometric axis, because an impact arriving from the left lateral direction produces asymmetric deformation across the left-side and right-side junction fastener assemblies that an impact arriving from the frontal midline does not.

The junction fastener assembly deformation measurement is inherently a multi-layer measurement analogous to the foam compression measurement disclosed supra, and like the foam compression measurement, it is producible only within a multi-layer instrumented architecture where the layers on both sides of the deforming junction—the facemask conductor assemblies and the shell conductor arrays—report their respective positions simultaneously within a shared coordinate reference frame. A single accelerometer mounted on the facemask cage, or a single accelerometer mounted on the shell, cannot independently measure the facemask-to-shell relative displacement at the junction point, because each accelerometer reports only its own acceleration without an independent reference for the other member's simultaneous position. The junction deformation measurement requires concurrent position data from both the facemask-side and shell-side instrumented layers and computes the inter-member displacement as the differential between them—a computation that depends architecturally upon the multi-layer hierarchical confidence system disclosed herein and that cannot exist in any single-layer helmet sensor system regardless of the sophistication of the individual sensors populating that single layer.

Sensing modalities suitable for integration within the junction fastener assembly include, without limitation: TENG-based (Triboelectric Nanogenerator) sensing elements positioned at contact-separation interfaces within the junction, generating charge proportional to deformation magnitude and rate; piezoelectric sensing elements (such as PVDF polymer film, PZT ceramic elements, or piezoelectric fiber composites) bonded to or embedded within the deforming structural body of the clip, strap, or retainer; strain gauge arrays (resistive foil, semiconductor, or optical fiber Bragg grating) measuring strain distribution across the junction fastener body during loading; capacitive gap sensors measuring the distance between conductive surfaces on the facemask side and the shell side of the junction; piezoresistive polymer or elastomer elements whose electrical resistance changes as a function of compressive or tensile deformation; magnetostrictive or magnetoelastic elements whose magnetic permeability changes under mechanical stress, detectable by adjacent pickup coils; or any combination of these or functionally equivalent transduction modalities. The specification of multiple alternative sensing technologies is deliberate and reflects the technology-agnostic architectural principle established throughout this disclosure: the junction deformation measurement function is defined by its position within the multi-layer hierarchy (at the inter-member mechanical interface) and its computational role (providing inter-member displacement data to the sensor fusion engine), not by the specific transduction technology employed at any given attachment point.

The kinetic energy harvesting function of the junction fastener assembly exploits the same mechanical deformation events that produce sensing data. Because TENG and piezoelectric transduction mechanisms generate electrical charge as an intrinsic consequence of mechanical deformation, and because the junction fastener assemblies undergo repeated deformation cycles during operational use—not only during major impact collisions but during routine facemask vibration, head-turning movements that shift the facemask against the shell, incidental contact during play, and ambient mechanical loading transmitted through the cage structure—the sensing elements within the junction inherently produce harvestable electrical energy concurrent with their sensing function. This dual-output characteristic—simultaneous sensing data and harvestable energy from the same deformation event at the same transduction element—means that energy harvesting at the junction fastener assembly is not an additional component added to the sensing architecture but an emergent capability of the sensing architecture itself: the same TENG layer that detects junction deformation magnitude also generates charge that, when rectified and stored through power management circuitry, contributes to the electrical energy budget available for powering the helmet's computing, communication, and sensing electronics (see FIG. 12).

The electrical conductor bridging function addresses a practical engineering challenge specific to the facemask-to-shell interface: the facemask bar multi-channel conductor assemblies terminate at the bar ends, and the shell-embedded conductor arrays are encapsulated within or laminated to the thermoplastic matrix, and these two conductor networks must be electrically interconnected across a mechanical junction that is designed to deform. Conventional rigid electrical connectors (pin-and-socket, board-to-board, or hermetic feed-through assemblies) are unsuitable for this application because they cannot accommodate the repeated elastic deformation of the junction without fatigue failure of the connector contacts. The instrumented junction fastener assembly addresses this by incorporating flexible, deformation-tolerant conductor paths—such as serpentine-routed traces on flexible printed circuit substrates, helically wound micro-coaxial conductors, conductive elastomer interconnects, or spring-loaded pogo-pin arrays with sufficient travel to accommodate junction deformation range—within the body of the clip, strap, or retainer element. These conductor paths maintain electrical continuity between the facemask-side and shell-side conductor networks throughout the full range of junction deformation encountered during operational use, including repeated high-rate impact deformation cycles. In embodiments where the junction fastener assembly incorporates TENG or piezoelectric elements, the harvested energy conductors and the bridging signal conductors may share a common flexible circuit substrate, further reducing the component count and assembly complexity at each attachment point.

The multi-functional junction fastener assembly is visually indistinguishable from its conventional non-instrumented counterpart when installed on the helmet, satisfying the Visual Concealment Strategy requirements disclosed herein. The external dimensions, surface finish, color, and attachment geometry of the instrumented junction fastener assembly match those of the standard manufacturer-specified attachment hardware for the applicable helmet model, such that no opposing team, broadcast camera, official, or spectator can determine by visual inspection whether a given helmet's facemask attachment hardware is instrumented. In embodiments employing manufacturer-specific attachment systems (including, without limitation, Riddell Quick Release pin mechanisms, Schutt quarter-turn fastener systems, channel-and-projection interlocking systems, or any functionally equivalent proprietary or standardized attachment methodology), the instrumented junction fastener assembly is designed to be mechanically interchangeable with the non-instrumented original equipment manufacturer component, requiring no modification to the helmet shell attachment apertures, the facemask bar termini, or the NOCSAE-certified mechanical performance characteristics of the attachment system.

### Distributed Kinetic Energy Harvesting Architecture:

The kinetic energy harvesting capability disclosed for the junction fastener assemblies supra is one node within a broader distributed kinetic energy harvesting architecture that extends across all mechanically active layers and components of the instrumented helmet assembly and, by architectural extension, across the complete instrumented equipment ensemble constituting the Performer Spatial Assembly. The distributed kinetic energy harvesting architecture is an inherent emergent capability of the multi-layer hierarchical confidence architecture disclosed herein, arising from the fact that each instrumented layer undergoes mechanical deformation during operational use and that the TENG-based and/or piezoelectric-based sensing elements integrated into each layer for contact detection, deformation measurement, or position sensing purposes simultaneously produce harvestable electrical charge as an intrinsic byproduct of their transduction mechanism.

Within the helmet assembly, kinetic energy harvesting nodes include, without limitation: (a) the junction fastener assemblies at facemask-to-shell attachment points, harvesting energy from junction flexion, compression, tension, and torsion as disclosed supra; (b) the TENG sensing elements within the facemask bar multi-channel extrusion profiles, harvesting energy from bar-to-bar contact events, facemask vibration, and bar flexion during impact loading; (c) the TENG and/or graphene-based sensing elements embedded within or laminated to the thermoplastic shell, harvesting energy from shell vibration, shell flexion at impact sites, and shell-to-padding friction during relative displacement events; (d) the TENG and/or piezoelectric sensing elements integrated within the compressible foam padding layers through the serpentine, helical, and co-molded conductor geometries disclosed herein, harvesting energy from the repeated compression-decompression cycles that the foam undergoes during both impact events and routine wearing; (e) the TENG and/or graphene-based sensing elements within the cranial liner garment (balaclava, skullcap, or equivalent head-conforming textile substrate), harvesting energy from the friction between the liner and the foam padding interior surface and between the liner and the MOCAP turf tape or skin surface during head movement; and (f) the chin strap assembly, whose dynamic tension fluctuations during jaw movement, head turning, and impact-induced helmet displacement produce harvestable mechanical energy through textile-integrated TENG elements or strap-embedded piezoelectric elements.

Each harvesting node contributes its generated charge to a common power management bus within the helmet assembly. The power management bus incorporates rectification circuitry converting the alternating-polarity charge output of TENG and piezoelectric elements into direct-current energy suitable for storage, energy storage elements (including, without limitation, thin-film solid-state batteries, printed micro-supercapacitors, or flexible supercapacitor arrays integrated into the helmet liner or shell interior surface), and voltage regulation circuitry supplying stable operating voltage to the helmet's UWB positioning tags, TENG/graphene sensing readout electronics, local processing and data bus controllers, and wireless communication transceivers. The distributed topology of the harvesting architecture ensures that no single harvesting node bears sole responsibility for powering the helmet electronics; rather, the aggregate energy contribution from all nodes across all layers provides the requisite power budget, with the relative contribution of each node varying dynamically as a function of activity intensity—during periods of high physical contact, junction fastener and foam compression harvesting nodes contribute disproportionately; during periods of active head movement without contact, cranial liner friction and chin strap tension harvesting nodes contribute disproportionately; during facemask-specific contact events, the facemask bar TENG nodes contribute disproportionately. This activity-responsive energy generation profile is architecturally self-balancing: the conditions that demand the most sensing and communication activity (high-contact play requiring real-time adjudication data) are the same conditions that generate the most harvestable mechanical energy across the distributed harvesting network.

The distributed kinetic energy harvesting architecture extends beyond the helmet assembly to all instrumented equipment items within the Performer Spatial Assembly. Shoulder pad assemblies incorporate harvesting-capable sensing elements at structurally analogous junction points: the fastener and hinge assemblies connecting the front and rear shell halves of the shoulder pad, the strap and buckle assemblies connecting the shoulder pad to the torso, and the lacing or elastic connectors at the lateral edges of the shell—each of which undergoes repeated elastic deformation during blocking, tackling, and general athletic movement. The compressible foam elements within the shoulder pad interior (clavicle padding, deltoid caps, rib pad inserts) provide foam-compression harvesting nodes identical in operating principle to those disclosed for the helmet foam layer supra. The rigid thermoplastic shoulder pad shell itself provides vibration and flexion harvesting through shell-embedded TENG or piezoelectric elements, analogous to the helmet shell harvesting nodes. The instrumented outer jersey worn over the shoulder pads provides textile-friction harvesting from the relative movement between the jersey fabric and the underlying hard-shell surfaces during athletic motion.

Instrumented gloves—including, without limitation, American football receiver gloves, goalkeeper gloves, baseball batting gloves, hockey gloves, lacrosse gloves, boxing gloves, and combat sport hand wraps—provide kinetic energy harvesting through the TENG-based and graphene-based sensing layers already integrated into the glove construction for contact detection and hand-position sensing purposes as disclosed herein. The palmar surface, dorsal surface, and inter-digital web regions of the glove undergo continuous mechanical flexion, compression, friction, and contact-separation events during gripping, catching, throwing, blocking, and striking motions. These deformation events are the same events that the integrated TENG and graphene sensing layers are designed to detect and measure, and the electrical charge generated as a byproduct of that detection is harvestable through the same power management circuitry employed in the helmet distributed harvesting architecture. In glove embodiments where the wrist-mounted computing hub aggregates finger-level sensing data, the harvested energy from glove-integrated TENG and graphene elements is routed to the wrist hub's energy storage elements, contributing to the power budget for the hub's computing, communication, and data aggregation functions. The continuous high-frequency mechanical activity of the hands during athletic performance—particularly in sports requiring constant grip modulation, ball handling, and manual dexterity—produces a sustained energy harvesting output that may, in activity-intensive periods, meet or exceed the power requirements of the wrist-mounted computing hub without supplementary battery power.

Instrumented footwear, instrumented kneepads and elbowpads, instrumented hip pads, and instrumented protective cups each contribute additional harvesting nodes through the same architectural principle: the TENG, graphene, and/or piezoelectric sensing elements already present for contact sensing and deformation measurement inherently generate harvestable energy concurrent with their sensing function, and this energy is captured, rectified, stored, and distributed through local power management circuitry within each equipment item. The aggregate energy harvested across the complete Performer Spatial Assembly—comprising all instrumented equipment items worn by a single athlete—constitutes a whole-body distributed kinetic energy harvesting system whose total energy output is proportional to the athlete's cumulative mechanical activity across all body regions and equipment layers.

The distributed kinetic energy harvesting architecture disclosed herein is distinguished from prior art single-point energy harvesting systems (such as a discrete piezoelectric patch mounted on a helmet shell, or a sole-embedded piezoelectric generator in footwear) by the combination of: (a) harvesting from a plurality of mechanically active layers and junction points distributed across multiple equipment items rather than from a single harvesting device at a single location; (b) harvesting as an emergent byproduct of sensing elements whose primary function is contact detection, deformation measurement, or spatial position determination, rather than from dedicated harvesting devices whose sole purpose is energy generation; (c) integration within a multi-layer hierarchical confidence architecture wherein each harvesting node occupies a defined position in the layer hierarchy and the harvested energy supports the computational and communication functions of that same hierarchy; and (d) activity-responsive self-balancing energy generation wherein the harvesting output increases in proportion to the operational demands requiring that energy, because the mechanical events producing harvestable energy are the same mechanical events requiring sensing, computation, and communication resources. No prior art protective sports equipment energy harvesting system exhibits this combination of characteristics because no prior art system possesses the multi-layer instrumented hierarchical architecture from which the distributed harvesting capability architecturally emerges.

The distributed kinetic energy harvesting architecture disclosed supra converges with the conductor routing geometries and spatial deformation measurement capabilities disclosed throughout this specification to establish a triple-function unification principle applicable to all instrumented equipment substrates: each conductor routing geometry—whether serpentine, zig-zag, spiral, or any topological variant thereof—simultaneously performs three architecturally inseparable functions within a single physical structure. First, the conductor geometry routes electrical signals and data between nodes, performing its primary function as an interconnection pathway within the four-tier hierarchical tracking architecture. Second, the same conductor geometry, instrumented with position-sensitive elements at periodic reference nodes along its path, generates vector data encoding the three-dimensional spatial configuration of the substrate surface it traverses—each conductor path constitutes a vector whose endpoints and intermediate reference nodes define a directed spatial element, and the aggregate of conductor-path vectors distributed across an equipment surface produces a sparse vector wireframe representation of the three-dimensional sculptural surface of that equipment item at each measurement epoch. Third, the same conductor geometry, composed of TENG-capable, piezoelectric-capable, or graphene-based transduction filaments as disclosed herein, generates harvestable electrical charge during the mechanical deformation events that it is simultaneously measuring, contributing to the distributed energy harvesting architecture without requiring any dedicated harvesting structure beyond the sensing conductor itself.

For zig-zag conductor routing geometries specifically, the apexes of each zig-zag period constitute spatially fixed reference nodes whose inter-node distances in the undeformed calibration state provide a triangulated measurement baseline. When the underlying substrate deforms during athletic activity, the triangle edge lengths defined by adjacent zig-zag apexes change in determinable patterns that encode the magnitude, direction, and spatial distribution of the deformation event. For spiral and concentric conductor routing geometries, height variations along the spiral path relative to the substrate plane create measurable micro-distances between adjacent reference points along the conductor; these micro-distances chart the three-dimensional surface topography of the equipment panel traversed by the spiral, and substrate deformation alters the topographical profile in a measurable manner correlated to the deformation magnitude and direction. In each case, the manufacturing pattern deposited during normal garment or equipment construction is simultaneously the measurement architecture deployed during operational use—no additional measurement infrastructure beyond the conductor geometry itself is required, and no modification to the conductor geometry beyond what is required for signal routing and energy harvesting is necessary to achieve the spatial measurement function. This triple-function unification—conductor routing, spatial deformation measurement, and kinetic energy harvesting performed simultaneously by a single physical structure installed during normal manufacturing—is architecturally unique to the multi-layer cooperative system disclosed herein, because no prior art system possesses the hierarchical layer architecture within which the triple-function capability operates, and no prior art single-layer smart garment or single-component smart equipment item achieves the cooperative inter-object spatial mesh from which the vector wireframe acquires adjudicative meaning.

The term “hierarchically diagnosed” as used herein refers to the methodology whereby concussion-relevant impact characteristics—including anatomical skull position and orientation at the moment of contact, foam padding compression magnitude and spatial distribution across the impact surface, helmet shell displacement relative to the underlying cranium, and impact surface identification distinguishing crown contact from lateral or facemask contact—are derived not from any single sensor or single equipment layer but from the inter-layer differential computations across the full cranial layer hierarchy disclosed herein, each layer contributing a diagnostically distinct data stream that acquires clinical meaning only through correlation with the data streams from the other layers within the calibrated multi-layer assembly. This hierarchically diagnosed capability bridges directly to the occupant body-state monitoring applications disclosed in the preceding section, wherein the same inter-layer diagnostic methodology applied to a military flight helmet or motorsport crash helmet produces incapacitation detection and foam performance monitoring outputs that cockpit-mounted cameras and vehicle telemetry systems cannot produce for the same architectural reasons that sideline cameras and conventional single-layer helmet sensors cannot produce concussion-grade diagnostic data in the athletic context.

### Plasticized Steel Facemask Integration:

Facemasks present the harshest integration environment, with the plasticoat layer (1-3 millimeters) experiencing direct bar-to-bar impact and repeated flexion. Integration approaches include plasticoat-embedded conductors positioned between steel substrate and outer surface, and internal hollow bar routing through tubular bar stock providing maximum mechanical protection. Given high conductor damage probability, redundant conductive paths ensure continued operation when individual paths fail, with degradation monitoring enabling replacement before tracking capability falls below adjudication-grade thresholds.

Facemask integration enables detection of the “facemask” penalty—illegal grasping of an opponent's facemask. Contact sensing elements detect the pressure signature and spatial pattern characteristic of hand grasping, distinguishing illegal grasping from incidental contact. Correlation with hand and glove tracking identifies the specific player and hand responsible—a determination that camera observation frequently cannot make when multiple hands contact the facemask region simultaneously.

In a preferred embodiment, the facemask bar stock is manufactured using a custom extrusion die that produces a multi-channel cross-sectional profile rather than a conventional solid round or single-hollow tubular geometry. Specifically, the extrusion profile comprises a solid structural core surrounded by a plurality of longitudinal channels—in one embodiment, four circular channels arranged in a symmetrically distributed pattern about the central axis of the bar. Each channel extends the full operational length of the facemask bar segment and is dimensioned to accommodate one or more sensor conductor filaments, micro-coaxial transmission lines, or TENG/graphene-based sensing elements. The channels are separated from one another and from the outer surface of the bar by structural walls of sufficient thickness to maintain the mechanical integrity required for protective sports equipment compliance under applicable governing body standards (including, without limitation, NOCSAE impact attenuation requirements for American football facemasks).

Because the creation of internal channels necessarily reduces the load-bearing cross-sectional area of the bar, the multi-channel extrusion profile may employ alloy compositions having higher yield strength, ultimate tensile strength, or both, relative to the carbon steel compositions (such as SAE 1050 through SAE 1065) conventionally used in facemask bar stock. Suitable higher-strength alloy compositions include, without limitation: chromium-molybdenum alloy steels (such as AISI 4130 or AISI 4140), precipitation-hardened stainless steels (such as 17-4PH or 15-5PH), maraging steels, titanium alloys (such as Ti-6Al-4V), or nickel-chromium-molybdenum alloys. The selection of alloy composition is governed by the requirement that the multi-channel bar exhibit equivalent or superior deflection resistance, fatigue life, and impact absorption characteristics relative to a conventional solid-cross-section carbon steel bar of the same outer diameter, such that the instrumented facemask satisfies all applicable safety certification standards without requiring modification to helmet attachment hardware or facemask geometric form factor.

The multi-channel geometry enables functional segregation of conductor types within the facemask bar. In one embodiment, a first channel carries TENG-based tactile sensor filaments for contact and grasp detection; a second channel carries graphene-based capacitive sensor conductors for proximity detection through the plasticoat layer; a third channel carries UWB micro-coaxial transmission lines or miniaturized antenna feed elements for spatial position reporting; and a fourth channel carries power distribution conductors and digital data bus lines interconnecting sensor nodes distributed along the facemask bar length. This functional segregation reduces electromagnetic cross-talk between sensing modalities, prevents mechanical damage to one conductor type from propagating to others, and enables independent replacement or upgrade of individual conductor assemblies without requiring complete bar replacement.

At each terminus of a facemask bar segment, a sealed multi-port connector assembly provides environmental isolation and electrical interconnection between the conductor assemblies within the bar channels and the processing electronics housed elsewhere within the helmet assembly (such as within the helmet shell, padding cavities, or chin strap housing). The connector assembly employs moisture-resistant sealing (such as O-ring compression seals, potting compounds, or heat-shrink encapsulation) to prevent perspiration, precipitation, and cleaning solution intrusion into the channel lumens during operational use. Where facemask bars are joined at welded or bolted intersection nodes, the conductor assemblies are routed through the intersection via sealed junction housings that maintain channel-to-channel segregation and provide strain relief against the mechanical loads transmitted through the bar-to-bar connection points.

The multi-channel extrusion profile is visually indistinguishable from conventional solid-round facemask bar stock when the plasticoat polymer coating is applied to the outer surface, because the channels are entirely internal to the bar and the outer diameter, surface finish, and coating characteristics remain identical to those of non-instrumented facemask bars. This visual indistinguishability satisfies the concealment requirements established in the Visual Concealment Strategy described herein, and prevents opposing teams, broadcast cameras, or spectators from identifying which equipment items are instrumented.

The multi-channel facemask bar integration described herein is distinguished from medical multi-lumen catheter tubing, industrial multi-bore cable conduit, and bicycle handlebar internal cable routing by the combination of: (a) compliance with protective sports equipment impact certification standards requiring resistance to repeated high-velocity collisions; (b) functional segregation of heterogeneous sensing modalities (triboelectric, capacitive, radio-frequency, and power/data) within a single structural member; (c) alloy composition selection specifically optimized for the trade-off between structural cross-section reduction and mechanical performance maintenance; and (d) integration within a complete Object-Originated Spatial Awareness tracking architecture wherein the facemask conductors participate in generating position data from the tracked object itself rather than serving as passive markers observed by external sensors.

### Multi-Channel Extrusion Profile for Rigid Tubular Structural Members

The preceding equipment integration embodiments describe sensor and conductor embedding within flexible, compressible, laminated, and thermoplastic substrates. A distinct class of sporting equipment and venue infrastructure components presents a fundamentally different integration challenge: rigid tubular structural members composed of metallic alloys, where the member simultaneously serves a structural load-bearing function, defines a regulatory boundary or adjudication surface, and must accommodate embedded sensing and communication conductors without alteration to its external dimensional profile, surface finish, or mechanical certification status. Examples of such rigid tubular structural members include, without limitation: American football helmet facemask bars, basketball rim tubing, soccer and football goalpost uprights and crossbars, hockey goal frame tubing, lacrosse goal frame tubing, handball goal frame tubing, tennis net post tubing, volleyball net post tubing, rugby goalpost uprights and crossbars, and any other rigid metallic tubular member that defines or participates in a boundary, scoring zone, or contact adjudication surface within a field or court of play.

General Principle of Multi-Channel Extrusion Integration: Rather than routing sensor conductors through a single hollow core (as in conventional tubular bar stock) or applying conductors exclusively to an external coating layer (as in the plasticoat-embedded approach described supra), the present invention discloses a purpose-engineered extrusion die that produces bar or tube stock having a multi-channel cross-sectional profile. The multi-channel profile comprises a solid or substantially solid structural core material surrounding a plurality of longitudinal channels, each channel extending the full operational length of the structural member segment and each channel being dimensioned to accommodate one or more sensor conductor filaments, micro-coaxial transmission lines, optical fibers, TENG-based sensing elements, graphene-based capacitive sensing elements, or power and data bus conductors.

The number, diameter, angular distribution, and radial position of the longitudinal channels within the cross-section are determined as a function of at least the following design parameters: (a) the outer diameter of the structural member as specified by the applicable governing body's equipment or facility standards; (b) the minimum structural wall thickness required to maintain equivalent or superior mechanical performance (yield strength, ultimate tensile strength, fatigue life, impact absorption, deflection resistance) relative to a conventional solid or single-hollow member of the same outer diameter and conventional alloy composition; (c) the number of functionally distinct conductor types requiring segregated routing; (d) the sensor density and spatial resolution required for the specific adjudication application; and (e) the alloy composition selected to compensate for the cross-sectional area reduction caused by the channel voids.

Because the creation of longitudinal channels necessarily reduces the net load-bearing cross-sectional area of the structural member, the multi-channel extrusion profile may employ alloy compositions having higher yield strength, higher ultimate tensile strength, or both, relative to the alloy compositions conventionally used for the same structural member in its non-instrumented form. The invention does not require any single specific alloy; rather, the alloy selection principle is that the instrumented multi-channel member must exhibit mechanical performance at least equivalent to the non-instrumented conventional member under all applicable certification test protocols. Exemplary higher-strength alloy compositions suitable for this purpose include, without limitation: chromium-molybdenum alloy steels (such as AISI 4130 or AISI 4140), precipitation-hardened stainless steels (such as 17-4PH, 15-5PH, or Custom 455), maraging steels (such as 18Ni-250 or 18Ni-300 grade), titanium alloys (such as Ti-6Al-4V or Ti-3Al-2.5V), nickel-chromium-molybdenum alloys (such as Inconel 718), or duplex stainless steels (such as SAE 2205). Where the conventional non-instrumented member is manufactured from aluminum alloy (as is common in soccer goalposts), suitable higher-strength aluminum compositions include 7075-T6, 7050-T7451, or 2024-T3 series alloys. The foregoing alloy examples are illustrative and not limiting; any alloy composition that satisfies the equivalent-or-superior mechanical performance criterion for the specific structural application falls within the scope of this disclosure.

Functional Channel Segregation: The multi-channel geometry enables functional segregation of heterogeneous conductor types within a single structural member. In embodiments where four channels are provided (suitable for smaller-diameter members such as facemask bars and basketball rim tubing), the channel allocation may be configured as follows: a first channel carrying TENG-based tactile sensor filaments for direct contact detection; a second channel carrying graphene-based capacitive sensor conductors for proximity detection and through-coating sensing; a third channel carrying UWB micro-coaxial transmission lines or miniaturized antenna feed elements for active spatial position reporting; and a fourth channel carrying power distribution conductors and digital data bus lines interconnecting sensor nodes distributed along the member length. This functional segregation reduces electromagnetic cross-talk between sensing modalities, prevents mechanical damage to one conductor type from propagating to adjacent conductor assemblies, and enables independent replacement or upgrade of individual conductor types without requiring replacement of the entire structural member.

In embodiments where larger-diameter structural members provide sufficient cross-sectional area to accommodate a greater number of channels (such as six, eight, ten, twelve, or more channels), the additional channels may be allocated to provide increased sensor density, redundant conductor paths for fault tolerance, circumferential contact localization capability, or dedicated channels for additional sensing modalities such as optical fiber Bragg grating strain sensors, piezoelectric vibration sensors, or temperature monitoring elements.

Variable Channel Count Scaling Principle: The channel count is not fixed but scales as a function of the structural member diameter, the available cross-sectional area after maintaining minimum structural wall thickness, and the sensor density requirements of the specific adjudication application. This variable channel count principle is formalized as follows: for structural members having an outer diameter of less than approximately 20 millimeters (such as facemask bars), a minimum of two and a preferred maximum of four channels are provided; for structural members having an outer diameter of approximately 20 to 60 millimeters (such as basketball rim tubing), four to six channels are provided; for structural members having an outer diameter of approximately 60 to 130 millimeters (such as soccer goalpost uprights and crossbars conforming to FIFA Laws of the Game specifying a maximum diameter of 120 millimeters), six to twelve or more channels are provided. The foregoing diameter-to-channel-count ranges are preferred embodiments and not absolute limitations; the design principle is that available internal volume scales with the square of the diameter while structural wall thickness requirements scale linearly, yielding progressively greater channel capacity as member diameter increases.

Circumferential Contact Localization: In embodiments where the channel count is sufficient to distribute sensor conductor filaments at known angular positions around the circumference of the tubular structural member (typically six or more channels distributed at approximately equal angular intervals), the system achieves circumferential contact localization capability. When a game ball or player body part contacts the structural member, the specific subset of channel-resident sensors that register the contact event, combined with the relative signal amplitudes across the activated channels, reveals the angular position on the member circumference where contact occurred. This circumferential contact localization enables the system to distinguish between contact events occurring on the inside face of the member (facing the playing area or goal interior), the outside face (facing away from the playing area), the top surface, or the bottom surface of the member. This distinction is adjudication-critical in applications where the rules of play assign different consequences to contact on different faces of the same structural member.

For example, in association football (soccer), a ball striking the inside face of a goalpost upright and deflecting into the goal produces a different adjudication outcome than a ball striking the outside face of the same upright and deflecting away from the goal. Similarly, a ball striking the underside of a crossbar and deflecting downward toward the goal line produces a different trajectory (and different adjudication question regarding whether the ball fully crossed the goal line) than a ball striking the top surface of the crossbar and deflecting upward and away. By instrumenting the goalpost and crossbar with multi-channel extrusion profiles having sufficient channel density for circumferential contact localization, the structural members themselves actively report which face experienced contact, the temporal duration of contact, and the contact force magnitude—data that, when combined with the ball's own Object-Originated position reporting, provides redundant multi-source adjudication confirmation for scoring determinations.

American Football Facemask Embodiment: American Football Helmet Facemask. The facemask cage of an American football helmet is composed of multiple interconnected bars of plasticized carbon steel, typically having an approximately circular cross-section of approximately 6 to 10 millimeters in outer diameter. In the non-instrumented conventional form, these bars are solid round stock or simple tubular stock, coated with a plasticoat polymer layer for player protection. In the instrumented embodiment, the facemask bars are manufactured using a custom extrusion die producing a multi-channel cross-section with four longitudinal circular channels arranged in a symmetrically distributed pattern about the central axis of the bar. The structural wall material between and around the channels is composed of a higher-strength alloy (such as AISI 4130 chromium-molybdenum steel or a precipitation-hardened stainless steel) selected to provide equivalent or superior deflection resistance, fatigue life, and impact absorption relative to the conventional carbon steel solid bar of the same outer diameter, such that the instrumented facemask satisfies all applicable NOCSAE safety certification standards without requiring modification to helmet attachment hardware or facemask geometric form factor. The plasticoat coating is applied to the outer surface of the multi-channel extrusion in an identical manner to its application on conventional bar stock, rendering the instrumented facemask visually indistinguishable from its non-instrumented counterpart. The four channels are allocated to carry TENG tactile sensor filaments (first channel), graphene capacitive sensor conductors (second channel), UWB micro-coaxial or antenna feed elements (third channel), and power/data bus conductors (fourth channel) as described in the general principle supra. At each terminus of a facemask bar segment, a sealed multi-port connector assembly provides environmental isolation and electrical interconnection between the channel-resident conductor assemblies and the processing electronics housed elsewhere within the helmet assembly. At welded or bolted bar-to-bar intersection nodes, sealed junction housings maintain channel-to-channel segregation and provide strain relief. This facemask embodiment enables detection and automated adjudication of “facemask” grasping penalties through correlation of TENG contact patterns on the facemask bars with hand-position tracking data from the opposing player's gloves, as described in the Hard-Shell Protective Equipment section supra.

Embodiment: Basketball Rim. The basketball rim is a tubular steel member (typically approximately 16 to 18 millimeters in diameter solid rod, or equivalent tubular stock, formed into a circular hoop of 457 millimeters internal diameter per FIBA/NBA standards) to which the net is attached and upon which all scoring adjudication events depend. In the instrumented embodiment, the rim is manufactured using a multi-channel extrusion profile with four to six longitudinal channels. The channel-resident conductors enable the rim to actively report its precise three-dimensional position and spatial geometry in real time via UWB position reporting—a critical capability because basketball backboards and rim assemblies are not perfectly rigid and deflect measurably under dunking loads, breakaway rim actuation, and cumulative mechanical fatigue during play. The TENG sensor filaments within the rim channels detect ball-on-rim contact events with temporal resolution sufficient to distinguish between the ball contacting the rim and subsequently entering or not entering the cylinder-data directly relevant to basket-interference and goaltending adjudication. The rim channels also carry graphene-based capacitive proximity sensors that detect the ball's approach to the rim plane before physical contact occurs, enabling predictive trajectory analysis. The outer surface of the rim is finished with the standard orange powder coating or equivalent sport-compliant surface treatment, rendering the instrumented rim visually and tactilely indistinguishable from its non-instrumented counterpart. Because the basketball rim is subject to repeated high-energy dunking impacts, the alloy selection for the multi-channel rim extrusion prioritizes fatigue life and ductility in addition to yield strength, with chromium-molybdenum steel (AISI 4130) or maraging steel being preferred compositions for this application.

Embodiment: Soccer Goalpost Uprights and Crossbar. Association football (soccer) goalposts and crossbars are tubular metallic members that, per FIFA Laws of the Game, may be circular, elliptical, or rectangular in cross-section, with a maximum diameter (for circular profiles) of 120 millimeters. This substantially larger cross-sectional area, relative to the facemask and basketball rim applications described supra, permits a multi-channel extrusion profile with a significantly greater number of longitudinal channels—in a preferred embodiment, eight to twelve channels distributed at approximately equal angular intervals around the interior of the tubular cross-section. The increased channel count serves three purposes beyond those achieved in smaller-diameter applications. First, the greater sensor density enables finer-grained circumferential contact localization, allowing the system to resolve ball contact position on the post or crossbar circumference to within a few degrees of arc, which directly determines whether the ball struck the inside face (deflecting toward goal) or outside face (deflecting away). Second, the additional channels provide redundant conductor paths for fault tolerance over the substantially longer operational length of a goalpost upright (2.44 meters per FIFA standards) or crossbar (7.32 meters per FIFA standards), where conductor integrity over extended runs is a greater reliability concern than in the shorter facemask bar segments. Third, the additional channels accommodate dedicated sensing modalities that benefit from the larger available volume, such as fiber Bragg grating optical strain sensors that detect post deflection and vibration patterns resulting from ball impact-providing an independent physical measurement that corroborates the contact events reported by the TENG and graphene-based sensors in adjacent channels.

The goalpost and crossbar structural members are typically manufactured from aluminum alloy in contemporary professional installations. In the instrumented embodiment, the multi-channel extrusion employs a higher-strength aluminum alloy (such as 7075-T6 or 7050-T7451) or, alternatively, a transition to stainless steel or titanium alloy composition where the governing body's specifications permit, to compensate for the cross-sectional area reduction while maintaining compliance with all applicable structural load, wind resistance, and safety certification requirements. The exterior surface of the instrumented goalpost and crossbar receives the same paint, powder coat, or anodized finish as the non-instrumented counterpart, preserving visual indistinguishability.

Where the goalpost and crossbar segments are joined (at the two upright-to-crossbar junctions and at the base ground anchor points), sealed junction assemblies route the channel-resident conductor assemblies through the structural connection while maintaining channel segregation, environmental sealing, and strain relief. Power and data aggregation electronics may be housed within the junction assembly enclosures or within the ground-anchor base housings, where they are physically protected and accessible for maintenance.

The instrumented goalpost and crossbar, in combination with the Object-Originated position reporting from the game ball itself, provide a dual-source scoring adjudication system in which both the ball and the goal structure independently report spatial data relevant to goal-line determinations. This dual-source architecture is distinguished from all existing Goal Line Technology systems (including camera-based systems such as Hawk-Eye and magnetic-field-based systems such as GoalControl) by the fundamental paradigm inversion: both the ball and the boundary structure generate their own spatial data rather than being passively observed by external sensors. The contact event data from the goalpost circumferential sensors, combined with the ball's own reported trajectory and surface deformation data, provides adjudication confidence that external observation systems cannot achieve in scenarios involving deflections off structural members—precisely the scenarios where existing systems exhibit their greatest uncertainty.

Additional Rigid Tubular Member Applications. The multi-channel extrusion profile methodology is not limited to the three sport-specific embodiments detailed above. The same design principles—custom extrusion die, multi-channel cross-section, compensating alloy selection, functional channel segregation, sealed termination and junction assemblies, and visual indistinguishability preservation-apply to any rigid tubular structural member within the scope of sporting equipment or venue infrastructure that serves a boundary, scoring, or adjudication function. Analogous implementations include, without limitation: hockey goal frame tubing (where puck contact on the inside versus outside of the post determines goal validity), lacrosse and handball goal frame tubing, rugby goalpost uprights and crossbars, tennis net post tubing (where net-cord adjudication may benefit from post-contact detection), volleyball net post assemblies, and any future sport-specific installation where rigid tubular infrastructure defines or participates in adjudication boundaries.

Prior Art Distinction for Multi-Channel Extrusion Profile: The multi-channel extrusion profile for rigid tubular structural members as described herein is distinguished from all known prior art by the simultaneous combination of the following five elements, no one of which alone is sufficient to define the invention but all of which together constitute the novel contribution: (a) the structural member satisfies the impact, load, and safety certification requirements of a recognized sports equipment or venue infrastructure standard, and is not a non-structural conduit, catheter, cable duct, or decorative element; (b) the channels within the structural member house a plurality of functionally distinct sensing modalities (including at minimum one contact-detection modality and one spatial-position-reporting modality) that cooperate to provide both contact event data and three-dimensional positional data from the same structural member; (c) the alloy composition of the structural member is specifically selected to compensate for the cross-sectional area reduction caused by the channels, such that the instrumented member exhibits equivalent or superior mechanical performance to the conventional non-instrumented member under all applicable certification test conditions; (d) the external appearance, dimensional profile, and surface finish of the instrumented member are indistinguishable from those of the non-instrumented member, satisfying the visual concealment requirements established by this specification; and (e) the sensing and communication elements housed within the channels participate in an Object-Originated Spatial Awareness architecture wherein the structural member itself actively generates and reports spatial data, rather than serving as a passive target observed by external sensors. No known prior art in multi-lumen medical catheter tubing, industrial cable conduit, bicycle handlebar internal cable routing, or structural hollow section steelwork combines all five of these elements, because none of those prior art domains requires simultaneous satisfaction of sports equipment impact certification, multi-modal sensor integration, compensating alloy selection, visual concealment, and participation in an object-originated spatial awareness tracking paradigm.

### Impact Force Measurement, Body-State Monitoring, and Cross-Domain Diagnostic Applications:

The integration of accelerometer arrays alongside UWB tracking enables objective force magnitude measurement supporting officiating determinations involving contact severity—distinguishing incidental contact from unnecessary roughness, legal tackles from flagrant fouls. Current officiating relies on officials' subjective visual impression of force magnitude; the system provides calibrated force data as additional input while preserving human judgment over penalty determination. This capability addresses the fundamental limitation that cameras observe motion but cannot measure force—they can show that a collision occurred but cannot quantify whether it exceeded the force threshold distinguishing legal from illegal contact.

The same architectural principle—multi-layer body-conformal instrumentation producing occupant body-state data through object-originated spatial awareness rather than external observation—extends beyond contact sport officiating into operational domains where the consequences of failing to detect occupant incapacitation, postural degradation, or body-state anomalies are not merely adjudicative but life-critical. The multi-layer helmet hierarchy disclosed herein, comprising skin-adhered MOCAP turf tape, instrumented cranial liner garment, compressible padding, and rigid outer shell, is architecturally identical whether the outer shell is an athletic helmet, a military flight helmet, or a motorsport crash helmet. The instrumented inner garment layers disclosed herein for the torso—MOCAP turf tape, instrumented inner shirt, instrumented outer uniform—are architecturally identical whether the outer garment is a football jersey or a fire-resistant flight suit, anti-G suit, or motorsport driver suit. In each case, the multi-layer hierarchical confidence architecture produces the same dual output: anatomical ground truth position of the occupant's body and deformation state of the equipment layers overlying that anatomy. The following cross-domain applications are expressly contemplated:

In military and high-performance aviation, the critical unresolved problem is detecting G-force induced Loss of Consciousness (G-LOC) and other pilot incapacitation events with sufficient speed and reliability to enable automated flight recovery before the aircraft enters an unrecoverable state. Current cockpit-mounted camera systems attempting to monitor pilot body state—head droop, torso slump, limb relaxation indicative of consciousness loss—fail precisely when they are most needed because the high-G loading conditions that cause G-LOC simultaneously cause helmet displacement, visor occlusion, arm flail, and cockpit geometry interference that obstruct camera line-of-sight to the very postural indicators the cameras are intended to observe. Aircraft flight control telemetry cannot distinguish pilot incapacitation from deliberate zero-input flight states because from the fly-by-wire system's perspective, a pilot who has lost consciousness and a pilot who is deliberately holding inputs steady produce identical control surface commands. The multi-layer instrumented architecture disclosed herein resolves this limitation: an instrumented fire-resistant cranial liner garment (such as a Nomex or fire-resistant balaclava, flight helmet liner hood, or analogous head-conforming fire-resistant textile substrate) worn under the flight helmet, combined with an instrumented fire-resistant inner flight suit layer worn under the outer flight suit or anti-G suit, provides continuous three-dimensional tracking of the pilot's head position, cervical spine orientation, torso posture, and limb positions through the same object-originated spatial emission architecture disclosed throughout this application—immune to cockpit camera occlusion, independent of lighting conditions, and operative during the high-G transient events that defeat external observation. The system detects the characteristic postural signatures of G-LOC onset—progressive head droop exceeding voluntary relaxation thresholds, cervical flexion inconsistent with volitional head positioning, torso slump against restraint harness geometry, and bilateral upper-limb relaxation—through inter-layer differential analysis comparing the body-conformal inner reference layer against the outer equipment layers, distinguishing true anatomical postural change from equipment shift induced by G-loading. This detection capability is unavailable to any single-layer helmet sensor system, any cockpit-mounted camera system, and any aircraft telemetry system operating independently, because each of those approaches lacks the multi-layer body-conformal reference architecture necessary to distinguish occupant body movement from equipment displacement under dynamic loading conditions.

In high-velocity motorsport—including without limitation NASCAR, Formula 1, IndyCar, World Endurance Championship, and rally racing—a parallel unresolved problem exists: detecting driver incapacitation during and immediately following crash sequences, and monitoring progressive driver fatigue and postural degradation over race durations that may exceed several hours. Current cockpit-mounted cameras (mandated in Formula 1 since 2019 for driver monitoring) suffer the same line-of-sight limitations as aviation cockpit cameras—the crash dynamics that make incapacitation detection most urgent simultaneously produce the helmet displacement, HANS device interaction, halo structure occlusion, and cockpit deformation that defeat camera-based observation. Vehicle telemetry cannot distinguish a driver who has lost consciousness from a driver who has voluntarily released the steering input, because the telemetry measures vehicle state, not occupant body state. The multi-layer instrumented architecture disclosed herein, implemented through an instrumented fire-resistant cranial liner garment worn under the crash helmet and an instrumented fire-resistant inner suit layer worn under the outer driver suit, provides the same occupant body-state monitoring capability described for the aviation embodiment—continuous postural tracking through object-originated spatial emission, immune to the cockpit camera occlusion that defeats current monitoring approaches. Beyond incapacitation detection, the continuous postural data stream enables detection of progressive ergonomic fatigue signatures—subtle shifts in head carriage, increasing cervical lateral flexion, altered grip posture—that precede measurable lap time degradation and that are invisible to vehicle telemetry and unreliable through cockpit camera observation over extended race durations.

For avoidance of doubt: the military aviation, motorsport, and other helmeted-occupant embodiments described in this section do not require architectural modification to the multi-layer hierarchical confidence system, the sequential layered calibration protocol, the AI-driven sensor fusion engine, or the dual-output anatomical-position-versus-equipment-position reporting capability disclosed herein for athletic applications. The occupant body-state monitoring capability in these cross-domain applications is an inherent consequence of the same Object-Originated Spatial Awareness paradigm, the same multi-garment hierarchical confidence architecture, and the same inside-to-out layered calibration methodology that distinguishes this invention from all prior art in the athletic domain. The architectural identity across domains is not coincidental but structural: any environment in which a human occupant wears a rigid helmet over inner textile layers, and in which external observation of that occupant's body state is compromised by equipment geometry, cockpit enclosure, dynamic loading, or occlusion, presents the same measurement problem that the multi-layer body-conformal architecture was designed to solve—the inability of external observation to distinguish occupant body movement from equipment displacement. No prior art system in any of the enumerated domains—athletic, military aviation, or motorsport—provides multi-layer body-conformal occupant tracking with hierarchical confidence weighting and dual-output anatomical-versus-equipment position reporting, because no prior art system in any of these domains instruments the occupant's inner garment layers with active spatial emission elements operating within the Object-Originated Spatial Awareness paradigm.

### Body Armor:

The military and law enforcement training application further encompasses body armor and ballistic plate carrier systems as multi-layer hierarchical embodiments analogous to the athletic protective equipment hierarchies disclosed herein. A plate carrier assembly comprises at minimum three instrumented layers: (1) a rigid ballistic plate (ceramic, polyethylene, or composite) analogous to the thermoplastic helmet shell, carrying surface-integrated or inter-lamination conductor arrays; (2) a soft armor backing panel (aramid fiber weave) analogous to the foam padding layer, carrying deformation-sensing elements; and (3) an inner carrier vest or base layer garment worn against the torso serving as the body-conformal reference layer. The inter-layer differential measurements across this three-layer hierarchy produce force-magnitude and contact-location data for training munition impacts during force-on-force exercises, wherein simulated munitions (paint-marking rounds, UTM or Simunition cartridges, and equivalent training projectiles) constitute the game ball analog—a projectile whose impact on an opponent's instrumented body armor is adjudicated through cooperative spatial data between the projectile's launcher-originated trajectory data and the recipient's body-armor contact detection, replacing subjective visual observation of paint marks or honor-system hit acknowledgment.

### Shape Tape & “Mocap” as “Ground Truth”

MOCAP/Turf Tape/Shape tape comprises a multi-layered, die-cut, flexible composite structure engineered for skin adhesion across anatomically contoured body regions. The apparatus functions simultaneously as UWB micro-tag array, UWB anchor reference, touch/proximity sensing surface, and abrasion barrier—a convergence of functions impossible with discrete marker placement. The base layer comprises biocompatible elastomer (polyurethane or silicone-based polymer, 0.1-2.0 mm thickness) with pressure-sensitive adhesive exhibiting peel strength sufficient for dynamic athletic movement while permitting residue-free removal. Interior layers incorporate TENG and/or graphene-based touch sensing circuitry, flexible-substrate conductor integration arrays and UWB antenna traces, said arrays incorporated through woven, knitted, printed, bonded, or other flexible-substrate conductor integration methods disclosed herein. Exterior surfaces include friction-modulating polymer (cross-linked polyethylene or PTFE) optimized for turf interaction, with perforations enabling breathability during prolonged exertion.

The shape tape architecture contemplates two surface-curvature capture configurations. Concentric ring configuration positions successively smaller discrete rings following the natural topographic gradient from panel perimeter toward geometric centroid, enabling independent serialization and modular replacement. Continuous spiral configuration employs a single spiraling conductor path analogous to fingerprint topology, originating at panel perimeter and progressively tightening toward center, providing inherent continuity verification wherein complete signal propagation confirms conductor integrity. Both configurations achieve dense topographic resolution through interpolation between nested contour positions without requiring full-surface coverage that would violate Physical Compliance constraints.

The claimed adjudication-grade accuracy requires systematic registration procedures establishing verified correspondence between physical positions of tracking elements embedded in equipment and uniforms and their computed coordinates within the system's virtual spatial model. Because the system operates under the Measurement Causality Paradigm Inversion—wherein tracked objects generate their own spatial data rather than being externally observed-enhanced positioning can be achieved by adopting a pre-performance “weigh in” topographical registration protocol. This registration procedure establishes correspondence between the object-originated spatial emissions and independently verified ground truth positions.

### P.S.A.—Equipment Ensemble Identification, Federation, and Topographical Registration Protocol:

The present invention contemplates an operational infrastructure for federating and registering the plurality of EDID-bearing equipment components worn or carried by each performer into a unified Performer Spatial Assembly (PSA) through a pre-performance “weigh in” protocol. This protocol executes in two structurally distinct phases: Phase 1 (EDID Federation/“the Flash”) binds all EDID-bearing components assigned to a single performer into a single federated adjudicative identity for the duration of the defined performance session, such that all Timestamped Spatial Emission Data records originating from any constituent component are attributed to the correct PSA and that no EDID component can be ambiguously assigned to more than one PSA during that session. Phase 2 (Topographical Registration) registers each federated component against a vector-based topographical wireframe representation of the performer's three-dimensional sculptural surface contours, establishing the spatial correspondence between each EDID-bearing component's emission origin and its anatomical or equipment position within the performer's body geometry. The two-phase architecture ensures that the AI-driven sensor fusion engine receives both identity-attributed and anatomically-positioned Timestamped Spatial Emission Data from the moment live performance commences, enabling adjudication-grade spatial determinations without post hoc geometric reconstruction. This pre-performance protocol enables all components of the PSA to be recognized as belonging to a single identified performer, distinguishable from all other performers despite simultaneous tracking of 50+ players, officials, and equipment elements within the same spatial volume.

Prior to each performance, the pre-performance session-bound EDID federation and topographical registration protocol executes wherein each instrumented performer and game object undergoes Phase 1 EDID federation followed by Phase 2 structured topographical registration capturing the precise three-dimensional geometry of all EDID-bearing tracking elements relative to anatomical landmarks, equipment boundaries, and anatomical ground truth position references, as well as binding all the components of a Performer Spatial Assembly together into a federated adjudicative identity. The resulting federation and registration data enables the AI-driven sensor fusion engine to interpret Timestamped Spatial Emission Data as anatomically meaningful spatial information—transforming a cluster of UWB tag emission coordinates into the precise anatomical ground truth position of a performer's knee relative to the ground plane or boundary line.

The MOCAP turf tape that occupies the innermost layer in the multi-layered hierarchical adjudication plays an important role as establishing anatomical ground truth position references for the topographical registration phase. The topographical registration produces a vector-based topographical wireframe representation of the performer—comprising sparse topographical coordinate collections defining anatomical articulation boundaries—rather than an undifferentiated point cloud surface reconstruction (SEE: Lexicography Item 8, Point Cloud). This distinction is architecturally significant: the vector-based topographical wireframe assigns each EDID-bearing component to a distinct node within a hierarchically differentiated anatomical topology, establishing per-component EDID attribution at anatomical-region granularity. This is the architectural basis for the system's ability to report the anatomical ground truth position of individual body regions independently rather than treating the performer as an undifferentiated volumetric mass. The pre-performance session-bound EDID federation and topographical registration protocol can be conducted via multiple sequential phases. In static registration, each performer is positioned within a topographical registration volume equipped with high-precision optical measurement systems, namely structured-light scanners that capture three-dimensional positions of visible tracking element reference points simultaneously with corresponding UWB-reported coordinates. This simultaneous capture establishes the transformation matrix between tracking system coordinate frame and anatomical reference frame for each participant, accounting for variations in body geometry, equipment fit, and tag placement across individuals. Coupled with a photogrammetry scan layer, the 2D reference captures can provide skin and hair texture for Name-Image-Likeness legal purposes. Correspondence mapping from static registration is stored as session-bound topographical registration data and applied to all subsequent position computations throughout the performance. For game balls and equipment, equivalent registration captures spatial relationships between embedded tag arrays and geometric center, surface boundaries, and panel seam locations. The topographical registration can itself be a multi-layered process, where the performer can be scanned in their underlying layers, such as inner shirts and MOCAP turf tape, and then with their safety equipment and outer uniform layers in order to establish and render a multi-layered anatomical ground truth representation of the performer for later use in positioning, broadcasting, and video game reconstruction.

Following static registration, dynamic verification confirms calibration validity under movement conditions representative of actual gameplay. Each participant may executes a standardized motion sequence—walking, running, jumping, arm extension, sport-specific movements—while the system records both tracking-derived positions and ground truth reference measurements from optical calibration infrastructure. Discrepancies between expected and observed positions trigger recalibration or equipment adjustment before live play. Dynamic verification detects registration discrepancies not manifest during static registration: equipment shifting during movement, antenna detuning under flexion, or systematic biases from body-coupled electromagnetic effects varying with posture and limb configuration. This sequence can be part of the locker room or field warm-up routines. When equipment needs to be replaced mid-performance, handheld wands can bind the EDID's of the Performer Spatial Assembly together with the equipment the performer is already wearing.

During live performance, continuous calibration monitoring and drift correction compare tracking-derived spatial relationships against geometric constraints known to be invariant. Physical dimensions of game equipment—football length, basketball diameter—provide continuous reference measurements; computed distance deviation between tags on opposite ball ends quantifies accumulated drift and triggers corrective adjustment. Anatomical constraints of the human skeleton—fixed limb segment lengths between joint centers—provide ongoing calibration verification for player-worn arrays. When accumulated drift exceeds adjudication-grade thresholds, recalibration procedures invoke during natural stoppages using referee-carried mobile calibration references or fixed calibration targets at known field positions. This continuous calibration architecture ensures ground truth validity throughout event duration, distinguishing the present invention from prior art systems assuming static calibration validity without ongoing verification.

The equipment ensemble registration protocol can operates through three complementary infrastructure embodiments purpose engineered for the different types of Acrobatic Performances and events; for example, the topographical registration of a ballerina's uniform would be substantially different than that of that envisioned for the American football layers of safety gear. In American football, the topographical registration sequence could employ a locker room registration tunnel and/or a sideline registration station that can work with/or a handheld registration wands for quick equipment replacement. The registration protocol interfaces with the Spatiotemporal Integrity Validation (SIV) and Officiating Proof-of-Position (OPoP) architectures described elsewhere herein. Registered ensemble identities enable SIV to detect anomalous tracking signatures suggesting equipment tampering or unauthorized substitution. OPoP attestations incorporate ensemble identity verification, ensuring that position claims are attributable to authenticated, league-certified equipment rather than spoofed or counterfeit tracking elements.

### Field Surface Touch & Proximity Sensing

The present invention extends the Object-Originated Spatial Awareness paradigm to the playing surface itself, transforming the field from a passive substrate observed by external cameras into an active participant that detects, localizes, and reports contact events at the spatial participant that detects, localizes, and reports contact events at the point of occurrence. This architectural inversion parallels the equipment integration methodology: just as instrumented game balls and player equipment emit their own spatial data rather than awaiting external observation, the instrumented field surface and Spatial Delimiters (SEE: Inventor's Lexicography)—the delimiters of the performance venue including endzone pylons, corner markers, boundary lines, goals, nets, and goalposts, themselves employing the Enveloping Substrate Methodology—generate contact event data intrinsically rather than requiring inference from overhead imagery (see FIG. 2).

For avoidance of doubt regarding scale and operational context: the sensing field surface disclosed herein is designed for professional athletic venues of civic stadium dimensions-regulation football fields of 120 yards length, soccer pitches exceeding 100 meters, and comparable large-format performance surfaces. The engineering constraints, infrastructure requirements, signal routing architectures, and environmental durability specifications for stadium-scale turf systems operating under professional athletic loading conditions bear no meaningful similarity to small-format pressure-sensitive mats designed for individual exercise or rehabilitation applications. Any characterization of consumer-scale pressure mats as anticipating stadium-scale sensing infrastructure would constitute a category error conflating fundamentally distinct engineering domains.

The Primary Tier for the field surface proximity sensing is the Boundary-Line Cooperative Sensing Array—wherein the American football four inches (10.16 cm) wide regulation sideline and the five inches (12 cm) wide FIFA compliant line have a sensing strip of equal width just under the natural or artificial turf—in order to make what is traditionally only graphically represented on the field have an active adjudicatory role in the performance. The American football “gridiron” would be a functional part of the game/performance.

The Secondary Tier for the field surface sensing is the touch-sensitivity of the turf grass blades, when the VSA utilizes artificial turf. The invention contemplates whisker-inspired tactile sensing arrays wherein dense arrangements of flexible, deflection-sensitive elements—implemented through Micro-Electro-Mechanical Systems (MEMS), Hall-effect magnetic sensors, or Fiber Bragg Grating (FBG) optical fibers—detect contact pressure, contact area geometry, and force distribution when performers contact the surface. Alternatively or additionally, Triboelectric Nanogenerator (TENG)-based tactile strands form a compliant, self-powered sensing mesh generating electrical signals through the triboelectric effect in response to compression, tension, or friction. TENG materials offer self-powering capability eliminating distributed batteries, high mechanical durability under repetitive athletic loading, flexibility permitting integration into irregular surfaces, and environmental resilience including moisture resistance and thermal stability.

The whisker-TENG array operates in discrete, addressable sectors with each sensor element assigned a unique identifier, transforming the field into a coordinate-addressable touch surface reporting contact location, contact area shape, force distribution, and temporal duration. Contact patterns—handprints, footprints, knee imprints—support officiating determinations including player in-bounds or out-of-bounds status, ball-carrier down-by-contact rulings, and touch-based scoring verification. The sensing surface provides redundant positioning validation for active UWB micro-tag networks, enhancing multi-sensor fusion accuracy during pile-up or congested conditions where line-of-sight signals are compromised.

Where the sensing elements comprise optical fiber substrates, the field surface additionally functions as a programmable visual display capable of real-time chromatic output. This embodiment enables dynamic rendering of field markings, team logos, sponsor graphics, and rule-relevant visual indicators directly on the playing surface rather than solely on overhead displays. Venues hosting multiple tenants—such as NFL and NCAA teams sharing a stadium—benefit from instant visual reconfiguration between events without physical remarking. The actual first-down line becomes visible to in-stadium spectators rather than existing only as a broadcast overlay; contested toe-tap catch contact points illuminate at the precise location of turf contact for all observers; ball placement for subsequent plays achieves cartesian precision rather than referee visual estimation. Optical fiber chromatic capability may incorporate partial opacity to prevent excessive surface brightness while maintaining visual clarity under stadium lighting conditions. This visual output architecture obsoletes early-twentieth-century mechanical technologies including chain gang down markers and manually positioned pylons, replacing approximate human positioning with digitally verified spatial coordinates rendered directly on the playing surface.

The field surface thus operates as both a spatial sensing system and a visual output system unified through the same optical fiber substrate—receiving contact data and emitting visual confirmation simultaneously, embodying the bidirectional data flow characteristic of the Object-Originated Spatial Awareness paradigm.

### Unique Identifier

One anticipated use of this combination-of-art invention is collegiate sports, where recent court decisions recognized that the “name, image and likeness” (NIL) of collegiate athletes constitutes intellectual property entitling athletes to compensation for capture and reuse of their performances. The system provides means by which performances can be captured, rebroadcast, and simulated as part of the system's EDID unique identifiers, where each performer's body shape is recognized, converting acrobatic and theatrical movements into serialized products comparable to digital music, books, and movies. The unique identifiers this invention generates differentiate one player's performance for intellectual property tracking from other's, much like ISBN does for copyright and book sales.

The Equipment Decentralized Identifier (EDID) attribution architecture protocol connects performer identity to downstream content products, extends an unbroken cryptographic chain from the moment of spatial data origination through every subsequent use of that data in broadcast, interactive entertainment, cinematic production, archival, or any other consumption context. Each spatial datum generated by any sensing element within a performer's Performer Spatial Assembly carries the originating EDID's cryptographic signature, establishing that the datum was produced by a specific authenticated sensing element assigned to a specific identified performer during a specific identified performance session. When these spatial data records are assembled into Volumetric Performance Reconstructions, formatted as Spatially Enriched Broadcast Signals, or delivered as Interactive Performance Data Streams, the cryptographic attestation chain persists through every processing step, embedding performer attribution within the content itself rather than maintaining attribution as an external administrative record that can be separated from, overwritten, or lost independently of the content it describes.

This architecturally intrinsic attribution distinguishes the present invention's intellectual property tracking capability from all prior art sports content attribution systems. Existing broadcast attribution relies on production metadata—camera logs, production notes, editorial records—maintained separately from the broadcast content and vulnerable to loss, corruption, or deliberate manipulation. Existing video game attribution relies on contractual licensing agreements wherein performer identity is associated with statistical attribute profiles through business records external to the game engine's data structures. In both cases, attribution is administratively applied rather than architecturally embedded: the content can exist and function without the attribution, and the attribution can be modified, removed, or disputed without altering the content. The present invention's EDID-authenticated provenance chain cannot be separated from the spatial content it attests to without destroying the cryptographic integrity that the Spatiotemporal Integrity Validation architecture is designed to detect. A Geometric Performance Capture record of a specific performer's specific performance carries that performer's attribution as an intrinsic structural property of the data, not as an external label.

The implications for Name, Image, and Likeness revenue management are substantial. A broadcast containing twenty-two simultaneously tracked athletes cannot, under existing systems, attribute specific spatial content elements to specific performers with cryptographic verifiability. The present invention's EDID-authenticated attribution architecture provides precisely this capability: every spatial datum within a broadcast, interactive entertainment product, or archived performance record is cryptographically linked to the specific performer whose Performer Spatial Assembly generated it, enabling automated usage tracking, compensation calculation, and rights enforcement at a granularity that no prior art content production system can achieve. This architecture transforms performer spatial data from a bulk commodity licensed through collective bargaining agreements into an individually attributable, individually licensable digital asset whose commercial exploitation is governed by the performer's own authorization at every distribution tier.

The EDID protocol enables cross-venue identity persistence wherein equipment maintains verifiable identity records across deployment venues, seasons, and competitive events. Game balls carry EDIDs whose documents accumulate attestations across all venues and games, creating cryptographically verifiable provenance records suitable for memorabilia authentication, intellectual property attribution, and regulatory compliance. Player wearable EDID provenance records may include calibration attestations from each venue's infrastructure, distinguishing measurement variations from cross-venue differences versus genuine equipment degradation or tampering.

The Equipment Decentralized Identifier is distinguished from prior art RFID-based equipment identification in professional sports—including RFID chips in footballs, RFID tags in player shoulder pads, and passive RFID labels in equipment management—in that: (a) EDID provides cryptographic proof of identity through digital signatures verifiable without central authority connectivity, whereas RFID systems transmit static identifiers susceptible to cloning and replay attacks; (b) EDID enables selective credential disclosure wherein equipment may attest to specific attributes (e.g., league certification validity) without revealing complete identity information, whereas RFID systems transmit complete stored data upon interrogation; (c) EDID supports identity recovery and revocation through cryptographic key rotation and DID document updates, whereas RFID identity compromise requires physical replacement of compromised tags; and (d) EDID documents maintain immutable audit trails of identity-related events including issuance, credential grants, and revocations, whereas RFID systems typically lack standardized audit mechanisms.

Now I have everything needed. Let me deliver the full analysis and the section drafts inline.

### Revised Budget Calculation

The handoff plan was built on a 17-sheet drawing estimate. AE has confirmed 18 sheets. All other counts are unchanged:

| Component | Sheets |
|---|---|
| Specification (V82) | 168 |
| Claims | 26 |
| Abstract | 1 |
| Drawings | 18 |
| Total filing | 213 |
| Next fee threshold | 250 |
| Free headroom | 37 sheets |

The headroom is identical to the handoff plan's calculation—37 free sheets—because the one additional drawing sheet was already inside the 201-250 increment that was already being paid. No budget change.

### Section Status Reconciliation

Section A (Brief Description of Drawings) is already complete—it was inserted into V81 and confirmed present in V82. The handoff plan predated that work. The tracker below reflects this.

Sections B through F remain to be authored. With 37 sheets of headroom and language required to be very efficient, here is the revised per-section word target calibrated to that constraint. At ~330 words per patent spec page:

| Section | Target (efficient) | Sheets |
|---|---|---|
| B-EDID Operational | ~1,650 words | ~5 |
| C-Embodiment Expansion | ~1,650 words | ~5 |
| D-VSA Physical Compliance | ~1,650 words | ~5 |
| E-OPoP/SIV Mechanics | ~1,320 words | ~4 |
| F-Forensic Replay Ledger | ~660 words | ~2 |
| Total | ~6,930 words | ~21 sheets |

This lands comfortably at 213+21=234 sheets, leaving 16 sheets of buffer before the next fee threshold. Each section is written to its efficient floor-maximum legal coverage per word.

Proceeding section by section, inline, in order B→C→D→E→F.

### Section B-EDID FULL Operational Description

Insertion anchor (verbatim FIND string for LibreOffice): EDID documents maintain immutable audit trails of identity-related events including issuance, credential grants, and revocations, whereas RFID systems typically lack standardized audit mechanisms.

This text is the last sentence of the current UNIQUE IDENTIFIER section. The new content is appended immediately after this sentence, continuing the same paragraph structure—NO new bullet points. New paragraphs follow as flowing prose.

INSERT after the anchor sentence:

Equipment Decentralized Identifier Generation and Component Binding. An EDID is generated at the time of component manufacture or assembly through a decentralized identifier generation protocol conforming to the W3C Decentralized Identifiers specification. The generation process produces a globally unique identifier string, a public-private key pair, and a DID document that anchors the identifier to a verifiable cryptographic root. The private key is embedded within the component's secure element or trusted execution environment at manufacture and is never transmitted or exposed outside the component. The public key is recorded in the DID document, which is published to a distributed ledger or decentralized registry accessible to all authorized participants in the Cooperative Spatial Mesh. The EDID binding to a physical component is permanent and inseparable: an EDID is not a label affixed to a component but a cryptographic identity constitutively embedded in it (see FIG. 1). For a single sensing element—a UWB tag, a graphene contact sensor, a TENG harvesting layer-one EDID governs that element's identity throughout its operational life. For an equipment assembly treated as a unit—a game ball, a helmet, a boundary array segment—the assembly-level EDID federates the identities of all constituent sensing elements into a single adjudicative identity for purposes of the Cooperative Spatial Mesh.

Stage 1 Emission with EDID Attribution Constitutively Bound at Origination. Every record of Timestamped Spatial Emission Data emitted from an EDID-bearing component carries that component's EDID cryptographic signature as a constitutive element of the record—not as a post-hoc label appended during processing, but as an inseparable attribute present at the moment of origination. The three-dimensional coordinate, orientation quaternion, timestamp at nanosecond resolution, modality-specific confidence metric, and EDID signature are emitted as a single indivisible record. This constitutive binding is the architectural distinction between object-originated spatial data and data produced by external observation systems: in an external observation system, spatial data is captured first and identity is assigned afterward through inference; in the present invention, identity originates the spatial data and the two are never separated.

EDID Attribution Persistence Through SIV and Sensor Fusion. The Spatiotemporal Integrity Validation process receives Timestamped Spatial Emission Data records and validates each against kinematic plausibility bounds, cross-modal consistency criteria, and temporal continuity constraints. SIV does not strip, replace, or aggregate the EDID attributions of contributing Stage 1 records. The post-SIV Spatiotemporal Data record retains the originating EDID identifiers of every contributing Stage 1 record, producing an attributable fusion output in which the provenance of every contributing sensing element is preserved in the validated determination. Where multiple EDID-bearing components contribute to a single fused determination—as in the case of a performer spatial assembly whose deformable volumetric boundary is determined through the cooperative emission of dozens of distributed sensing elements—the fusion output records each contributing EDID's weighted contribution to the determination, creating a multi-source attribution record rather than a single-source attribution.

Downstream Attribution Persistence Through Broadcast and Content Chain. EDID attribution persists through all downstream processing stages. A Spatially Enriched Broadcast Signal derived from EDID-attributed Spatiotemporal Data carries embedded performer attribution within the signal architecture itself—not as separable metadata that can be stripped during transcoding or distribution, but as a structural element of the signal format (see FIG. 9). Volumetric Performance Reconstructions derived from EDID-attributed records carry EDID provenance through every rendering and distribution step. This architecture enables EDID-attributed content to function as a verifiable performer identity record throughout the full content lifecycle, supporting NIL rights enforcement, broadcast licensing verification, and regulatory compliance with performer identity protection frameworks without reliance on external rights management systems that are architecturally separable from the content.

Session Lifecycle: Federation, Replacement, and Archival. EDID identity is managed across a performance session through three lifecycle phases. At session initialization, the topographical registration procedure federates all EDID-bearing components assigned to each performer and each venue spatial assembly element into session-bound adjudicative identities, recording the federation structure in the genesis block of the Forensic Replay Ledger (see FIG. 1A). Mid-session equipment replacement—a player substituting an injured performer's worn equipment, or a damaged boundary array segment being swapped—is handled through a re-federation protocol that records the substitution event in the ledger with timestamp, retiring the replaced component's EDID from the active federation and activating the replacement component's EDID without interrupting session continuity. At session termination, the complete federation record, all EDID-attributed Spatiotemporal Data records, and all OPoP certificates are archived to the Forensic Replay Ledger as an immutable session record.

### Anticipated Embodiment Expansion

### Vehicular Surface Integration for Motorsport and Aviation Competition

The Object-Originated Spatial Awareness architecture disclosed herein extends beyond team athletics to any domain of Acrobatic Performance. Contemplated embodiments include high-velocity motorsport vehicles (NASCAR, Formula 1, IndyCar) where multi-car incidents at 200+ mph exceed camera-based spatial resolution; aerobatic aircraft competitions where three-dimensional course compliance through gates and altitude boundaries requires sub-centimeter verification; and unmanned vehicle racing where miniaturized sensor architectures accommodate size and weight constraints precluding conventional tracking equipment.

In motorsport and aviation competition contexts where vehicle body panels, aerodynamic surfaces, and structural fairings are fabricated through composite lay-up processes, the invention contemplates reinforcement mesh substrates in which conductive fibers are interwoven directly into the fiberglass, carbon fiber, or aramid reinforcement fabric prior to resin impregnation and autoclave curing. When an aerodynamic component—such as a front wing endplate, rear diffuser panel, engine cover, or aircraft wing skin—is formed through the composite molding process, the conductive fiber network within the reinforcement mesh permanently assumes the aerodynamic contour geometry of the finished component. The conductive paths thereby become intrinsic structural constituents of the load-bearing composite rather than surface-applied coatings or post-manufacture attachments, and cannot be removed, repositioned, or separated from the structural laminate without destroying the component. This integration methodology achieves conformal circuit architecture that faithfully follows compound-curvature aerodynamic surfaces through the same manufacturing process that establishes the component's structural and aerodynamic properties, eliminating the need for secondary bonding, mechanical fastening, or surface-applied conductive coatings that could alter aerodynamic characteristics, add parasitic mass, or degrade under thermal cycling, vibration fatigue, and debris impact experienced in competitive motorsport environments.

For vehicle body panels, aerodynamic surfaces, and fairings not fabricated through composite reinforcement lay-up—including metallic body panels, formed thermoplastic components, and painted surfaces—the graphene-based conductive paint formulations, vulcanized sensor substrates, and conformal circuit lamination techniques described in the Equipment Embedding sections apply through manufacturing processes compatible with existing automotive and aerospace production. For tire compounds, vulcanized sensor embedding achieves integration within the rubber matrix through the same curing process that establishes the tire's mechanical and thermal properties.

The conductive-mesh-integrated reinforcement and the surface-applied conductive paint formulations represent complementary integration modalities applicable to different substrate compositions within a single vehicle. A composite-bodied motorsport vehicle may employ conductive reinforcement mesh within its carbon fiber monocoque, wing elements, and diffuser panels while simultaneously utilizing graphene-based conductive paint on metallic suspension components, engine covers, or regulatory identification surfaces. The resulting vehicle wireframe capture aggregates spatial data from both integration modalities through the unified hierarchical tracking architecture, enabling complete vehicle envelope reconstruction through the Forensic Replay Ledger with sub-millisecond temporal resolution. This multi-modality integration provides incident reconstruction evidentiary records, position-and-shape determination for regulatory compliance verification, and performance telemetry unavailable through external observation systems regardless of vehicle construction methodology.

In a further embodiment directed to occupant safety monitoring in motorsport, the vehicular surface integration disclosed supra extends to driver-worn safety equipment operating within the same multi-layer hierarchical confidence architecture disclosed for athletic protective equipment. The Head and Neck Support device (commonly designated HANS device or equivalent frontal head restraint system mandated by the Fédération Internationale de l′Automobile and comparable sanctioning bodies) constitutes a rigid yoke resting on the driver's shoulders with tethers connecting to the helmet, mechanically constraining head displacement during deceleration events. This yoke-to-helmet tether attachment constitutes a junction fastener analog, and is instrumented with TENG-based and piezoelectric-based sensing elements at the tether anchor points to capture junction loading data encoding the force magnitude, direction, and temporal profile of head restraint engagement during impact events—data that post-incident forensic analysis currently reconstructs from vehicle telemetry and onboard camera imagery rather than from direct measurement at the restraint interface itself. The instrumented HANS device operates within a cooperative spatial mesh comprising the driver's instrumented helmet, the instrumented driver suit functioning as a Performer Spatial Assembly, the instrumented vehicle body panels disclosed supra, and—critically—the instrumented vehicles of other competitors within communication range, establishing a multi-vehicle cooperative mesh that reconstructs the complete spatial geometry of multi-car incidents through object-originated data from all participating vehicles and drivers simultaneously. This multi-vehicle cooperative incident reconstruction addresses the regulatory requirement established by the FIA following the fatalities and severe injuries in single-seater and closed-cockpit racing that demonstrated the inadequacy of circuit-mounted camera arrays and vehicle-mounted onboard cameras to reconstruct occupant body state during multi-vehicle impacts occurring at velocities and rotational rates that exceed camera frame-rate resolution.

### AI Integration

The AI subsystem coordinates self-reported spatial data from participating objects into a unified model. The AI operates on data that already exists within the tracked system-emitted by instrumented equipment, players, and field infrastructure—not on data reconstructed from external camera observation or signal inference. This architectural distinction means the AI subsystem enhances an inherently superior data source rather than compensating for the fundamental limitations of external observation.

Key innovations include reinforcement learning (RL) algorithms that autonomously optimize positioning accuracy through real-time feedback loops, and Generative Adversarial Networks (GANs) employed to simulate complex spatial environments, reducing dependency on exhaustive physical data collection and accelerating model training for diverse venue geometries. Deep learning architectures—including Convolutional Neural Networks (CNNs) for spatial pattern recognition and Recurrent Neural Networks (RNNs) for temporal movement prediction-classify position data, detect anomalies, and forecast object trajectories. Edge AI solutions perform neural inference at the sensor or node level for ultra-low latency applications, reducing cloud computation dependency.

### Cross-Venue Adaptation Protocol

In embodiments requiring deployment across multiple professional sports venues—such as tournament configurations involving successive matches at geographically distinct stadiums—the system implements a Cross-Venue Adaptation Protocol utilizing transfer learning and domain generalization techniques specifically engineered for professional sports environments. Unlike general indoor positioning systems where environmental adaptation may tolerate extended calibration periods and degraded accuracy during transition, the system disclosed herein must preserve adjudication-grade positioning accuracy (≤ 1/16th inch spatial resolution) while adapting to unseen venues within operationally constrained timeframes.

The Cross-Venue Adaptation Protocol addresses unique domain shift challenges encountered when transitioning between professional sports venues, including: (a) venue-specific multipath signatures arising from distinct architectural geometries, seating configurations, and structural materials; (b) variable electromagnetic interference patterns from broadcast equipment, stadium lighting systems, and spectator electronic devices present in quantities ranging from tens of thousands to over one hundred thousand simultaneous sources; (c) crowd-density-dependent signal attenuation profiles that vary not only between venues but within a single venue across pre-game, active play, and post-game periods; and (d) temporary infrastructure configurations such as tournament-specific field dimensions, portable goal structures, or reconfigured playing surfaces that alter the spatial reference framework relative to permanently installed anchor infrastructure.

The domain generalization methodology employs a pre-trained deep convolutional neural network (DCNN) architecture for Angle of Arrival (AoA) estimation, wherein network parameters have been optimized using aggregated Channel Impulse Response (CIR) data from previously characterized venues. For adaptation to an unseen venue, the system implements a fine-tuning protocol requiring acquisition of a minimal calibration dataset followed by transfer learning weight adjustment that preserves generalized feature representations while adapting output layer parameters to the target venue's propagation characteristics. In at least one embodiment, minimal calibration dataset acquisition is integrated with standard pre-event system verification procedures-referee and officiating crew movement during pre-match field inspection provides sufficient geometric coverage and CIR sample diversity to complete transfer learning adaptation without dedicated calibration sessions.

The Cross-Venue Adaptation Protocol is further distinguished from prior art domain generalization approaches in that: (a) the adaptation must maintain tracking continuity for a plurality of simultaneously tracked elements including players, officials, game balls, and equipment, rather than adapting for single-target scenarios typical of consumer or industrial positioning; (b) the acceptable adaptation-period accuracy degradation is bounded by adjudication requirements rather than navigation convenience thresholds; (c) the system must adapt to venues exhibiting professional sports-specific interference sources including RF-intensive broadcast operations, LED advertising displays operating at frequencies that may couple with positioning signals, and synchronized timing systems used for television production; and (d) the transfer learning protocol must preserve the system's ability to distinguish between similar tracked elements (e.g., distinguishing between two players in close proximity) during the adaptation period, as ambiguous position assignments during live competition would constitute adjudication failure regardless of aggregate accuracy metrics.

### Non-Line-of-Sight Detection Via Statistical Anomaly Modeling

In embodiments addressing Non-Line-of-Sight (NLoS) signal conditions, the system employs statistical anomaly detection methods that model the expected distribution of Line-of-Sight (LoS) signal characteristics and identify NLOS events as deviations from this baseline. This approach is particularly suited to professional sports environments wherein NLOS conditions arise intermittently during body contact, pile-up events, contested possessions, or momentary occlusion-resulting in datasets where NLOS samples are sparse relative to LoS samples. Standard supervised classification methods trained on such imbalanced datasets exhibit degraded NLOS detection accuracy precisely during adjudication-critical moments.

To address this challenge, the system employs Generalized Gaussian Distribution (GGD) modeling of LoS signal parameters, including variance of estimated ranging distance σ²_d and received power of the first signal path P_fp. The GGD probability density function takes the form p (x; μ, α, β)=(β/2αΓ(1/β))×exp (−|x−μ|\hat{ }β/α\hat{ }β), where μ is the location parameter, α is the scale parameter, β is the shape parameter controlling tail behavior, and Γ denotes the gamma function. When β=2, the GGD reduces to the standard Gaussian distribution; values of β<2 accommodate heavier tails characteristic of sports-environment signal variability.

For each incoming UWB measurement, the system computes the likelihood L=p (σ²_d; μ_d, α_d, β_d)×p(P_fp; μ_p, α_p, β_p) based on GGD parameters fitted to historical LOS measurements, flagging measurements as probable NLOS when L falls below threshold L_min calibrated to venue baseline conditions. NLOS-flagged measurements receive enhanced error mitigation, reduced weighting in sensor fusion, or cross-modal verification against independent sensing modalities.

The statistical anomaly detection methodology is not limited to the GGD formulation. Equivalent approaches achieving the functional goal of identifying NLOS conditions through deviation from fitted LoS baselines fall within scope, including: (a) alternate GGD parameterizations employing variance-based scaling, shape parameter inversion (κ=1/β), or log-likelihood formulations of the same underlying distribution; (b) Student's t-distributions or other heavy-tailed parametric families capable of accommodating the excess kurtosis observed in sports-environment signal measurements; (c) Laplace distributions representing the β=1 special case of the GGD family; (d) mixture models combining multiple Gaussian or non-Gaussian components to capture multi-modal signal characteristics; (e) non-parametric kernel density estimates trained on venue-specific LoS calibration data; (f) machine learning classifiers including support vector machines, neural networks, or ensemble methods trained to distinguish LoS from NLOS based on the same underlying signal features; or (g) any probabilistic or deterministic decision function that flags measurements as probable NLOS based on statistical deviation from expected LoS signal characteristics. The inventive concept resides in applying statistical anomaly detection to NLOS mitigation in professional sports adjudication environments—characterized by transient human-tissue occlusion, equipment-material interference, and contact-event-induced signal anomalies—rather than in any specific mathematical formulation.

### Temporal Synchronization Architecture for Distributed Tracking Elements

Adjudication-grade positioning accuracy requires precise temporal alignment across all distributed tracking elements. Without nanosecond-level temporal coherence among UWB micro-tags, fixed anchors, inertial measurement units, touch sensors, and acoustic nodes, spatial relationships computed from time-of-flight measurements would contain systematic errors rendering simultaneous position determinations unreliable for officiating purposes. The temporal synchronization architecture ensures all positioning data streams share a common time reference with sufficient precision that electromagnetic signal propagation delay—approximately 3.3 nanoseconds per meter—does not introduce positional ambiguity exceeding the system's accuracy threshold of one-sixteenth of an inch.

The system employs hierarchical clock distribution wherein a master timing reference, derived from GPS-disciplined oscillators or atomic clock sources, propagates to venue-level timing controllers, zone-level aggregators, and individual tracking elements through wired backbone connections and wireless synchronization protocols. Fixed infrastructure anchors maintain synchronization through wired Ethernet connections supporting IEEE 1588 Precision Time Protocol (PTP), achieving sub-microsecond alignment. Mobile tracking elements synchronize wirelessly through periodic timing beacon exchanges with nearby anchors, employing two-way ranging protocols that compensate for propagation delay and enable clock offset estimation with nanosecond-level resolution.

Each mobile tracking element incorporates a temperature-compensated crystal oscillator (TCXO) sustaining timing accuracy during synchronization gaps. The AI-driven sensor fusion engine monitors clock drift rates and applies predictive drift compensation based on historical oscillator behavior, thermal conditions, and time since last synchronization. When synchronization confidence degrades below adjudication-grade thresholds, the system flags affected position determinations for enhanced scrutiny rather than presenting potentially erroneous data as authoritative.

Timestamp reconciliation protocols align data streams from sensors with disparate sampling rates, communication latencies, and processing delays. Raw sensor measurements receive hardware-level timestamps at acquisition, prior to processing or transmission delay. The central fusion engine reconstructs temporal sequences of physical events—such as the order in which a player's knee, elbow, and ground plane achieved contact during a tackle—by interpolating position estimates to common reference instants and applying latency compensation models. This event sequencing capability is essential for adjudication scenarios where temporal order determines rules outcomes: whether a receiver established possession before or after crossing the boundary plane, or whether contact occurred before or after a throwing motion commenced.

### Acoustic Near-Field Timing Coordination

The temporal synchronization architecture incorporates non-audible acoustic signaling as a supplemental timing coordination layer for high-density event regions where radio-frequency synchronization reliability degrades. Acoustic signals operating in ultrasonic or near-ultrasonic frequency bands propagate through air at well-characterized velocities over short distances, providing a locally coherent temporal reference independent of RF channel conditions. In adjudication-critical zones—goal areas, sideline boundaries, pile-up regions—multiple sensing modalities must timestamp near-simultaneous events with sufficient precision to resolve temporal ordering. When RF congestion from broadcast equipment, spectator devices, or dynamic frequency hopping degrades wireless time distribution reliability, the acoustic timing layer provides an alternative synchronization path. Fixed infrastructure elements or referee-carried mobile nodes emit time-structured acoustic signals that nearby receivers detect and use to refine local clock offsets, compensate for communication latency, and reduce uncertainty in event sequencing.

During stoppages of play, restarts, or adjudication-critical moments, referee-associated acoustic timing beacons enable nearby player-worn tags, ball-embedded sensors, and boundary infrastructure to re-align local clocks prior to resumption of live play, reducing drift accumulation and improving confidence in subsequent event timestamps. This cooperative timing layer operates within the Object-Originated Spatial Awareness paradigm: tracked objects actively participate in establishing temporal coherence rather than passively awaiting external synchronization signals.

Timing data derived from the acoustic layer integrates with the system's Spatiotemporal Integrity Validation mechanisms, enabling post-event verification that adjudication decisions were based on temporally consistent data across all sensing modalities. Acoustic timing signals are authenticated, cooperative, and restricted to authorized system components; the system does not capture or process human-audible sound or ambient audio content.

### Security & Fraud Prevention

### Blockchain-Based Verification Against Fraud and Manipulation:

The Object-Originated Spatial Awareness paradigm extends to data integrity verification: just as tracked objects generate their own spatial data rather than awaiting external observation, tracked objects also generate cryptographically verifiable attestations of their position rather than relying solely on external infrastructure to certify location claims. This architectural consistency—producing the Officiating Proof-of-Position (OPoP) certificates defined in the Inventor's Lexicography—ensures that the security layer operates within the same paradigm inversion as the positioning layer, with objects actively participating in verification rather than serving as passive subjects of external certification.

Consistent with the Spatiotemporal Integrity Validation (SIV) architecture defined in the Inventor's Lexicography, the security layer operates as a pre-attestation gateway screening position data before blockchain commitment or Officiating Proof-of-Position certificate generation. The cryptographic attestation architecture described herein produces an additional characteristic of the system's output that carries significant implications for content protection and jurisdictional enforcement: every Spatially Enriched Broadcast Signal, Volumetric Performance Reconstruction, and Interactive Performance Data Stream produced by the system carries an embedded provenance chain that traces each spatial datum back to a specific EDID-authenticated sensing element at a specific cryptographically attested timestamp. This provenance chain is not an optional metadata layer applied after content production; it is an inherent structural characteristic of content produced through the Object-Originated Spatial Awareness Paradigm, because the spatial data originates from authenticated devices whose identity and measurement integrity are verified at the point of emission. Any entity that receives, retransmits, processes, or commercially exploits content carrying this embedded provenance chain is utilizing a data product whose structural characteristics—specifically, the combination of object-originated spatial data, EDID-authenticated measurement provenance, and unbroken cryptographic attestation—are exclusively producible through the methods and apparatus disclosed herein. The embedded provenance chain therefore serves both an evidentiary function (establishing the trustworthiness of spatial measurements for adjudication purposes) and a rights management function (enabling identification of content derived from the disclosed system regardless of the jurisdiction in which the hardware was manufactured or the data was initially captured).

### Officiating Proof-of-Position Protocol

The system implements an Officiating Proof-of-Position (OPoP) protocol wherein tracked objects generate cryptographically verifiable position attestations through collective agreement of multiple independent positioning sources. Unlike general-purpose Proof-of-Location systems designed for consumer location-based services—which typically verify proximity to fixed infrastructure beacons with meter-level accuracy sufficient for geofencing applications—the Officiating Proof-of-Position protocol is specifically engineered for professional sports adjudication requirements, wherein boundary-crossing determinations, contact events, and rules enforcement depend on sub-millimeter positional accuracy under conditions of physical occlusion, electromagnetic interference, and high-velocity motion.

The OPoP protocol operates through a distributed attestation architecture wherein each positioning modality contributing to the sensor fusion engine—including Ultra-Wideband ranging, inertial measurement integration, acoustic near-field confirmation, touch and proximity sensing, and optical tracking where available—generates a partial position attestation comprising a timestamped position estimate, a confidence metric, and a cryptographic signature derived from modality-specific sensing hardware. These partial attestations are aggregated through a threshold signature scheme requiring a configurable minimum number of independent modality confirmations—for example, at least three of five available modalities—before generating a valid collective Officiating Proof-of-Position. This threshold aggregation ensures position proofs cannot be generated or forged through manipulation of any single sensing modality, providing Byzantine fault tolerance against individual sensor failure, calibration drift, environmental interference, or adversarial tampering.

Mobile anchor elements—including referee-worn positioning devices, player-worn tag arrays operating in anchor mode, and ball-embedded sensors—participate in the OPoP attestation protocol as independent witnesses whose proximity-verified ranging measurements contribute to the collective position proof. When fixed perimeter anchors experience degraded line-of-sight during pile-up events, goal-mouth scrambles, or dense player formations, mobile anchor witnesses provide localized attestation maintaining position proof validity through occlusion events. Referee-worn mobile anchors serve dual function as both positioning infrastructure and OPoP witnesses, enabling position proofs incorporating official proximity verification alongside automated sensor measurements.

OPoP attestation is selectively generated for adjudication-critical events—boundary crossings, goal-line determinations, contact events, possession changes—rather than continuously for all position updates, concentrating cryptographic verification resources on events most likely to require evidentiary support. Each OPoP certificate is incorporated into the blockchain-backed audit ledger with associated metadata including contributing modalities, confidence scores, and environmental conditions, enabling post-event reconstruction of the evidentiary basis for any officiated determination.

The Officiating Proof-of-Position protocol is distinguished from prior art consumer Proof-of-Location systems by adaptation to professional sports constraints: tracked entities engage in non-cooperative, high-velocity physical competition rather than cooperative location proof scenarios; attesting infrastructure must preserve athletic performance characteristics; accuracy requirements are bounded by official rules specifications rather than approximate geofencing tolerances; and position proofs must withstand scrutiny in contexts where officiating determinations affect competitive outcomes, athlete safety, and potentially legal liability, imposing evidentiary standards substantially exceeding consumer location verification requirements.

### Spatiotemporal Integrity Validation

The system implements a Spatiotemporal Integrity Validation (SIV) module operating as a pre-attestation screening layer between the sensor fusion engine and the blockchain-backed audit ledger. The SIV module receives candidate position updates from the multi-modal sensor fusion pipeline and subjects each update to physics-constrained plausibility tests before permitting incorporation into the tamper-evident record or generation of Officiating Proof-of-Position certificates.

The Spatiotemporal Integrity Validation architecture comprises a two-stage verification pipeline materially distinct in methodology from machine learning fraud detection systems deployed in financial blockchain networks. In the first stage, a pre-insertion anomaly detector evaluates incoming position data against kinematic plausibility constraints derived from human biomechanical models and equipment physical properties. Position updates reporting velocities, accelerations, or trajectory curvatures exceeding established physical limits—such as a player allegedly traversing ten meters in fifty milliseconds, or a ball exhibiting instantaneous direction reversal without contact event—are flagged as anomalous and withheld from blockchain commitment pending secondary verification. Kinematic constraint models are parameterized by sport-specific profiles accounting for distinct motion characteristics; maximum sustainable sprint velocity for a soccer player differs from peak skating speed of a hockey player, and the system maintains separate constraint libraries for each supported sport type.

In the second stage, a cross-modal consistency validator examines agreement between position estimates contributed by independent sensing modalities, computing divergence between UWB-derived position, IMU-integrated trajectory, acoustic ranging confirmation, and touch sensor spatial inference. Updates exhibiting statistically improbable divergence—wherein one modality reports position substantially inconsistent with consensus of other modalities—trigger anomaly classification. The cross-modal validator employs ensemble machine learning classifiers including gradient boosting decision trees and random forest aggregation, trained on labeled datasets comprising both legitimate multi-modal position data and synthetically generated spoofing scenarios.

The SIV module implements temporal continuity enforcement, rejecting position updates requiring physically impossible displacement rates relative to the immediately preceding validated position. A position claim at time t₂ is rejected if the Euclidean distance to the validated position at time t₁ exceeds the product of maximum physically achievable velocity v_max and the elapsed time interval (t₂−t₁), with appropriate margin for measurement uncertainty. This continuity enforcement prevents injection of fabricated position data that might satisfy instantaneous plausibility tests but violates trajectory coherence over time.

The SIV module is distinguished from prior art financial fraud detection systems—which analyze transaction graphs, spending patterns, and account behavior profiles—by reliance on physics-constrained validation rather than pattern-based anomaly scoring. Financial fraud detection identifies anomalies by comparing transaction characteristics against historical behavioral baselines; Spatiotemporal Integrity Validation identifies anomalies by comparing position claims against immutable physical laws governing motion in three-dimensional space. This physics-grounded methodology provides detection capability against novel attack vectors not present in training data, as any manipulation attempt must ultimately produce position claims that either satisfy or violate fundamental kinematic constraints regardless of attack technique sophistication.

In certain embodiments, the SIV module maintains a quarantine buffer for position updates classified as anomalous but not definitively fraudulent, enabling retrospective validation once additional temporal context becomes available—for example, reclassifying as legitimate a position update that initially appeared to violate velocity constraints if subsequent updates reveal the tracked entity was engaged in a fall or collision event temporarily exceeding normal kinematic parameters.

### LoRaWAN and IoT Security:

The present invention incorporates LoRaWAN (Long Range Wide Area Network) as a low-power, wide-area communication backbone enabling the Infrastructure-Independent Localization Mode disclosed herein. While Ultra-Wideband provides the primary ranging and positioning capability, LoRaWAN serves as the coordination layer through which distributed tracking elements—player-worn tags, referee devices, ball-embedded sensors, portable boundary markers—establish and maintain the cooperative spatial mesh without dependence on permanently installed venue infrastructure.

In Infrastructure-Independent Localization Mode, tracked objects must coordinate their spatial relationships, synchronize timing references, exchange role designations (tag-only versus dual-function anchor-and-tag), and aggregate partial position data into collective spatial determinations—all without relying on fixed infrastructure that may be unavailable, damaged, or not yet installed. LoRaWAN's architectural characteristics make it uniquely suited to this coordination function: support for thousands of low-power devices within a single network; range sufficient to span stadium-scale venues including outdoor practice fields, player tunnels, and parking areas; minimal infrastructure requirements (a single gateway can coordinate an entire venue); and power consumption compatible with battery-operated wearables and equipment-embedded sensors operating throughout extended competitions.

The LoRaWAN layer enables several operational scenarios that fixed-infrastructure-dependent systems cannot support:
Tournament and Temporary Venue Deployment: When competitions occur at venues lacking permanent positioning infrastructure—international tournaments, neutral-site championships, outdoor exhibition matches—the LoRaWAN backbone enables rapid deployment of adjudication-grade tracking using only portable equipment transported with the officiating crew. Referee-worn devices, portable boundary pylons with embedded LoRaWAN gateways, and equipment-embedded sensors establish a complete tracking mesh within the pre-match setup window without requiring venue modification or permanent installation.
Outdoor Training and Practice Environments: Professional athletic training frequently occurs on practice fields, outdoor facilities, and temporary installations where permanent UWB anchor infrastructure would be impractical or cost-prohibitive. The LoRaWAN coordination layer extends tracking capability to these environments, enabling biomechanical analysis, technique coaching, and injury-risk monitoring with the same equipment used during competition.
Redundant Communication During RF Congestion: Stadium environments during major events present extreme RF congestion from broadcast equipment, spectator devices, LED displays, and production systems. When primary communication channels experience degradation, the LoRaWAN backbone provides a resilient fallback coordination path operating in sub-GHz frequency bands less susceptible to the interference sources concentrated in higher frequency allocations.
Extended-Duration Event Sustainment: Multi-day tournaments, doubleheaders, and events with extended pre-game and post-game coverage require tracking elements to maintain coordination across timeframes exceeding typical battery-intensive communication protocols. LoRaWAN's low-power characteristics enable sustained mesh coordination without depleting the batteries powering embedded sensors and wearable tags.

The LoRaWAN architecture implements security measures appropriate to adjudication-grade positioning data: end-to-end AES-256 encryption protecting position data in transit; device authentication ensuring only authorized equipment participates in the spatial mesh; and integration with the Spatiotemporal Integrity Validation module for anomaly detection identifying potential spoofing or injection attacks. The long-range transmission characteristics that enable wide-area coordination also increase exposure to eavesdropping and replay attacks; the encryption and authentication layers mitigate these vulnerabilities while preserving the operational flexibility that LoRaWAN provides.

The LoRaWAN communication architecture is distinguished from consumer IoT deployments-smart home devices, agricultural sensors, asset tracking—by the professional sports adjudication requirements it must support: real-time coordination latency bounded by officiating decision timelines rather than periodic reporting acceptable for environmental monitoring; security requirements driven by competitive integrity and potential legal liability rather than consumer convenience; device density and update rates reflecting dozens of simultaneously tracked athletes rather than sparse sensor deployments; and Physical Compliance constraints requiring communication hardware integrated into athletic equipment without affecting performance characteristics. Consumer LoRaWAN deployments optimize for battery longevity and minimal infrastructure cost; the adjudication-grade LoRaWAN architecture disclosed herein optimizes for coordination reliability, security, and seamless integration with the broader multi-modal positioning system.

### Mathematical Formula Reference Notice and Functional Equivalence Statement

The mathematical formulas contained in this specification employ Greek letters, subscripts, superscripts, and specialized mathematical notation that may render inconsistently across different word processing applications, PDF converters, operating systems, and character encoding standards. To ensure the precise mathematical expressions intended by the inventor are preserved without ambiguity, a formula reference image is incorporated herein by reference and should be considered the authoritative representation of all mathematical formulas appearing in this specification. In the event of any discrepancy between the inline text rendering of a formula and the corresponding formula appearing in the referenced image, the image shall govern.

### Functional Equivalency Declaration:

The specific mathematical formulas disclosed throughout this specification—including but not limited to the Generalized Gaussian Distribution probability density function, likelihood threshold computations, convex envelope membership tests, composite eligibility scoring functions, rotation estimation residuals, and uncertainty scaling relationships—represent preferred embodiments selected for clarity of exposition and computational tractability. These formulas are not intended to limit the scope of the claimed invention to their specific mathematical form. Practitioners skilled in the art of statistical signal processing, computational geometry, optimization theory, sensor fusion, and machine learning will recognize that each disclosed formula admits mathematically equivalent reformulations, alternate parameterizations, logarithmic transformations, and functionally similar alternative approaches that achieve substantially the same result through substantially the same means. Such equivalents—whether employing different variable naming conventions, alternative distributional families, transformed coordinate systems, or substitute algorithmic implementations—fall within the scope of the disclosed invention when applied to the same functional purpose within the context of multi-modal positioning for professional sports adjudication. The inventive concepts disclosed herein reside in the application of statistical anomaly detection to NLOS mitigation, geometric containment testing to dynamic role allocation, and multi-modal sensor fusion to rotation estimation under Physical Compliance constraints, rather than in the specific mathematical symbols or algebraic arrangements employed to express these concepts. Any claim interpretation that would limit the invention to a single mathematical formulation while excluding functionally equivalent alternatives would be contrary to the inventor's intent and inconsistent with the full scope of the disclosure.

The performer spatial assembly and venue spatial assembly architecture disclosed herein is domain-agnostic: a performer spatial assembly denotes any federation of EDID-bearing instrumented entities whose spatial states are to be determined, and a venue spatial assembly denotes any federation of EDID-bearing spatial delimiters that define the adjudicative coordinate frame of the operating environment. Neither construct is specific to athletic competition. The following embodiments demonstrate the architecture's application across non-sports domains, each presenting spatial tracking challenges that the external observation paradigm cannot resolve and that the present invention addresses through object-originated, identity-attributed spatial emission (see FIG. 16).

Medical Rehabilitation and Physical Therapy. Instrumented joint braces, compression garments, and orthotic devices constitute performer spatial assemblies in clinical rehabilitation environments. EDID-bearing sensing elements embedded in therapeutic equipment emit Timestamped Spatial Emission Data reflecting limb geometry, joint angle trajectory, and deformation state across rehabilitation exercises without requiring external camera observation that is occluded by clinic furniture, therapist positioning, and clothing layers. The Cooperative Spatial Mesh captures bilateral asymmetry by processing simultaneous emissions from instrumented left and right limbs, resolving mutual occlusion events—one limb crossing in front of the other during a therapy exercise—that defeat external camera-based systems. The durational contact-state topology captured between instrumented limb and therapy surface provides quantitative rehabilitation progress metrics at a resolution that visual observation cannot achieve. Physical Compliance requirements parallel sports equipment requirements: instrumented therapeutic devices must preserve the biomechanical properties of the therapeutic intervention, including joint loading curves, compression gradients, and range-of-motion limits specified in the treatment protocol.

Industrial Safety and Worker Monitoring. Instrumented personal protective equipment—hard hats, safety harnesses, cut-resistant gloves, steel-toed footwear—constitutes performer spatial assemblies in industrial environments. Instrumented machinery housings, restricted-zone boundary markers, and equipment exclusion perimeter elements constitute venue spatial assemblies. The Cooperative Spatial Mesh provides continuous spatial monitoring of worker proximity to hazardous machinery without requiring line-of-sight observation that is obstructed by structural elements, machinery bodies, airborne particulate, and environmental conditions endemic to industrial facilities. Contact events between worker protective equipment and machinery surfaces are characterized with durational precision—onset, duration, intensity distribution, and termination—rather than binary event detection, providing a contact-state record sufficient for regulatory compliance documentation, incident reconstruction, and equipment wear-cycle monitoring (see FIG. 8). The topographical registration procedure establishes the precise coordinate frame of all instrumented machinery and zone boundaries at the start of each shift, with the genesis block anchoring all worker proximity records to the session coordinate frame.

Theatrical and Dance Performance. Instrumented costumes, props, and stage set elements constitute the Cooperative Spatial Mesh in live performance environments. The Forensic Replay Ledger captures continuous durational contact-state topology between performers and between performers and instrumented props—the graduated compression of a costume element during a supported lift, the dwell time of contact between a dancer and a partner—creating a performance record that cannot be reconstructed from external camera observation after the event. The EDID attribution chain creates cryptographically verifiable performer identity records linking each spatial data record to the specific instrumented garment worn by the identified performer, providing the technological infrastructure for NIL rights enforcement, royalty distribution, and posthumous performance licensing in contexts where the performed motion is the subject of intellectual property claims.

Veterinary and Equine Performance Monitoring. Instrumented saddle equipment, leg wraps, and performance harnesses on equine athletes constitute performer spatial assemblies. Track boundary markers, jump uprights, and gate elements constitute venue spatial assemblies. The system captures the three-dimensional spatial state of the animal and its equipment through EDID-bearing sensors embedded in the equipment itself, without requiring the animal to cooperate with external observation infrastructure or tolerate external sensor placement that affects natural movement. Physical Compliance requirements are analogous to sports equipment requirements: instrumented equipment must preserve the animal's natural gait, weight distribution, and performance characteristics, and must satisfy all applicable equine welfare and competition equipment regulations.

Spatiotemporal Integrity Validation—Operational Sequence. The Spatiotemporal Integrity Validation process operates as a pre-attestation gateway positioned between the sensor fusion engine output and the Forensic Replay Ledger (see FIG. 15). SIV receives each candidate Spatiotemporal Data record produced by the AI-driven sensor fusion engine and subjects it to a three-stage validation sequence before the record is eligible for OPoP attestation or ledger commitment (see FIG. 18).

In the first stage, physics-constrained plausibility testing evaluates the candidate record against three categories of biomechanical and physical constraints. Kinematic capability testing confirms that the reported position change between the candidate record and the immediately preceding validated record for the same EDID-attributed entity is consistent with the biomechanical velocity and acceleration constraints of the tracked object class—a game ball cannot transition from rest to maximum recorded flight velocity without an associated force event record; a performer's extremity cannot appear at a spatial coordinate without a continuous trajectory record linking it to its prior position. Spatial boundary testing confirms that the reported position remains within the defined tracking volume and does not penetrate registered venue infrastructure elements whose coordinates were fixed during topographical registration. Inter-object consistency testing confirms that the spatial states of simultaneously tracked EDID-attributed entities are mutually physically consistent—two solid objects cannot occupy the same spatial volume without a registered contact event.

In the second stage, an ensemble machine learning classifier evaluates the candidate record for signatures associated with sensor manipulation, spoofing, transmission corruption, and systematic sensor failure modes. The ensemble comprises gradient boosting classifiers, random forest aggregators, and neural classifiers trained on synthetically generated manipulation signatures and historically observed sensor anomaly patterns. Each classifier independently scores the candidate record; the ensemble aggregate score is compared against configurable confidence thresholds. Records scoring above the clean-pass threshold proceed to OPoP attestation. Records scoring in the confidence-degraded band proceed to OPoP attestation with reduced confidence weighting recorded in the OPoP certificate. Records scoring below the rejection threshold are quarantined from ledger commitment, flagged for forensic review, and excluded from the adjudicative record.

In the third stage, cross-modal agreement verification confirms that the contributing modalities—UWB ranging, IMU inertial data, acoustic near-field ranging, and TENG contact sensing—produce mutually consistent determinations within reconciliation thresholds. Modality outputs within the reconciliation threshold are resolved by weighted voting using the modality confidence scores carried in each Stage 1 Timestamped Spatial Emission Data record. Modality conflicts exceeding the reconciliation threshold are resolved by the Dynamic Authority Modulation architecture, which assigns adjudicative authority among contributing modalities based on context-defined relevance criteria applied at the time of the conflict.

Officiating Proof-of-Position—Operational Sequence. OPoP attestation is generated for adjudication-critical events—boundary crossings, goal-line determinations, contested possession events, and out-of-bounds determinations—identified by the Dynamic Authority Modulation architecture as requiring cryptographic evidentiary verification. Not every Spatiotemporal Data record receives OPoP attestation; the attestation architecture concentrates verification resources on events most likely to require evidentiary support in officiating review or legal proceedings.

An OPoP certificate is constructed through distributed attestation: each contributing modality submits a cryptographically signed attestation of its contribution to the fused position determination, identifying its EDID, its Stage 1 Timestamped Spatial Emission Data records contributing to the fusion, its modality-specific confidence score, and its signed commitment to the fused output. Referee-worn mobile anchors contribute proximity-verified ranging attestations as independent physical witnesses to the determination, providing a non-electronic corroboration layer. The OPoP certificate aggregates these independent attestations into a single verifiable proof that the stated spatial determination was produced by the identified EDID-bearing components at the stated nanosecond-resolution timestamp.

Forensic Replay Ledger—Architecture and Operational Description. The Forensic Replay Ledger is a session-specific, append-only distributed ledger initialized at the start of each performance session during pre-performance topographical registration and terminated at session close. It is not a general-purpose blockchain but a purpose-built spatial adjudication and performance attestation architecture whose scope is bounded by the performance session and whose write authority is distributed among the authorized nodes of the Cooperative Spatial Mesh.

The ledger is initialized through a genesis block generated during topographical registration. The genesis block contains the venue identifier, session identifier, session-start timestamp at nanosecond resolution, the complete venue coordinate frame definition derived from topographical registration of all venue spatial assembly elements, a cryptographic hash of the topographical registration scan data, and the EDID identifiers and registered positions of all VSA components and all PSA federations active at session initialization. The genesis block is committed to the distributed ledger nodes through threshold consensus before any performance-phase records are written, establishing an immutable coordinate and identity ground truth against which all subsequent records are validated (see FIG. 20).

Performance-phase records are written to the ledger in two categories. Continuous Spatiotemporal Data records—the full stream of SIV-validated position determinations for all tracked EDID-attributed entities—are written at the sensor fusion engine's output rate, each entry carrying the originating EDID identifiers, the validated three-dimensional coordinates, the nanosecond timestamp, the ensemble confidence score, and the chain hash linking it to the preceding entry. OPoP-attested records—the subset of adjudication-critical events that have received full OPoP certificate construction—are written as compound entries containing the Spatiotemporal Data record and the complete OPoP certificate with all contributing modality attestations and referee proximity witness signatures. All entries are append-only; no entry can be modified or deleted after consensus commitment.

Immutability is enforced through distributed threshold consensus: no single node controls write authority, and no entry achieves ledger commitment without cryptographic agreement from a quorum of distributed ledger nodes. This architecture eliminates the single-point-of-failure vulnerability that makes production metadata—camera logs, editorial records, operator-annotated event flags—inadequate for evidentiary purposes, because any single node's records can be fabricated or corrupted without affecting the consensus record.

Retrieval for officiating review is executed by event timestamp and EDID identifier, returning the complete OPoP certificate with contributing attestations in milliseconds. The retrieval replaces the process of examining footage to estimate a spatial state with the process of retrieving a stored and attested spatial determination—the difference between reconstruction and recall. For legal, arbitration, and regulatory proceedings, the cryptographic chain from genesis block through the contested entry constitutes an unbroken provenance record independently verifiable by any party with access to the ledger's public verification infrastructure, without requiring the testimony of any operator who was present at the performance.

### ILLUSTRATIONS

### Illustrative Nature of the Drawings:

The accompanying drawings are provided for purposes of illustration and explanation of the inventive principles disclosed herein. The drawings depict representative embodiments and structural relationships in a form sufficient to enable a person having ordinary skill in the art to understand and practice the invention as described in this specification. The illustrated embodiments are not intended to limit the invention to any particular physical configuration, geometric proportion, material composition, scale, component placement, or implementation-specific design, and the systems, assemblies, and components depicted may be realized across a wide variety of equipment types, sporting environments, technological platforms, and operational contexts, including configurations not yet standardized at the time of filing or that are governed by rules and equipment specifications adopted or revised after the filing date of this application. The drawings depict object-originated, identity-attributed spatial structures as described in this specification and are not intended to represent externally observed, passively captured, or post-hoc reconstructed geometries. Where a drawing is susceptible to multiple interpretations, the written description set forth in this specification shall control, and the drawings shall be interpreted in a manner consistent with the functional, structural, and architectural principles expressly set forth herein. Variations, substitutions, rearrangements, and modifications of the illustrated embodiments that remain consistent with the disclosed principles and that do not depart from the scope of the appended claims are expressly contemplated.

FIG. 1, adapted from the parent application (U.S. application Ser. No. 17/461,021), depicts the four-level identity abstraction from two-dimensional point representation to three-dimensional EDID-attributed deformable volumetric form. FIG. 1A illustrates a PSA session record as a federated decentralized identifier (DID) string with per-component EDID assignment. FIG. 1B illustrates the pre-performance session-bound topographical registration procedure (Weigh-In) by which all EDID-bearing components of a performer spatial assembly are bound into a single federated adjudicative identity and registered against a vector-based topographical wireframe representation of the performer's three-dimensional surface contours.

FIG. 2, adapted from the parent application, depicts the deformable volumetric boundary of a game ball performer spatial assembly across free-flight and contact states. FIG. 2A-2G illustrate that the adjudicative boundary is the outer surface of the deformable volumetric form rather than a centroid or rigid shell approximation, and depict the ball-to-field-marking contact geometry at the adjudicative threshold.

FIG. 3, adapted from the parent application, depicts Dynamic Authority Modulation across an American football play scenario. The figure illustrates per-PSA authority ranking—from ball carrier at highest priority through distal defender at lowest—and shows goal-line delimiter emission from the venue spatial assembly cooperating with performer spatial assembly emissions to produce the EDID-Attributed Deformable Volumetric Boundary Determination in real time.

FIG. 4, comprising FIG. 4A-4E, depicts the game ball as a performer spatial assembly, illustrating EDID-bearing sensor panel placement on the ball surface across multiple embodiment configurations.

FIG. 5, comprising FIG. 5A-5F, depicts venue spatial assembly boundary array configurations embedded in the field surface, illustrating distributed EDID-bearing emitter placement defining the adjudicative boundary zone.

FIG. 6, comprising FIG. 6A-6D, depicts goal-line boundary determination, showing the cooperative emission geometry between ball performer spatial assembly and venue spatial assembly boundary array elements at the adjudicative threshold.

FIG. 7 depicts the multi-layer garment authority architecture and durational contact-state characterization, illustrating differential displacement computation between outer and inner EDID-bearing equipment layers—the displacement gap between outer and inner layer positional records serving as the primary adjudicative signal—the authority reversal logic driven by adjudicative event type, and the two-of-three consensus tie-breaking logic governing cross-validation among distributed filament sensors.

FIG. 8 depicts the Ballet Litmus Test temporal contact-state topology timeline, illustrating continuous durational characterization of contact type, foot—surface region, kinematic parameters, and EDID attribution across a sequential pose-transition performance-establishing that the system captures graduated contact-state progression and duration rather than binary event detection.

FIG. 9 depicts the cryptographic provenance chain from EDID document through emission, compilation, transmission, Spatiotemporal Integrity Validation, and forensic replay ledger anchoring, establishing tamper-evident attribution continuity from the point of origination within the EDID-bearing component through adjudication.

FIG. 10, comprising FIG. 10A-10F, depicts jersey and garment performer spatial assembly embodiments, including the EDID-bearing junction fastener inter-layer conductor configuration providing signal continuity between anatomical proximity layers.

FIG. 11, comprising FIG. 11A-11E, depicts hard-shell protective equipment (helmet), venue spatial assembly fixed anchor hardware, goal net venue spatial assembly delimiter, and woven conductive filament three-dimensional antenna embodiments.

FIG. 12, comprising FIG. 12A-12C, depicts triboelectric nanogenerator (TENG) energy harvesting layer integration, a hockey stick as a non-ball game object performer spatial assembly, and a vehicular embodiment illustrating application of the OOASAP architecture across non-sporting mobile platforms.

FIG. 13 depicts the five paradigm inversion identifiers cataloguing the structural inversions of the Object-Originated Spatial Awareness Paradigm relative to the external observation paradigm: PI-01 (Measurement Causality Inversion), PI-02 (Infrastructure Conceptual Inversion), PI-03 (Collision-Assumptive Inversion), PI-04 (Deformable-Body and Boundary-Primary Inversions), and PI-05 (Dynamic Adjudicative Relevance Hierarchy Inversion), showing the full cooperative spatial mesh architecture with performer spatial assemblies and venue spatial assembly as peer contributors.

FIG. 14 depicts the complete Object-Originated Spatial Awareness data flow from cooperative spatial mesh emission through the two-stage pipeline-Stage 1 Timestamped Spatial Emission Data to Stage 2 Spatiotemporal Data—to the EDID-Attributed Deformable Volumetric Boundary Determination, illustrating all emission modalities, compilation, transmission, and the contributions of performer spatial assembly, venue spatial assembly, and mobile anchor.

FIG. 15 depicts the sensor fusion pipeline from input modalities through pre-processing, fusion core, and output generation to the EDID-Attributed Deformable Volumetric Boundary Determination and Forensic Replay Ledger, including the Ground Truth Data Store, Pre-Performance Topographical Registration Data input, the live-performance Calibration Correction feedback path for continuous drift-correction, and the Continuous Refinement Feedback Loop. FIG. 20, presented on the same sheet, depicts the Genesis Block/Weigh-In Ledger Anchor establishing session-bound EDID federation and topographical registration as the cryptographic ground truth anchor for the performance session.

FIG. 16 depicts the paradigm inversion comparison between the external observation paradigm and the Object-Originated Spatial Awareness Paradigm, illustrating the Primary Spatial Identity Record and its derived projections—Volumetric Frame Sequence, Identity Trajectory Manifold, Contact-State Event Topology, Spatiotemporal Field Representation, and Performance-Topology Representation—and establishing that identity originates the spatial data rather than being assigned to geometry after external observation.

FIG. 17 depicts the overhead geometry of reciprocal ranging within the cooperative spatial mesh, showing performer spatial assemblies, game ball, mobile anchor, and venue spatial assembly fixed anchors as peer contributors to the distributed ranging network without a central coordinating hub.

FIG. 18 depicts the Spatiotemporal Integrity Validation gate enforcing Kinematic Plausibility Bounds, Cross-Modal Consistency Check, and Temporal Continuity Enforcement between Stage 1 Timestamped Spatial Emission Data and Stage 2 validated Spatiotemporal Data, with validated data proceeding to Officiating Proof-of-Position attestation and rejected data excluded from the adjudicative record.

FIG. 19, presented on the same sheet as FIG. 18, depicts the Dynamic Adjudicative Relevance Hierarchy across STATE A and STATE B game configurations, illustrating that authority rank assignments among performer spatial assemblies are dynamically reassigned based on game state and are never permanently fixed by roster position or pre-configured priority order.

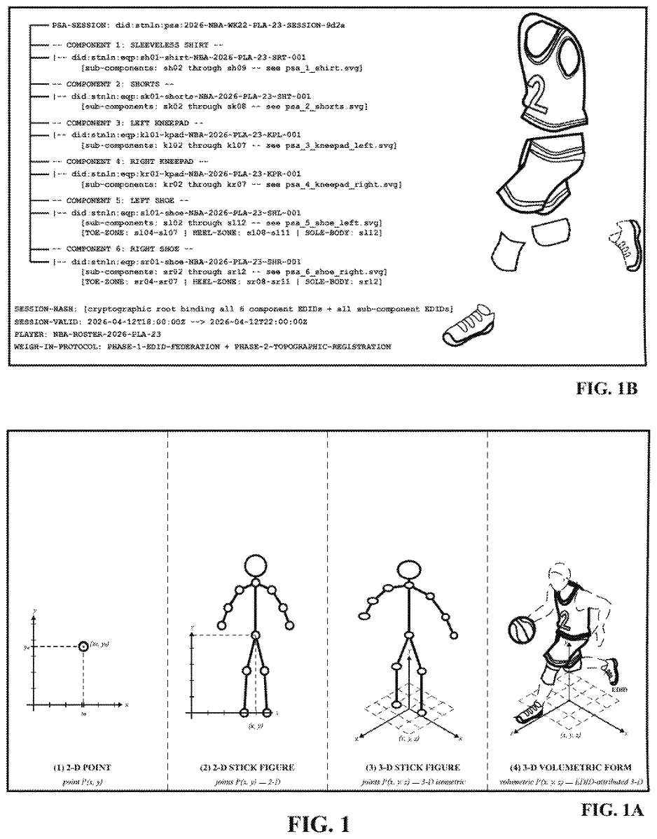

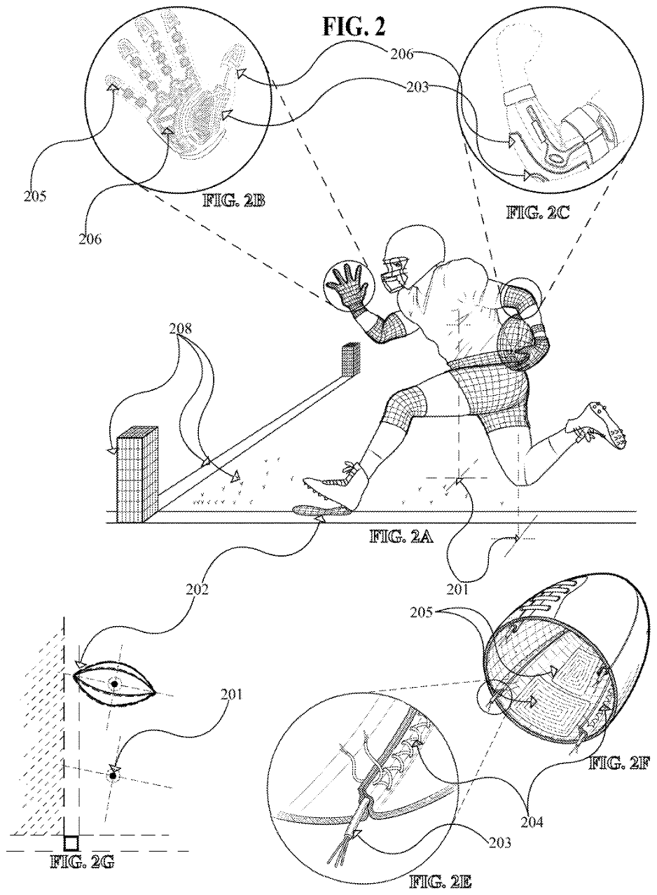

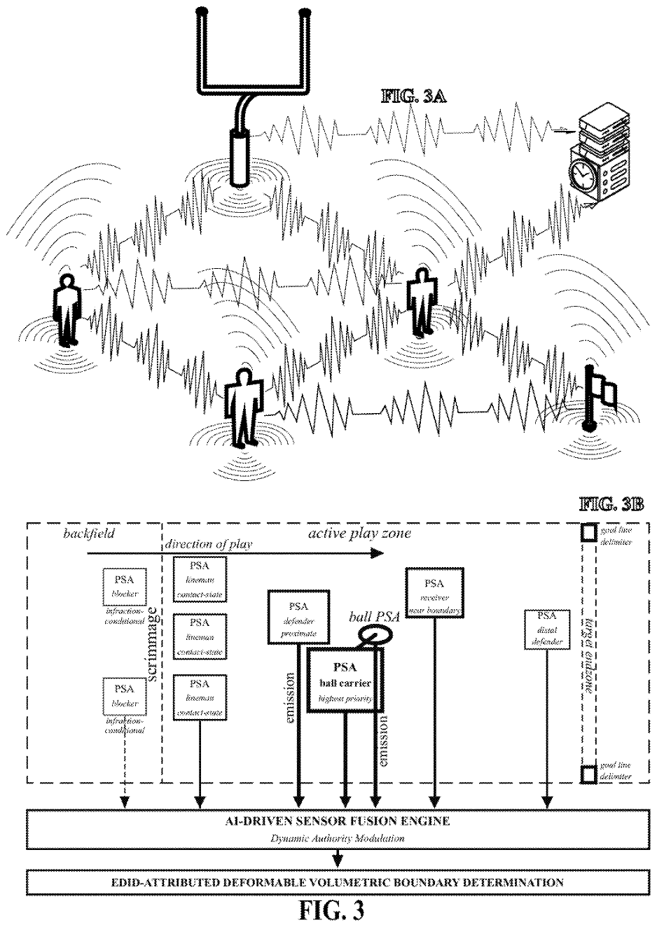

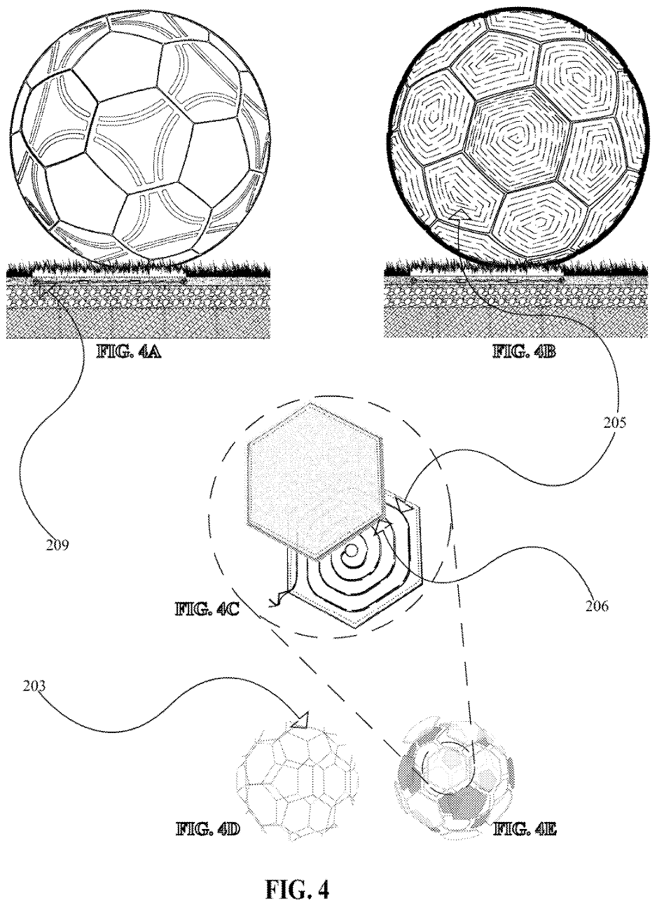

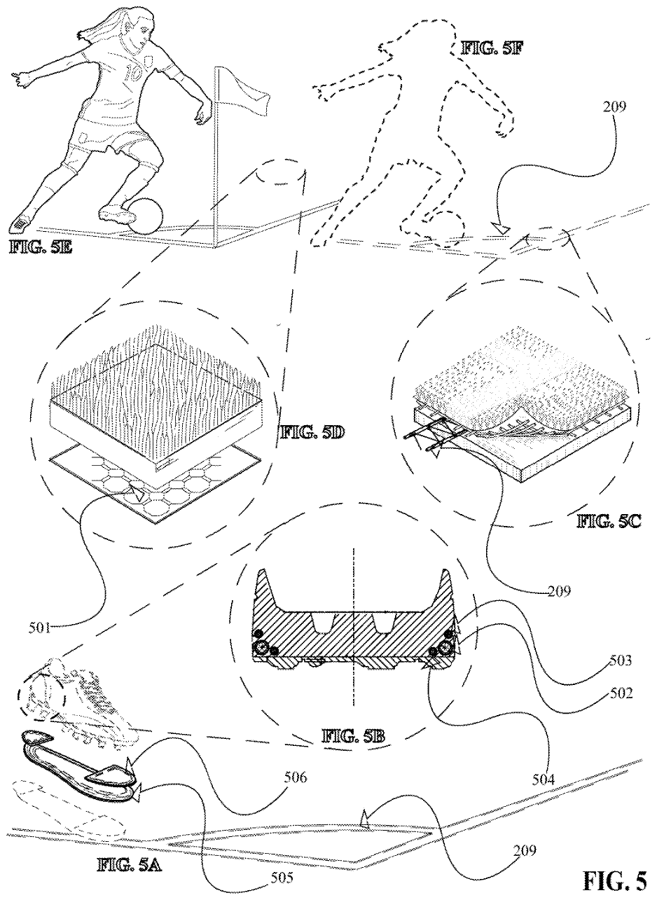

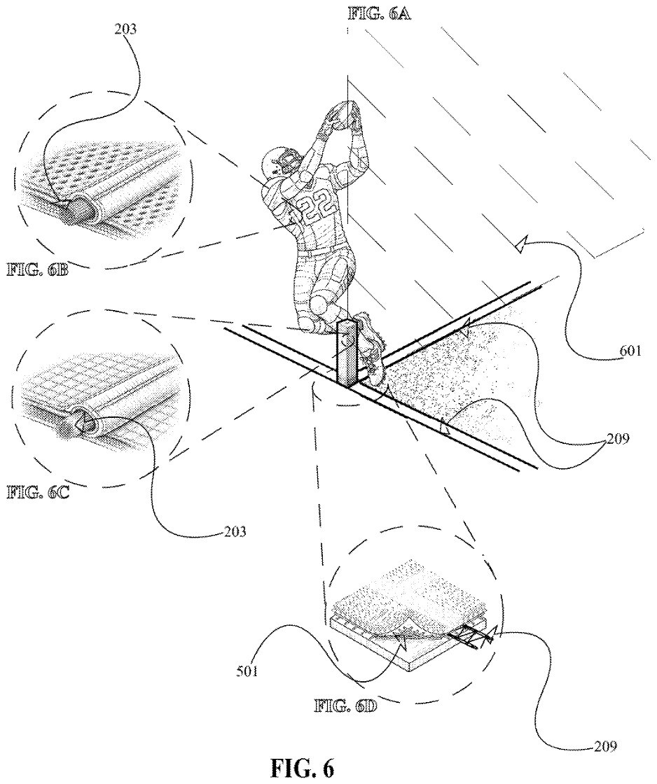

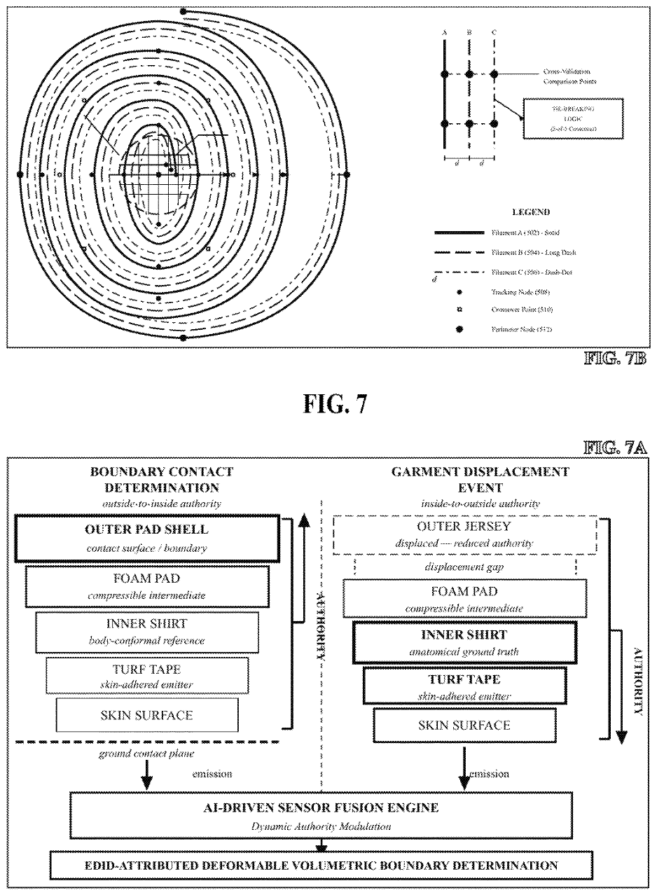

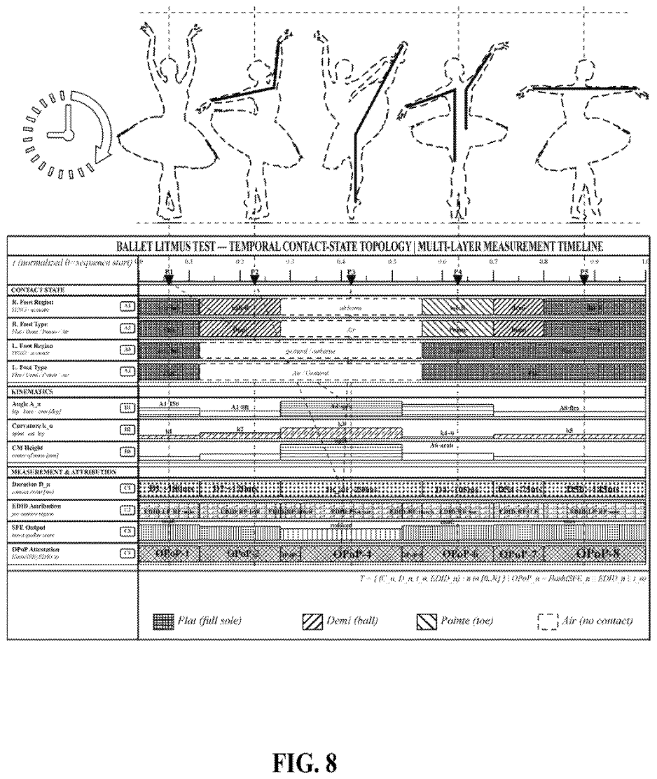

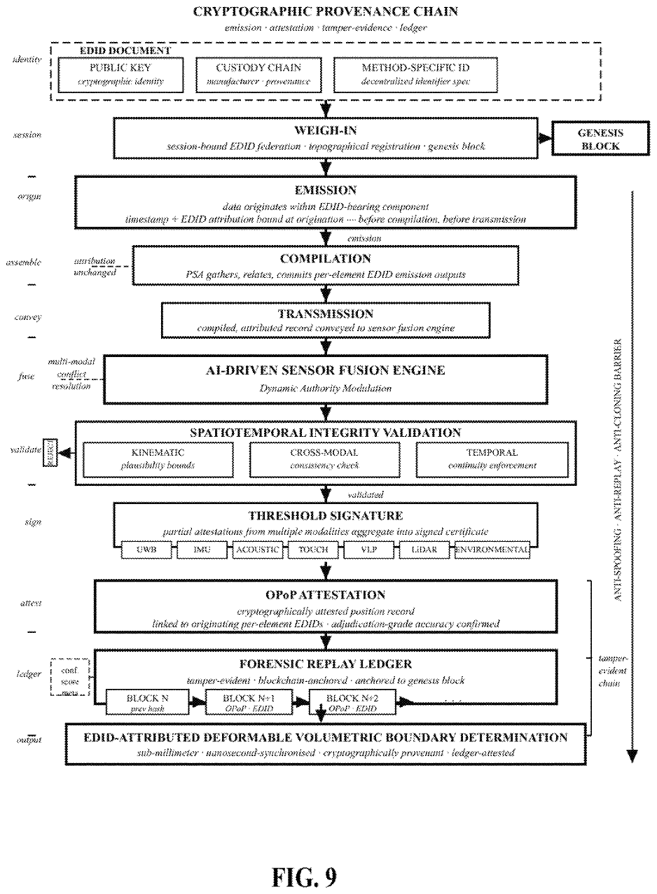

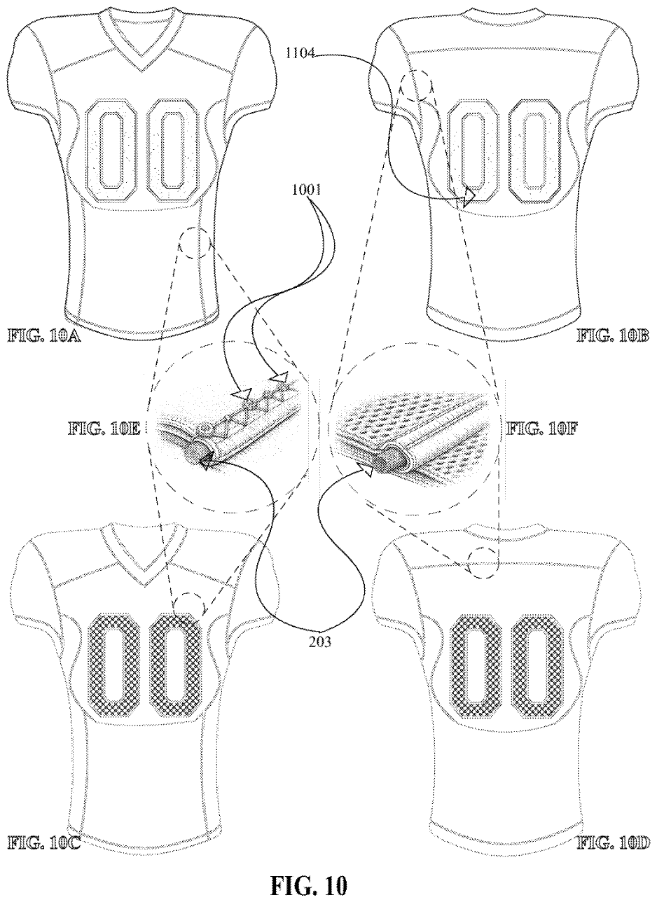

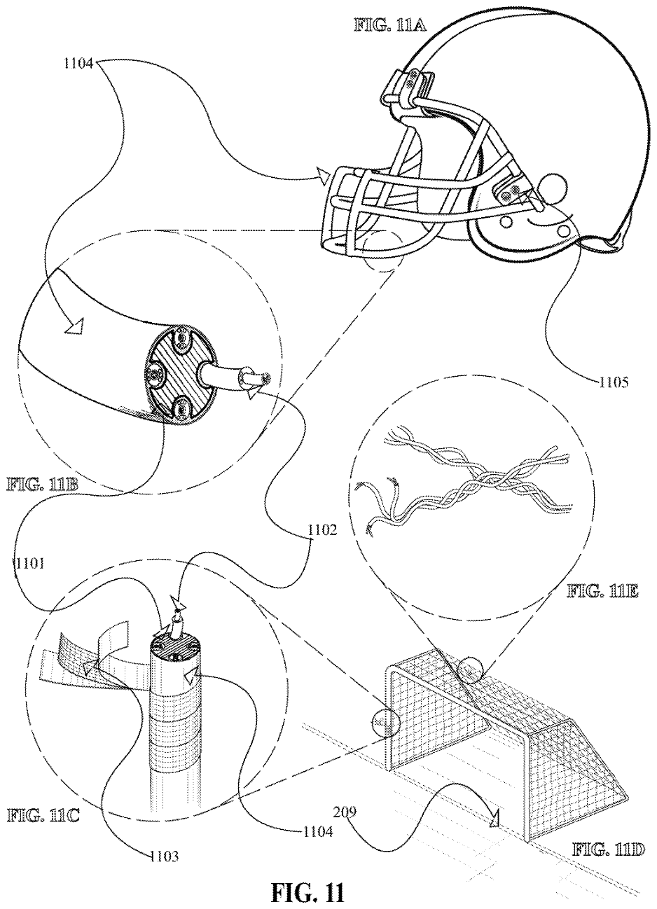

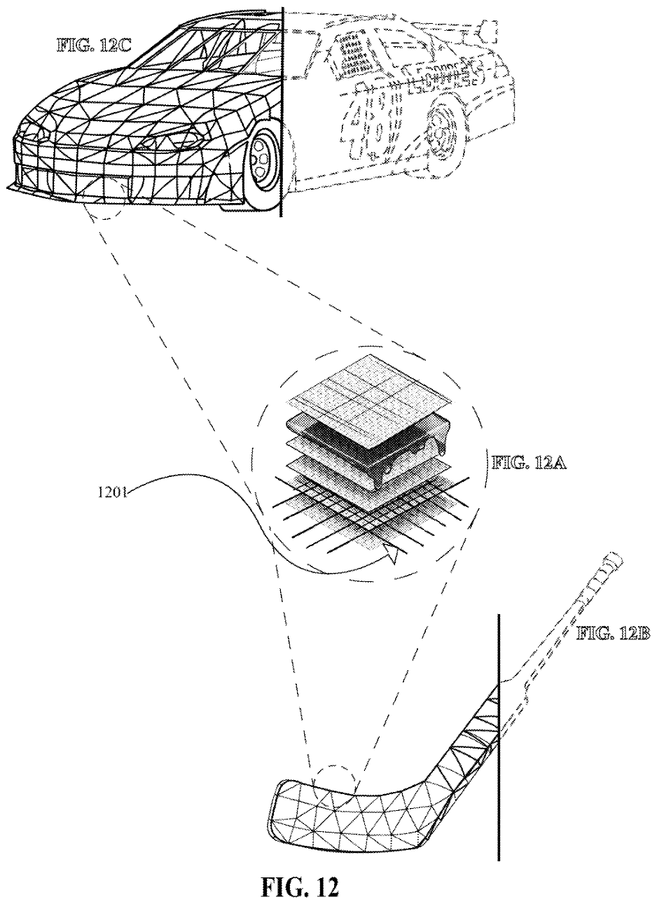

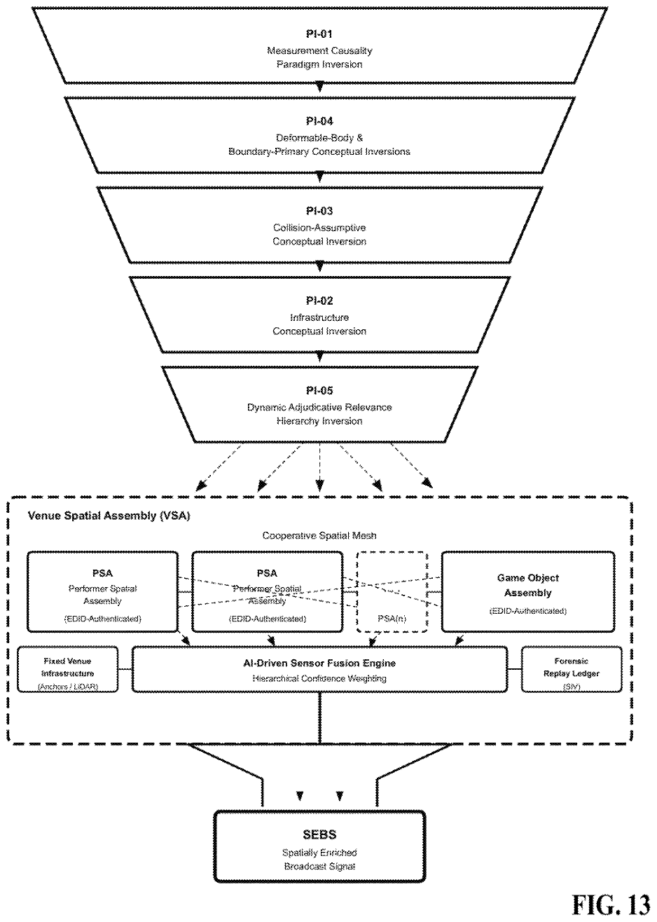

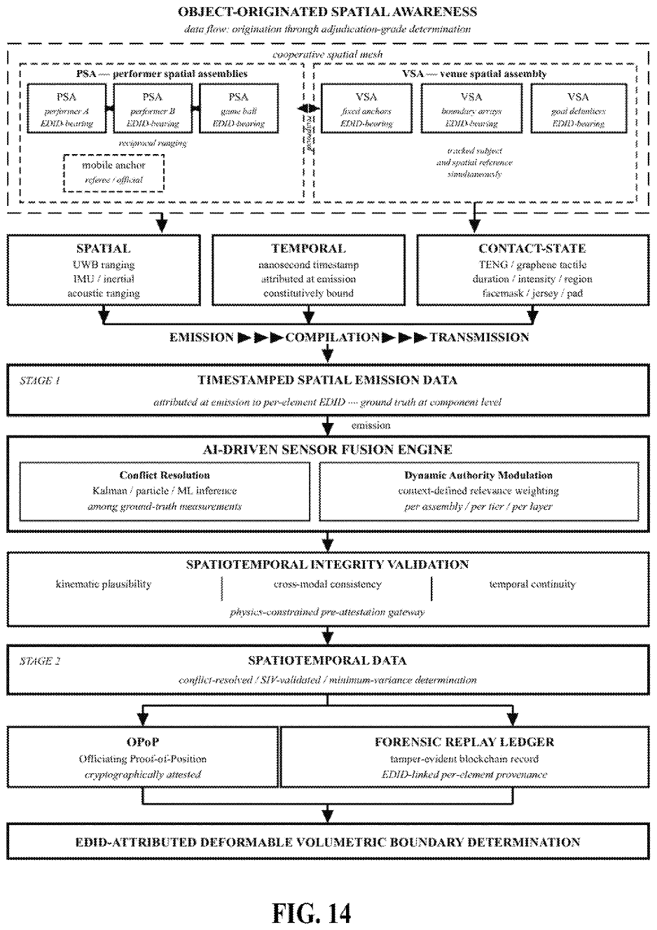

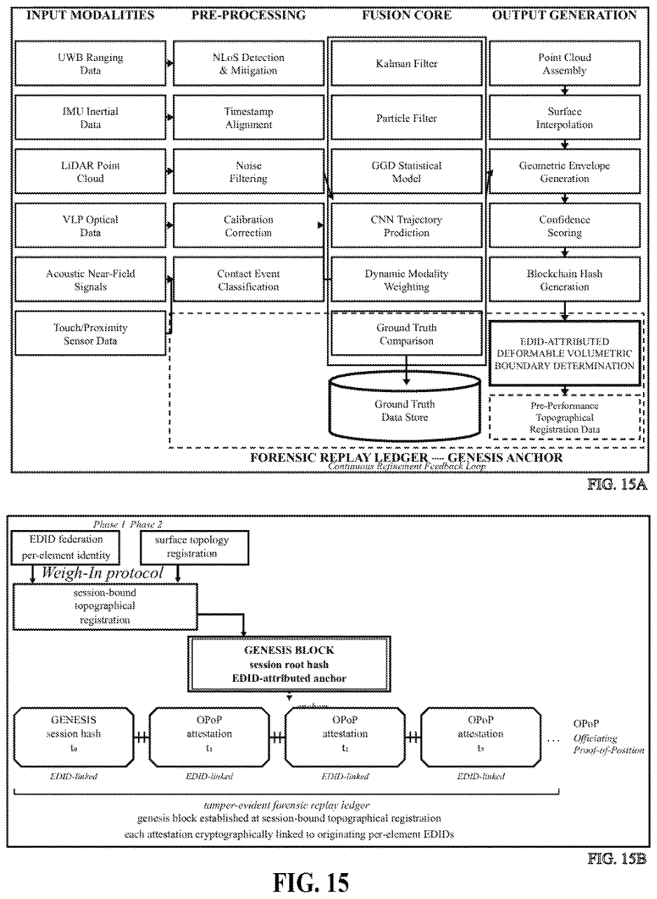

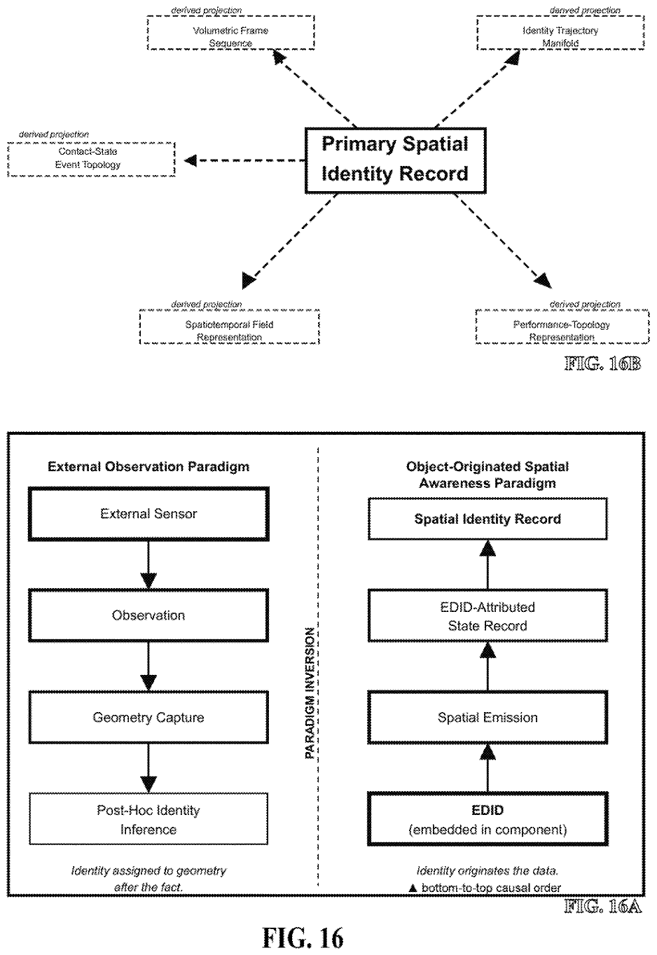

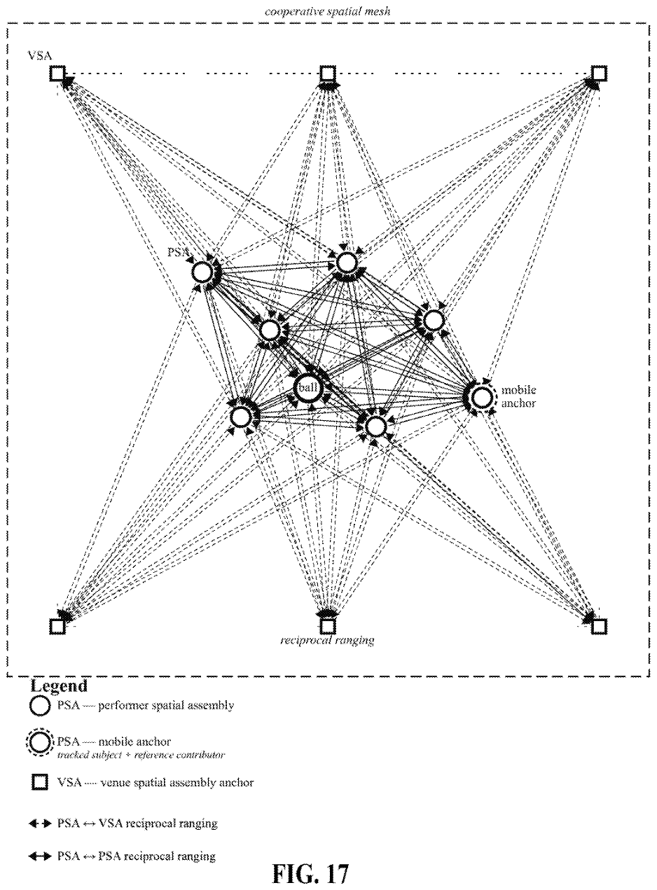

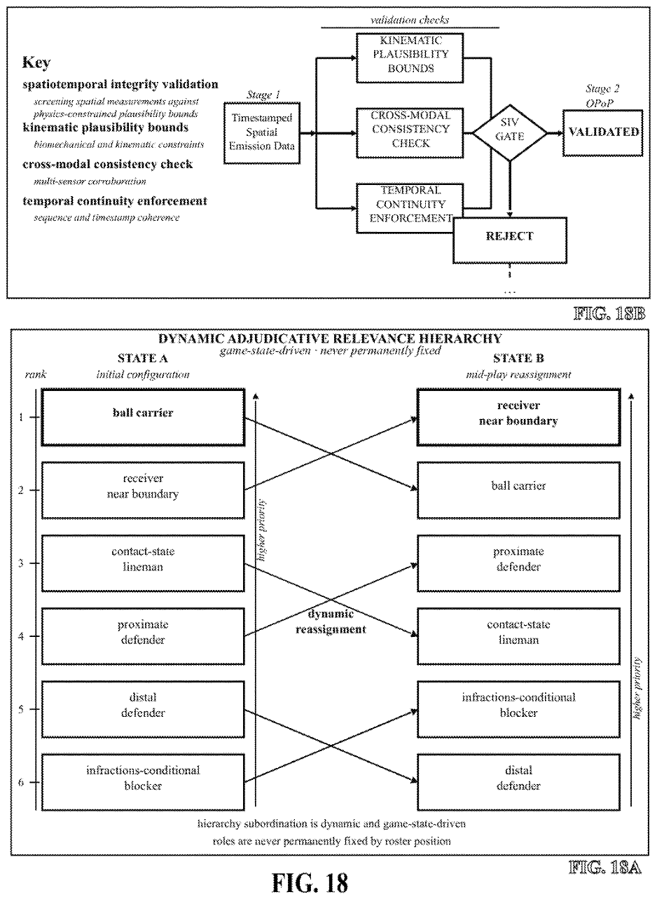

### BIBLIOGRAPHY

Patent Literature (Originating with this Application):
1. 10955257B2, Interactive 3D Point Cloud Matching, Assignee: Olympus Global, Pub.: Mar. 23, 2021
2. 10500472B2, Athletic Touch-Sensing Equipment, Pub. Date: Dec. 10, 2019
3. WO2016206412A1, Smart Ball-Ground System, Gengee Tech. Co., Ltd., Pub. Date: Dec. 29, 2016
4. 9185361B2, Camera-Based Tracking and Position Determination, Gentex, Pub.: Nov. 10, 2015
5. 20140361906A1, Active Sports Tracker and Method, Pub. Date: Dec. 11, 2014
6. 8672810B2, Athletic Performance Monitoring Systems and Methods, Assignee: Nike, Inc., Pub.: Mar. 18, 2014
7. WO2010065886A1, Athletic Performance Monitoring System, Assignee: Nike, Inc., Pub.: Jun. 10, 2010
8. 7649467B2/U.S. Pat. No. 7,649,466B2, Localization System and Method for Localizing Objects or Animals Using Such a Localization System, Assignee: Eyeon Trust B.V., Pub.: Jan. 19, 2010
   Patent Literature (Continuation in Part patent application Ser. No. 17/461,021):
9. 2018/0310644 A1, Poupyrev et al
10. 2010/0274447 A1, Stumpf
11. 2016/0202755 A1, Connor (also cited as 2015/0075303)
12. 2005/0202905 A1, Chesser
13. 2011/0118065 A1, Krysiak (also cited as 2011/0118062)
14. 2015/0375083 A1, Stelfox
   Non-Patent Literature (Originating with this Application):

### A-D:

1. Bhandari, Vedant, Phillips, Tyson Govan, & McAree, Peter Ross. “Minimal Configuration Point Cloud Odometry and Mapping.” The International Journal of Robotics Research, vol. 43, no. 11, 2024, pp. 1831-1850. DOI: 10.1177/02783649241235325.
2. Blauberger, P., Marzilger, R., & Lames, M. Validation of Player and Ball Tracking with a Local Positioning System. Sensors, vol. 21, no. 4, 2021, p. 1465. DOI: 10.3390/s21041465.
3. Brambilla, G., et al. (2016/2020). “Blockchain-Based Proof of Location.” arXiv preprint arXiv:1607.00174. Available at: https://arxiv.org/abs/1607.00174
4. Buchheit, Martin, Poon, T.K., Allen, A., Modonutti, M., Gregson, W., & Di Salvo, V. “Integrating Different Tracking Systems in Soccer: Multiple Camera Semi-Automatic System, Local Position Measurement, and GPS Technologies.” Journal of Sports Sciences, 2014.
5. Bastida-Castillo, A., Gómez-Carmona, C. D., De la Cruz Sánchez, E., & Pino-Ortega, J. (2019). Comparing accuracy between global positioning systems and ultra-wideband-based position tracking systems used for tactical analyses in soccer. European Journal of Sport Science, 19(9), 1157-1165. DOI: 10.1080/17461391.2019.1584248.
6. Cha, Kyeong-Ju, Lee, Jung-Bum, Ozger, Mustafa, & Lee, Woong-Hee. “When Wireless Localization Meets Artificial Intelligence: Basics, Challenges, Synergies, and Prospects.” Applied Sciences, vol. 13, 2023, article 12734. DOI: 10.3390/app132312734.

### E-J:

7. Feature-Based Generalized Gaussian Distribution Method for NLOS Detection (arXiv:2304.11091) Authors: Fuhu Che, Qasim Zeeshan Ahmed, Jaron Fontaine, et al. Published: Apr. 14, 2023 (IEEE September 2022)
8. English, Chad, et al. “TriDAR: A Hybrid Sensor for Exploiting the Complementary Nature of Triangulation and LIDAR Technologies.” Proceedings of the 8th International Symposium on Artificial Intelligence, Robotics and Automation in Space (iSAIRAS), ESA SP-603, Munich, Germany, 5-8 Sep. 2005.
9. Fernández, Miguel, Carlos Vázquez, and Samuel Ver Hoeye. “2.4 GHz Fully Woven Textile-Integrated Circularly Polarized Rectenna for Wireless Power Transfer Applications.” IEEE Access, 2023. DOI: 10.1109/ACCESS.2023.1120000.
10. 20. Fuchs, Philip X., Chou, Yi-Cheng, Chen, Wei-Han, Fiolo, Nicholas J., & Shiang, Tzyy-Yuang. “Accuracy of a Local Positioning System for Time-Series Speed and Acceleration and Performance Indicators in Game Sports.” Sports Biomechanics, 2023. DOI: 10.1080/14763141.2022.2110513.
11. Gupta, Vikas Kumar, Singh, Nongthombam Klinton, & Richardson, Maibam. “3D Point Cloud Generation Using IMU for Indoor Positioning.” International Journal of Innovative Research & Development, vol. 3, issue 5, May 2014. ISSN: 2278-0211 (Online).
12. Hailu, T. G., Guo, X., Si, H., Li, L., & Zhang, Y. Theories and Methods for Indoor Positioning Systems: A Comparative Analysis, Challenges, and Prospective Measures. Sensors, vol. 24, no. 21, 2024, p. 6876. DOI: 10.3390/s24216876.
13. Hou, Xiaoyue, Arslan, Tughrul, Juri, Arief, & Wang, Fengzhou. “Indoor Localization for Bluetooth Low Energy Devices Using Weighted Off-set Triangulation Algorithm.” University of Edinburgh, U K, 2023.

### K-L:

14. Karashchuk, Pierre, et al. “Anipose: A Toolkit for Robust Markerless 3D Pose Estimation.” Cell Reports, vol. 36, 2021, article 109730. DOI: 10.1016/j.celrep.2021.109730.
15. Lefèvre, T., Guignard, B., Karcher, C., Reche, X., Font, R., & Komar, J. A deep dive into the use of local positioning systems in professional handball: Automatic detection of players' orientation, position and game phases to analyze specific physical demands. PLOS ONE, vol. 18, no. 8, 2023, e0289752. DOI: 10.1371/journal.pone.0289752.
16. Li, X., et al. “A Novel Adaptive Spectrum Forming Filter: Application in Cognitive Ultra-Wideband.” EURASIP Journal on Wireless Communications and Networking (2010). ResearchGate publication #220362266.
17. Luteberget, Live Steinnes, & Gilgien, Matthias. “Validation Methods for Global and Local Positioning-Based Athlete Monitoring Systems in Team Sports: A Scoping Review.” BMJ Open Sport & Exercise Medicine, 2020, vol. 6, e000794. DOI: 10.1136/bmjsem-2020-000794.
18. Luteberget, Live S., Spencer, Matt, & Gilgien, Matthias. “Validity of the Catapult ClearSky T6 Local Positioning System for Team Sports Specific Drills in Indoor Conditions.” Frontiers in Physiology, vol. 9, 2018, article 115. DOI: 10.3389/fphys.2018.00115.

### M-R:

19. Mohammed, S., et al. “A Machine Learning and Blockchain-Based Efficient Fraud Detection Mechanism.” MDPI Sensors 22 (19): 7162 (2022). Available at: https://www.mdpi.com/1424-8220/22/19/7162
20. Mostafa Naseri, Adnan Shahid, Eli De Poorter (Ghent University) Adapting UWB AoA Estimation (Domain Generalization) Source: ScienceDirect, Internet of Things journal, Vol. 27, 2024
21. Nosouhi, M. R., et al. “Blockchain for Secure Location Verification.” ScienceDirect, Journal of Network and Computer Applications (2019), https://www.sciencedirect.com/science/article/abs/pii/S074373151930320X
22. Noccela Oy. (2022). European League of Football-UWB player tracking. In Qorvo White Paper: Ultra-Wideband Enables Smart Factory of the Future, pp. 4-5. Available at: https://www.qorvo.com/resources/d/qorvo-ultra-wideband-uwb-enables-smart-factory-of-the-future-white-paper
23. Pino-Ortega, J., Oliva-Lozano, J. M., Gantois, P., Nakamura, F. Y., & Rico-González, M. Comparison of the validity and reliability of local positioning systems against other tracking technologies in team sport: A systematic review. Proceedings of the Institution of Mechanical Engineers, Part P: Journal of Sports Engineering and Technology, vol. 236, no. 2, 2022, pp. 73-82. DOI: 10.1177/1754337120988236.
24. Rekkas, Vasileios P., Iliadis, Lazaros A., Sotiroudis, Sotirios P., Boursianis, Achilles D., Sarigiannidis, Panagiotis, Plets, David, Joseph, Wout, Wan, Shaohua, Christodoulou, Christos G., Karagiannidis, George K., & Goudos, Sotirios K. “Artificial Intelligence in Visible Light Positioning for Indoor IoT: A Methodological Review.” IEEE Open Journal of the Communications Society, 2023. DOI: 10.1109/OJCOMS.2023.3327211.
25. Rico-González, Markel, Los Arcos, Asier, Clemente, Filipe M., Rojas-Valverde, Daniel, & Pino-Ortega, José. “Accuracy and Reliability of Local Positioning Systems for Measuring Sport Movement Patterns in Stadium-Scale: A Systematic Review.” Applied Sciences, vol. 10, 2020, article 5994. DOI: 10.3390/app10175994.
26. Ridolfi, M., Vandermeeren, S., Defraye, J., Steendam, H., Gerlo, J., De Clercq, D., Hoebeke, J., & De Poorter, E. Experimental Evaluation of UWB Indoor Positioning for Sport Postures. Sensors, vol. 18, no. 1, 2018, p. 168. DOI: 10.3390/s18010168.

### S-Z:

27. Sathyan, T., Shuttleworth, R., Hedley, M., & Davids, K. Validity and reliability of a radio positioning system for tracking athletes in indoor and outdoor team sports. Behavior Research Methods, vol. 44, 2012, pp. 1108-1114. DOI: 10.3758/s13428-012-0192-2.
28. Serpiello, F. R., Hopkins, W. G., Barnes, S., Tavrou, J., Duthie, G. M., Aughey, R. J., & Ball, K. Validity of an Ultra-Wideband Local Positioning System to Measure Locomotion in Indoor Sports. Journal of Sports Sciences, vol. 36, no. 15, 2018, pp. 1727-1733. DOI: 10.1080/02640414.2017.1411867.
29. Torres-Ronda, L., Beanland, E., Whitehead, S., Sweeting, A., & Clubb, J. Tracking Systems in Team Sports: A Narrative Review of Applications of the Data and Sport Specific Analysis. Sports Medicine-Open, vol. 8, 2022, article 15. DOI: 10.1186/s40798-022-00408-Z.
30. Torres-Ronda, L., Clubb, J., & Beanland, E. Tracking Systems in Team Sports: Back to Basics. Sports Performance Science Reports (SPSR), issue 159, 2022. DOI: Not Available.
31. Vadivu, P. Kandha, et al. “Application of Woven Antenna in Wireless Communication Device Integrated Apparel and Bedlinen.” International Journal of Engineering Science and Technology, vol. 2, issue 10, October 2010. URL: https://www.researchgate.net/publication/50366229.
32. Waqar, Adnan, Iftekhar Ahmad, Daryoush Habibi, and Quoc Viet Phung. “Analysis of GPS and UWB Positioning System for Athlete Tracking.” Measurement: Sensors, vol. 14, 2021, article 100036. DOI: 10.1016/j.measen.2020.100036.
33. World Wide Web Consortium (W3C). “Decentralized Identifiers (DIDs) v1.0.” W3C Recommendation. Available at: https://www.w3.org/TR/did-core/
34. Wu, Y., Xu, H., Wang, W., & Kang, H. Research on Indoor Sports Positioning Algorithm Based on UWB. Proceedings of the 10th International Conference on Control, Automation and Information Sciences (ICCAIS), Xi′an, China, 2021, pp. 638-643. DOI: Not Available.
35. Yang, D., et al. Hermite-Gaussian pulse orthogonalization research. [Academic literature on cognitive UWB]
36. Zhang, K., Zheng, L., Pei, R., Chen, L., & Xu, F. Light-weight, high-gain antenna with broad temperature adaptability based on multifunctional 3D woven spacer Kevlar/polyimide composites. Composites Communications, vol. 30, 2022, p. 101061. DOI: 10.1016/j.coco.2022.101061.
   Non-Patent Literature (Continuation in Part patent application Ser. No. 17/461,021):
37. Shi et al., “Advanced Functional Fiber and Smart Textile”, Springer, Vol. 1, Pgs 3-31, 2 Jul. 2019.

1. A system for object-originated, adjudication-grade spatial determination of continuously deformable bodies during professional sporting events, wherein adjudication-grade accuracy is defined as positional uncertainty equal to or better than a predetermined threshold in all three spatial dimensions, and wherein all tracked elements of said system maintain nanosecond-level temporal synchronization through hierarchical clock distribution, and wherein timestamped spatial emission data contributing to said determination originates from within tracked objects through emission rather than from external line-of-sight dependent observation, the system comprising:
(a) a plurality of per-element equipment decentralized identifiers (EDIDs), each EDID being a cryptographically verifiable, globally unique identifier assigned to a respective physical sports equipment component and conforming to a decentralized identifier specification, said plurality of EDIDs federated into session-bound identities wherein all EDID components belonging to a single performer are digitally bound into a single adjudicative identity for the duration of a defined performance session;
(b) a plurality of tracking elements embedded along anatomical contour lines of performer-worn equipment, wherein said embedded tracking elements satisfy Physical Compliance preserving weight distribution, rotational balance, elasticity, surface friction, and aerodynamic properties of certified sports equipment such that the equipment continues to meet governing body equipment performance specifications after integration of said tracking elements;
(c) a performer spatial assembly for each performer, said performer spatial assembly comprising a federated grouping of said EDID-bearing equipment components operating as a continuously deformable volumetric identity whose contour, surface topology, and volumetric envelope are updated in real time, wherein said identity is not treated as a rigid body and its spatial state is not reducible to six-degree-of-freedom rigid-body parameters, and wherein said performer spatial assembly is not merely a collection of tagged EDID objects but is a computationally reconstructed volumetric entity whose constituent EDID-bearing components cooperatively define the three-dimensional boundary, contour, and positional state of the performer while remaining individually distinguishable contributors within said deformable volumetric identity,
wherein each said performer spatial assembly comprises a plurality of differentiated anatomical and equipment-associated surface regions, each said surface region associated with a respective per-element EDID and configured to emit timestamped spatial emission data such that said differentiated surface regions are independently spatially determinable in three-dimensional space relative to one another within said performer spatial assembly, said differentiated surface regions possessing independently trackable three-dimensional spatial states and independently trackable deformation states, such that timestamped spatial emission data attributed at emission to said per-element EDIDs preserves region-level identity independent of spatial proximity, contact, compression, deformation, or occlusion among said differentiated surface regions;
(d) said performer spatial assembly organized in a hierarchical tracking modality comprising at least two hierarchically ordered tracking tiers including at least a boundary-defining tier and a contact-sensing tier, said contact-sensing tier comprising contact-sensing elements specifically configured for temporally continuous contact-state measurement characterizing duration, intensity, and region-specific contact progression during contact between performers or between a performer and a venue spatial assembly component, wherein said hierarchical tracking modality may further comprise interior contour tiers and mesh-fill tiers as additional intermediate tracking tiers between said boundary-defining tier and said contact-sensing tier;
(e) an AI-driven sensor fusion engine receiving multi-modal timestamped spatial emission data emitted by said differentiated surface regions of said performer spatial assemblies, said timestamped spatial emission data being attributed at emission to respective per-element EDIDs, and producing conflict-resolved deformable volumetric boundary determinations through iterative multi-modal reconciliation against the continuously deformable volumetric identity model, wherein said sensor fusion engine integrates timestamped spatial emission data across a plurality of independent sensing modalities spanning a plurality of distinct technical domains, and wherein said sensor fusion engine implements a dynamic authority modulation architecture that reversibly assigns, reassigns, and modulates context-defined authority weights among said differentiated surface regions and among hierarchically ordered tracking tiers based on proximity to authoritative boundary surfaces, event-conditioned adjudicative relevance, positional stability, and signal quality, such that said authority weights are never permanently fixed by garment order, equipment layer position, or performer role classification;
(f) a venue spatial assembly comprising anchor components each possessing respective EDIDs, wherein said anchor components may include fixed anchor components, mobile anchor components, or any combination thereof depending on deployment requirements of the tracked activity: a reciprocal spatial emission architecture wherein said performer spatial assemblies and said venue spatial assembly emit timestamped spatial emission data to one another; and a cooperative spatial mesh wherein said performer spatial assemblies and said venue spatial assembly function as mutual spatial references such that tracked assemblies serve simultaneously as tracked subjects and as spatial reference contributors for other assemblies, wherein spatial data originates from within tracked objects rather than from external line-of-sight dependent observation;
(g) wherein said system generates adjudication-grade continuous spatial measurements at sub-millisecond intervals derived directly from timestamped spatial emission data emitted by said EDID-associated differentiated surface regions without post hoc geometric reconstruction from external line-of-sight dependent observation, and performs spatiotemporal integrity validation screening said spatial measurements against physics-constrained plausibility bounds derived from biomechanical and kinematic constraints of the deformable bodies being tracked; and
(h) wherein said system generates proof-of-position attestations comprising cryptographically attested position records for spatial measurements that have passed said spatiotemporal integrity validation, each attestation cryptographically linked to originating per-element EDIDs, and records said attestations in a tamper-evident forensic replay ledger anchored to a genesis block established during pre-performance calibration.

2. A method for object-originated, adjudication-grade spatial determination of continuously deformable bodies during professional sporting events, wherein adjudication-grade accuracy is defined as positional uncertainty equal to or better than a predetermined threshold in all three spatial dimensions, and wherein all timestamped spatial emission data contributing to said determination maintains nanosecond-level temporal synchronization through hierarchical clock distribution, and wherein timestamped spatial emission data contributing to said determination originates from within tracked objects through emission rather than from external line-of-sight dependent observation, the method comprising:
(a) receiving, at a processing system operatively coupled to a plurality of tracking elements physically embedded in sports equipment, timestamped spatial emission data emitted by said tracking elements, wherein each tracking element is embedded along anatomical contour lines of performer-worn equipment and satisfies Physical Compliance preserving weight distribution, rotational balance, elasticity, surface friction, and aerodynamic properties of certified sports equipment, and wherein each equipment component bearing a tracking element possesses a respective per-element equipment decentralized identifier (EDID) that is a cryptographically verifiable, globally unique identifier conforming to a decentralized identifier specification, and wherein said spatial emissions originate from within said equipment rather than from external line-of-sight dependent observation;
(b) federating, for each performer, said timestamped spatial emission data emitted by a plurality of said EDID-bearing equipment components into a performer spatial assembly representing a continuously deformable volumetric identity whose contour, surface topology, and volumetric envelope are computationally reconstructed in real time, wherein said volumetric identity is not treated as a rigid body and its spatial state is not reducible to six-degree-of-freedom rigid-body parameters, wherein said federating comprises digitally binding all EDID components belonging to said performer into a single adjudicative identity for the duration of a defined performance session,
wherein said performer spatial assembly comprises a plurality of differentiated anatomical and equipment-associated surface regions, each said surface region associated with a respective per-element EDID and configured to emit timestamped spatial emission data such that said differentiated surface regions are independently spatially determinable in three-dimensional space relative to one another within said performer spatial assembly, said differentiated surface regions possessing independently trackable three-dimensional spatial states and independently trackable deformation states, such that timestamped spatial emission data attributed at emission to said per-element EDIDs preserves region-level identity independent of spatial proximity, contact, compression, deformation, or occlusion among said differentiated surface regions, and wherein said performer spatial assembly is organized in a hierarchical tracking modality comprising at least two hierarchically ordered tracking tiers including at least a boundary-defining tier and a contact-sensing tier, said contact-sensing tier comprising contact-sensing elements specifically configured for temporally continuous contact-state measurement characterizing duration, intensity, and region-specific contact progression during contact between performers or between a performer and a venue spatial assembly component, wherein said hierarchical tracking modality may further comprise interior contour tiers and mesh-fill tiers as additional intermediate tracking tiers between said boundary-defining tier and said contact-sensing tier;
(c) fusing, through an AI-driven sensor fusion engine, multi-modal timestamped spatial emission data emitted by said differentiated surface regions of said performer spatial assemblies, said timestamped spatial emission data being attributed at emission to respective per-element EDIDs, and multi-modal timestamped spatial emission data from a venue spatial assembly comprising anchor components each possessing respective EDIDs, wherein said anchor components may include fixed anchor components, mobile anchor components, or any combination thereof depending on deployment requirements of the tracked activity, to produce conflict-resolved deformable volumetric boundary determinations through iterative multi-modal reconciliation against the continuously deformable volumetric identity model, wherein said sensor fusion engine integrates timestamped spatial emission data across a plurality of independent sensing modalities spanning a plurality of distinct technical domains, and wherein said sensor fusion engine implements a dynamic authority modulation architecture that reversibly assigns, reassigns, and modulates context-defined authority weights among said differentiated surface regions and among hierarchically ordered tracking tiers based on proximity to authoritative boundary surfaces, event-conditioned adjudicative relevance, positional stability, and signal quality, such that said authority weights are never permanently fixed by garment order, equipment layer position, or performer role classification, and wherein said performer spatial assemblies and said venue spatial assembly emit timestamped spatial emission data to one another through a reciprocal spatial emission architecture and function as mutual spatial references within a cooperative spatial mesh such that tracked assemblies serve simultaneously as tracked subjects and as spatial reference contributors for other assemblies;
(d) validating said conflict-resolved deformable volumetric boundary determinations by performing spatiotemporal integrity validation screening spatial measurements derived directly from timestamped spatial emission data emitted by said EDID-associated differentiated surface regions without post hoc geometric reconstruction from external line-of-sight dependent observation against physics-constrained plausibility bounds derived from biomechanical and kinematic constraints of the deformable bodies being tracked, said validating producing validated spatial determinations at sub-millisecond intervals; and
(e) generating proof-of-position attestations comprising cryptographically attested position records for spatial measurements that have passed said spatiotemporal integrity validation, each attestation cryptographically linked to originating per-element EDIDs, and recording said attestations in a tamper-evident forensic replay ledger anchored to a genesis block established during pre-performance calibration.

3. A method for generating a temporally continuous, region-differentiated spatial identity record from object-originated timestamped spatial emission data emitted during a tracked activity, wherein said spatial identity record structurally embodies object-originated spatial awareness in that its embedded spatial metadata originates from within tracked objects through emission rather than from external line-of-sight dependent observation, the method comprising:
(a) receiving, at a content production processing system, timestamped spatial emission data emitted by a plurality of differentiated surface regions each physically associated with a respective instrumented object component bearing an intrinsic per-element equipment decentralized identifier (EDID) that is a cryptographically verifiable, globally unique identifier conforming to a decentralized identifier specification, said differentiated surface regions comprising anatomical and equipment-associated surface regions of one or more performer spatial assemblies and venue-associated surface regions of one or more venue spatial assemblies, each said performer spatial assembly and venue spatial assembly being an assembly class within the same cooperative spatial mesh wherein all EDID-bearing components serve simultaneously as tracked subjects and spatial reference contributors, wherein said timestamped spatial emission data is emitted from within said instrumented object components rather than from external line-of-sight dependent observation;
(b) generating, from said received timestamped spatial emission data, a temporally ordered sequence of time-indexed state records over a defined event interval, each state record including surface geometry, region-specific deformation state, articulated configuration, and region-specific three-dimensional spatial state including position and orientation attributed at emission to said intrinsic per-element EDID, and surface contact topology,
wherein said EDID attribution differentiates discrete anatomical and equipment-associated surface regions within each said performer spatial assembly, said differentiated surface regions possessing independently trackable spatial and deformation states,
wherein said generated sequence is derived directly from timestamped spatial emission data emitted by said EDID-associated surface regions without post hoc geometric reconstruction from external line-of-sight dependent observation,
and preserving continuity of deformable volumetric identity by maintaining persistent EDID attribution for said differentiated surface regions across successive time indices independent of spatial proximity, contact, compression, deformation, or occlusion, such that surface-specific contact-state durations are determinable from said ordered sequence;
(c) producing, from said temporally ordered sequence of time-indexed state records, at least one of: (i) a spatially enriched broadcast signal formatted for real-time broadcast or streaming distribution, wherein said signal carries embedded spatial metadata enabling receiving systems to render virtual camera viewpoints, augmented reality overlays, or three-dimensional scene reconstructions from perspectives not corresponding to any physical camera position; (ii) a volumetric performance reconstruction preserving spatial accuracy throughout a defined event interval of a recorded activity; (iii) an interactive performance data stream formatted for consumption by interactive entertainment platforms, simulation engines, or digital gaming environments, wherein said data stream preserves sufficient geometric fidelity to enable consuming applications to reconstruct articulated body motion, equipment deformation, and surface contact topology with accuracy not achievable through any external line-of-sight dependent observation system, hub-and-spoke spatial architecture, or unidirectionally hierarchical tracking infrastructure wherein tracked objects serve as passive subjects rather than as active emitters; (iv) an identity-trajectory data structure in which each EDID-associated surface region defines an identity-continuous spatial trajectory preserved through successive time indices independently of occlusion, contact, compression, deformation, or proximity events occurring among tracked subjects, wherein said identity continuity is an architectural property of the object-originated spatial emission architecture and is structurally absent from records derived from external line-of-sight dependent observation systems wherein occlusion interrupts the observational chain upon which identity attribution depends; (v) a spatiotemporal field representation in which the tracked environment is expressed as a continuously evolving spatial field populated by EDID-attributed identity regions whose spatial states evolve across successive temporal indices, wherein contact topology is expressed as interaction edges within said field, and wherein said field representation preserves structural continuity through contact and occlusion events that would produce field discontinuities in any external line-of-sight dependent observation system; (vi) a contact-state event topology record in which the onset, duration, and termination of surface contact events among EDID-attributed surface regions are preserved as temporally ordered state transitions constitutively attributed to specific EDID-differentiated surface regions, wherein said contact-state durations and surface-region identities are first-class constitutive attributes of the record rather than inferences derived from externally observed positional frames; or (vii) a performance-topology representation Structured as simultaneous multi-channel temporal data in which EDID-associated surface regions constitute identity channels distributed along a temporal axis and contact-state intervals, deformation states, and spatial transitions are expressed as temporally resolved events attributed to said channels, wherein said multi-channel temporal structure preserves the rhythmic and sequential contact-state topology of the tracked activity as an ordered, differentiated temporal record;
(d) embedding, within said produced content, cryptographic provenance chains linking spatial metadata to originating EDIDs through proof-of-position attestations, wherein each attestation is cryptographically linked to the specific EDID-bearing instrumented object component that generated the underlying spatial data, such that per-subject attribution is maintained as an architecturally intrinsic property of said content rather than as a separable administrative record; and
(e) outputting or distributing said produced content through at least one output or distribution channel, wherein a cryptographic access control layer enforces tiered access rights governing access resolution, temporal availability, and attribution preservation across access tiers.

4. A non-transitory computer-readable medium storing a temporally ordered, region-differentiated spatial identity data record derived from object-originated spatial emission during a tracked activity, said spatial identity data record comprising:
(a) a temporally ordered sequence of spatiotemporal state records over a defined event interval, each said state record including surface geometry, region-specific deformation state, articulated configuration, region-specific three-dimensional spatial state including position and orientation, and surface contact topology, each such state record being attributed at emission to an intrinsic per-element equipment decentralized identifier (EDID) that is a cryptographically verifiable, globally unique identifier conforming to a decentralized identifier specification, said EDID associated with a differentiated anatomical or equipment-associated surface region of a performer spatial assembly,
wherein said per-element EDIDs differentiate discrete surface regions within said performer spatial assembly, said differentiated surface regions possessing independently trackable three-dimensional spatial states and independently trackable deformation states within said performer spatial assembly,
wherein said spatial data record is derived directly from timestamped spatial emission data emitted by said EDID-associated surface regions without post hoc geometric reconstruction from external line-of-sight dependent observation,
and wherein said temporally ordered sequence preserves continuity of deformable volumetric identity by maintaining persistent EDID attribution for said differentiated surface regions across successive time indices independent of spatial proximity, contact, compression, deformation, or occlusion among surface regions, including through contact and occlusion events that would interrupt external line-of-sight dependent observation systems,
such that surface-specific contact-state intervals are determinable from said temporally ordered sequence;
(b) surface contact maps recording contact events, compression states, and surface interaction topology between said differentiated surface regions and venue spatial assembly components or surface regions of other performer spatial assemblies, derived from a collision-assumptive spatial architecture wherein contact between a performer spatial assembly and a venue spatial assembly component, or between performer spatial assemblies, is treated as structurally significant signal data rather than as an error condition to be filtered or discarded, and wherein venue spatial assembly components bearing EDID-attributed contact-sensing elements contribute contact-state emission data to said surface contact maps as active participants in the collision-assumptive architecture rather than as passive contact surfaces;
(c) infrastructure-mode metadata indicating whether spatiotemporal determinations contained in said spatial identity data record were derived from fixed-anchor infrastructure positioning, reciprocal-ranging positioning among mobile assemblies, or a combination thereof;
(d) context-defined authority weighting metadata identifying one or more authoritative boundary surfaces pursuant to context-supplied evaluative criteria promulgated by a recognized governing authority with jurisdiction over the tracked activity, wherein said boundary significance criteria are applied to said authority weighting metadata at deployment time without incorporating any specific revision or edition of said criteria by reference, and wherein said authority weighting metadata reflects dynamic allocation of measurement priority based on context-defined relevance criteria including proximity to said authoritative boundary surfaces during said tracked activity;
(e) cryptographically attested position records, each position record cryptographically linked to the originating EDID of the specific equipment component whose sensing element generated the underlying spatial measurement, said cryptographic attestation maintaining an unbroken provenance chain from the point of spatial data origination through inclusion in said spatial identity data record;
wherein the combination of elements (a) through (e) constitutes a structural signature that is architecturally unachievable by any data record produced through any external line-of-sight dependent observation system, hub-and-spoke spatial architecture, or unidirectionally hierarchical tracking infrastructure wherein tracked objects serve as passive subjects rather than as active emitters, because such systems cannot produce temporally ordered, region-differentiated state records attributed at emission to intrinsic per-element identifiers originating from within tracked objects, cannot preserve continuity of deformable volumetric identity through contact and occlusion events without post hoc geometric reconstruction from external line-of-sight dependent observation, cannot generate surface contact maps from a collision-assumptive spatial architecture wherein contact is recorded at differentiated surface regions independently of external line-of-sight dependent observation, and cannot embed cryptographic attestation maintaining an unbroken provenance chain traceable to equipment identifiers physically embedded within tracked objects.

5. The system of claim 1, wherein said performer spatial assembly further comprises a multi-garment hierarchical confidence architecture employing active, self-reporting sensor substrates at a plurality of anatomical proximity layers spanning said differentiated surface regions, wherein an inner body-conformal garment layer functions as an anatomical reference datum whose verified spatial correspondence to underlying anatomical surfaces is established through pre-performance session-bound EDID federation and topographical registration, wherein all EDID-bearing components of said performer spatial assembly are bound into a single federated adjudicative identity and each said component is registered against a vector-based topographical wireframe representation of the performer's three-dimensional sculptural surface contours, said wireframe representation comprising sparse topographical coordinate collections defining anatomical articulation boundaries rather than undifferentiated point cloud surface reconstruction, and wherein said AI-driven sensor fusion engine computes differential displacement from timestamped spatial emission data emitted by EDID-bearing elements of said inner body-conformal garment layer and timestamped spatial emission data emitted by EDID-bearing elements of said outer equipment layers at each said anatomical proximity layer, said differential displacement differentiating fabric deformation state signals from anatomical movement signals derived from said inner body-conformal garment layer, said multi-garment hierarchical confidence architecture producing simultaneous independent outputs comprising anatomical position of the performer derived through inter-layer corrections toward said inner body-conformal garment layer and spatiotemporal state of outermost equipment boundary surfaces of said performer spatial assembly, wherein said dynamic authority modulation architecture of claim 1 determines which said independent output is authoritative based on context-defined relevance criteria including anatomical proximity, wherein said authority determination is driven by adjudicative event type as defined by officiating rules of a recognized governing authority with jurisdiction over the tracked activity applied at deployment time without incorporating any specific revision or edition of said rules by reference, such that said inner body-conformal garment layer receives highest authority weighting when said adjudicative event type requires determination of anatomical ground truth position and said outermost equipment boundary surfaces receive highest authority weighting when said adjudicative event type requires determination of the outermost physical boundary of said performer spatial assembly, said authority weighting among said anatomical proximity layers being reversibly reassignable in response to changing event conditions rather than permanently fixed by garment layer order.

6. The system of claim 1, wherein said system further comprises a collision and deformation assumptive spatial architecture wherein contact between performers or between a performer and a venue spatial assembly component is treated as a structurally significant signal condition to be measured and temporally characterized rather than as an error condition to be filtered or discarded as in hub-and-spoke choreographic positioning architectures wherein collision avoidance is a governing structural constraint and contact between tracked objects is treated as a fault condition to be prevented through centralized trajectory coordination, said collision and deformation assumptive spatial architecture cooperating with said conflict-resolved deformable volumetric boundary determinations such that said AI-driven sensor fusion engine maintains spatial resolution at adjudication-grade accuracy during contact events by resolving contact geometry at said differentiated surface regions of said performer spatial assemblies rather than at rigid-body centroid approximations, and wherein said contact is characterized with temporal continuity preserving contact-state duration and region-specific contact progression at said differentiated surface regions, wherein said contact-sensing elements within said collision and deformation assumptive spatial architecture generate continuous contact-state Timestamped Spatial Emission Data records characterizing contact force magnitude, contact duration, and region-specific contact progression as durational quantities rather than as binary event markers, said records produced through transduction mechanisms generating graduated electrical output proportional to contact force or mechanical deformation without requiring external sensor polling or external observation of said contact event, said contact-state Timestamped Spatial Emission Data records attributed at emission to respective per-element EDIDs of said contact-sensing elements at said differentiated surface regions, said transduction mechanisms including but not limited to triboelectric charge generation, piezoelectric voltage generation, and capacitance variation under mechanical deformation, or functionally equivalent contact-sensing transduction mechanisms.

7. The system of claim 1, wherein protective equipment junctions within said performer spatial assembly at which a first EDID-bearing rigid structural member is mechanically coupled to a second EDID-bearing rigid structural member comprise instrumented junction fastener assemblies, each said junction fastener assembly performing simultaneous functions of: (i) structural attachment of said first rigid structural member to said second rigid structural member; (ii) inter-member mechanical stress-state characterization measuring magnitude, rate, direction, and spatial distribution of relative displacement between said first and second rigid structural members at each attachment point during contact events, said junction mechanical stress-state data attributed at emission to the per-element EDIDs of the structural members bridged by said junction fastener assembly; (iii) kinetic energy harvesting converting mechanical energy of junction deformation into electrical energy available for powering sensing, computing, and communication electronics within said performer spatial assembly; and (iv) electrical conductor bridging routing power, data, and sensor signal conductors between conductor networks of said first and second rigid structural members through deformation-tolerant conductor paths maintaining electrical continuity throughout a full range of operational junction deformation, wherein said inter-member mechanical stress-state characterization produces directionally distinguishable deformation signatures such that compressive deformation at the junction produced by impact events is structurally distinguishable from tensile deformation at the junction produced by grasping or pulling events through polarity and phase relationship of sensing elements within said junction fastener assembly, and wherein said inter-member mechanical stress-state characterization further produces asymmetric deformation patterns across spatially distributed junction fastener assemblies enabling determination of impact vector direction relative to the structural geometry of said performer spatial assembly, wherein said inter-member junction deformation measurement is inherently a multi-layer measurement requiring concurrent Timestamped Spatial Emission Data from instrumented layers on both sides of said junction fastener assembly within said hierarchical tracking modality and is therefore producible only within a multi-layer instrumented architecture wherein said AI-driven sensor fusion engine computes inter-member displacement as a differential between simultaneous position reports from said first and second rigid structural members, said junction mechanical stress-state data cooperating with said conflict-resolved deformable volumetric boundary determinations by providing rules-adjudication and safety-protocol loading-state characterization at inter-member mechanical interfaces within said performer spatial assembly, said junction mechanical stress-state data being adjudicatively interpretable only within the multi-modal EDID-attributed architecture of said performer spatial assembly and not constituting an independent spatial tracking architecture, or functionally equivalent alternatives for instrumented inter-member mechanical stress-state characterization within said hierarchical tracking modality.

8. The system of claim 1, wherein said venue spatial assembly further comprises boundary-line cooperative sensing arrays integrated into field boundary markers, each said field boundary marker being a two-dimensional regulatory marking area of governed width whose lateral edge at which field territory terminates constitutes the legally operative adjudicative boundary of the field in the same Boundary-Primary sense that the outer perimeter of said performer spatial assembly constitutes the legally operative boundary of the performer, each said boundary-line cooperative sensing array comprising a distributed proximity and contact detection surface responsive to approach and contact of EDID-bearing elements of said performer spatial assemblies, said boundary-line cooperative sensing arrays generating Timestamped Spatial Emission Data attributed at emission to respective venue spatial assembly EDIDs independently of said performer spatial assemblies, wherein said boundary-line cooperative sensing arrays cooperate with said differentiated surface regions of said performer spatial assemblies through said reciprocal spatial emission architecture of element (f) to produce dual-origin boundary determination wherein Timestamped Spatial Emission Data emitted independently by performer-side EDID-differentiated surface regions and by venue-side boundary-line sensing elements are temporally correlated by said AI-driven sensor fusion engine to resolve which specific EDID-differentiated surface region of said performer spatial assembly contacted the playing surface within, upon, or beyond said field boundary marker, and in what temporal sequence relative to other EDID-differentiated surface regions of the same performer spatial assembly, said dual-origin boundary determination being resolved at the level of individual EDID-differentiated surface regions rather than at the level of the performer spatial assembly as an undifferentiated whole such that the boundary-line spatiotemporal state of each said differentiated surface region is independently determinable, wherein said dynamic authority modulation architecture of element (e) assigns authoritative weighting to said differentiated surface regions based on their proximity to the lateral edge of said field boundary marker at which field territory terminates and on event-conditioned adjudicative relevance, said field boundary marker being an EDID-bearing venue spatial assembly component whose sensing substrate is dimensionally co-extensive with the full width of its regulatory marking such that the outer lateral edges of said marking define the authoritative spatial boundary in the same Boundary-Primary sense that the outer perimeter of said performer spatial assembly defines the authoritative spatial boundary of the performer, and wherein contact state between said EDID-differentiated surface regions of said performer spatial assembly and said field boundary marker is independently determinable as one of: contact entirely within the marking area, contact at the lateral edge of said marking at which field territory begins, contact at the lateral edge of said marking at which field territory terminates, or contact beyond the lateral edge of said marking at which field territory terminates, each constituting a distinct adjudicative spatial state resolvable through said dual-origin boundary determination, and wherein said dual-origin boundary determination cooperates with participation state filtering for adjudication purposes such that said AI-driven sensor fusion engine evaluates the participation state of each performer spatial assembly whose EDID-differentiated surface regions are detected within a spatial and temporal window of a boundary interaction event and includes only emissions from performer spatial assemblies assigned an active field presence state in the boundary adjudication determination, said dual-origin boundary determination providing cross-validated boundary adjudication with spatial and temporal resolution exceeding that achievable by either said boundary-line cooperative sensing arrays or said performer-side differentiated surface regions in isolation, or functionally equivalent alternatives for dual-origin boundary determination through cooperative spatial emission between venue-integrated and performer-worn EDID-differentiated sensing elements.

9. The system of claim 5, wherein said inner body-conformal garment layer of said multi-garment hierarchical confidence architecture further comprises a body-conformal shape tape substrate adhered or fitted directly to a performer's body surface, said shape tape substrate carrying active spatial emission elements at a plurality of said differentiated surface regions and functioning as said anatomical reference datum within said multi-garment hierarchical confidence architecture, said shape tape substrate establishing verified geometric correspondence between physical anatomical surfaces of said performer and EDID-attributed surface regions of said performer spatial assembly through said pre-performance session-bound topographical registration, wherein said shape tape substrate provides anatomical ground truth positions attributed at emission to respective per-element EDIDs against which said AI-driven sensor fusion engine applies continuous live-performance drift-correction calibration to inter-layer transfer functions mapping differential displacement between each successive anatomical proximity layer and said body-conformal shape tape substrate, said inter-layer transfer functions operating bidirectionally such that said AI-driven sensor fusion engine resolves spatiotemporal state at any said anatomical proximity layer through said continuously calibrated inter-layer transfer functions in the direction identified as authoritative by said dynamic authority modulation architecture for the current evaluative context, or functionally equivalent alternatives for pre-performance session-bound topographical registration of a body-conformal emission substrate as the anatomical ground truth reference datum within an object-originated spatial awareness architecture.

10. The system of claim 1, wherein said cooperative spatial mesh of element (f) operates through a dynamic role allocation architecture wherein each said performer spatial assembly, each said venue spatial assembly anchor component, and each EDID-bearing game object and field delimiter assembly simultaneously functions as both a Timestamped Spatial Emission Data originator emitting multi-modal Timestamped Spatial Emission Data attributed at emission to respective per-element EDIDs from said differentiated surface regions and a cooperative spatial reference contributor to other assemblies within said cooperative spatial mesh through said reciprocal spatial emission architecture of element (f), said cooperative spatial reference contribution of each said assembly comprising Timestamped Spatial Emission Data emitted across said plurality of independent sensing modalities spanning said plurality of distinct technical domains of element (e) and being dynamically weighted by said dynamic authority modulation architecture of element (e) according to proximity to authoritative boundary surfaces, event-conditioned adjudicative relevance, positional stability, signal quality, and geometric distribution relative to current performance events, wherein said dynamic authority modulation architecture operates upon said cooperative spatial reference contributions concurrently with and through the same nested hierarchical topology as said context-defined authority weights applied among said differentiated surface regions and among said hierarchically ordered tracking tiers within each said performer spatial assembly, such that cooperative spatial reference weighting among assemblies, authority modulation among anatomical proximity layers within each assembly, and reliability weighting among sensing modalities are resolved concurrently by said AI-driven sensor fusion engine as interdependent functions of said dynamic authority modulation architecture rather than as independent weighting operations, wherein said cooperative spatial mesh accommodates heterogeneous assembly classes comprising performer-worn assemblies optimized for sensing density within Physical Compliance constraints, officiating crew assemblies carrying enhanced transmission, signal repetition, and mobile anchor capability exploiting reduced Physical Compliance constraints, game object assemblies carrying substrate-specific sensor configurations, and venue-integrated assemblies carrying static geometric reference framework, said heterogeneous assembly classes contributing complementary and differentiated Timestamped Spatial Emission Data to said cooperative spatial mesh such that the cooperative spatial reference value of each assembly class derives from its distinct capabilities within said nested hierarchical topology rather than from homogeneous node functionality, and wherein said dynamic role allocation architecture accommodates non-programmatic, reactive, collision-assumptive movement of deformable bodies whose spatial states are not reducible to rigid-body parameters, said dynamic role allocation architecture being structurally distinct from hub-and-spoke choreographic positioning architectures wherein collision avoidance is a governing structural constraint and contact between tracked objects is treated as a fault condition to be prevented through centralized trajectory coordination, wherein said cooperative spatial mesh maintains adjudication-grade spatial determination without dependency upon fixed venue anchor infrastructure by deriving spatial reference from the dynamic cooperation of said assemblies whose spatial data originates from within said assemblies rather than from external line-of-sight dependent observation, said cooperative spatial mesh providing cross-venue operational continuity wherein said system operates across venues possessing different infrastructure configurations including venues possessing no fixed anchor infrastructure through said dynamic cooperation of said EDID-bearing assemblies, or functionally equivalent alternatives for achieving adjudication-grade spatial determination through object-originated cooperative spatial reference within said nested hierarchical topology.

11. The system of claim 1, wherein said tracking elements employ cognitive spectrum adaptation wherein radio frequency spectral parameters are dynamically adjusted in response to detected interference conditions, and wherein said cognitive spectrum adaptation is constrained such that the fidelity and attribution integrity of EDID-attributed Timestamped Spatial Emission Data transmitted by said differentiated surface regions to said AI-driven sensor fusion engine is preserved as an inviolable priority during spectral adaptation, such that said cognitive spectrum adaptation cooperates with said AI-driven sensor fusion engine by ensuring that spectral adaptation decisions do not degrade the adjudication-grade fidelity of EDID-attributed Timestamped Spatial Emission Data transmitted by said differentiated surface regions below said predetermined threshold as defined in claim 1, wherein said cognitive spectrum adaptation preserves per-element EDID attribution and region-level differentiation of transmitted Timestamped Spatial Emission Data across the full range of spectral adaptation states such that spectral reassignment of any tracking element does not merge, collapse, or reassign the EDID attribution of Timestamped Spatial Emission Data transmitted by the reassigned tracking element or by any other tracking element within said performer spatial assembly, or functionally equivalent alternatives for preserving adjudication-grade fidelity and EDID attribution integrity of Timestamped Spatial Emission Data transmitted by said differentiated surface regions during dynamic radio frequency spectral adaptation.

12. The system of claim 1, further comprising an adjudication participation state architecture, said adjudication participation state architecture assigning to each EDID-bearing performer spatial assembly and venue spatial assembly component a participation state selected from a defined set of participation states including at least an active field presence state for EDID-bearing performer spatial assemblies and venue spatial assembly components whose EDID-attributed Timestamped Spatial Emission Data transmitted by their differentiated surface regions is adjudicatively relevant to current performance events and a reduced-priority field presence state for EDID-bearing performer spatial assemblies and venue spatial assembly components whose EDID-attributed Timestamped Spatial Emission Data transmitted by their differentiated surface regions is not adjudicatively relevant to current performance events, said adjudication participation state architecture providing state-aware emission filtering wherein said AI-driven sensor fusion engine applies differentiated Timestamped Spatial Emission Data acquisition, processing, and reporting protocols to EDID-attributed Timestamped Spatial Emission Data transmitted by the differentiated surface regions of each EDID-bearing performer spatial assembly and venue spatial assembly component based on the participation state assigned to that EDID-bearing performer spatial assembly or venue spatial assembly component, wherein said state-aware emission filtering modulates the fidelity, temporal resolution, and adjudicative weighting applied to EDID-attributed Timestamped Spatial Emission Data transmitted by each EDID-bearing performer spatial assembly and venue spatial assembly component's differentiated surface regions according to adjudicative relevance associated with each participation state, such that EDID-attributed Timestamped Spatial Emission Data transmitted by EDID-bearing performer spatial assemblies and venue spatial assembly components in an active field presence state is processed at full adjudication-grade fidelity while data transmitted by EDID-bearing performer spatial assemblies and venue spatial assembly components in a reduced-priority field presence state receive reduced processing allocation without terminating EDID attribution or region-level differentiation for those assemblies, wherein said participation state assignments are dynamic and reversible, updatable in response to event-conditioned adjudicative state transitions throughout a defined performance session, and wherein said adjudication participation state architecture operates upon EDID-attributed spatial data originating from within said performer spatial assemblies through emission rather than upon positional estimates derived from external fixed-sensor observation of performer locations, or functionally equivalent alternatives for state-aware modulation of Timestamped Spatial Emission Data transmission processing fidelity across EDID-bearing performer spatial assemblies and venue spatial assembly components of differing adjudicative relevance within an object-originated spatial awareness architecture.

13. The system of claim 5, further comprising a pre-performance session initialization protocol, said session initialization protocol comprising: binding said EDIDs of all equipment components belonging to each performer into said session-bound identities of claim 1, establishing the authoritative mapping between physical equipment components bearing respective per-element EDIDs and said differentiated surface regions of said performer spatial assembly such that each said differentiated surface region is associated with a specific EDID-bearing equipment component for the duration of a defined performance session; executing a pre-performance session-bound topographical registration establishing inter-layer transfer functions for each said anatomical proximity layer within said multi-garment hierarchical confidence architecture, said topographical registration verifying geometric correspondence between said inner body-conformal garment layer functioning as said anatomical reference datum and each successive outer anatomical proximity layer at each said differentiated surface region across a range of articulation states characteristic of the tracked activity; and creating said genesis block anchoring said tamper-evident forensic replay ledger of claim 1, wherein said genesis block records said authoritative mapping between physical equipment components and said session-bound identities such that all subsequent proof-of-position attestations recorded in said tamper-evident forensic replay ledger are cryptographically traceable to the EDID-to-region mapping established during said session initialization protocol, or functionally equivalent alternatives for establishing pre-performance session-bound topographical registration of said multi-garment hierarchical confidence architecture and EDID-to-identity binding within an object-originated spatial awareness architecture.

14. The method of claim 2, further comprising filtering EDID-attributed Timestamped Spatial Emission Data transmitted by the differentiated surface regions of said EDID-bearing performer spatial assemblies and venue spatial assembly components based on an adjudication participation state assigned to each EDID-bearing performer spatial assembly and venue spatial assembly component, said filtering comprising applying differentiated Timestamped Spatial Emission Data acquisition, processing, and reporting protocols to EDID-attributed Timestamped Spatial Emission Data transmitted by the differentiated surface regions of each EDID-bearing performer spatial assembly and venue spatial assembly component based on the participation state assigned to that EDID-bearing performer spatial assembly or venue spatial assembly component, wherein said filtering cooperates with said fusing step by modulating the fidelity, temporal resolution, and adjudicative weighting applied to EDID-attributed Timestamped Spatial Emission Data transmitted by each EDID-bearing performer spatial assembly and venue spatial assembly component's differentiated surface regions according to adjudicative relevance associated with each participation state, such that EDID-attributed Timestamped Spatial Emission Data transmitted by EDID-bearing performer spatial assemblies and venue spatial assembly components in an active field presence state is processed at full adjudication-grade fidelity while data transmitted by EDID-bearing performer spatial assemblies and venue spatial assembly components in a reduced-priority field presence state receive reduced processing allocation without terminating EDID attribution or region-level differentiation for those assemblies, wherein said participation state assignments are dynamic and reversible, updatable in response to event-conditioned adjudicative state transitions throughout a defined performance session, and wherein said filtering operates upon EDID-attributed spatial data originating from within said performer spatial assemblies through emission rather than upon positional estimates derived from external fixed-sensor observation of performer locations, or functionally equivalent alternatives for state-aware modulation of Timestamped Spatial Emission Data transmission processing fidelity across EDID-bearing performer spatial assemblies and venue spatial assembly components of differing adjudicative relevance within an object-originated spatial awareness architecture.

15. The method of claim 2, wherein said fusing step further comprises dynamically evaluating cooperative spatial reference contributions within said cooperative spatial mesh through a dynamic role allocation wherein each said performer spatial assembly, each said venue spatial assembly anchor component, and each EDID-bearing game object and field delimiter assembly simultaneously contributes multi-modal Timestamped Spatial Emission Data attributed at emission to respective per-element EDIDs from said differentiated surface regions to said fusing through said reciprocal spatial emission architecture, said cooperative spatial reference contributions comprising Timestamped Spatial Emission Data across said plurality of independent sensing modalities spanning said plurality of distinct technical domains and being dynamically weighted by said dynamic authority modulation architecture according to proximity to authoritative boundary surfaces, event-conditioned adjudicative relevance, positional stability, signal quality, and geometric distribution relative to current performance events, wherein said dynamic authority modulation architecture operates upon said cooperative spatial reference contributions concurrently with and through the same nested hierarchical topology as said context-defined authority weights applied among said differentiated surface regions and among said hierarchically ordered tracking tiers within each said performer spatial assembly, such that cooperative spatial reference weighting among assemblies, authority modulation among anatomical proximity layers within each assembly, and reliability weighting among sensing modalities are resolved concurrently by said AI-driven sensor fusion engine as interdependent functions of said dynamic authority modulation architecture rather than as independent weighting operations, wherein said fusing accommodates heterogeneous assembly classes comprising performer-worn assemblies optimized for sensing density within Physical Compliance constraints, officiating crew assemblies carrying enhanced transmission, signal repetition, and mobile anchor capability exploiting reduced Physical Compliance constraints, game object assemblies carrying substrate-specific sensor configurations, and venue-integrated assemblies carrying statie geometric reference framework, said heterogeneous assembly classes contributing complementary and differentiated Timestamped Spatial Emission Data such that the cooperative spatial reference value of each assembly class derives from its distinct capabilities within said nested hierarchical topology rather than from homogeneous node functionality, and wherein said dynamic role allocation accommodates non-programmatic, reactive, collision-assumptive movement of deformable bodies whose spatial states are not reducible to rigid-body parameters, said dynamic role allocation architecture being structurally distinct from hub-and-spoke choreographic positioning architectures wherein collision avoidance is a governing structural constraint and contact between tracked objects is treated as a fault condition to be prevented through centralized trajectory coordination, wherein said fusing maintains adjudication-grade spatial determination without dependency upon fixed venue anchor infrastructure by deriving spatial reference from the dynamic cooperation of said assemblies whose spatial data originates from within said assemblies rather than from external line-of-sight dependent observation, said fusing providing cross-venue operational continuity wherein said method operates across venues possessing different infrastructure configurations including venues possessing no fixed anchor infrastructure through said dynamic cooperation of said EDID-bearing assemblies, or functionally equivalent alternatives for achieving adjudication-grade spatial determination through object-originated cooperative spatial reference within said nested hierarchical topology.

16. The method of claim 3, wherein said volumetric performance reconstruction produced in said producing stop preserves a full geometric envelope of each performer spatial assembly comprising said differentiated surface regions throughout a defined event interval of a recorded activity, said volumetric performance reconstruction retaining three-dimensional surface geometry, deformation state, articulated joint kinematics derived from said region-differentiated volumetric data, and surface contact topology across successive spatiotemporal state records with spatiotemporal accuracy sufficient for forensic reconstruction of region-specific contact events, contact durations, and deformation states, wherein said volumetric performance reconstruction cooperates with said cryptographic provenance chains by maintaining per-element EDID attribution throughout said reconstruction, and wherein said volumetric performance reconstruction cooperates with said cryptographic access control layer of claim 3 such that tiered access permissions govern the resolution, temporal granularity, and attribution detail available to different consuming application tiers accessing said reconstruction, wherein said tiered access operates upon hierarchically differentiated Timestamped Spatial Emission Data whose hierarchical differentiation is dynamically modulated by context-defined relevance criteria, preserving surface contact topology derived from said hierarchical tracking modality of claim 1 rather than upon undifferentiated point cloud surface representations, such that said tiered access permissions modulate access to sparse vector-based topographical wireframe data whose hierarchical layer differentiation is an architecturally intrinsic property of said object-originated spatial data unavailable to consuming applications operating upon undifferentiated surface topology point cloud data constructed from an externally observed line-of-sight dependent system, or functionally equivalent alternatives for producing temporally continuous volumetric performance records with maintained cryptographic provenance.

17. The non-transitory computer-readable medium of claim 4, wherein said spatial identity data record is further formatted as an interactive performance data stream structured for machine consumption by game engines, simulation platforms, and interactive entertainment applications, said interactive performance data stream comprising articulated configuration parameters, surface deformation coefficients, and contact event descriptors, each derived from said region-differentiated, EDID-attributed Timestamped Spatial Emission Data of said spatial identity data record, organized in a temporally indexed format enabling consuming applications to reconstruct three-dimensional region-differentiated performer motion including independent spatial position and orientation of each EDID-attributed surface region within said performer spatial assembly, equipment deformation, and surface contact topology at frame rates determined by the consuming application rather than by an originating capture rate, or functionally equivalent alternatives for delivering region-differentiated performer Timestamped Spatial Emission Data to interactive applications at application-determined frame rates.

18. The system of claim 13, wherein said multi-garment hierarchical confidence architecture comprises, for a cranial region of a performer, a multi-layer cranial hierarchy comprising at least two hierarchically ordered layers, said multi-layer cranial hierarchy in its preferred embodiment comprising: (i) a skin-adhered body-conformal reference substrate applied directly to cranial, temporal, and posterior cervical surfaces of the performer, said skin-adhered body-conformal reference substrate functioning as the anatomical reference datum for the cranial region within said multi-garment hierarchical confidence architecture by virtue of its direct skin-surface adhesion, and receiving highest authority weighting for cranial anatomical position determination within said dynamic authority modulation architecture of claim 1; (ii) a sensor-equipped cranial liner garment worn over said skin-adhered body-conformal reference substrate and under helmet interior padding, said cranial liner garment carrying tracking elements that emit Timestamped Spatial Emission Data attributed at emission to respective per-element EDIDs, contact sensing circuitry, and flexible-substrate conductor integration arrays incorporated into the textile substrate of said cranial liner garment through woven, knitted, printed, bonded, or functionally equivalent flexible-substrate conductor integration methods; (iii) compressible energy-absorbing foam padding within a helmet interior, said foam padding accommodating compression-tolerant conductor geometries that maintain electrical continuity through repeated compression-decompression cycles; and (iv) a rigid thermoplastic outer shell accommodating conductor integration through in-mold embedding or inter-layer lamination, wherein each said layer of said multi-layer cranial hierarchy comprises EDID-bearing equipment components whose tracking elements independently emit Timestamped Spatial Emission Data attributed at emission to their respective per-element EDIDs, and wherein said AI-driven sensor fusion engine applies the inter-layer transfer functions established during said session initialization protocol of claim 13 to the Timestamped Spatial Emission Data emitted by each layer's EDID-bearing components to derive the cranial anatomical ground truth position from any layer's emitted data through successive inter-layer corrections applied in the direction of authority established by said dynamic authority modulation architecture of claim 1, or functionally equivalent alternatives for hierarchically instrumented cranial tracking within said multi-garment hierarchical confidence architecture.

19. The system of claim 18, wherein said multi-layer cranial hierarchy produces dual independent outputs comprising: (i) the anatomical ground truth position and orientation of the performer's cranium derived from Timestamped Spatial Emission Data attributed at emission to the per-element EDIDs of the EDID-bearing components of said skin-adhered body-conformal reference substrate through successive inter-layer corrections applied in the direction of authority established by said dynamic authority modulation architecture of claim 1; and (ii) an equipment-to-anatomy displacement measurement representing spatial deviation between said rigid thermoplastic outer shell and said performer's cranium derived from Timestamped Spatial Emission Data attributed at emission to the per-element EDIDs of EDID-bearing components of said rigid thermoplastic outer shell and said skin-adhered body-conformal reference substrate across successive spatiotemporal state records, said dual independent outputs cooperating to enable adjudication determinations identifying which differentiated surface region of the performer's cranial hierarchy initiated contact and which differentiated surface region of an opposing performer's cranial hierarchy was spatially coincident at the contact event, as resolved through cooperative triangulation of EDID-attributed Timestamped Spatial Emission Data emitted by the differentiated surface regions of both cranial hierarchies and adjudicated by said AI-driven sensor fusion engine through said dynamic authority modulation architecture of claim 1, or functionally equivalent alternatives for dual-output cooperative cranial contact determination within said multi-layer cranial hierarchy.

20. The system of claim 19, further comprising a concussion protocol diagnostic architecture, said concussion protocol diagnostic architecture cooperatively integrating EDID-attributed Timestamped Spatial Emission Data transmitted by the differentiated surface regions of said multi-layer cranial hierarchy to produce simultaneous multi-output diagnostic determinations comprising at least: (i) real-time determination of whether a specific impact event exceeded rated energy absorption capacity of said compressible energy-absorbing foam padding, derived from inter-layer displacement measurements between EDID-attributed Timestamped Spatial Emission Data transmitted by EDID-bearing components of said foam padding layer and said rigid thermoplastic outer shell; (ii) spatial mapping of compression distribution across said foam padding during impact distinguishing focal-point loading from distributed loading, derived from differential displacement patterns across spatially distributed EDID-bearing components of said foam padding layer; (iii) detection of progressive foam degradation through tracked decrease in inter-layer distance recovery relative to registered baseline established during said pre-performance session-bound topographical registration of claim 13; and (iv) quantification of inter-member load transfer at instrumented junction fastener assemblies connecting a facemask cage to said rigid thermoplastic outer shell, wherein said concussion protocol diagnostic architecture operates upon EDID-attributed spatial data originating from within said multi-layer cranial hierarchy through emission rather than upon positional estimates derived from external fixed-sensor observation of performer locations, and wherein said concussion protocol diagnostic architecture operates upon said multi-layer cranial hierarchy regardless of the occupational domain of said rigid thermoplastic outer shell, such that said diagnostic determinations are produced identically whether said outer shell comprises an athletic helmet, a military flight helmet, a motorsport crash helmet, a firefighter helmet, or functionally equivalent protective headgear for helmeted-occupant environments, and wherein said sensor-equipped cranial liner garment within said multi-layer cranial hierarchy comprises a garment appropriate to said occupational domain including but not limited to a fire-resistant flight suit hood, a Nomex balaclava, or a flash hood, or functionally equivalent cranial liner garments for non-sports helmeted-occupant applications, and wherein said simultaneous multi-output diagnostic determinations of claim 19 comprising cranial anatomical ground truth position and equipment-to-anatomy displacement are maintained regardless of said occupational domain, or functionally equivalent alternatives for cooperative multi-output cranial diagnostic determination within said multi-layer cranial hierarchy.

21. The non-transitory computer-readable medium of claim 4, wherein said surface contact maps of element (b) comprise a temporally ordered sequence of region-attributed contact-state records, each said contact-state record identifying: (i) a specific EDID-differentiated surface region of a performer spatial assembly involved in a contact event with a non-performer physical surface or with a surface region of another performer spatial assembly; (ii) a contact-state classification distinguishing among at least a sustained contact state, a transient impact state, and an airborne non-contact state for said identified surface region; and (iii) a spatiotemporal duration for each said contact-state classification at said identified surface region, said duration being a first-class constitutive attribute of the Timestamped Spatial Emission Data record rather than derived from post hoc temporal indexing of externally observed frames; wherein said temporally ordered sequence preserves, for each EDID-differentiated surface region independently, the temporal ordering, duration, and state-transition timing of successive contact events such that a sustained surface drag is recorded as a structurally distinct contact-state expression from a transient impact at the same surface region, and such that an ordered sequence of region-attributed contact-state transitions across a plurality of independently trackable differentiated surface regions—including sequential left-region and right-region contact alternations, simultaneous multi-region contacts, and variable-duration airborne intervals between contacts—is determinable from said temporally ordered sequence without post hoc geometric reconstruction from external line-of-sight dependent observation, wherein said determinability arises from the intrinsic per-element EDID attribution at emission and object-originated temporal continuity of said spatial data rather than from frame-by-frame geometric reconstruction of externally observed image sequences, and wherein said contact-state characterization operates with equal temporal fidelity across all contact-state classifications including sustained contact states, transient impact states, and airborne non-contact states, such that non-contact intervals are preserved as durational states within said temporally ordered sequence with the same region-attributed temporal precision as contact intervals, and such that the complete temporal topology of contact-state transitions constitutes a continuous, EDID-differentiated characterization of the physical interaction between said performer spatial assembly and its environment rather than a discrete event log of contact occurrences.
